(19) United States
(12) Patent Application Publication
(10) Pub. No.: US 2005/0120232 A1
(43) Pub. Date: Jun. 2, 2005

(54) Data terminal managing ciphered content data and license acquired by software

(76) Inventors: Yoshihiro Hori, Osaka (JP); Toru Kamimura, Shiga (JP); Shinya Miyazono, Hygo (JP); Takahisa Hatakeyama, Kanagawa (JP); Masataka Takahashi, Ishikawa (JP); Takashi Tsunehiro, Kanagawa (JP); Yoshio Ohmori, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/416,538

(22) PCT Filed: Nov. 27, 2001
(86) PCT No.: PCT/JP01/10344

(30) Foreign Application Priority Data
Nov. 28, 2000 (JP) 2000-361632
Nov. 29, 2000 (JP) 2000-362913

(51) Int. Cl. G06F 12/14; H04L 9/00

(52) U.S. Cl. 713/193; 705/57

(57) ABSTRACT

A hard disk (530) of a personal computer has a content list file (150) and an encrypted private file (162). A license administration device (520) stores a binding key Kb in a license region (5215B) of a memory. The encrypted private file (162) can be decrypted and encrypted with the binding key Kb stored in the license administration device (520). The license of the obtained and encrypted content data is stored as private information in the encrypted private file (162). Consequently, the encrypted content data and the license distributed by software can be shifted to another data terminal device.

### TECHNICAL FIELD

The present invention relates to a data terminal device used in a data distribution system, which can secure a copyright relating to copied information.

### BACKGROUND ART

Owing to progress in information communication networks such as the Internet in recent years, users can easily access network information through personal terminals employing cellular phones or the like.

Over such information communication network, information is transmitted as digital signals. Therefore, each user can copy music data and movie data, which are transmitted via the information communication network, without substantial degradation in the audio quality and picture quality.

Accordingly, a right of a copyright owner may be significantly infringed when copyrighted creation or production such as music data and movie data are transmitted over the information communication network without appropriate measures for protecting the copyrights.

Conversely, top priority may be given to the copyright protection by disabling or inhibiting distribution of copyrighted data over the information communication network, which is growing exponentially. However, this causes disadvantages to the copyright owner who can essentially collect a predetermined copyright royalty for copying of copyrighted data.

Instead of the distribution over the information communication network described above, distribution may be performed via record mediums storing digital data. In connection with the latter case, music data stored in CDs (Compact Disks) on the market can be freely copied in principle onto magneto-optical disks (e.g., MDs) as long as the copied music is only for the personal use. However, a personal user performing digital recording or the like indirectly pays predetermined amounts in prices of the digital recording device itself and the mediums such as MDs as guaranty moneys to a copyright owner.

Further, the music data is digital data formed of digital signals, and substantially no deterioration occurs in copied information when music data is copied from a CD to an MD. Therefore, for the copyright protection, such structures are employed that the music information cannot be copied as digital data from the MD to another MD.

In view of the above, the public distribution itself of copyrighted materials such as music data or movie data over the digital information communication network must be inhibited by sufficient measures for the copyright protection, because such distribution itself is restricted by the pubic transmission right of the copyright holder.

For the above case, it is necessary to inhibit unauthorized further copy of the content data such as music data or image data, which was distributed to and was once received by the public over the information communication network.

Such a data distribution system has been proposed that a distribution server holding the encrypted content data distributes the encrypted content data and the license to memory cards attached to terminal devices such as cellular phones via the terminal devices. In this data distribution system, a public encryption key of the memory card, which has been authenticated by an certification authority, and its certificate are sent to the distribution server when requesting the distribution of encrypted content data. After the distribution server determines the reception of the authenticated certificate, the encrypted content data and a license key for decrypting the encrypted content data are sent to the memory card. When distributing the encrypted content data and the license, the distribution server and the memory card generate a session key, which is different from those generated in other distribution. With the session key thus generated, the public encryption key is encrypted, and the keys are exchanged between the distribution server and the memory card.

Finally, the distribution server sends the license, which is encrypted with the public encryption key peculiar to each memory card, and is further encrypted with the session key, as well as the encrypted content data to the memory card. The memory card records the license and the encrypted content data thus received in the memory card.

When the encrypted content data recorded in the memory card is to be reproduced, the memory card is attached to the cellular phone. In addition to an ordinary function of the telephone, the cellular phone has a dedicated circuit for reading the encrypted content data and the license key from the memory card, decrypting the encrypted content data thus read with the read license key, and reproducing it for external output.

As described above, the user of the cellular phone can receive the encrypted content data from the distribution server via the cellular phone, and can reproduce the encrypted content data.

Such content distribution service is now performed that content data is distributed over the Internet to personal computers. In this content distribution service using the Internet, it is possible to distribute the encrypted content data and the license in a manner similar to the foregoing distribution manner. For distributing the encrypted content data to the personal computers, software installed in the personal computer is used for distributing the encrypted content data and the license, and the security of the encrypted content data is lower than that in the case where the encrypted content data is written into the memory card. By attaching the above memory card or a device having a license administration structure similar to that of the memory card to a personal computer, it is possible to provide a security level similar to that achieved by directly writing the license into the memory card attached to the cellular phone.

However, if the distribution service is constructed based on the assumption that the memory card or the above device is attached to the personal computer, this reduces opportunities of distribution. Accordingly, the content distribution service can be practical if the distribution is performed depending on the security level desired by the content data supplier only when the personal computer at the destination has the capability for it. Thereby, the personal computer having the capabilities for both the security levels receives the licenses by the installed software and the above device. Thus, the personal computer receives and administers the licenses having different security levels, respectively.

In still another manner of obtaining the encrypted content d ata and the license, music data can be obtained by ripping from music CDs. The ripping produces encrypted music data (encrypted content data) from music data as well as a license for decrypting and reproducing the encrypted music data. According to this ripping, a watermark defining rules of use of the content data is detected from the content data, and the encrypted content data and the license are produced in accordance with contents of the detected watermark. Because of its characteristics, the license thus produced is administered at a lower security level administered by software.

When the encrypted content data and the license keys are received at different security levels, the license key received at a high security level cannot be handled at a low security level. Conversely, the license key received at a low security level can be handled at a high security level without a problem when viewed from a concept of security. However, various restrictions are imposed on such handling due to the high security level, and thus impair conveniences. Further, even if both the security levels can be handled, functions for different security levels may operate independently of each other. This likewise impairs the conveniences of users. Accordingly, it is necessary to provide an operating or handling environment for administering both the security levels in a unified manner.

According to the content data distribution over the Internet in recent years, the content data is administered by software. In this case, the data itself recorded in an auxiliary recording device of the personal computer can be freely duplicated, and therefore the use of the duplicated data is restricted in such a manner that the data is recorded in an encrypted form linked with information such as a version of BIOS or an ID number of a CPU, which can be obtained from the personal computer and is peculiar to the personal computer, for allowing use of the duplicated content data by another personal computer.

This administration method can be utilized for distribution of the encrypted content data and the license, and the security can be ensured by recording the information in an encrypted form uniquely linked with the personal computer. In this case, however, it is completely impossible to cut out the distributed license from the personal computer.

In the above case where the license received by the personal computer cannot be taken out from the personal computer at all, the encrypted content data and the license, which are already received, can no longer be utilized when the personal computer is damaged, the BIOS is updated or the CPU is changed.

### DISCLOSURE OF THE INVENTION

Accordingly, an object of the invention is to provide a data terminal device, which can shift encrypted content data and a license distributed by software to another data terminal device.

Another object of the invention is to provide a data terminal device, which can administer received license keys distributed at different security levels in accordance with the corresponding security levels, respectively.

According to the invention, a data terminal device obtaining encrypted content data prepared by encrypting content data and a license for decrypting the encrypted content data to obtain original plaintext, and providing the encrypted content data and the license to another data terminal device, includes a module unit obtaining the encrypted content data and the license by software, and administering the license a device unit decrypting the encrypted private file and storing a binding license including a binding key encrypting the decrypted private file in a dedicated region; a storing unit storing data; and a control unit. The storing unit stores a plurality of encrypted content data, and an encrypted private file including the plurality of license, and encrypted with the binding key. In providing the license, the control unit reads the encrypted private file from the storing unit, and provides the encrypted private file to the module unit. The module unit obtains the binding license from the device unit, extracts the binding key from the obtained binding license, and provides the license obtained by decrypting the encrypted private file with the extracted binding key.

Preferably, in initializing the encrypted private file, the module unit produces the binding license including the binding key, produces a private file not including the license, encrypts the produced private file with the produced binding key to produce the encrypted private file, and provides the produced binding license to the device unit. The control unit stores the encrypted private file produced by the module unit in the storing unit.

Further preferably, in obtaining the license, the control unit provides the obtained license to the module unit, reads the encrypted private file stored in the storing unit, and provides the read encrypted private file to the module unit. The module unit obtains the binding license from the device unit, decrypts the provided and encrypted private file with the binding key included in the binding license obtained from the device unit, adds the provided license to the decrypted private file to update the private file, and encrypts the updated private file with the binding key to produce the updated and encrypted private file. The control unit overwrites the encrypted private file stored in the storing unit with the encrypted private file produced and updated by the module unit.

Preferably, in providing the license, the control unit sends the encrypted content data corresponding to the license and stored in the storing unit to a destination of the license.

Preferably, after sending the license, the module unit produces one new binding key, produces one new binding license including the produced one new binding key, produces one new encrypted private file by encrypting the private file with the one new binding key, and provides the produced one new binding license to the device unit. The device unit stores the received one new binding license in the dedicated region by overwriting. The control unit overwrites the encrypted private file stored in the storing unit with the one new encrypted private file produced by the module unit.

Preferably, in sending the license to the different data terminal device, the control unit receives authentication data from the different data terminal device, provides the authentication data to the module unit, reads the encrypted private file from the storing unit, and provides the encrypted private file to the module unit. When the module unit authenticates the authentication data received from the different data terminal device, the module unit constructs an encryption path to the different data terminal device via the control unit, obtains the binding license from the device unit, decrypts the received and encrypted private file with the binding key included in the binding license obtained from the device unit, extracts the license to be sent from the decrypted private file, and sends the extracted license to the different data terminal device via the encryption path. After sending the license, the module unit produces one new binding key, produces one new binding license including the produced one new binding key, deletes the sent license from the private file, encrypts the private file previously including the sent and deleted license with the one new binding key to produce one new encrypted private file, and provides the produced one new binding license to the device unit. The device unit stores the received one new binding license in the dedicated region by overwriting. The control unit overwrites the encrypted private file stored in the storing unit with the one new encrypted private file produced by the module unit.

Preferably, in obtaining the binding license from the device unit, the module unit provides authentication data peculiar to the module unit itself to the device unit, constructs an encryption communication path to the device unit in response to authentication of the authentication data by the device unit, and obtains the binding license from the device unit via the constructed encryption communication path.

Preferably, in providing the binding license to the device unit, the module unit receives the authentication data from the device unit, constructs an encryption communication path to the device unit in response to authentication of the received authentication data, and provides the binding license to the device unit via the constructed encryption communication path.

More preferably, in obtaining the encrypted content data and the license from the distribution server connected over a data communication network, the control unit obtains the encrypted content data from the distribution server over the data communication network, the module unit provides the authentication data peculiar to the module unit itself via the control unit and over the data communication network, and constructs an encryption communication path with respect to the distribution server, and obtains the license from the distribution server via the constructed encryption communication path.

Preferably, when the content data is obtained, the control unit provides the obtained content data to the module unit, reads the encrypted private file stored in the storing unit, and provides the read encrypted private file to the module unit. The module unit produces a license for the provided content data, produces encrypted content data by encrypting the provided content data with the produced license in a reproducible manner, obtains the binding license from the device unit, decrypts the provided and encrypted private file with the binding key included in the obtained binding license, updates the private file by newly adding the produced license to the decrypted private file, produces the updated and encrypted private file by encrypting the updated private file with the binding key. The control unit overwrites the encrypted private file stored in the storing unit with the updated and encrypted private file produced by the module unit, and stores the encrypted content data produced by the module unit in the storing unit.

Preferably, the encrypted private file includes, for each license, check-out information for checking out the license to a data recording device. In sending the license to the data recording device, the control unit receives authentication data from the data recording device, provides the received authentication data to the module unit, reads the encrypted private file from the storing unit, and provides the encrypted private file to the module unit. When the module unit authenticates the authentication data received from the data recording device, the module unit constructs an encryption path to the data recording device via the control unit, obtains the binding license from the device unit, decrypts the provided and encrypted private file with a binding key included in the obtained binding license, extracts the license to be sent and the check-out information from the decrypted private file, produces a check-out license to be checked out to the data storing device based on the license to be sent when it is determined from the extracted check-out information that check-out of the license is allowed, constructs an encryption path to the data recording device via the control unit, sends the check-out license to the data recording device via the encryption path, obtains specifying information for specifying the data recording device via the encryption path, produces new check-out information by adding the obtained specifying information to the check-out information, produces one new private file by overwriting the check-out information of the private file with the new check-out information, and produces one new encrypted private file by encryption with the binding key. The control unit overwrites the encrypted private file stored in the storing unit with the one new encrypted private file produced by the module unit.

Preferably, the encrypted private file includes, for each license, check-out information for checking out the license to a data recording device. In sending the license to the data recording device, the control unit receives authentication data from the data recording device, provides the received authentication data to the module unit, reads the encrypted private file from the storing unit, and provides the encrypted private file to the module unit. When the module unit authenticates the authentication data received from the data recording device, the module unit constructs an encryption path to the data recording device via the control unit, obtains the binding license from the device unit, decrypts the provided and encrypted private file with a binding key included in the obtained binding license, extracts the license to be sent and the check-out information from the decrypted private file, produces a check-out license to be checked out to the data recording device based on the license to be sent when it is determined from the extracted check-out information that check-out of the license is allowed, constructs an encryption path to the data recording device via the control unit, sends the check-out license to the data recording device via the encryption path, and obtains specifying information for specifying the data recording device via the encryption path. After sending the license, the module unit produces one new binding key, produces one new binding license including the produced new binding key, produces new check-out information by adding the obtained specifying information to the check-out information, produces one new private file by overwriting the check-out information of the private file with the new check-out information, produces one new encrypted private file by encrypting the produced one new private file with the one new binding key, and provides the produced one new binding license to the device unit. The device unit stores the received one new binding license in the dedicated region by overwriting. The control unit overwrites the encrypted private file stored in the storing unit with the one new encrypted private file produced by the module unit.

According to the invention, a data terminal device obtaining encrypted content data prepared by encrypting content data and a license for decrypting the encrypted content data to obtain original plaintext, and providing the encrypted content data and the license to another data terminal device, includes a module unit obtaining the encrypted content data and the license by software, producing a dedicated license by effecting encryption suitable to administration on the license, and administering the license; a device unit storing a binding license including a binding key in a dedicated region; a storing unit storing data; and a control unit. The storing unit stores a plurality of encrypted content data, a plurality of administration files including the dedicated license, and an encrypted private file encrypted uniquely and including the binding license as a component. In providing the license, the control unit reads the encrypted private file and the administration files from the storing unit, and provides the encrypted private file and the administration files to the module unit. The module unit extracts the binding license by decrypting the encrypted private file, obtains the binding license from the device unit, and provides the license obtained by decrypting the dedicated license included in the administration files when the extracted binding license matches with the binding license extracted from the encrypted private file.

Preferably, in initializing the encrypted private file, the module unit produces the binding license including the binding key, produces a private file storing the produced binding license, uniquely encrypts the produced private file to produce the encrypted private file, and provides the produced binding license to the device unit. The control unit stores the encrypted private file produced by the module unit in the storing unit.

More preferably, in obtaining the license, the control unit provides the obtained license to the module unit, produces the dedicated file including the dedicated license produced by the module unit, and stores the dedicated file in the storing unit. The module unit uniquely encrypts the provided license to produce the dedicated license.

More preferably, in providing the license, the control unit sends the encrypted content data corresponding to the license and stored in the storing unit to a destination of the license.

More preferably, after providing the license, the module unit produces one new binding key, produces one new binding license including the produced one new binding key, produces one new private file including the one new binding license, produces one new encrypted private file by uniquely encrypting the produced one new private file, and provides the produced one new binding license to the device unit. The device unit stores the received one new binding license in the dedicated region by overwriting. The control unit overwrites the encrypted private file stored in the storing unit with the one new encrypted private file produced by the module unit, and deletes the administration file including the license.

More preferably, in sending the license to the different data terminal device, the control unit receives authentication data from the different data terminal device, provides the authentication data to the module unit, reads the encrypted private file and the administration file from the storing unit, and provides the encrypted private file and the administration file to the module unit. The module unit extracts the binding license by decrypting the encrypted private file, obtains the binding license from the device unit, constructs an encryption path to the different data terminal device via the control unit when the extracted binding license matches with the binding license extracted from the encrypted private file and the authentication data received from the different data terminal device is authenticated, and sends the license obtainable by decrypting the provided and dedicated license to the different data terminal device via the encryption path. After sending the license, the module unit produces one new binding key, produces one new binding license including the produced one new binding key, produces one new private file including the produced one new binding license, produces one new encrypted private file by uniquely encrypting the produced one new private file, and provides the produced one new binding license to the device unit. The device unit stores the received one new binding license in the dedicated region by overwriting. The control unit overwrites the encrypted private file stored in the storing unit with the one new encrypted private file produced by the module unit, and deletes the administration file including the license.

Preferably, a manner of the uniquely encrypting the file is linked with information peculiar to data terminal device and obtainable from the data terminal device.

More preferably, in providing the binding license to the device unit, the module unit receives authentication data from the device unit, constructs an encryption communication path to the device unit in response to authentication of the received authentication data, and provides the binding license to the device unit via the constructed encryption communication path.

More preferably, in obtaining the binding license from the device unit, the module unit provides authentication data peculiar to the module unit itself to the device unit, constructs an encryption communication path to the device unit in response to authentication of the authentication data by the device unit, and obtains the binding license from the device unit via the constructed encryption communication path.

More preferably, in obtaining the encrypted content data and the license from the distribution server connected over a data communication network, the control unit obtains the encrypted content data from the distribution server over the data communication network. The module unit provides the authentication data peculiar to the module unit itself via the control unit and over the data communication network, constructs an encryption communication path to the distribution server, and obtains the license from the distribution server via the constructed encryption communication path.

More preferably, when the content data is obtained, the control unit provides the obtained content data to the module unit, produces the administration file including the dedicated license produced by the module unit, and writes the produced administration file and the encrypted content data produced by the module unit in the storing unit. The module unit produces a license for the obtained content data, produces encrypted content data by encrypting the obtained content data with the produced license in a reproducible manner, and produces the dedicated license including the produced license.

More preferably, the dedicated license includes check-out information for checking out the license to a data recording device. In sending the license to the data recording device, the control unit receives authentication data from the data recording device, provides the received authentication data to the module unit, reads the encrypted private file and the administration file from the storing unit, and provides the encrypted private file and the administration file to the module unit. The module unit extracts the binding license by decrypting the encrypted private file; obtains the binding license from the device unit; produces a check-out license to be checked out to the data recording device based on the license obtained by decrypting the provided dedicated license when the obtained binding license matches with the binding license extracted from the encrypted private file, the authentication data received from the data recording device is authenticated and it is determined according to the check-out information obtainable by decrypting the provided dedicated license that the check-out of the license is allowed; constructs an encryption path to the data recording device via the control unit; sends the check-out license to the data recording device via the encryption path; obtains specifying information specifying the data recording device via the encryption path from the data recording device; produces new check-out information by adding the obtained specifying information to the check-out information; and produces one new dedicated license including the license included in the provided dedicated license and the new check-out information. The control unit overwrites the dedicated license in the administration file stored in the storing unit with the one new dedicated license produced by the module unit.

More preferably, after sending the check-out license, the module unit produces one new binding key, produces one new binding license including the produced new binding key, produces one new private file including the produced one new binding license, produces one new encrypted private file by uniquely encrypting the produced one new private file, and provides the produced one new binding license to the device unit. The device unit stores the received one new binding license in the dedicated region by overwriting. The control unit overwrites the encrypted private file stored in the storing unit with the one new encrypted private file produced by the module unit.

According to the invention, a data terminal device obtaining encrypted content data prepared by encrypting content data and a license for decrypting the encrypted content data to obtain original plaintext, and administering the encrypted content data and the license, includes a device unit obtaining the license at a first security level, and administering the license at the first security level; a module unit obtaining the license at a second security level lower than the first security level, producing a dedicated license by effecting encryption suitable to administration at the second security level on the license, and administering the license; a storing unit storing data; and a control unit. The device unit includes a recording unit for recording the license while keeping a correspondence to an administration number. The storing unit stores a plurality of first administration files including a plurality of encrypted content data and the administration numbers corresponding to the licenses administered by the device unit, a plurality of second administration files including the dedicated license, and a plurality of encrypted content data corresponding to the first administration file or the second administration file. When the control unit obtains the license at the first security level, the control unit provides the license obtained at the first security level to the device unit, produces the first administration file, and writes the produced first administration file and the encrypted content data obtained corresponding to the license obtained at the first security level in the storing unit. When the control unit obtains the license at the second security level, the control unit provides the license obtained at the second security level to the module unit, obtains the dedicated license including the license obtained at the second security level from the module unit, produces the second administration file, and writes the produced second administration file and the encrypted content data obtained corresponding to the license obtained at the second security level in the storing unit.

More preferably, when the control unit obtains the license at the first security level, the control unit provides the administration number to the device unit, and produces the first administration file including the same administration number as the provided administration number. The device unit holds the license based on the administration number received from the control unit.

Preferably, the module unit produces the dedicated license in an encryption manner determined based on information peculiar to the control unit.

Preferably, the dedicated license included in the second administration file includes check-out information for checking out the encrypted content data obtained at the second security level to another device.

More preferably, the control unit obtains the encrypted content data and the license by receiving the encrypted content data and/or the license from a content supply device.

Further preferably, the device unit further includes an authentication data holding unit for holding the authentication data for the content supply device. The control unit sends the authentication data read from the device unit to the content supply device, and receives at least the license based on the authentication of the authentication data by the content supply device.

Further preferably, the module unit executes reception of the encrypted content data and the license at the second security level by a program.

Further preferably, when the content data is obtained, the control unit provides the obtained content data to the module unit. The module unit produces the license, produces the encrypted content data by encrypting the obtained content data with the produced license in a reproducible manner, and produces the dedicated license including the produced license. The control unit obtains the dedicated license including the license produced by the module unit and the produced and encrypted content data from the module unit, produces the second administration file, and writes the produced second administration file and the produced and encrypted content data in the storing unit.

Further preferably, the module unit obtains rules of use assigned to the content data, and produces the license in accordance with the obtained rules of use.

Further preferably, the module unit produces the dedicated license including check-out information for checking out the encrypted content data obtained at the second security level to another device.

Preferably, the data terminal device further includes an interface unit transmission to and from a data recording device; and a key operating unit for entering an instruction. The control unit specifies the first administration file stored in the storing unit and the encrypted content data in accordance with a shift instruction applied via the key operating unit, reads the administration number from the specified first administration file, provides the read administration number to the device unit, obtains the specified and encrypted content data from the storing unit, and sends the obtained and encrypted content data to the data recording device via the interface unit. The device unit constructs an encryption path to the data recording device via the control unit and the interface unit, and provides the license corresponding to the applied administration number to the data recording device via the encryption path.

Further preferably, the device unit erases the license when the device unit provides the license to the data recording device via the encryption path.

Preferably, the data terminal device further includes an interface unit for transmission to and from a data recording device; and a key operating unit entering an instruction. The control unit specifies the second administration file stored in the storing unit and the encrypted content data in accordance with a shift instruction applied via the key operating unit, reads the dedicated license from the specified second administration file, provides the read dedicated license to the module unit, obtains the specified and encrypted content data from the storing unit, and sends the obtained and encrypted content data to the data recording device via the interface unit. The module unit decrypts the applied dedicated license, constructs an encryption path to the data recording device via the control unit and the interface unit based on the check-out information included in the dedicated license, produces the check-out license based on the license included in the provided dedicated license, provides the produced check-out license to the data recording device via the encryption path, obtains specifying information specifying the data recording device via the encryption path from the data recording device, produces new check-out information by adding the obtained specifying information to the check-out information, and produces one new dedicated license including the license included in the provided dedicated license and the new check-out information. The control unit overwrites the dedicated license in the second administration file stored in the storing unit with the one new dedicated license produced by the module unit.

More preferably, the control unit sends encrypted content data and the license to the data recording device based on the authentication of the authentication data obtained from the data recording device via the interface unit.

### BRIEF DESCRIPTION OF THE DRAWINGS

FIG. 1 is a schematic diagram showing a concept of a data distribution system according to the invention.

FIG. 2 is a schematic view showing another-concept of the data distribution-system according to the invention.

FIG. 3 illustrates characteristics of data, information and others for communication in the data distribution systems shown in FIGS. 1 and 2.

FIG. 4 illustrates characteristics of keys and others for encryption in the data distribution systems shown in FIGS. 1 and 2.

FIG. 5 is a schematic block diagram showing a structure of a distribution server in the data distribution systems shown in FIGS. 1 and 2.

FIG. 6 is a schematic block diagram showing a structure of a personal computer in the data distribution systems shown in FIGS. 1 and 2.

FIG. 7 is a schematic block diagram showing a structure of a terminal in the data distribution system shown in FIG. 2.

FIG. 8 is a schematic block diagram showing a structure of a memory card in the data distribution systems shown in FIGS. 1 and 2.

FIG. 9 is a schematic block diagram showing a structure of a license administration device included in the personal computer shown in FIG. 6.

FIGS. 10-13 are first to fourth flow charts illustrating a distribution operation at a high security level in the data distribution systems shown in FIGS. 1 and 2, respectively.

FIGS. 14-17 are first to fourth flow charts illustrating a distribution operation at a low security level in the data distribution systems shown in FIGS. 1 and 2, respectively.

FIG. 18 illustrates a function model of CD ripping.

FIG. 19 is a flowchart illustrating an operation of ripping in the data distribution systems shown in FIGS. 1 and 2.

FIGS. 20-23 are first to fourth flow charts illustrating a shift/duplicate operation of encrypted content data and a license in the data distribution systems shown in FIGS. 1 and 2, respectively.

FIGS. 24-27 are first to fourth flow charts illustrating a check-out operation in the data distribution systems shown in FIGS. 1 and 2, respectively.

FIGS. 28-30 are first to third flow charts illustrating a check-in operation in the data distribution systems shown in FIGS. 1 and 2, respectively.

FIGS. 31 and 32 are first and second flow charts illustrating a reproduction operation of a cellular phone and a reproduction terminal, respectively.

FIG. 33 illustrates recording forms of data in a hard disk and a license administration device of a personal computer.

FIG. 34 illustrates a recording form of data in a memory card.

FIG. 35 illustrates characteristics of data, information and others used for administering a license supplied by distribution at a low security level in the personal computer shown in FIGS. 1 and 2.

FIGS. 36-38 are first to third flow charts illustrating initialization of private file performed according to a second embodiment by the personal computer shown in FIGS. 1 and 2, respectively.

FIGS. 39-43 are first to fifth flow charts illustrating a distribution operation performed according to the second embodiment at a low security level in the data distribution systems shown in FIGS. 1 and 2, respectively.

FIGS. 44-46 are first to third flow charts illustrating a ripping operation performed according to the second embodiment in the data distribution systems shown in FIGS. 1 and 2, respectively.

FIGS. 47-51 are first to fifth flow charts illustrating a check-out operation performed according to the second embodiment in the data distribution systems shown in FIGS. 1 and 2, respectively.

FIGS. 52-55 are first to fourth flow charts illustrating a check-in operation performed according to the second embodiment in the data distribution systems shown in FIGS. 1 and 2, respectively.

FIG. 56 illustrates a structure of a content list file on a hard disk of a personal computer.

FIGS. 57-64 are first to eighth flow charts illustrating shift of encrypted content data and a license to and from the personal computer in the data distribution systems shown in FIG. 2, respectively.

FIG. 65 illustrates recording forms of data in a hard disk and a license administration device of a personal computer according to the second embodiment.

FIGS. 66-68 are first to third flow charts illustrating another operation of initializing a private file performed according to a third embodiment by the personal computer shown in FIGS. 1 and 2, respectively.

FIGS. 69-72 are first to fourth flow charts illustrating a distribution operation performed according to the third embodiment at a low security level in the data distribution systems shown in FIGS. 1 and 2, respectively.

FIGS. 73 and 74 are first and second flow charts illustrating a ripping operation performed according to the third embodiment in the data distribution systems shown in FIGS. 1 and 2, respectively.

FIG. 75-79 are first to fifth flow charts illustrating a check-out operation performed according to the third embodiment in the data distribution systems shown in FIGS. 1 and 2, respectively.

FIGS. 80-83 are first to fourth flow charts illustrating a check-in operation performed according to the third embodiment in the data distribution systems shown in FIGS. 1 and 2, respectively.

FIGS. 84-90 are first to seventh flow charts illustrating an operation performed according to the third embodiment for shiftring or duplicating encrypted content data and a license to a personal computer in the data distribution systems shown in FIGS. 1 and 2, respectively.

### BEST MODE FOR CARRYING OUT THE INVENTION

Embodiments of the invention will now be described with reference to the drawings. The same or similar parts or portions bear the same reference numbers in the figures, and description thereof will not be repeated.

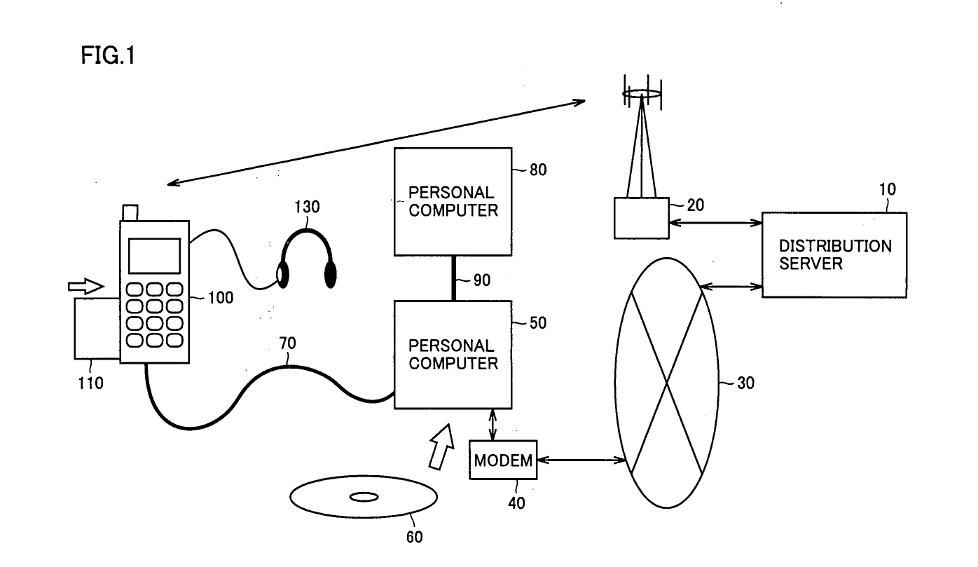

FIG. 1 is a schematic diagram showing a concept of a whole structure of a data distribution system, from which encrypted content data is obtained by a data terminal device (personal computer) according to the invention.

Description will now be given by way of example on a structure of a data distribution system, which distributes digital music data to a memory card 110 attached to a cellular phone 100 of each user via a cellular phone network, and also distributes digital music data to personal computer 50 on the Internet. However, as will become apparent from the following description, the present invention is not limited to such a case. The present invention is applicable to the distribution of other copyrighted materials, i.e., content data such as image data, movie data and others.

Referring to FIG. 1, a distribution carrier 20 relays a distribution request, which is sent from a user over a cellular phone network, to a distribution server 10. Distribution server 10, which administers the copyrighted music data, determines whether memory card 110 on cellular phone 100 of the user requesting the data distribution has proper or regular authentication data or not, and thus whether memory card 110 is a regular memory card or not. If regular, the music data, which will be referred to also as “content data” hereinafter, will be distributed to the memory card by distribution carrier 20, i.e., the cellular phone company after being encrypted in a predetermined encryption manner. For this distribution, distribution carrier 20 is supplied from distribution server 10 with the encrypted content data and a license, which is information required for reproducing the encrypted content data and includes a license key for decrypting the encrypted content data.

Distribution carrier 20 sends the encrypted content data and the license via the cellular phone network and cellular phone 100 to memory card 110 attached to cellular phone 100, which sent the distribution request over its own cellular phone network.

In FIG. 1, memory card 110 is releasably attached to cellular phone 100 of the user. Memory card 110 receives the encrypted content data received by cellular phone 100, decrypts the content data encrypted for the distribution, and then provides the decrypted data to a music reproduction unit (not shown) in cellular phone 100.

The cellular phone user, for example, can reproduce the content data to listen to the music via headphones 130 or the like connected to cellular phone 100.

According to the above structure, the user cannot reproduce the music from the data distributed from distribution server 10 without utilizing memory card 110.

Further, distribution server 10 may be configured such that every distribution of content data, e.g., for one song is counted, and distribution carrier 20 will collect the royalty, which is charged every time the user receives (downloads) the distributed content data, together with charges for telephone calls. Thereby, the copyright owner can easily ensure the royalty.

In FIG. 1, distribution server 10 is provided with a license administration module (software), which is a program module having the same license administering function as memory card 110, or a license administration device (hardware) having the same license administration function as memory card 110, and distributes a license and encrypted content data to a personal computer 50 in a manner similar to that for cellular phone 100 in response to an access performed by personal computer 50 via a modem 40 and over Internet network 30 for requesting the distribution.

In FIG. 1, it is assumed that personal computer 50 is provided with a license administration module and a license administration device. Thereby, distribution server 10 performs authentication processing to determine whether personal computer 50 accessing thereto for data distribution uses software provided with the license administration module having valid or regular authentication data or not, and thus whether the regular license administration module is used or not. If the proper license administration module is used, personal computer 50 constructs an encryption communication path to the regular license administration module on the communication path formed of Internet network 30 and modem 40 in accordance with predetermined procedures, and sends the license through the encryption communication path. The license administration module of personal computer 50 uniquely encrypts the received license for protection, and records it on a hard disk (HDD) or another auxiliary recording device connected to personal computer 50. Personal computer 50 also receives from distribution server 10 the encrypted content data, which is prepared by encrypting the music data in a predetermined encrypting manner allowing decryption with the license key included in the license, and records it on the hard disk as it is.

Personal computer 50 also includes the license administration device. Provision of the license administration device allows reception of the distributed data at a higher security level than the security level of recording on the hard disk by the license administration module, i.e., at the same security level as that of the reception by cellular phone 100 and memory card 110. Personal computer 50 receives the encrypted content data and the license from distribution server 10 via modem 40 and Internet network 30. For this reception, the license administration module directly receives and records the license via an encryption communication path, which is constructed between distribution server 10 and the license administration device in accordance with the same procedures as those for constructing the path between distribution server 10 and the license administration module as already described. The encrypted content data is recorded on the hard disk as it is. This license administration device holds the security in the send/receive and administration of the license by hardware similarly to memory card 110, and can achieve a higher security level than the license administration module holding the security by the software. For discrimination of the security levels and the licenses, the security level of security ensured by hardware such as memory card 110 or the license administration device will be referred to as a “level 2”, and the license, which required the security at level 2 for distribution, is referred to as a “level-2 license”, hereinafter. Likewise, the security level of security ensured by software such as the license administration module will be referred to as a “level 1”, and the license, which required the security at level 1 for distribution, is referred to as a “level-1 license”, hereinafter. The license administration device and the license administration module will be described later in greater detail.

In the case of distribution to personal computer 50 over Internet network 30, distribution server 10 may likewise be configured such that every distribution of content data, e.g., for one song is counted, and distribution carrier 20 will collect the royalty, which is charged every time the user receives (downloads) the distributed content data, together with charges for telephone calls. Thereby, the copyright owner can easily ensure the royalty.

In FIG. 1, personal computer 50 uses the license administration module to produce the encrypted content data, which is restricted to local use, from the music data obtained from a music CD (Compact Disk) 60 storing the music data as well as the license for reproducing the encrypted content data. This processing is referred to as “ripping”, and corresponds to an operation of obtaining the encrypted content data and the license from music CD 60. Since the security level of the license for local use by the ripping is not high under any circumstances due to the properties of ripping, such license is handled as the level-1 license regardless of the manner of ripping. The ripping will be described later in greater detail.

Further, personal computer 50 is coupled to cellular phone 100 via a USB (Universal Serial Bus) cable 70, and can transmits the encrypted content data and the license to and from memory card 110 on cellular phone 100. However, the data and license are handled in the manner depending on the security level of the license, as will be described later in greater detail.

In FIG. 1, personal computer 50 may be provided with a function of using the license administration module and reproducing the encrypted content data only if the encrypted content data has the level-1 license directly administered by the license administration module. The reproduction of the encrypted content data having the level-2 license is allowed if the personal computer includes a content reproducing circuit having the security ensured by the hardware. For the sake of simplicity, reproduction by the personal computer is not described in detail.

According to the data distribution system shown in FIG. 1, personal computer 50 receives the encrypted content data and the license from distribution server 10 via modem 40 and Internet network 30, and also obtains the encrypted content data and the license from music CD 60. Memory card 110 attached to cellular phone 100 receives the encrypted content data and the license from distribution server 10 over the cellular phone network, and also receives the encrypted content data and the license, which are obtained from distribution server 10 or music CD 60 by personal computer 50. The user of cellular phone 100 can obtain the encrypted content data and the license from music CD 60 by interposing personal computer 50 therebetween.

Memory card 110 attached to cellular phone 100 can save the encrypted content data and the license, which are received from distribution server 10 over the cellular phone network, in personal computer 50.

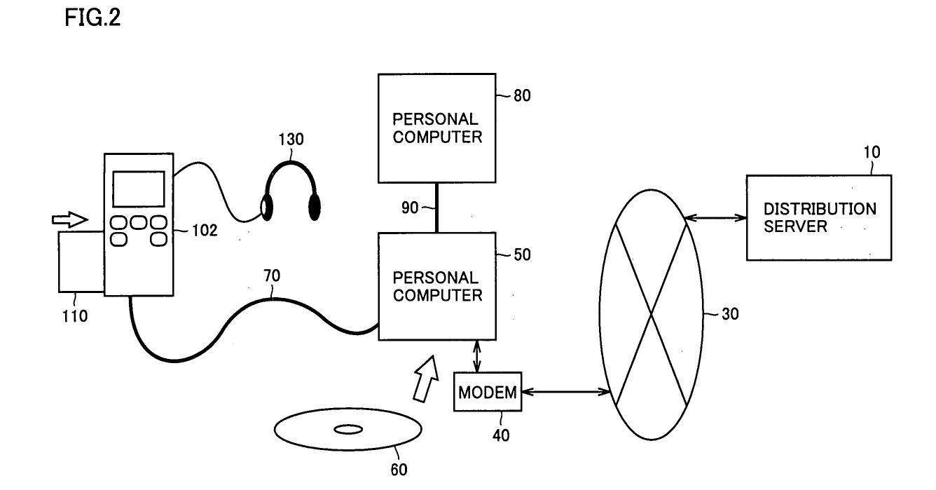

FIG. 2 shows a data distribution system using a reproduction terminal 102, which does not have a function of receiving the encrypted content data and the license from distribution server 10 over the cellular phone network. In the data distribution system shown in FIG. 2, memory card 110 attached to reproduction terminal 102 receives the encrypted content data and the license, which are obtained from distribution server 10 or music CD 60 by personal computer 50. Since personal computer 50 obtains the encrypted content data and the license, even the user of reproduction terminal 102 not having a communication function can receive the encrypted content data.

Accordingly, the structure in FIG. 2 is the same as that in FIG. 1 except for that distribution carrier 20 is not present.

In FIG. 2, reproduction terminal 102 of the user is configured to allow releasable attachment of memory card 110. Memory card 110 receives the encrypted content data received by reproduction terminal 102, decrypts the encryption performed for the above distribution, and provide the content data to a music reproducing unit (not shown) in reproduction terminal 102.

Further, the user can reproduce the content data for listening via headphones 130 or the like connected to reproduction terminal 102.

Memory card 110 can be commonly used in both the systems in FIGS. 1 and 2, and the encrypted content data, which is recorded in memory card 110 with the license by one of the system can be produced by the other system if memory card 110 is lent or checked out to the other system. More specifically, the encrypted content data and the license can be recorded in memory card 110 attached to cellular phone 100, and then memory card 110 can be attached to reproduction terminal 102 for reproducing music from the encrypted-content data. Also, operations can be performed vice versa. Using the medium, the encrypted content data and the license can be shared.

In the structures shown in FIGS. 1 and 2, the system requires several manners or the like for allowing recording and/or reproduction of the content data, which is distributed in the encrypted form, on the user side of the cellular phone, reproduction terminal or the personal computer. First, it requires a manner for distributing the encryption key in a communication system. Second, the manner of encrypting the content data to be distributed is required. Third, it is required to employ the manner or structure of protecting the content data against unauthorized copying of the distributed content data.

Embodiments of the invention, which will now be described, particularly relate to structures for enhancing the ability to protect the copyright of the content data in such a manner that can enhance functions for authentication and check of a receiver or a destination of the content data at the time of generation of each of the sessions of distribution, shift, check-out, check-in and reproduction, and can prevent output of the content data to an unauthenticated recording device or data reproduction terminal (the data reproduction terminal capable of content reproduction may also be referred to as the “cellular phone” or “personal computer” hereinafter) as well as the recording device or data reproduction terminal, in which the decryption key is broken.

In the following description, transmission of the content data from distribution server 10 to various cellular phones, personal computers and others will be referred to as “distribution”, hereinafter.

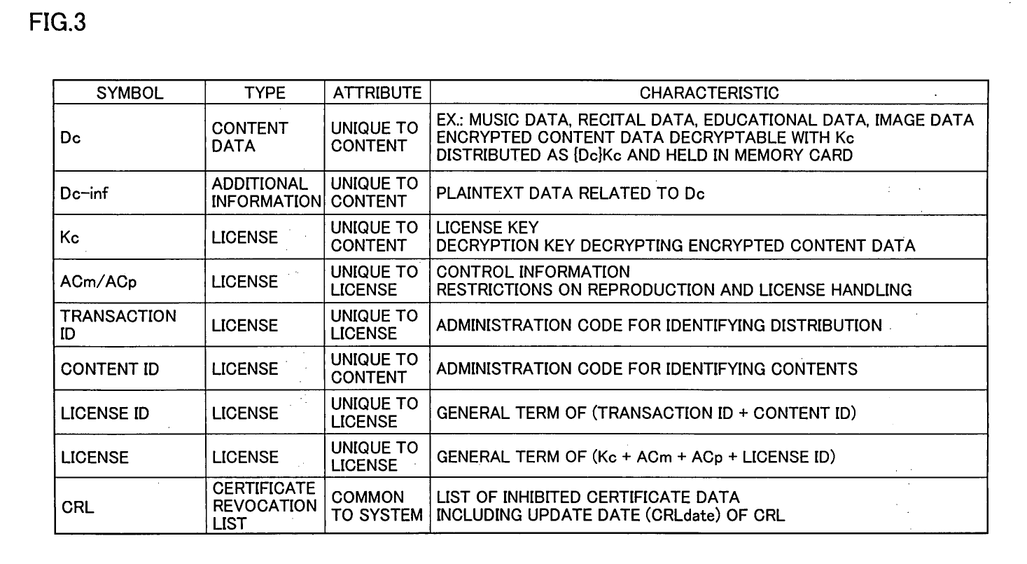

FIG. 3 shows characteristics of data, information and others used for communication in the data distribution systems shown in FIGS. 1 and 2.

First, the data distributed from distribution server 10 will be described. Dc indicates the content data such as music data. Content data Dc is encrypted in a format allowing decryption with a license key Kc. Encrypted content data {Dc}Kc, which can be decrypted with license key Kc, is distributed by distribution server 10 to users of the cellular phones or personal computers while keeping this format.

In the following description, the expression “{Y}X” represents that data Y is encrypted in the format allowing decryption with decryption key X.

Together with the encrypted content data, distribution server 10 distributes additional information Dc-inf, which includes information relating to, e.g., copyright of the content data or server access. Additional information Dc-inf is plaintext information. As the license, license key Kc as well as a transaction ID, which is an administration code for specifying the distribution of the license key or the like from distribution server 10, are transmitted between distribution server 10 and cellular phone 100, or between distribution server 10 and personal computer 50. The transaction ID is used also for specifying the license not distributed, and thus the license aimed at local use. For distinguishing between the license to be distributed and that for the local use, the transaction ID bears “0” at its leading end for indicating the local use. The transaction ID bearing the number other than “0” at its leading end is used for distribution. The license further includes a content ID, which is a code for identifying content data Dc, an access control information ACm, which is produced based on license purchase conditions AC including the number of licenses determined by designation from the user side, and relates to restrictions on access to the license in the license administration device (e.g., memory card, license administration device or license administration module), reproduction control information ACp, which is control information for reproduction in the content reproducing circuit (cellular phone 100, reproduction terminal 102 or the like), and others. More specifically, access control information ACm is the control information for externally outputting the license or license key from the memory card, the license administration module or the license administration device, and includes an allowed reproduction times (the allowed times of license key output for reproduction), control information relating to the shift/copy of the license and the security level of the license. Reproduction control information ACp is used for restricting reproduction after the content reproduction circuit receives the license key for reproduction, and relates to the restricted reproduction period, reproduction speed change restriction, reproduction range designation (partial license) and others.

In the following description, the transaction ID and the content ID will be collectively referred to as the license ID, and license key Kc, license ID, access control information ACm and reproduction control information ACp will be collectively referred to as the license.

For the sake of simplicity, access control information ACm in the following description restricts only the two items, i.e., the reproduction times (0: reproduction inhibited, 1-254: allowed reproduction times, 255: no limit), which are the control information for restricting the reproduction time(s), and the shift/copy flag (0: shift and copy are inhibited, 1: only shift is allowed, 2: shift and copy are allowed), which can restrict the shift and copy of the license. Also, reproduction control information ACp restricts only the reproduction period (UTC time code), which is the control information specifying the allowed period of reproduction.

In the embodiments, a certificate revocation list CRL is operated so that the distribution and reproduction of the content data can be inhibited in each of the classes of the license administration devices (e.g., memory card, license administration device and license administration module) and the content reproducing circuits (e.g., cellular phone 100 and reproduction terminal 102).

The certificate revocation list is a data file including a list of identification codes identifying class certificates held in the recording devices and the content reproduction circuits, which can neither receive the distributed license nor reproduce the data because such distribution and reproduction are inhibited. When the class certificate bearing the identification code, which is listed in certificate revocation list CRL, is received, it is inhibited to provide the license key to a sender of the class certificate even when the received class certificate is a regular certificate. The class certificate will be described later. All the devices and programs performing the license administration and storage as well as the reproduction, are related to the content data protection, are potential targets to be listed.

Certificate revocation list CRL is administered in distribution server 10, and is recorded and held in the recording device. Certificate revocation list CRL must be updated to renew the data at appropriate times. For updating certificate revocation list CRL in the license administration device, the date and time of update of the certificate revocation list is determined from the license administration device attached to the cellular phone or the personal computer when distributing the license such as a license key. When it is determined, from a comparison with the update date/time in certificate revocation list CRL held by distribution server 10, that the updating has not been done, the updated certificate revocation list is distributed to the cellular phone or personal computer. For updating the certificate revocation list, such a manner may be employed that the sender sends the latest or newer certificate revocation list to rewrite the certificate revocation list held in the receiver. Alternatively, such a manner may be employed that the sender prepares differential data, which has been added after the date and time of update of the certificate revocation list held in the receiver, and adds the differential data to the certificate revocation list held in the receiver. In the former manner, certificate revocation list CRL bears the date/time of the production of the list or the record date/time of each of identification codes listed in certificate revocation list CRL, and the date/time of the production or the record date/time of the latest one(s) among the added identification code(s) is used as the date/time of update of certificate revocation list CRL. In the latter manner, the record date/time of each of the identification codes in the list is described.

In the following description, it is assumed that the processing of updating certificate revocation list CRL is performed by distributing and adding differential CRL.

As described above, certificate revocation list CRL is held and operated not only in the distribution server but also in the license administration device, which records and administers the license. Thereby, in the case of reproduction as well as the shift, copy and check-out of the license, it is impossible to inhibit supply of the license from the license administration device to the content reproducing circuit (cellular phone or reproduction terminal) or the license administration device (memory card, license administration device or license administration module), which is a dangerous device due to breakage of the security or leakage of the key peculiar to the class. Therefore, such a situation can be prevented that the distributed license is supplied from the distribution destination or receiver to the dangerous device. When the security is broken, or the key peculiar to the class leaks, the content reproducing circuit cannot reproduce the content data, and the content administration device cannot obtain the new license.

As described above, certificate revocation list CRL held and administered by the license administration device is updated to renew the data in response to distribution. Administration of certificate revocation list CRL in the memory card or the license administration device is performed by recording it independently of the upper level in a tamper resistant module at a high level ensuring security by hardware. Administration of certificate revocation list CRL in the license administration module is performed by recording it on the hard disk or the like of the personal computer, which is protected at least against tampering by the encryption. In other words, the recording is performed in the tamper resistant module at a low level ensuring security by software. Therefore, the structure is configured to inhibit such a situation that certificate revocation list CRL is tampered from the upper level such as a file system, application program or the like. As a result, the protection of copyright of the data can be enhanced.

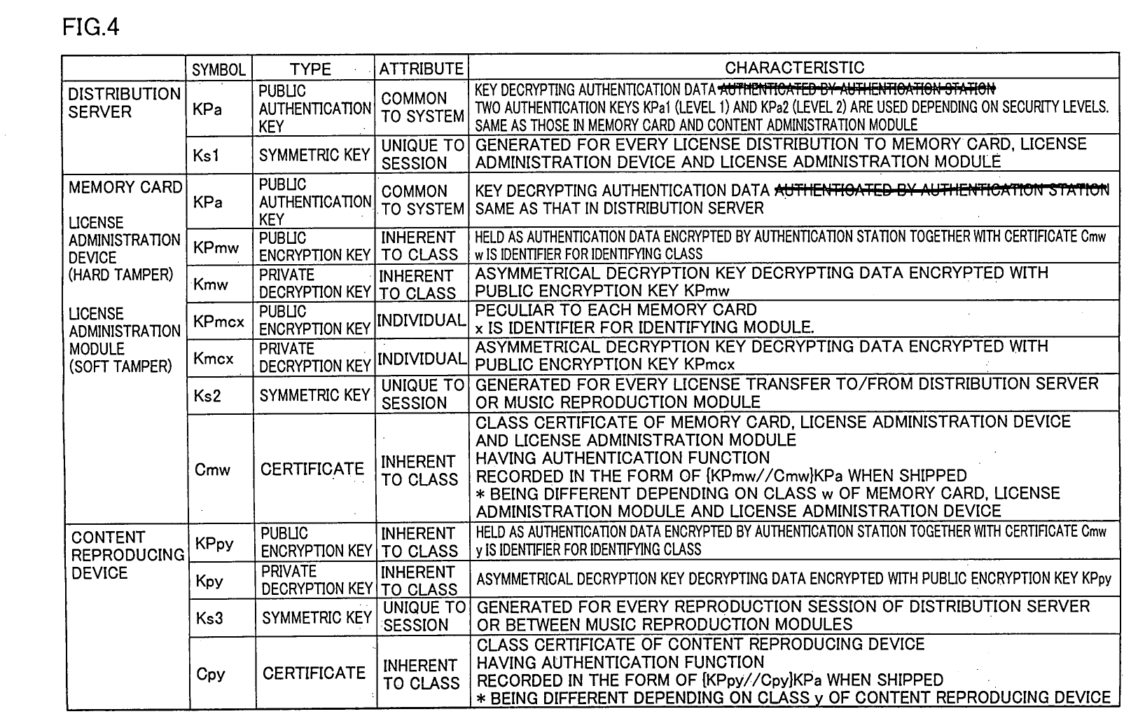

FIG. 4 illustrates characteristics of data, information and others for authentication, which are used in the data distribution systems shown in FIGS. 1 and 2.

The content reproduction circuit and license administration device are provided with individual public encryption keys KPpy and KPmw, respectively. Public encryption keys KPpy and KPmw can be decrypted with a private decryption key Kpy which is hold in the content reproduction circuit and a private decryption key Kmw which is hold in the memory card, license administration device or license administration module, respectively. These public encryption keys and private decryption keys have different values, which depend on the types of the content reproducing circuit and license administration device. These public encryption keys and private decryption keys are collectively referred to as class keys. The public encryption key and the private decryption key are referred to as the class public encryption key and the class private decryption key, respectively. The unit, in which the class key is commonly used, is referred to as the class. The class depends on a manufacturer, a kind of the product, a production lot and others.

Cpy is employed as a class certificate of the content reproducing circuit. Cmw is employed as a class certificate of the license administration device. These class certificates have information depending on the classes of the content reproducing circuit and license administration device.

The class public encryption key and the class certificate of the content reproducing circuit are recorded as authentication data {KPpy//Cpy}KPa in the data reproduction circuit at the time of shipment. The class public encryption keys and the class certificates of the memory card, license administration module and license administration device are recorded as authentication data {KPmw//Cmw}KPa in the license administration device at the time of shipment. The class public encryption key and the class certificate of the license administration module are recorded in the license administration device at the time of shipment. As will be described later in greater detail, KPa is a public authentication key, which is common in the whole distribution system. Public authentication key KPa is formed of a public authentication key KPa1 or KPa2 depending on the security level. Public authentication key KPa1 is used when the security level is level 1, and public authentication key KPa2 is used when the security level is level 2.

The class certificate includes an identification code, and is paired with the class public encryption key. The class, i.e., the unit having the symmetric class certificate, class public encryption key and private decryption key is the unit for inhibiting provision of the license key according to certificate revocation list CRL. When the tamper resistant module is broken, or the encryption is broken by the class key, i.e., when the leakage of the class private decryption key occurs, the identification code representing the class certificate of the class of the leaked key is listed in the certificate revocation list, and the system inhibits supply of the license to the content reproducing circuit and the license administration device having the class certificate specified by the identification code thus listed.

A public encryption key KPmcx is set for each of the license administration units formed of the license administration devices, and a individual private decryption key Kmcx is provided to allow decryption of the data encrypted with public encryption key KPmcx. The public encryption key and the private decryption key, which are peculiar to each memory card, will be collectively referred to as “individual keys”, public encryption key KPmcx will be referred to as a “individual public encryption key” and private decryption key Kmcx will be referred to as a “individual private decryption key”.

In addition to the above, symmetric keys Ks1-Ks3 are temporarily produced every time transmission of the license is performed. Symmetric keys Ks1-Ks3 are unique symmetric keys generated for each “session”, which is the unit of access or communication to or from the distribution server, the content reproducing circuit or the license administration device. These symmetric keys Ks1-Ks3 will be referred to as “session keys”, hereinafter.

These session keys Ks1-Ks3 have values peculiar to each session, and are administered by the distribution server, content reproducing circuit and license administration device. More specifically, session key Ks1 is generated for each distribution session by the distribution server. Session key Ks2 is generated for each of the distribution session and reproduction session by the license administration device. Session key Ks3 is generated for each reproduction session in the content reproducing circuit. The security can be improved in each session by transmitting these session keys, receiving the session keys produced by the destinations to perform encryption with the session keys thus received and sending the license keys and others.

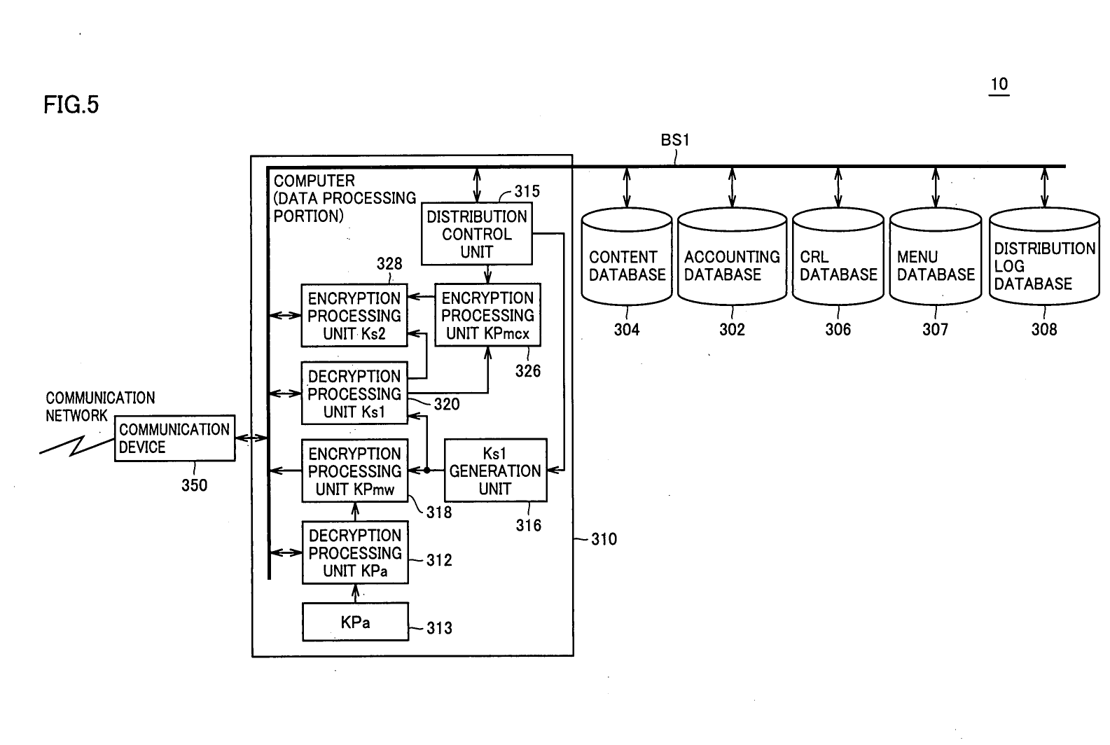

FIG. 5 is a schematic block diagram showing a structure of distribution server 10 shown in FIGS. 1 and 2.

Distribution server 10 includes an content database 304 for storing content data encrypted according to a predetermined scheme as well as distribution data such as a content ID, an account database 302 for holding accounting information according to the start of access to content data for each of the users of the cellular phones and personal computers, a CRL database 306 for administering certificate revocation lists CRL, a menu database 307 for holding the menu of content data held in content database 304, a distribution log database 308 for holding a log relating to distribution of the transaction ID and others specifying the distribution of the content data, license key and others for each distribution of the license, a data processing unit 310 for receiving data via a bus BS1 from content database 304, accounting database 302, CRL database 306, menu database 307 and distribution log database 308, and performing predetermined processing, and a communication device 350 for transmitting data between distribution carrier 20 and data processing unit 310 over the communication network.

Data processing unit 310 includes a distribution control unit 315 for controlling an operation of data processing unit 310 in accordance with the data on bus BS1, a session key generating unit 316 which is controlled by distribution control unit 315 to generate session key Ks1 in the distribution session, an authentication key holding unit 313 holding public authentication key KPa for decrypting authentication data {KPmw//Cmw}KPa sent for authentication from the license administration apparatus, i.e., the memory card, license administration device or the license administration module, a decryption processing unit 312 receiving authentication data {KPmw//Cmw}KPa sent for authentication from the memory card, license administration device or license administration module via communication device 350 and bus BS1, and decrypting it with public authentication key KPa sent from authentication key holding unit 313, a session key generating unit 316 generating session key Ks1, an encryption processing unit 318 encrypting session key Ks1 generated by session key generating unit 316 with class public encryption key KPmw obtained by decryption processing unit 312, and providing it onto bus BS1, and a decryption processing unit 320 receiving and decrypting the data, which is sent after being encrypted with session key Ks1.

Data processing unit 310 further includes an encryption processing unit 326 encrypting license key Kc and access control information ACm, which are obtained from distribution control unit 315, with individual public encryption key KPmcx, which is obtained by decryption processing unit 320 and is peculiar to each of the memory card, license administration device and license administration module, as well as an encryption processing unit 328 further encrypting the output of encryption processing unit 326 with session key Ks2 provided from decryption processing unit 320, and outputting it onto bus BS1.

Authentication key holding unit 313 holds two public authentication keys KPa1 and KPa2 corresponding to two security levels, respectively, and selects them in accordance with the authentication data sent from the destination.

Operations in the distribution session of distribution server 10 will be described later in greater detail with reference to flow charts.

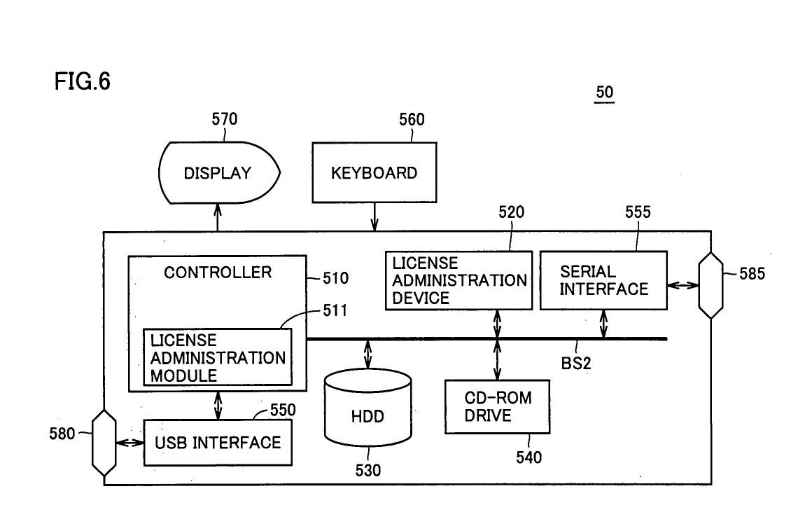

FIG. 6 is a schematic block diagram showing a structure of personal computer 50 shown in FIGS. 1 and 2. Personal computer 50 includes a bus BS2 for data transmission to and from various units in personal computer 50, a controller (CPU) 510 for internally controlling the personal computer and executing various programs, a hard disk (HDD) 530 and a CD-ROM drive 540, which are large-capacity storage devices connected to bus BS2 for recording and storing programs and/or data, a keyboard 560 for entering user's instructions and a display 570 for visually showing various kinds of information to users.

Personal computer 50 further includes a USB interface 550 for controlling transmission of data between controller 510 and a terminal 580 during transmission of the encrypted content data and the license to or from cellular phone 100, reproduction terminal 102 and personal computer 80, terminal 580 for connecting USB cable 70, a serial interface 555 for controlling data transmission between controller 510 and a terminal 585 during communication to or from distribution server 10 over Internet network 30 and modem 40, and terminal 585 for connection to modem 40 via a cable.

Controller 510 performs the control for sending the encrypted content data and others from distribution server 10 to a license administration module 511 over Internet network 30, and more specifically controls the transmission of data to and from distribution server 10. Also, controller 510 performs the control when the encrypted content data and the license are to be obtained by ripping from music CD 60 via CD-ROM drive 540. Further, personal computer 50 includes a license administration device 520, which transmits various keys to and from distribution server 10 for receiving the encrypted content data and the license from distribution server 10, and controls the license for reproducing the encrypted content data distributed thereto by hardware, and content administration module 511, which is a program to be executed by controller 510, receives the encrypted content data and the level-1 license from distribution server 10, and produces the dedicated license by uniquely encrypting the received license.

License administration device 520 is provided for transmitting the data by hardware when receiving the license from distribution server 10, and for administering the received license by hardware. Therefore, license administration device 520 can handle the license at level 2 requiring a high security level. Conversely, license administration module 511 is a program (software) to be executed by controller 510, is configured to transmit the data in the operation of receiving the license from distribution server 510, produce the encrypted content data and the license for a local use by ripping from music CD 60, to protect the obtained license by encrypting it and to store it on hard disk 530 for administration. License administration module 511 handles only the level-1 license at a lower security level than license administration device 520. Naturally, the level-1 license can be handled if the level 2 is the high security level.

As described above, personal computer 50 is internally provided with license administration module 511 and license administration device 520 for receiving the encrypted content data and the license from distribution server 10 over Internet network 30 as well as CD-ROM drive 540 for obtaining the encrypted content data and the license by ripping from music CD 60.

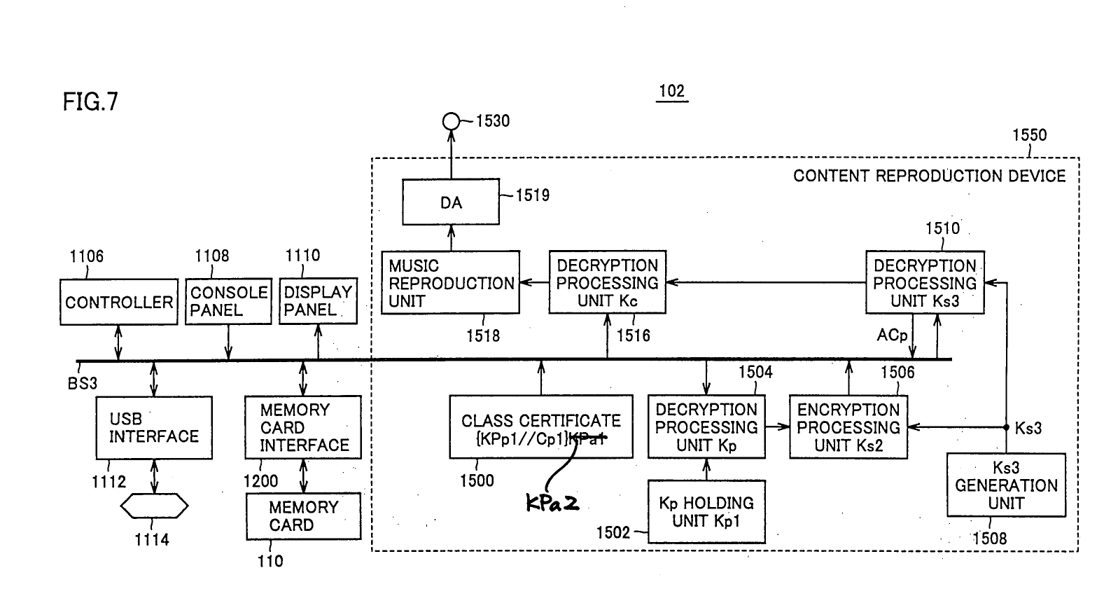

FIG. 7 is a schematic block diagram showing a structure of reproduction terminal 102 shown in FIG. 2.

Reproduction terminal 102 includes a bus BS3 for data transmission to various units in reproduction terminal 102, a controller 1106 for controlling the operation of reproduction terminal 102 via bus BS3, a console panel 1108 for externally applying instructions to reproduction terminal 102 and a display panel 1110 for providing information sent from controller 1106 and others to the user as visual information.

Reproduction terminal 102 further includes removable memory card 110 for storing and decrypting the content data (music data) sent from distribution server 10, a memory interface 1200 for controlling transmission of data between memory card 110 and bus BS3, a USB interface 1112 for controlling data transmission between bus BS3 and a terminal 1114 when receiving the encrypted content data and the license from personal computer 50, and terminal 1114 for connecting USB cable 70.

Reproduction terminal 102 further includes an authentication data holding unit 1500 for holding authentication data {KPp1//Cp1}KPa2 prepared by encrypting class public encryption key KPp1 and class certificate Cp1 into a state, which allows decryption with public authentication key KPa to authenticate the validity. It is assumed that the class y of reproduction terminal 102 is equal to one (y=1).

Reproduction terminal 102 further includes a Kp1 holding unit 1502 for holding Kp1, which is a decryption key peculiar to the class, and a decryption processing unit 1504, which decrypts the data received from bus BS3 with decryption key Kp1 to obtain session key Ks2 generated by memory card 110.

Reproduction terminal 102 further includes a session key generating unit 1508 for generating a session key Ks3, e.g., based on a random number for encrypting the data to be transmitted to and from memory card 110 via bus BS3 in the reproduction session, which is performed for reproducing the content data stored in memory card 110, and an encryption processing unit 1506, which encrypts session key Ks3 generated by session key generating unit 1508 with session key Ks2 obtained by decryption processing unit 1504, and outputs it onto bus BS3 when receiving license key Kc and reproduction control information ACp from memory card 110 in the reproduction session of the encrypted content data.

Reproduction terminal 102 further includes a decryption processing unit 1510, which decrypts the data on bus BS3 with session key Ks3 to output license key Kc and reproduction control information ACp, a decryption processing unit 1516, which receives encrypted content data {Dc}Kc from bus BS3, and decrypts it with license key Kc obtained from decryption processing unit 1510 to output the content data, a music reproducing unit 1518 for receiving the output of decryption processing unit 1516 and reproducing the content data, a D/A converter 1519 for converting the output of music reproducing unit 1518 from digital signals to analog signals, and a terminal 1530 for providing the output of D/A converter 1519 to an external output device (not shown) such as headphones.

In FIG. 7, a region surrounded by dotted line provides a content reproducing device 1550 for reproducing the music data by decrypting the encrypted content data. Content reproducing device 1550 is formed of a tamper resistant module.

Cellular phone 100 shown in FIG. 1 has a function of receiving the encrypted content data or the license distributed from distribution server 10 over the cellular phone network. Accordingly, the structure of cellular phone 100 shown in FIG. 1 corresponds to the structure, which is shown in FIG. 7, but is provided with ordinary functions of the cellular phone such as functions of an antenna for receiving radio signals sent over the cellular phone network, a transmission unit for converting the signals received from the antenna into baseband signals, and sending data sent from the cellular phone to the antenna after modulating it, a microphone, a speaker and an audio coder-decoder.

Operations in respective sessions of the respective components of cellular phone 100 and reproduction terminal 102 will be described later in greater detail with reference to flow charts.

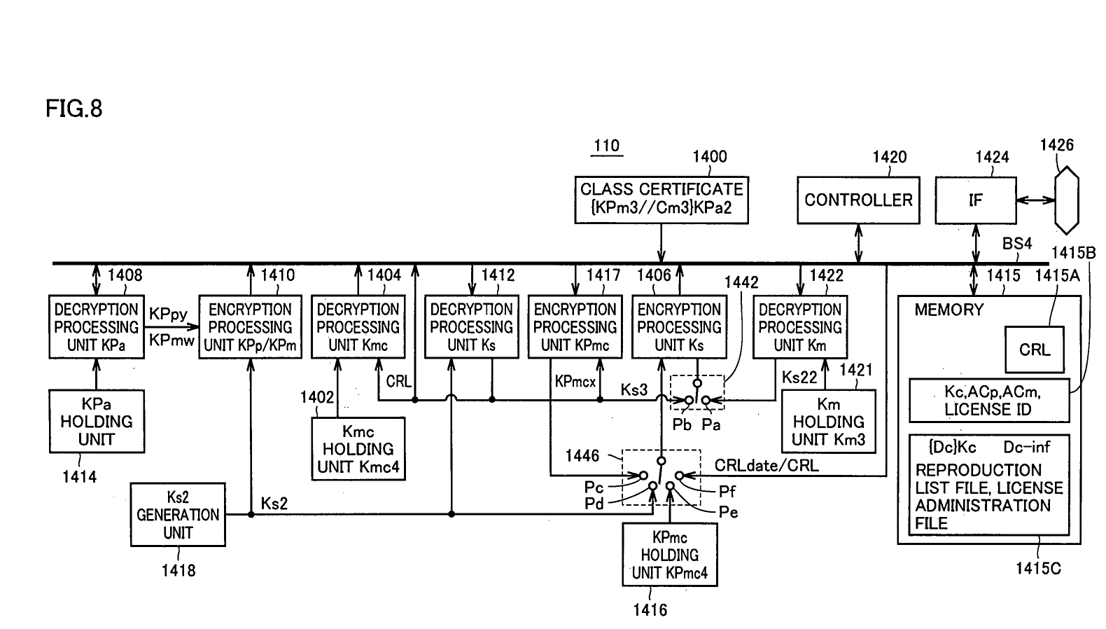

FIG. 8 is a schematic block diagram showing a structure of memory card 110 shown in FIGS. 1 and 2.

As already described, KPmw and Kmw are employed as the class public encryption key and the class private decryption key of the memory card, respectively, and class certificate Cmw in the memory card is also employed. It is assumed that the natural number w is equal to three in memory card 110 (w=3). The natural number x for identifying the memory card is equal to four (x=4). Accordingly, memory card 110 is provided with class public encryption key KPm3, class private decryption key Km3, class certificate Cm3, individual public encryption key KPmc and individual private decryption key Kmc4.

Accordingly, memory card 110 includes an authentication data holding unit 1400 for holding authentication data {KPm3//Cm3}KPa2, a Kmc holding unit 1402 for holding a individual private decryption key Kmc4, which is a decryption key peculiar to each memory card, a Km holding unit 1421 for storing a class private decryption key Km3 and a KPmc holding unit 1416 for storing a public encryption key KPmc4 used for encryption, which allows decryption with individual private encryption key Kmc4.

Owing to provision of the encryption key of the recording device, i.e., the memory card, the license key for each memory card can be administered independently of the other memory cards, as will be apparent from the following description.

Memory card 110 further includes an interface 1424 for transmitting signals to and from memory interface 1200 via a terminal 1426, a bus BS4 for transmitting signals to and from interface 1424, a decryption processing unit 1422 which receives data provided onto bus BS4 via interface 1424, also receives class private decryption key Km3 from Km holding unit 1421 and outputs session key Ks1 generated in the distribution session by distribution server 10 to a contact Pa, a KPa holding unit 1414 holding public authentication key KPa2 for decrypting and authenticating the authentication data, a decryption processing unit 1408 receiving public authentication key KPa2 sent from KPa holding unit 1414, executing the decryption with public authentication key KPa on the authentication data provided onto bus BS4 from the destination of the license, sending the result of the decryption and the class certificate thus obtained to controller 1420, and sending the class public key thus obtained to an encryption processing unit 1410, and an encryption processing unit 1406 encrypting the data selectively provided from a selector switch 1446 with a key selectively provided from a selector switch 1442, and outputting it onto bus BS4.

Memory card 110 further includes a session key generating unit 1418 for generating session key Ks2 in each of the distribution and reproduction sessions, encryption processing unit 1410 encrypting session key Ks2 generated from session key generating unit 1418 with class public encryption key KPpy or KPmw obtained by decryption processing unit 1408, and sending it onto bus BS4, a decryption processing unit 1412, receiving the data encrypted with session key Ks2 from bus BS4, and decrypting it with session key Ks2 obtained from session key generating unit 1418, and an encryption processing unit 1417 for encrypting the license, which is read from memory 1415 in the reproduction session of the encrypted content data, with individual public encryption key KPmcx (x≠4) of another license administration apparatus (memory card or license administration device), which is decrypted by decryption processing unit 1412.

Memory card 110 further includes a decryption processing unit 1404 for decrypting the data on bus BS4 with a individual public encryption key KPmc4 and decrypting the encrypted data with individual private decryption key Kmc4 of memory card 110, and a memory 1415 for receiving, from bus BS 4, and storing certificate revocation list CRL, which is successively updated by receiving differential certificate revocation list, i.e., the differential data for renewing certificate revocation list CRL, encrypted content data {Dc}Kc, license (Kc, Acp, ACm and license ID) for reproducing encrypted content data {Dc}Kc, additional information Dc-inf, the reproduction list of encrypted content data and the license administration file for administering the license. Memory 1415 is formed of, e.g., a semiconductor memory. Memory 1415 is formed of a CRL region 1415A, a license region 1415B and a data region 1415C. CRL region 1415A is a region for recording certificate revocation list CRL. License region 1415B is used for recording the license. Data region 1415C is used for recording encrypted content data {Dc}Kc, additional information Dc-inf of the encrypted content data, a license administration file for recording information required for license administration for each encrypted content data, and a reproduction list file for recording basic information for accessing the encrypted content data and the license stored in the memory card. Data region 1415C can be externally and directly accessed. The license administration file and reproduction list file will be described later in greater detail.

License region 1415B stores the license (license key Kc, reproduction control information ACp, access control information ACm and license ID) in record units, each of which is referred to as “entry” and is dedicated to recording of the license. For accessing the license, an entry number is used for designating the entry, in which the license is stored or is to be stored.

Memory card 110 further includes a controller 1420, which externally transmits data via bus BS4, and receives instructions for controlling operations of memory card 110.

All the structures except for data region 1415C necessarily form tamper resistant modules.

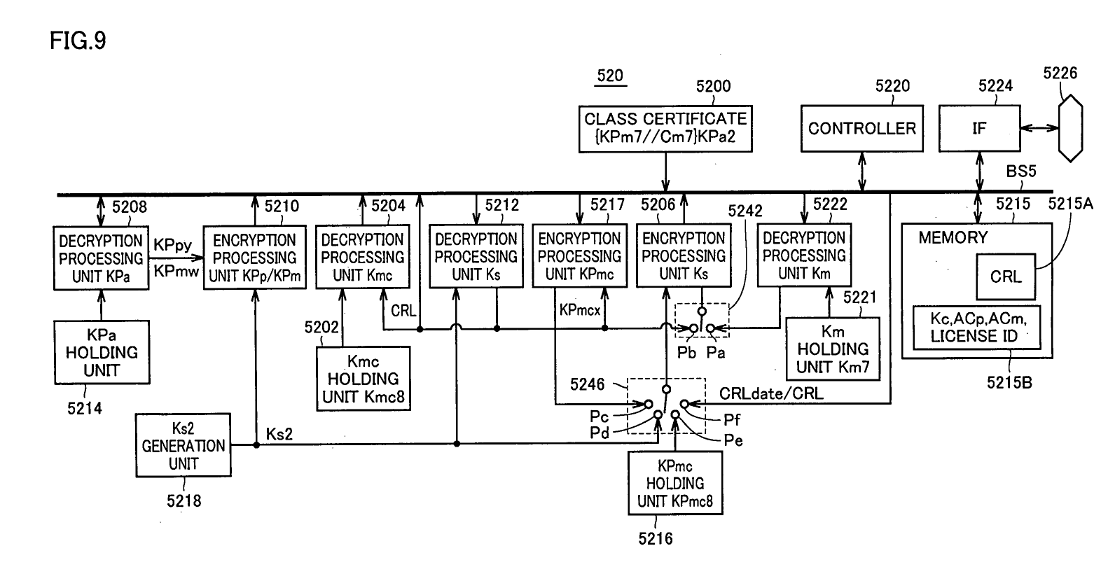

FIG. 9 is a schematic block diagram showing a structure of license administration device 520 arranged within personal computer 50. License administration device 520 basically has the same structure memory card 110 except for that a region corresponding to data region 1415C of memory card 110 is not required, and an interface 5224 different in function from interface 1424 and a terminal 5226 different in configuration from terminal 1426 are employed. In license administration device 520, an authentication data holding unit 5200, a Kmc holding unit 5202, a decryption processing unit 5204, an encryption processing unit 5206, a decryption processing unit 5208, an encryption processing unit 5210, a decryption processing unit 5212, a KPa holding unit 5214, a KPmc holding unit 5216, an encryption processing unit 5217, a session key generating unit 5218, a controller 5220, a Km holding unit 5221, a decryption processing unit 5222, interface 5224, terminal 5226, and selector switches 5242 and 5246 are the same as authentication data holding unit 1400, Kmc holding unit 1402, decryption processing unit 1404, an encryption processing unit 1406, decryption processing unit 1408, encryption processing unit 1410, decryption processing unit 1412, KPa holding unit 1414, KPmc holding unit 1416, encryption processing unit 1417, session key generating unit 1418, controller 1420, Km holding unit 1421, decryption processing unit 1422 and selector switches 1442 and 1446, respectively. However, authentication data holding unit 5200 holds authentication data {KPm7//Cm7}KPa2, and KPmc holding unit 5216 holds individual public encryption key KPm8, Km holding unit 5202 hold class private decryption key Km7, Kmc holding unit 5221 holds individual private decryption key Kmc8. The natural number w representing the class of license administration device 520 is equal to seven (w=7), and the natural number x identifying license administration device 520 is equal to eight (x=8).

License administration device 520 includes a memory 5215 for recording certificate revocation list CRL and license (Kc, ACp, ACm and license ID) instead of memory 1415 in memory card 110. Memory 5215 is formed of a CRL region 5215A storing certificate revocation list CRL and a license region 5215B storing the license.

Description will now be given on the operations in respective sessions of the data distribution systems shown in FIGS. 1 and 2.

### FIRST EMBODIMENT

[Distribution 1]

In the data distribution systems shown in FIGS. 1 and 2, the level-2 license and the encrypted content data corresponding to the level-2 license are distributed from distribution server 10 to personal computer 50, as will now be described below. In this operation, the level-2 license is directly distributed to license administration device 520 via an encryption communication path provided between distribution server 10 and license administration device 520 of personal computer 50, and is stored in license region 1415B of memory 1415 of license administration device 520. This operation will be referred to as “distribution 1”.

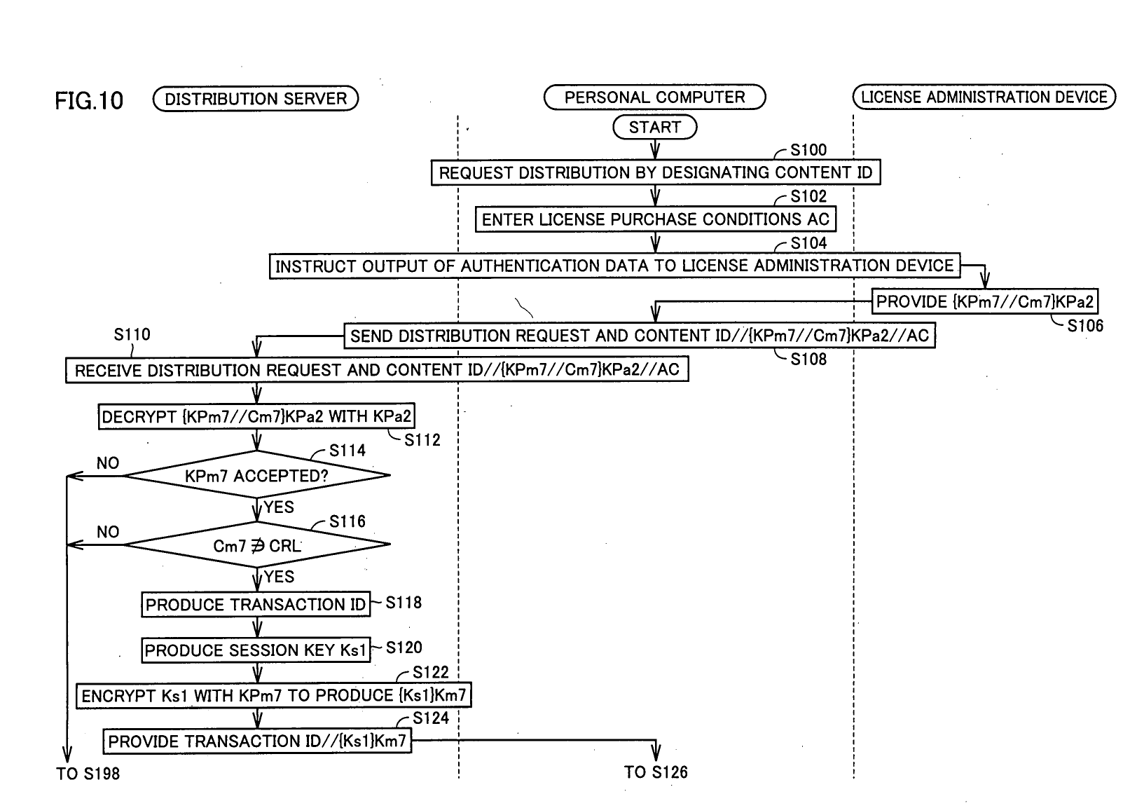

FIGS. 10-13 are first to fourth flow charts, which show the distribution operation (also referred to as a “distribution session” in some cases) in the data distribution systems shown in FIGS. 1 and 2, respectively, and more specifically, show the distribution to license administration device 520 in personal computer 50 performed at the time of purchasing the encrypted content data.

Before the processing in FIG. 10, the user connects user's personal computer 50 to distribution server 10 via modem 40, and thereby obtains the content ID for the intended content to be purchased from distribution server 10. The following description is based on the premise that the above operation is already performed.

Referring to FIG. 10, the user of personal computer 50 enters via keyboard 560 the distribution request by designating the content ID (step S100). Via keyboard 560, the user enters purchase conditions AC for purchasing the license of the encrypted content data (step S102). More specifically, access control information ACm and reproduction control information ACp of the encrypted content data are set, and purchase conditions AC are input for purchasing license key Kc used for decrypting the selected and encrypted content data.

When purchase conditions AC of encrypted content data are input, controller 510 provides an instruction of output of the authentication data to license administration device 520 (step S104). A controller 5220 of license administration device 520 receives the instruction of the authentication data output via interface 5224 and bus BS5. Controller 5220 reads authentication data {KPm7//Cm7}KPa2 from authentication data holding unit 5200 via bus BS5, and outputs authentication data {KPm7//Cm7}KPa2 via interface 5224 and terminal 5226 (step S106).

In addition to authentication data {KPm7//Cm7}KPa2 sent from license administration device 520, controller 510 of personal computer 50 sends the content ID, data AC of the license purchase conditions and the distribution request to distribution server 10 (step S108).

Distribution server 10 receives from personal computer 50 the distribution request, content ID, authentication data {KPm7//Cm7}KPa2 and data AC of license purchase conditions (step S110). Decryption processing unit 312 decrypts the authentication data provided from license administration device 520 with public authentication key KPa2 at level 2 (step S112).

Distribution control unit 315 performs authentication processing based on the result of decryption by decryption processing unit 312 to determine whether the received data is the authentication data encrypted for the purpose of verifying its authenticity or validity by a regular system or not (step S114). When it is determined that the received data is the valid authentication data, distribution control unit 315 approves and accepts class public encryption key KPm7 and class certificate Cm7. The operation moves to a next step S116. When distribution control unit 315 determines that it is not the valid authentication data, the data is not approved, and the distribution session ends without accepting class public encryption key KPm7 and class certificate Cm7 (step S198).

When class public encryption key KPm7 and class certificate Cm7 are accepted as a result of the authentication, distribution control unit 315 then refers to CRL database 306 to determine whether class certificate Cm7 of license administration device is listed in certificate revocation list CRL. When class certificate Cm7 is listed in the certificate revocation list, the distribution session ends (step S198).

When the class certificate of license administration device 520 is not listed in the certificate revocation list, next processing starts (step S116).

When it is determined from the result of authentication that the access is made from the personal computer provided with the license administration device, which has the valid authentication data, and the class is not listed in certificate revocation list CRL, distribution control unit 315 in distribution server 10 produces the transaction ID, which is the administration code for specifying the distribution (step S118). Also, session key generating unit 316 generates session key Ks1 for distribution (step S120). Session key Ks1 is encrypted by encryption processing unit 318 with class public encryption key KPm7 corresponding to license administration device 520 obtained by decryption processing unit 312 (step S122).

The transaction ID and encrypted session key Ks1 are externally output as transaction ID//{Ks1}Km7 via bus BS1 and communication device 350 (step S124).

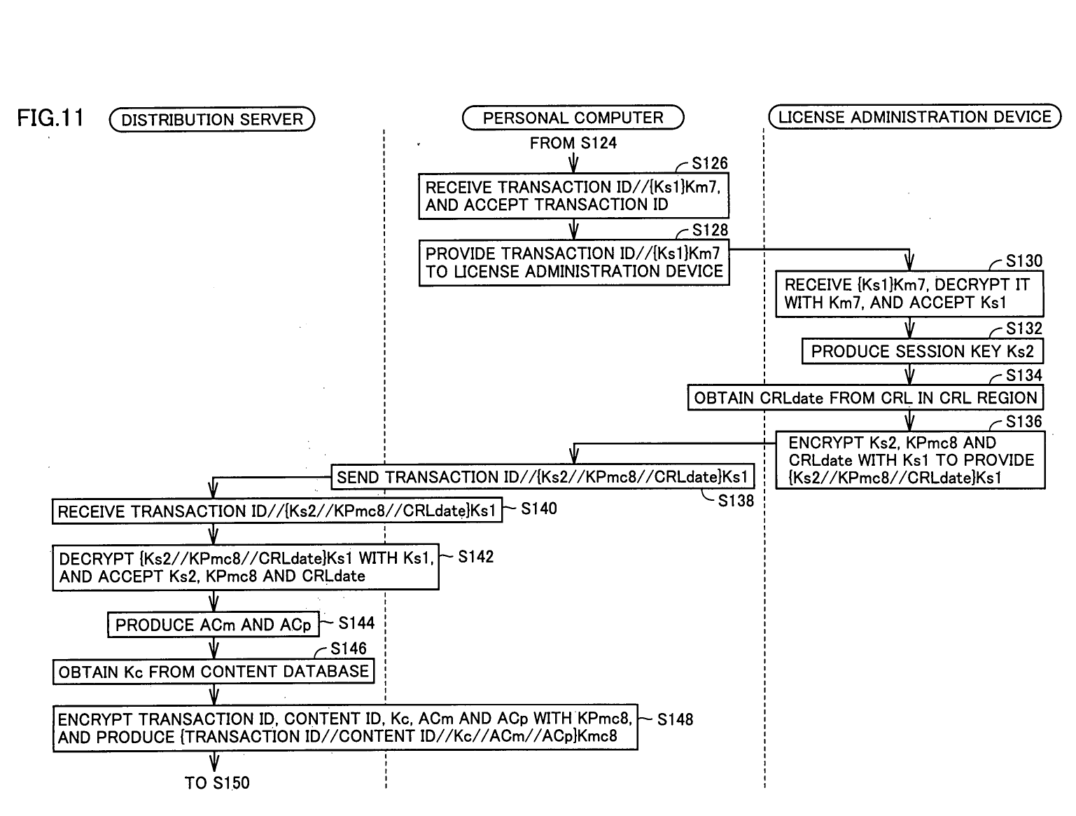

Referring to FIG. 11, when personal computer 50 receives transaction ID/{Ks1}Km7 (step S126), controller 510 provides transaction ID//{Ks1}Km7 to license administration device 520 (step S128). Thereby, in license administration device 520, decryption processing unit 5222 decrypts the data provided onto bus BS5 via terminal 5226 and interface 5224 with class private decryption key Km7, which is held by holding unit 5221 and is peculiar to license administration device 520, and thereby accepts session key Ks1 thus decrypted (step S130).

When the acceptance of session key Ks1 produced by distribution server 10 is confirmed, controller 5220 instructs session key generating unit 5218 to generate session key Ks2 to be produced in the distribution operation by license administration device 520. Session key generating unit 5218 produces session key Ks2 (step S132).

In the distribution session, controller 5220 extracts update date/time CRLdate from certificate revocation list CRL recorded in memory 5215 of license administration device 520, and provides it to selector switch 5246 (step S134).

Encryption processing unit 5206 encrypts session key Ks2, individual public encryption key KPmc8 and update date/time CRLdate of the certificate revocation list, which are obtained by successively selecting the contacts of selector switch 5246, with session key Ks1, which is obtained via contact Pa of selector switch 5242, to provide encrypted data {Ks2//KPmc8//CRLdate}Ks1 as one data string onto bus BS5 (step S136).

Encrypted data {Ks2//KPmc8//CRLdate}Ks1 provided onto bus BS5 is sent from bus BS5 to personal computer 50 via interface 5224 and terminal 5226, and is sent from personal computer 50 to distribution server 10 (step S138).

Distribution server 10 receives transaction ID//{Ks2//KPmc8//CRLdate}Ks1, decrypts it with session key Ks1 by decryption processing unit 320 and accepts session key Ks2 generated by license administration device 520, individual public encryption key KPmc8 peculiar to license administration device 520 and update date/time CRLdate of certificate revocation list CRL of license administration device 520 (step S142).

Distribution control unit 315 produces access control information ACm and reproduction control information ACp in accordance with the content ID and data AC of the license purchase conditions obtained in step S110 (step S144). Further, distribution control unit 315 obtains license key Kc for decrypting the encrypted content data from content database 304 (step S146).

Distribution control unit 315 provides the produced license, i.e., transaction ID, content ID, license key Kc, reproduction control information ACp and access control information ACm to encryption processing unit 326. Encryption processing unit 326 encrypts the license with public encryption key KPmc8, which is peculiar to license administration device 520 and is obtained by decryption processing unit 320, to produce encrypted data {transaction ID//content ID//Kc//ACm//ACp}Kmc8 (step S148).

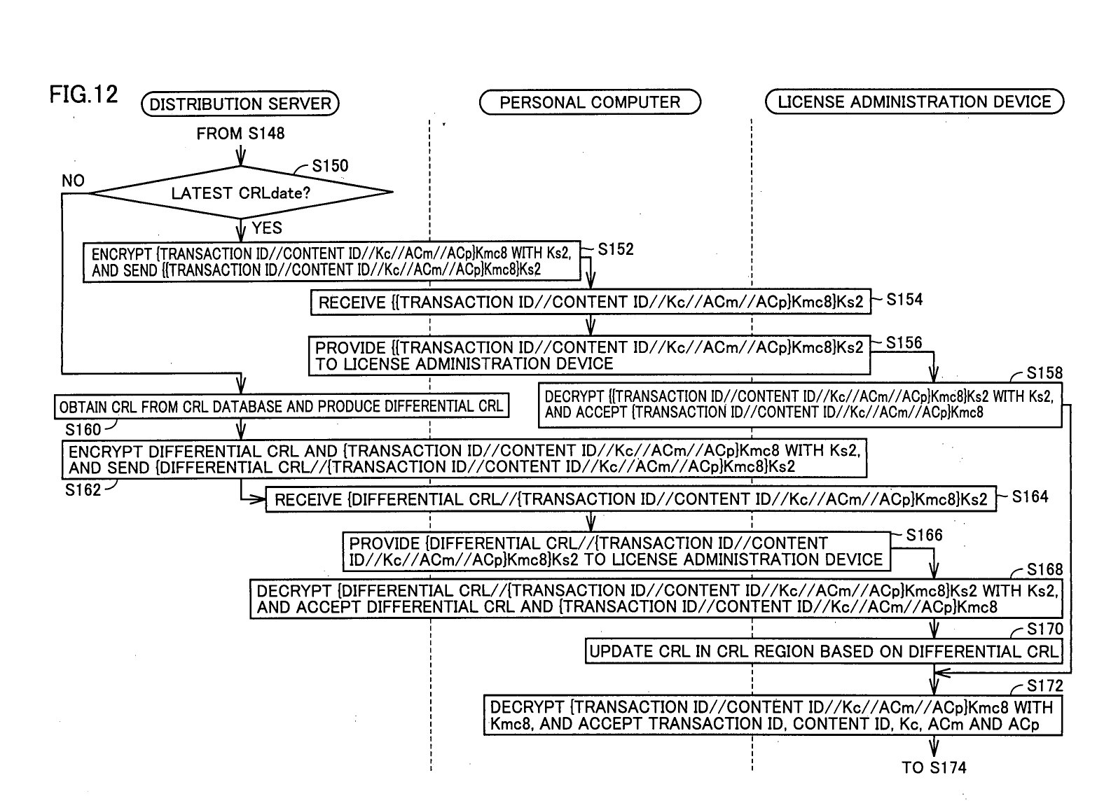

Referring to FIG. 12, in distribution server 10, update date/time CRLdate of the certificate revocation list, which is sent from license administration device 520, is compared with the update date/time of certificate revocation list CRL of distribution server 10 held in CRL database 306, and thereby it is determined whether certificate revocation list CRL held in license administration device 520 is the latest or not. When it is determined that certificate revocation list CRL held in license administration device 520 is the latest, the operation moves to a step S152. When certificate revocation list CRL held in license administration device 520 is not the latest, the operation moves to a step S160 (step S150).

When it is determined that list CRL is the latest, encryption processing unit 328 encrypts encrypted data {transaction ID//content ID//Kc//ACm//ACp}Kmc8 provided from encryption processing unit 326 with session key Ks2 generated by license administration device 520, and outputs encrypted data {{transaction ID//content ID//Kc//ACm//ACp}Kmc8}Ks2 onto bus BS1. Distribution control unit 315 sends encrypted data {{transaction ID//content ID//Kc//ACm//ACp}Kmc8}Ks2 on bus BS1 to personal computer 50 via communication device 350 (step S152).

Controller 510 of personal computer 50 receives encrypted data {{transaction ID//content ID//Kc//ACm//ACp}Kmc8}Ks2 (step S154), and provides it to license administration device 520 via bus BS5. Decryption processing unit 5212 of license administration device 520 receives encrypted data {{transaction ID//content ID//Kc//ACm//ACp}Kmc8}Ks2 via terminal 5226 and interface 5224, and decrypts it with session key Ks2 generated by session key generating unit 5218 to accept encrypted data {transaction ID//content ID//Kc//ACm//ACp}Kmc8 (step S158). Thereafter, the operation moves to a step S172.

When it is determined in distribution server 10 that certificate revocation list CRL held in license administration device 520 is not the latest, distribution control unit 315 obtains the latest certificate revocation list CRL from CRL database 306 via bus BS1 to produce the differential data, i.e., differential CRL (step S160).

Encryption processing unit 328 receives the output of encryption processing unit 326 and differential CRL of the certificate revocation list supplied from distribution control unit 315 via bus BS1, and encrypts them with session key Ks2 produced in license administration device 520. Encrypted data {differential CRL//{transaction ID//content ID//Kc//ACm//ACp}Kmc8}Ks2 provided from encryption processing unit 328 is sent to personal computer 50 via bus BS1 and communication device 350 (step S162).

Personal computer 50 receives encrypted data {differential CRL//{transaction ID//content ID//Kc//ACm//ACp}Kmc8}Ks2 sent thereto (step S164), and provides it via bus BS5 to license administration device 520 (step S166). In license administration device 520, decryption processing unit 5212 decrypts the received data provided onto bus BS5 via terminal 5226 and interface 5224. Decryption processing unit 5212 decrypts the received data on bus BS5 with session key Ks2, which is provided from session key generating unit 5218, and provides it onto bus BS5 (step S168).

In this stage, encrypted license {transaction ID//content ID//Kc//ACm//ACp}Kmc8, which can be decrypted with private decryption key Kmc8 held on Kmc holding unit 5221, and differential CRL are output onto bus BS5 (step S168). In accordance with the instruction from controller 5220, certificate revocation list CRL held in CRL region 5215A of memory 5215 is updated by adding accepted differential CRL thereto (step S170).

The operations in steps S152, S154, S156 and S158 are executed for distributing the license to license administration device 520 when certificate revocation list CRL of license administration device 520 is the latest. The operations in steps S160, S162, S164, S166, S168 and S170 are executed for distributing the license to license administration device 520 when certificate revocation list CRL of license administration device 520 is not the latest. From the update date/time CRLdate of the certificate revocation list sent from license administration device 520, as described above, it is determined one by one whether certificate revocation list CRL of license administration device 520 requesting for the distribution is the latest or not. When it is not the latest, the latest certificate revocation list CRL is obtained from CRL database 306, and differential CRL is sent to license administration device 520 to update certificate revocation list CRL of license administration device 520.

After steps S158 or S170, controller 5220 instructs decryption processing unit 5204 to decrypt encrypted license {transaction ID//content ID//Kc//ACm//ACp}Kmc8 with individual private decryption key Kmc8, and license (license key Kc, transaction ID, content ID, access control information ACm and reproduction control information ACp) is accepted (step S172).

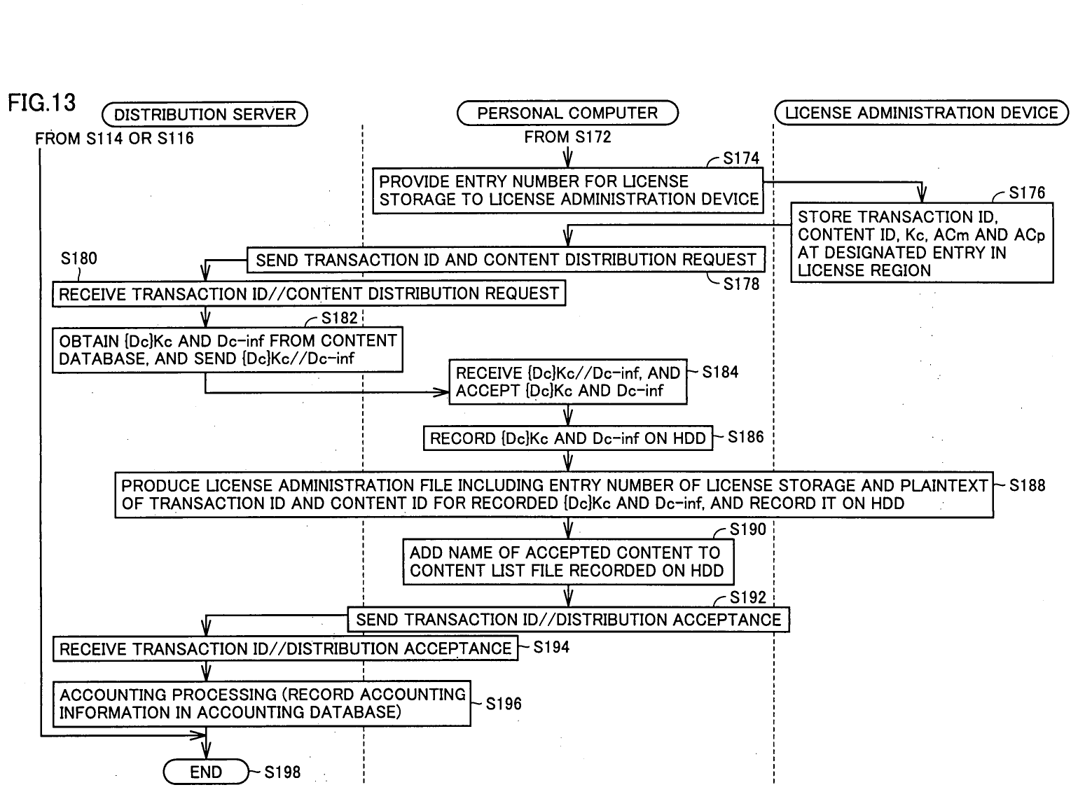

Referring to FIG. 13, controller 510 provides the entry number indicating the entry for storing the licenses, which are received by license administration device 520, to license administration device 520 (step S174). Thereby, controller 5220 of license administration device 520 receives the entry number via terminal 5226 and interface 5224, and stores license (license key Kc, transaction ID, content ID, access control information ACm and reproduction control information ACp), which is obtained in step S172, in license region 5215B of memory 5215 designated by the received entry number (step S176).

Controller 510 of personal computer 50 sends the transaction ID sent from distribution server 10 and the request for distribution of the encrypted content data to distribution server 10 (step S178).

Distribution server 10 receives the request for distribution of the transaction ID and the encrypted content data (step S180), obtains encrypted content data {Dc}Kc and additional information Dc-inf from content database 304, and outputs these data and information via bus BS1 and communication device 350 (step S182).

Personal computer 50 receives {Dc}Kc//Dc-inf, and accepts encrypted content data {Dc}Kc and additional information Dc-inf (step S184). Thereby, controller 510 records encrypted content data {Dc}Kc and additional information Dc-inf as one content file on hard disk 530 via bus BS2 (step S186). Controller 510 produces the license administration file, which includes the entry number of the license stored in license administration device 520 as well as plaintext of transaction ID and content ID, and corresponds to encrypted content data {Dc}Kc and additional information Dc-inf, and records it on hard disk 530 via bus BS2 (step S188). Further, controller 510 adds the accepted content information to the content list file recorded on hard disk 530, and more specifically adds names of the recorded content file and license administration file as well as information (e.g., title of tune and name of artist), which relates to the encrypted content data and is extracted from additional information Dc-inf (step S190). Then, controller 510 sends the transaction ID and the distribution acceptance to distribution server 10 (step S192).

When distribution server 10 receives transaction ID//distribution acceptance (step S194), it stores the accounting data in accounting database 302, and records the transaction ID in distribution log database 308. Thereby, processing of ending the distribution is executed (step S196), and the whole processing ends (step S198).

As described above, it is determined that license administration device 520 arranged within personal computer 50 is the device holding the regular or valid authentication data, and at the same time, it is determined that class public encryption key KPm7, which is encrypted and sent together with class certificate Cm7, is valid. After determining these facts, the content data can be distributed only in response to the distribution request sent from the license administration device having class certificate Cm7 not listed in the certificate revocation list, and thus the license administration device not mentioned in the class certificate list, of which encryption with public encryption key KPm7 is broken. Therefore, it is possible to inhibit the distribution to unauthorized license administration device as well as the distribution using the descrambled or broken class key.

The encryption keys produced in the distribution server and the license administration module are transmitted between them. Each of the distribution server and the license administration module executes the encryption with the received encryption key, and sends the encrypted data to the other so that the mutual authentication can be practically performed even when sending and receiving the encrypted data, and it is possible to improve the security in the data distribution system.

For receiving the license from distribution server 10, license administration device 520 transmits the data to and from distribution server 10 by hardware, and stores the license by hardware for reproducing the encrypted content data so that the security level thereof can be high. By using license administration device 520, therefore, personal computer 50 can receive the license distributed at a high security level, and can administer the license at a high security level of level 2.

According to the flow charts of FIGS. 10-13, it is also possible to distribute the encrypted content data and the license to memory card 110 attached to cellular phone 100 shown in FIG. 1 over the cellular phone network. This can be achieved by replacing personal computer 50 with cellular phone 100, and replacing license administration device 520 with memory card 110 in the above description. In this case, steps S186, S188 and S190 illustrated in FIG. 13 are executed in such a manner that the content file (encrypted content data {Dc}Kc and additional information Dc-inf) and the reproduction list file used instead of the content list file are recorded at data region 1415C in memory 1415 of memory card 110. The processing other than the above is performed in the same manner.

For distributing the encrypted content data and the license to memory card 110, the encrypted content data and the license are received and stored by hardware. Therefore, distribution of the encrypted content data and the license to memory card 110 can be administered at a high security level with level-2 license, as is done in the distribution of the encrypted content data and the license to license administration device 520.

[Distribution 2]

In the data distribution systems shown in FIGS. 1 and 2, the encrypted content data and the license are distributed from distribution server 10 to license administration module 511 of personal computer 50, as will be described below. This operation will be referred to as “distribution 2”.

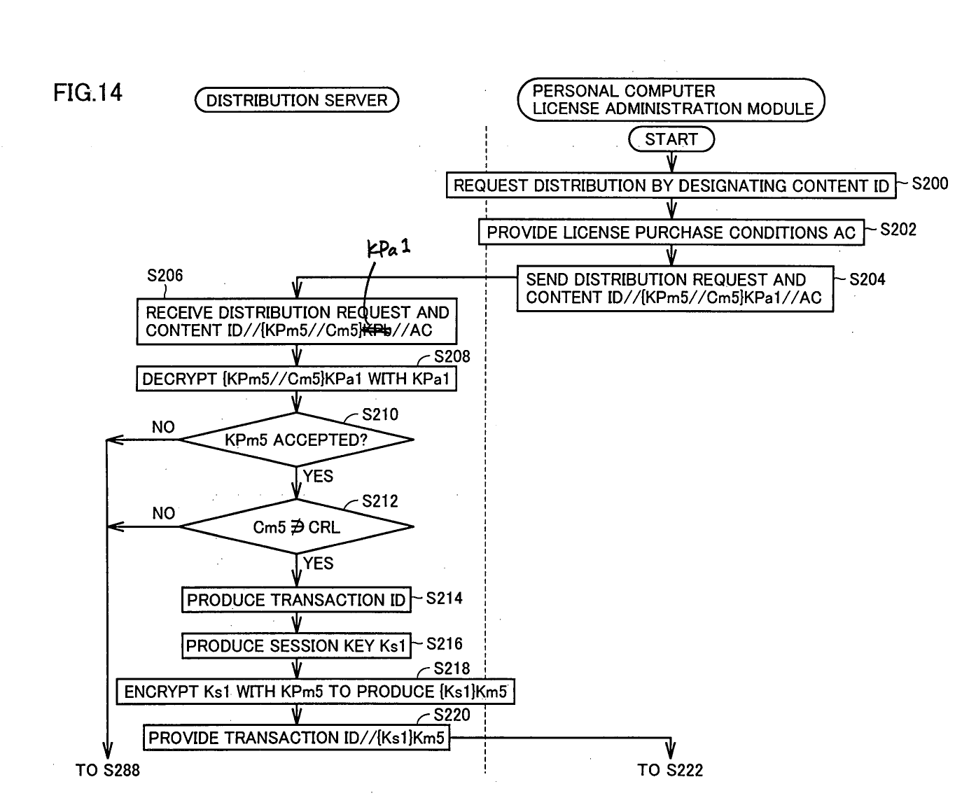

Before the processing in FIG. 14, the user connects user's personal computer 50 to distribution server 10 via modem 40, and thereby obtains the content ID for the intended content to be purchased. The following description is based on the premise that the above operation is already performed.

FIGS. 14-17 are first to fourth flow charts, which show the distribution operation in the data distribution systems shown in FIGS. 1 and 2, respectively, and more specifically, show the distribution to license administration module 511 in personal computer 50 performed at the time of purchasing the encrypted content data. License administration module 511 receives the encrypted content data and the license from distribution server 10 by executing the program. Although the communication path in the “distribution 2” (i.e., path between distribution server 10 and personal computer 50) transmits the data of the same format as that in the “distribution 1” with the security of the same structure as that in the “distribution 1”. However, distribution server 10 uses two public authentication keys KPa1 and KPa2. KPa2 is a public authentication key for determining the authentication data of memory card 110 and license administration device 520 of the security level of level 2. KPa1 is a public authentication key for determining the authentication data of license administration module 511 of the security level of level 1. License administration module 511 is a program module having the substantially same license administration function as license administration device 520. Therefore, class public authentication key KPmw, class private decryption key Kmw, class certificate Cmw, individual public encryption key KPmcx and individual private decryption key Kmcx are employed similarly to class administration device 520. Natural number w representing the class of license administration module 511 is equal to five (w=5), and natural number x identifying license administration module 511 is equal to six (x=6). Accordingly, license administration module 511 holds authentication data {KPm5//Cm5}KPa1, individual public encryption key KPm6, class private decryption key Km5 and individual private decryption key Kmc6.

Referring to FIG. 14, the user of personal computer 50 enters via keyboard 560 the distribution request by designating the content ID (step S200). Via keyboard 560, the user enters purchase conditions AC for purchasing the license of the encrypted content data (step S202). More specifically, access control information ACm and reproduction control information ACp of the encrypted content data are set, and purchase conditions AC are input for purchasing license key Kc used for decrypting the selected and encrypted content data.

When purchase conditions AC of encrypted content data are input, controller 510 reads authentication data {KPm5//Cm5}KPa1 from license administration module 511, and sends, in addition to authentication data {KPm5//Cm5}KPa1, the content ID, data AC of the license purchase conditions and the distribution request to distribution server 10 (step S204).

Distribution server 10 receives from personal computer 50 the distribution request, content ID, authentication data {KPm5//Cm5}KPa1 and data AC of license purchase conditions (step S206). Distribution control unit 315 determines based on class certificate Cm5 of authentication data {KPm5//Cm5}KPa1 whether the distribution at level 1 is requested or the distribution at level 2 is requested. Authentication data {KPm5//Cm5}KPa1 is provided from license administration module 511 for requesting the distribution at level 1 so that distribution control unit 315 determines that the distribution at level 1 is requested. Decryption processing unit 312 decrypts received authentication data {KPm5//Cm5}KPa1 with public authentication key KPa1 for level 1 (step S208).

Distribution control unit 315 performs authentication processing based on the result of decryption by decryption processing unit 312 to determine whether the received authentication data {KPm5//Cm5}KPa1 is the authentication data encrypted for level 1, and particularly for the purpose of verifying its authenticity or validity by a regular system or not (step S210). When it is determined that authentication data is the valid data for level 1, distribution control unit 315 approves and accepts class public encryption key KPm5 and class certificate Cm5. The operation moves to a step S212. When distribution control unit 315 determines that it is not the valid authentication data for level 1, the data is not approved, and the processing ends without accepting class public encryption key KPm5 and class certificate Cm5 (step S288).

Although description will be made no longer, distribution server 10 can directly send the license at level 1 to the license administration device 520 or memory card 110 having the security level of level 2 via personal computer 50.

When class public encryption key KPm5 and class certificate Cm5 are accepted as a result of authentication, distribution control unit 315 then refers to CRL database 306 to determine whether class certificate Cm5 of license administration module 511 is listed in certificate revocation list CRL. When class certificate Cm5 is listed in the certificate revocation list, the distribution session ends (step S288).

When the class certificate of license administration module 511 is not listed in the certificate revocation list, next processing starts (step S214).

When class public encryption key KPm5 and class certificate Cm5 are accepted as a result of the authentication processing, and it is determined that the class certificate is not listed in the certificate revocation list, distribution control unit 315 in distribution server 10 produces the transaction ID, which is the administration code for specifying the distribution (step S214). Also, session key generating unit 316 generates session key Ks1 for distribution (step S216). Session key Ks1 is encrypted by encryption processing unit 318 with class public encryption key KPm5 corresponding to license administration module 511 and obtained by decryption processing unit 312 (step S218).

The transaction ID and encrypted session key Ks1 are externally output as transaction ID//{Ks1}Km5 via bus BS1 and communication device 350 (step S220).

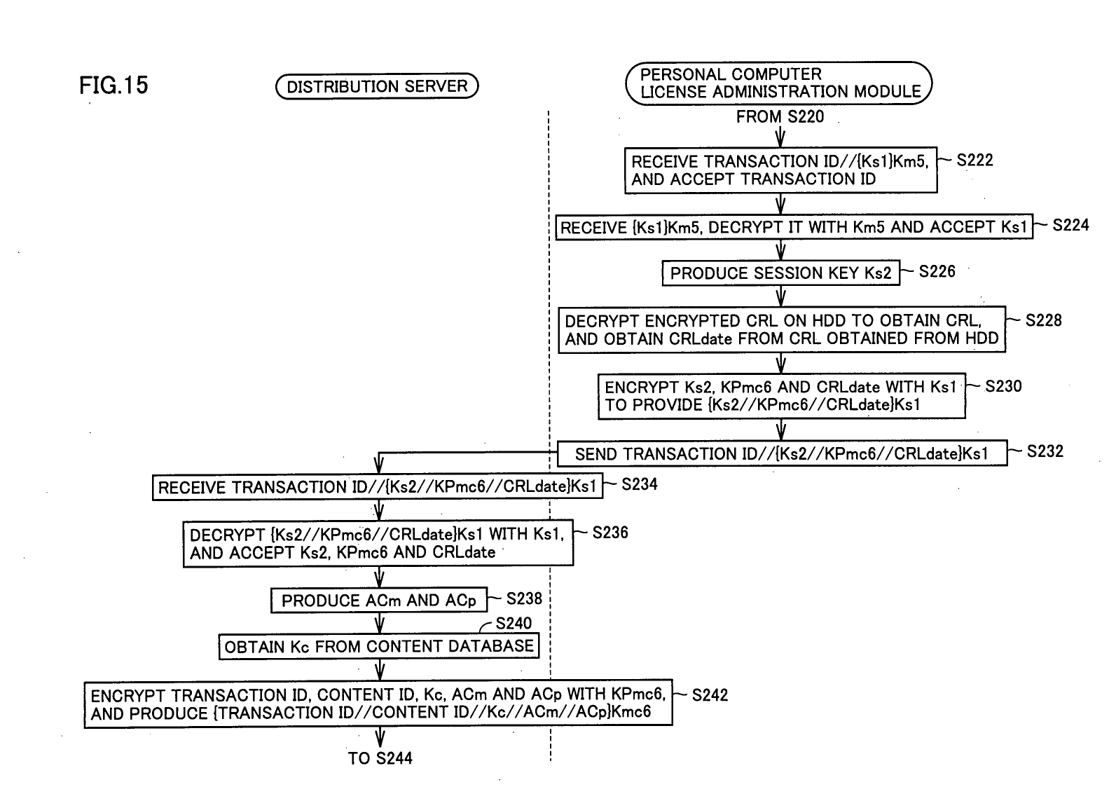

Referring to FIG. 15, when controller 510 of personal computer 50 receives transaction ID//{Ks1}Km5 (step S222), license administration module 511 receives encrypted data {Ks1}Km5; decrypts it with class private decryption key Km5 peculiar to license administration module 511 and accepts session key Ks1 (step S224).

License administration module 511 produces session key Ks2 when it confirms the acceptance of session key Ks1 produced by distribution server 10 (step S226). Controller 510 reads encrypted CRL stored on hard disk 530 via bus BS2. License administration module 511 decrypts encrypted CRL to obtain certificate revocation list CRL, and obtains update date/time CRLdate of the certificate revocation list from decrypted certificate revocation list CRL (step S228). License administration module 511 further encrypts session key Ks2, individual public encryption key KPmc6 and update date/time CRLdate of the certificate revocation list, which are produced by license administration module 511, with session key Ks1 generated in distribution server 10, to provide one data string, and outputs encrypted data {Ks2//KPmc6//CRLdate}Ks1 (step S230).

Controller 510 sends transaction ID//{Ks2//KPmc6//CRLdate}Ks1, which is prepared by adding the transaction ID to encrypted data {Ks2//KPmc6//CRLdate}Ks1, to distribution server 10 (step S232).

Distribution server 10 receives transaction ID//{Ks2//KPmc6//CRLdate}Ks1 (step S234), decrypts it with session key Ks1 by decryption processing unit 320 and accepts session key Ks2 produced by license administration module 511, individual public encryption key KPmc6 peculiar to license administration module 511 and update date/time CRLdate of the certificate revocation list in license administration module 511 (step S236).

Distribution control unit 315 produces access control information ACm and reproduction control information ACp in accordance with the content ID and data AC of the license purchase conditions obtained in step S206 (step S238). Further, distribution control unit 315 obtains license key Kc for decrypting encrypted content data {Dc}Kc from content database 304 (step S240).

Distribution control unit 315 provides the produced license, i.e., transaction ID, content ID, license key Kc, reproduction control information ACp and access control information ACm to encryption processing unit 326. Encryption processing unit 326 encrypts the license with public encryption key KPmc6, which is obtained by decryption processing unit 320 and is peculiar to license administration module 511, to provide encrypted data {transaction ID//content ID//Kc//ACm//ACp}Kmc6 (step S242).

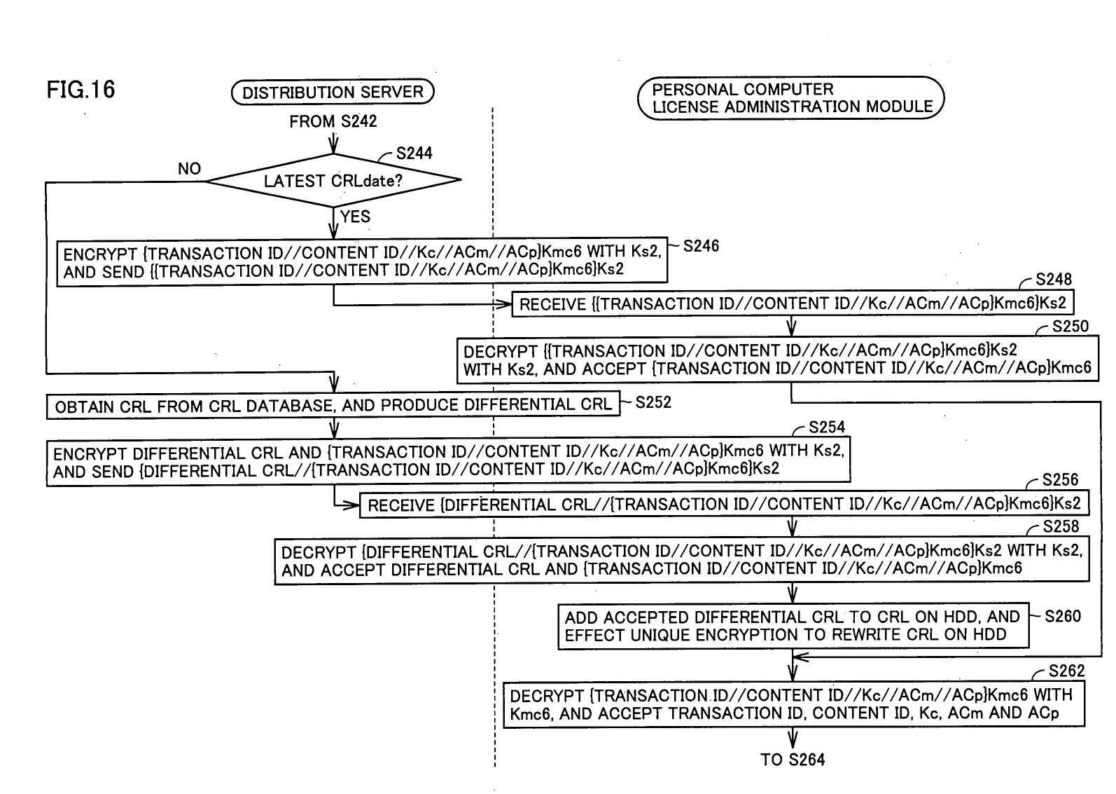

Referring to FIG. 16, in distribution server 10, update date/time CRLdate of the certificate revocation list, which is sent from license administration module 511, is compared with the update date/time of certificate revocation list CRL of distribution server 10 held in CRL database 306, and thereby it is determined whether certificate revocation list CRL held in license administration module 511 is the latest or not. When it is determined that certificate revocation list CRL held in license administration module 511 is the latest, the operation moves to a step S246. If certificate revocation list CRL held in license administration module 511 is not the latest, the operation moves to a step S252 (step S244).

When it is determined that certificate revocation list CRL is the latest, encryption processing unit 328 encrypts encrypted data {transaction ID//content ID//Kc//ACm//ACp}Kmc6 provided from encryption processing unit 326 with session key Ks2 produced by license administration module 511, and outputs encrypted data {{transaction ID//content ID//Kc//ACm//ACp}Kmc6}Ks2 onto bus BS1. Distribution control unit 315 sends encrypted data {{transaction ID//content ID//Kc//ACm//ACp}Kmc6}Ks2 on bus BS1 to personal computer 50 via communication device 350 (step S246).

Controller 510 of personal computer 50 receives encrypted data {{transaction ID//content ID//Kc//ACm//ACp}Kmc6}Ks2 (step S248), and license administration module 511 decrypts encrypted data {{transaction ID//content ID//Kc//ACm//ACp}Kmc6}Ks2 with session key Ks2 to accept encrypted data {transaction ID//content ID//Kc//ACm//ACp}Kmc6 (step S250). Thereafter, the operation moves to a step S262.

When it is determined in distribution server 10 that certificate revocation list CRL held in license administration module 511 is not the latest, distribution control unit 315 obtains the latest certificate revocation list CRL from CRL database 306 via bus BS1 to produce the differential data, i.e., differential CRL (step S252).

Encryption processing unit 328 receives the output of encryption processing unit 326 and differential CRL of certificate revocation list CRL supplied from distribution control unit 315 via bus BS1, and encrypts them with session key Ks2 produced in license administration module 511. Encrypted data {differential CRL//{transaction ID//content ID//Kc//ACm//ACp}Kmc6}Ks2 provided from encryption processing unit 328 is sent to personal computer 50 via bus BS1 and communication device 350 (step S254).

Personal computer 50 receives encrypted data {differential CRL//{transaction ID//content ID//Kc//ACm//ACp}Kmc6}Ks2 sent thereto (step S256), and license administration module 511 decrypts the received data with session key Ks2 to accept differential CRL and encrypted data {transaction ID//content ID//Kc//ACm//ACp}Kmc6 (step S258).

Controller 510 adds differential CRL thus accepted to certificate revocation list CRL obtained in step S228, effects unique encryption on the latest certificate revocation list CRL, and overwrite certificate revocation list CRL recorded on hard disk 530 with certificate revocation list CRL thus encrypted (step S260).

The operations in steps S246, S248 and S250 are executed for distributing license key Kc and others to license administration module 511 when certificate revocation list CRL of license administration module 511 is the latest. The operations in steps S252, S254, S256, S258 and S260 are executed for distributing license key Kc and others to license administration module 511 when certificate revocation list CRL of license administration module 511 is not the latest. As described above, every certificate revocation list CRL sent from license administration module 511 is processed to determine whether it is updated or not. If not updated, the latest certificate revocation list CRL is obtained from CRL database 306, and differential CRL is sent to license administration module 511 to update certificate revocation list CRL administered by the license administration module.

After step 250 or 260, encrypted license {transaction ID//content ID//Kc//ACm//ACp}Kmc6 is decrypted with private decryption key Kmc6, and the license (license key Kc, transaction ID, content ID, access control information ACm and reproduction control information ACp) is accepted (step S262).

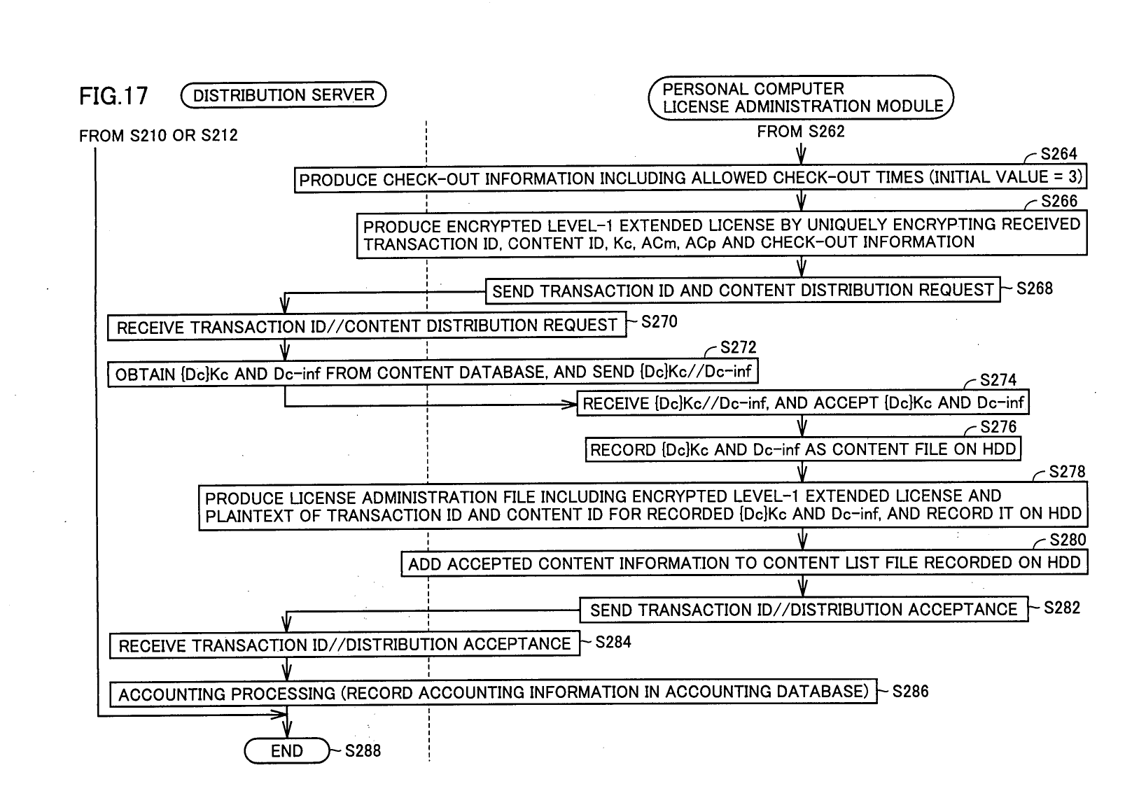

Referring to FIG. 17, license administration module 511 produces check-out information including allowed check-out times for checking out the encrypted content data and the license received from distribution server 10 to another device (step S264). In this case, the initial value of allowed check-out times is set to “3”. Thereby, license administration module 511 produces the encrypted level-1 extended license by effecting unique encryption on accepted license (transaction ID, content ID, license key Kc, access control information ACm and reproduction control information ACp) and the produced check-out information (step S266). In this case, license administration module 511 performs the encryption based on the ID number of controller (CPU) 510 of personal computer 50 and others. Therefore, the encrypted level-1 extended license thus produced is the license peculiar to personal computer 50, and the encrypted content data and the license cannot be sent to another device unless the check-out, which will be described later, is used. This is because a security hole is apparently present in the shift of the license under the administration at the security level of level 1, and therefore the shift of the license is not allowed.

Controller 510 of personal computer 50 sends the transaction ID sent from distribution server 10 and the request for distribution of the encrypted content data to distribution server 10 (step S268).

Distribution server 10 receives the request for distribution of the transaction ID and the encrypted content data (step S270), obtains encrypted content data {Dc}Kc and additional information Dc-inf from information database 304, and outputs these data and information via bus BS1 and communication device 350 (step S272).

Personal computer 50 receives {Dc}Kc//Dc-inf, and accepts encrypted content data {Dc}Kc and additional information Dc-inf (step S274). Thereby, controller 510 records encrypted content data {Dc}Kc and additional information Dc-inf as one content file on hard disk 530 via bus BS2 (step S276). Controller 510 produces the license administration file, which includes the encrypted level-1 extended license produced by license administration module 511 as well as plaintext of transaction ID and content ID, and corresponds to encrypted content data {Dc}Kc and additional information Dc-inf, and records it on hard disk 530 via bus BS2 (step S278). Further, controller 510 adds the accepted content information to the content list file recorded on hard disk 530, and more specifically adds names of the recorded content file and license administration file as well as information (title of tune and name of artist), which relates to the encrypted content data and is extracted from additional information Dc-inf (step S280). Then, controller 510 sends the transaction ID and the distribution acceptance to distribution server 10 (step S282).

When distribution server 10 receives transaction ID//distribution acceptance (step S284), it stores the accounting data in accounting database 302, and records the transaction ID in distribution log database 308. Thereby, processing for ending the distribution is executed (step S286), and the whole processing ends (step S288).

As described above, the encryption keys generated in the distribution server and the license administration module are sent and received, the encryption is executed with the received encryption key on each side, and the encrypted data is sent to the other side. Thereby, the mutual authentication can be practically performed even when sending and receiving the encrypted data, and it is possible to improve the security in the data distribution system and to operate certificate revocation list CRL, similarly to the case where the license is directly distributed to license administration device 520 and memory card 110.

In personal computer 50, however, license administration module 511 sends and receives the data by software, receives the license from distribution server 10 and administers the license thus received. In these points, the security level of the distribution of the license by license administration module 511 is lower than that in the case where the license is directly distributed to license administration device 520 and memory card 110.

[Ripping]

The user of personal computer 50 can obtain the encrypted content data and the license distributed thereto, and further can obtain music data from music CDs owned by the user for using it. From the viewpoint of the copyright protection of the copyright holder, digital copy of the music CD cannot be performed freely, but is allowed if it is performed for the personal use (i.e., for enjoying the music) by the owner of the CD with a tool provided with a copyright protection function. Accordingly, license administration module 511 includes a program executing the ripping function of obtaining music data from music CDs, and producing the encrypted content data and the license, which can be administered by license administration module 511.

In recent years, some kinds of music CDs contain electronic watermarks written in music data. The watermark describes, as rules of use, the range of use by the user determined by the copyright holder. In the processing of ripping the music data containing the rules of use described therein, the rules of use must be observed from the viewpoint of copyright protection. It is assumed that the rules of use define the copy conditions (inhibition of copy, copy-allowed generation or allowance of copy), effective period of copy, allowed maximum check-out times, edition, reproduction speed, regional code for reproduction, restrictions on reproduction times of copy and allowed use time. There are conventional music CDs, in which the watermark cannot be detected, and thus the rules of use are not described.

The ripping is performed by obtaining the music data directly from the music CD, and may also be performed in such a manner which the music data is obtained by changing music signals taken as analog signals into digital signals. Further, the ripping may be performed by obtaining the music data, which is compressed and encoded for reducing the amount of data. Further, the ripping may be performed by taking in, as the input, content data, which is distributed in a distribution system other than the distribution system of the embodiment.

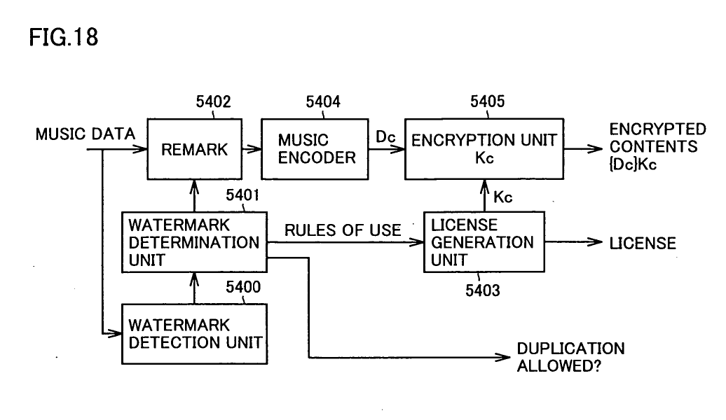

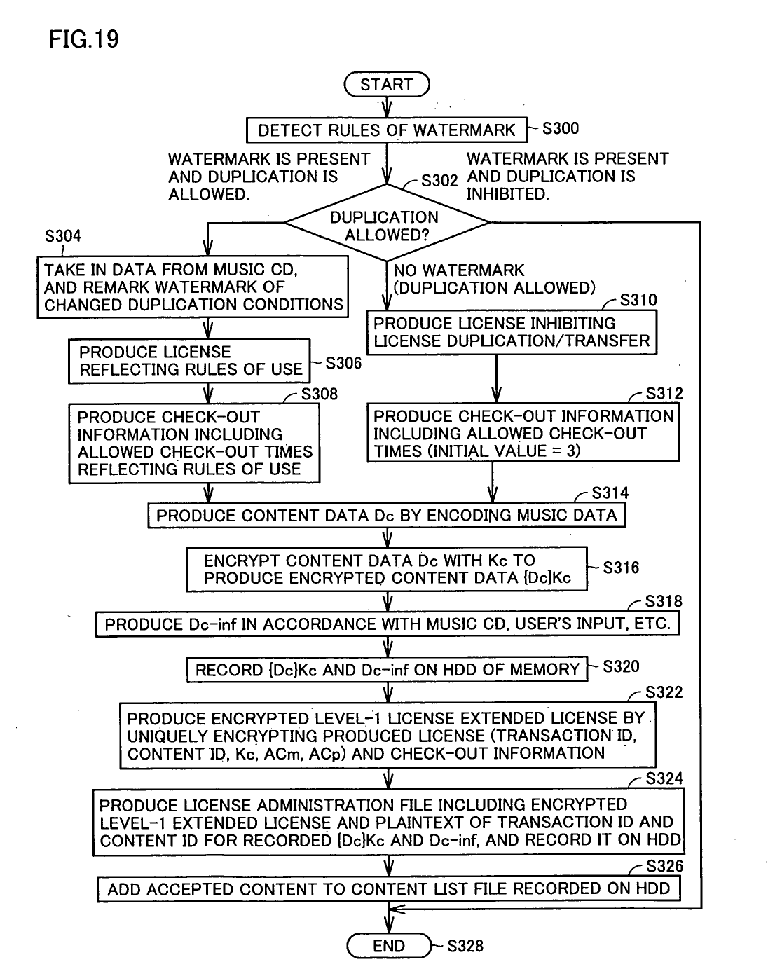

Referring to FIGS. 18 and 19, description will now be given on the operation of obtaining the encrypted content data and the license by ripping from the music CD storing music data.

FIG. 18 is a function block diagram illustrating a function of software for ripping the music data read from music CD 60 by CD-ROM drive 540 provided in personal computer 50 shown in FIG. 6. The software for ripping the music data includes a watermark detecting unit 5400, a watermark determining unit 5401, a re-mark unit 5402, a license generating unit 5403, a music encoder 5404 and an encrypting unit 5405.

Watermark detecting unit 5400 detects the watermark from the music data obtained from the music CD, and extracts the rules of use described therein. Watermark determining unit 5401 determines the result of detection performed by watermark detecting unit 5400, and thus determines whether the watermark is detected or not. When detected, watermark determining unit 5401 determines whether the ripping is allowed or not, based on the rules of use defined by the watermark. The fact that the ripping is allowed means that there is no rule of use defined by the watermark, or that the rules of use allowing copy and shift of the music data recorded on the music CD are defined by the watermark. The fact that the ripping is not allowed means that the rules of use inhibiting copy and shift of the music data recorded on the music CD are defined by the watermark.

When it is determined according to the result of determination by watermark determining unit 5401 that the rippling is allowed, and the instruction relating to the copy generation is present (i.e., when the copy and shift of the music data are allowed), re-mark unit 5402 replaces the watermark in the music data with another watermark describing changed copy conditions of the music data. However, in such a case that the analog signal is supplied for ripping, encoded music data is input, or music data distributed by another distribution system is input, the watermark is necessarily replaced regardless of the contents of the rules of use as long as the ripping is allowed. In this case, if there is an instruction relating to the copy generation, the contents of rules of use are changed. Otherwise, the obtained rules of use are used as they are.

License generating unit 5403 generates the license based on the result of determination by watermark determining unit 5401. Music encoder 5404 encodes the music data bearing the watermark, which is changed by re-mark unit 5402, into a predetermined format. Encrypting unit 5405 encrypts the music data sent from music encoder 5404 with license key Kc included in the license, which is generated by license generating unit 5403.

Referring to FIG. 19, description will now be given on the ripping operation by controller 510 in personal computer 50. When the ripping operation starts, watermark detecting unit 5400 detects the rules of use in the watermark based on the data, which is detected from the music CD (step S300). Watermark determining unit 5401 performs the determination based on the result of detection by watermark detecting unit 5400 and the rules of use recorded in the watermark, and more specifically determines whether the copy is allowed or not (step S302). In the case where the watermark is detected, the rules of use allow copy, and the access control information and reproduction control information in the license can comply with the contents of rules of use, it is determined that the ripping is allowed, and the operation moves to a step S304. When the watermark is detected, but the rules of use inhibits copy, or the access control information and reproduction control information in the license do not comply with the contents of rules of use, it is determined that the ripping is inhibited, and the operation moves to a step S328 for ending the ripping operation. When the watermark is not detected in the CD loaded to the drive, it is determined that the watermark is not contained, and the operation moves to a step S310.

When it is determined in step S302 that the ripping is allowed, the music data is taken out from music CD 60, and re-mark unit 5402 replaces the watermark included in the music data with a new watermark describing the changed copy conditions (step S304). When the rules of use of the last watermark allowed the copy to the third generation, the new watermark allows the copy to the second generation. License generating unit 5403 generates access control information ACm and reproduction control information ACp reflecting the rules of use as well as the license ID, content ID and license key only for the local use (step S306). License key Kc is a random number, and default values are assigned to items, to which the rules of use are not applied, in access control information ACm and reproduction control information ACp. Also, in access control information ACm, a shift/copy flag is set to zero for inhibiting the shift and copy, and the allowed reproduction times are set to 255 representing non-restriction. In the reproduction control information ACp, no restriction on the reproduction period is selected. Thereafter, license generating unit 5403 generates the check-out information including the allowed check-out times reflecting the rules of use (step S308). The allowed check-out times are equal to three unless otherwise specified.

In step S302, if the watermark is not detected, license generating unit 5403 generates the license inhibiting the copy and shift, and thus generates access control information ACm, in which the shift/copy flag inhibits the shift and copy (=0) and the allowed reproduction times are not restricted (=255), reproduction control information ACp not restricting the reproduction period as well as the license ID only for the local use, content ID and license key Kc (step S310). Thereafter, license generating unit 5403 generates check-out information including the allowed check-out times, of which initial value is equal to 3 (step S312).

After step S308 or S312, music encoder 5404 encodes the music data, which bears the changed watermark, in a predetermined format to generate content data Dc (step S314). Encrypting unit 5405 encrypts the music data sent from music encoder 5404 with license key Kc included in the license, which is generated by license generating unit 5403, to generate encrypted content data {Dc}Kc (step S316). Thereafter, additional information Dc-inf of content data Dc is produced from the information included in music CD 60 or from information entered by the user through keyboard 560 of personal computer 50 (step S318).

Thereby, controller 510 of personal computer 50 obtains encrypted content data {Dc}Kc and additional information Dc-inf via bus BS2, and records them on hard disk 530 as a content file (step S320). Controller 510 produces the encrypted level-1 extended license by effecting unique encryption on the produced license (transaction ID, content ID, license key Kc, access control information ACm and reproduction control information ACp) and the check-out information (step S322). Thereafter, controller 510 produces the license administration file, which includes the encrypted level-1 extended license as well as the plaintext of transaction ID and content ID, and corresponds to encrypted content data {Dc}Kc and additional information Dc-inf recorded on the hard disk in step S320, and records it on hard disk 530 (step S324). Finally, controller 510 adds the file name of the accepted content to the content list file recorded on hard disk 530 (step S326). Thereby, the ripping operation ends (step S328).

As described above, the encrypted content data and the license can likewise be obtained by the ripping from the music CD, and the obtained license is protected and administered together with the content distributed from distribution server 10. The encrypted content data and the license obtained by ripping from the music CD are protected at the same security level as the encrypted content data and the license obtained by the license administration module. Therefore, the encrypted content data and the license obtained by ripping cannot be basically taken out from the personal computer except for the case of the foregoing check-out.

[Shift/Copy]

In the data distribution systems shown in FIGS. 1 and 2, the license, which is distributed from distribution server 10 to license administration device 520 of personal computer 50, as well as the encrypted content data corresponding to this license are sent to memory card 110 attached to cellular phone 100 or reproduction terminal 102. Description will now be given on this operation. This operation will be referred to as “shift/copy”, and is performed only between units ensuring the security level of level 2. In the shift/copy operation, the determination whether the license can be duplicated or not is performed according to the shift/copy flag in access control information ACm included in the license. When the shift/copy flag allows the shift/copy (=3), the copy of the license is already allowed by the content provider or supplier. Therefore, when the shift/copy flag allows the shift/copy (=3), copy of the license is performed. Likewise, when the shift/copy flag allows only shift (=2), shift of the license is performed.

License administration device 520 is not allowed to supply the license only to the license administration device and the content reproducing circuit of the security level of level 2, and for this purpose, KPa holding unit 1414 holds only public authentication key KPa2 at level 2.

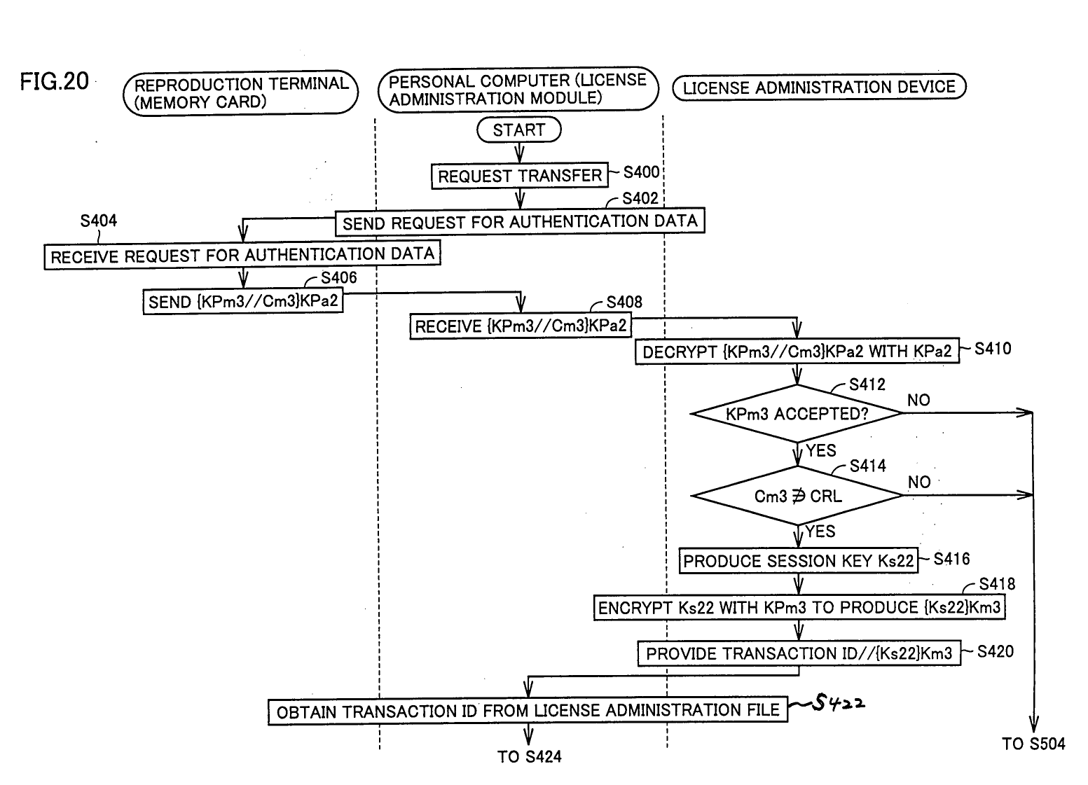

FIGS. 20-23 are first to fourth flow charts of the shift/copy operation performed in the data distribution systems shown in FIGS. 1 and 2, respectively, and particularly illustrate the shift/copy operation, in which the encrypted content data and the license received by license administration device 520 from distribution server 10 are given to memory card 110 attached to cellular phone 100 or reproduction terminal 102. Since cellular phone 100 and reproduction terminal 102 operate merely to relay the data in the shift operation, these are not shown in the flow charts. The following description is given on the case of shift to memory card 110 attached to reproduction terminal 102 shown in FIG. 2. However, shift to memory card 110 attached to cellular phone 100 shown in FIG. 1 is performed in a similar manner except for that cellular phone 100 functions instead of reproduction terminal 102.

Before the processing illustrated in FIG. 20, the user of personal computer 50 determines the content to be shifted or copied in accordance with the content list file, and the content file and the license administration file are specified. The following description is based on the premise that the above operation is already performed.

Referring to FIG. 20, when the user enters the shift request via keyboard 560 of personal computer 50 (step S400), controller 510 sends a request for sending of the authentication data to reproduction terminal 102 via USB interface 550, terminal 580 and USB cable 70 (step S402). Controller 1106 of reproduction terminal 102 receives the request for the authentication data via terminal 1114, USB interface 1112 and bus BS3, and sends the received request for the authentication data to memory card 110 via bus BS3 and memory card interface 1200. Controller 1420 of memory card 110 receives the request for the authentication data via terminal 1426, interface 1424 and bus BS4 (step S404).

When controller 1420 receives the request for the authentication data, it reads out authentication data {KPm3//Cm3}KPa2 from authentication data holding unit 1400 via bus BS4, and provides authentication data {(KPm3//Cm3}KPa2 thus read to reproduction terminal 102 via bus BS4, interface 1424 and terminal 1426. Controller 1106 of reproduction terminal 102 receives authentication data {KPm3//Cm3}KPa2 via memory card interface 1200 and bus BS3, and sends authentication data {KPm3//Cm3}KPa2 to personal computer 50 via bus BS3, USB interface 1112, terminal 1114 and USB cable 70 (step S406).

Thereby, controller 510 of personal computer 50 receives authentication data {KPm3//Cm3}KPa2 via terminal 580 and USB interface 550 (step S408), and sends authentication data {KPm3//Cm3}KPa2 thus received to license administration device 520 via bus BS2. Controller 5220 of license administration device 520 receives authentication data {KPm3//Cm3}KPa2 via terminal 5226, interface 5224 and bus BS5, and provides authentication data {KPm3//Cm3}KPa2 thus received to decryption processing unit 5208. Decryption processing unit 5208 decrypts authentication data {KPm3//Cm3}KPa2 with public authentication key KPa2 provided from KPa holding unit 5214 (step S410). Controller 5220 performs the authentication processing based on the result of decryption by decryption processing unit 5208 for determining whether the processing is performed correctly or not, and thus whether it receives or not the authentication data, which is encrypted for certifying its validity by a regular system, for authenticating the fact that memory card 110 holds class public encryption key KPm3 and class certificate Cm3 provided from the regular memory card (step S412). When it is determined that the authentication data is valid, controller 5220 approves and accepts class public encryption key KPm3 and class certificate Cm3. Then, next processing is performed in a step S414. When the authentication data is not valid, controller 5220 does not approve class public encryption key KPm3 and class certificate Cm3, and the processing ends without accepting them (S504).

Since license administration device 520 holds only pubic authentication key KPa2 corresponding to level 2, the authentication fails, and the processing ends if the request is made from license administration module 511 having the security level of level 1. Thus, the shift from level 2 to level 1 is impossible.

When it is determined that the regular memory card is used, controller 5220 then refers to CRL region 5215A of memory 5215 to determine whether class certificate Cm3 of memory card 110 is listed in certificate revocation list CRL or not. When class certificate Cm3 is listed in the certificate revocation list, the shift operation ends (step S504).

When the class certificate of memory card 110 is not listed in the certificate revocation list, the operation moves to a next step (S414).

When it is determined from a result of the authentication processing that the access is made from the reproduction terminal provided with the memory card having valid authentication data, and the class is not listed in the certificate revocation list, session key generating unit 5218 generates a session key Ks22 for shift (step S416). Encryption processing unit 5210 encrypts session key Ks22 thus produced with class public encryption key KPm3, which corresponds to memory card 110 and is obtained by decryption processing unit 5208 (step S418). Controller 5220 obtains encrypted data {Ks22}Km3 via bus BS5, and outputs encrypted data {Ks22}Km3 via bus BS5, interface 5224 and terminal 5226 (step S420).

When controller 510 of personal computer 50 receives encrypted data {Ks22}km3 from license administration device 520, it obtains transaction ID from the license administration file recorded on hard disk 530 (step S422).

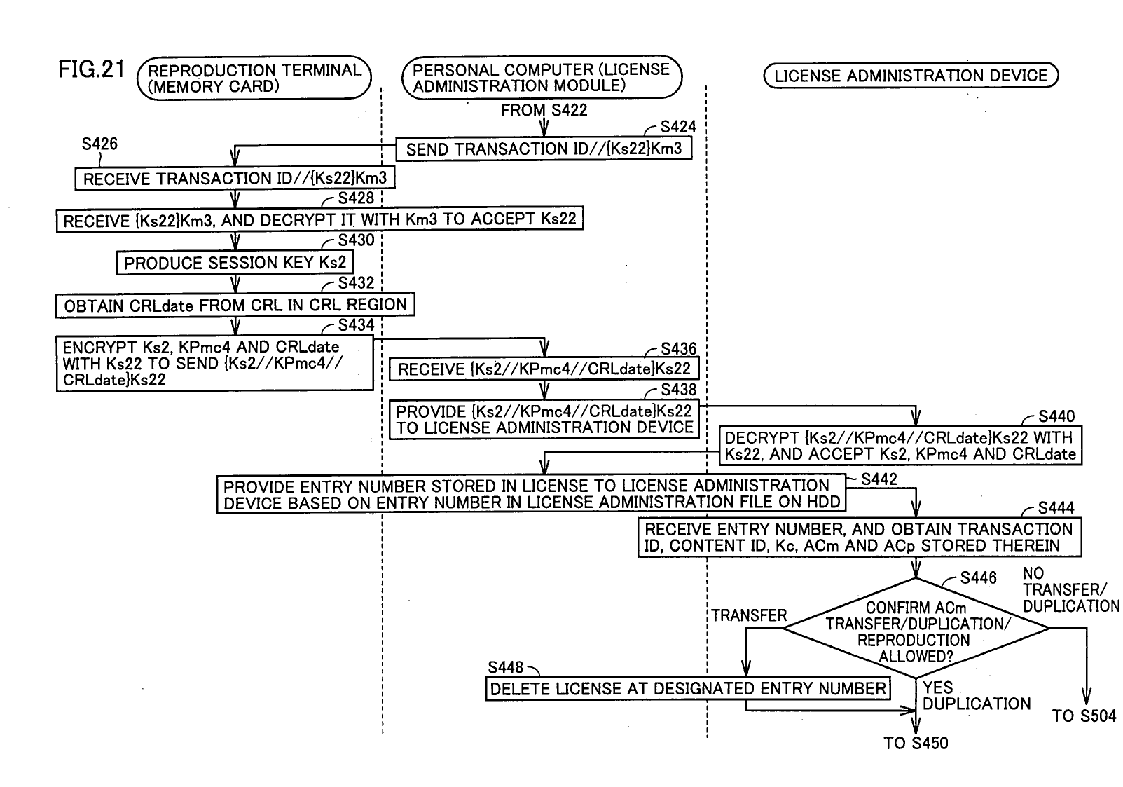

Referring to FIG. 21, controller 510 of personal computer 50 sends transaction ID//{Ks22}Km3, which is prepared by adding obtained transaction ID to encrypted data {Ks22}Km3, to reproduction terminal 102 via USB interface 550, terminal 580 and USB cable 70 (step S422). Thereby, controller 1106 of reproduction terminal 102 receives transaction ID//{Ks22}Km3 via terminal 1114, USB interface 1112 and bus BS3, and sends transaction ID//{Ks22}Km3 thus received to memory card 110 via memory card interface 1200. Controller 1420 of memory card 110 receives transaction ID//{Ks22}Km3 via terminal 1426, interface 1424 and bus BS4 (step S426). Decryption processing unit 1422 receives encrypted data {Ks22}Km3 from controller 1420 via bus BS4, and decrypts encrypted data {Ks22}Km3 with class private decryption key Km3 sent from Km holding unit 1421. Thereby, decryption processing unit 1422 accepts session key Ks22 (step S428). Session key generating unit 1418 generates session key Ks2 (step S430). Controller 1420 obtains update date/time CRLdate of the certificate revocation list from CRL region 1415A of memory 1415 via bus BS4, and provides update date/time CRLdate thus obtained to selector switch 1446 (step S432).

Thereby, encryption processing unit 1406 encrypts session key Ks2, individual public encryption key KPmc4 and update date/time CRLdate of the certificate revocation list, which are obtained by successively selecting the terminals of selector switch 1446, with session key Ks22, which is decrypted by decryption processing unit 1404, to produce encrypted data {Ks2//KPmc4//CRLdate}Ks22. Controller 1420 outputs encrypted data {Ks2//KPmc4//CRLdate}Ks22 to reproduction terminal 102 via bus BS4, interface 1424 and terminal 1426. Controller 1106 of reproduction terminal 102 receives encrypted data {Ks2//KPmc4//CRLdate}Ks22 via memory card interface 1200. Controller 1106 sends encrypted data {Ks2//KPmc4//CRLdate}Ks22 to personal computer 50 via USB interface 1112, terminal 1114 and USB cable 70 (step S434).

Controller 510 of personal computer 50 receives encrypted data {Ks2//KPmc4//CRLdate}Ks22 via terminal 580 and USB interface 550 (step S436), and provides encrypted data {Ks2//KPmc4//CRLdate}Ks22 to license administration device 520 via bus BS2 (step S438). Controller 5220 of license administration device 520 receives encrypted data {Ks2//KPmc4//CRLdate}Ks22 via terminal 5226, interface 5224 and bus BS5, and provides encrypted data {Ks2//KPmc4//CRLdate}Ks22 thus received to decryption processing unit 5212. Decryption processing unit 5212 decrypts encrypted data {Ks2//KPmc4//CRLdate}Ks22 with session key Ks22 provided from session key generating unit 5218, and accepts session key Ks2, individual public encryption key KPmc4 and update date/time CRLdate of the certificate revocation list (step S440).

Controller 510 of personal computer 50 reads from hard disk 530 the entry number included in the license administration file, which was recorded on hard disk 530 in step S424. Controller 510 provides the entry number thus read to license administration device 520 via bus BS2 (step S442). Controller 5220 of license administration device 520 receives the entry number via terminal 5226, interface 5224 and bus BS5, and reads license (transaction ID, content ID, license key Kc, access control information ACm and reproduction control information ACp) from the entry of license region 5215B in memory 5215 designated by the entry number (step S444).

Then, controller 5220 determines access control information ACm (step S346). More specifically, controller 5220 first determines, based on obtained access control information ACm, whether the license to be shifted to memory card 110 attached to reproduction terminal 102 allows the reproduction of the encrypted content data according to the allowed reproduction times or not. If the allowed reproduction times are zero, the encrypted content data cannot be reproduced with the license, and it is meaningless to shift the encrypted content data and the license to memory card 110 attached to reproduction terminal 102. In view of this, the above determination is performed. If the reproduction is allowed, it is determined from the shift/copy flag whether the shift/copy of the license are allowed or not.

If the reproduction of the encrypted content data is not allowed in step S446 (allowed reproduction times are zero), or the shift/copy flag inhibits the shift/copy (i.e., =0), it is determined from access control information ACm that the shift/copy are impossible so that the operation moves to step S504, and the shift operation ends. In step S446, if the reproduction of the encrypted content data is allowed (allowed reproduction times are not zero), and the shift/copy flag allows only the shift (i.e., =1), it is determined that the shift of license is allowed, and controller 510 deletes the license at the designated entry number in license region 5215B of memory 5215 (step S448), and the operation moves to a step S450. If the reproduction of the encrypted content data is allowed (allowed reproduction times are not zero), and the shift/copy flag allows the shift/copy (i.e., =3), it is determined that the copy of license is allowed and then the operation bypasses step S448, and goes to a step S450.

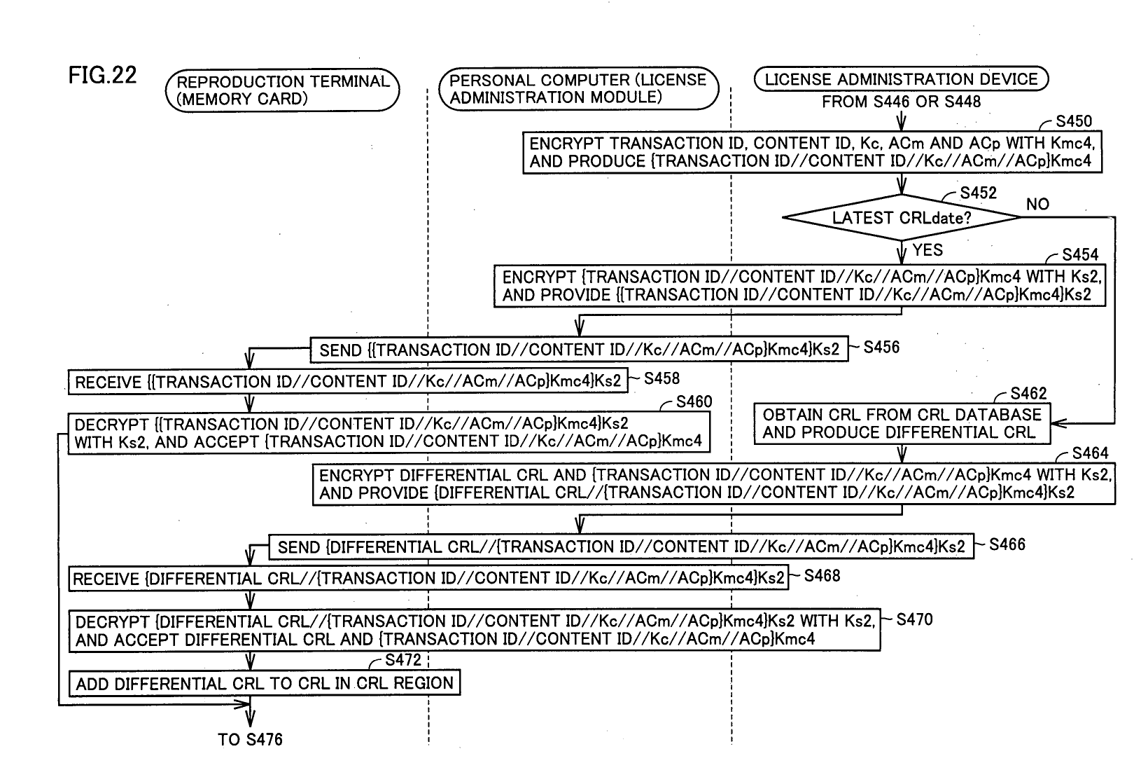

Referring to FIG. 22, encryption processing unit 5217 encrypts the license with individual public encryption key KPmc4, which is obtained by decryption processing unit 5212 and is peculiar to memory card 110, to produce encrypted data {transaction ID//content ID//Kc//ACm//ACp}Kmc4 (step S450). A comparison is made between update date/time CRLdate of the certificate revocation list sent from memory card 110 and the update date/time of the certificate revocation list held in CRL region 5215A by license administration device 520 for determining the newer certificate revocation list. When the certificate revocation list sent from memory card 110 is newer than the other, the operation moves to a step S450. When the certificate revocation list of license administration device 520 is newer than the other, the operation moves to a step S462 (step S452).

When it is determined that the certificate revocation list of memory card 110 is newer than the other, encryption processing unit 5206 encrypts encrypted data {transaction ID//content ID//Kc//ACm//ACp}Kmc4 provided from encryption processing unit 5217 with session key Ks2 generated by session key generating unit 5218, and provides encrypted data {{transaction ID//content ID//Kc//ACm//ACp}Kmc4}Ks2 onto bus BS5. Controller 5220 sends encrypted data {{transaction ID//content ID//Kc//ACm//ACp}Kmc4}Ks2 on bus BS5 to personal computer 50 via interface 5224 and terminal 5226 (step S454).

Controller 510 of personal computer 50 receives encrypted data {{transaction ID//content ID//Kc//ACm//ACp}Kmc4}Ks2, and sends it to reproduction terminal 102 via USB interface 550, terminal 580 and USB cable 70 (step S456).

Controller 1106 of reproduction terminal 102 receives encrypted data {{transaction ID//content ID//Kc//ACm//ACp}Kmc4}Ks2 via terminals 1114 and 1112 and bus BS3, and sends encrypted data {{transaction ID//content ID//Kc//ACm//ACp}Kmc4}Ks2 thus received to memory card 110 via bus BS3 and memory card interface 1200. Controller 1420 of memory card 110 receives encrypted data {{transaction ID//content ID//Kc//ACm//ACp}Kmc4}Ks2 via terminal 1426, interface 1424 and bus BS4 (step S458).

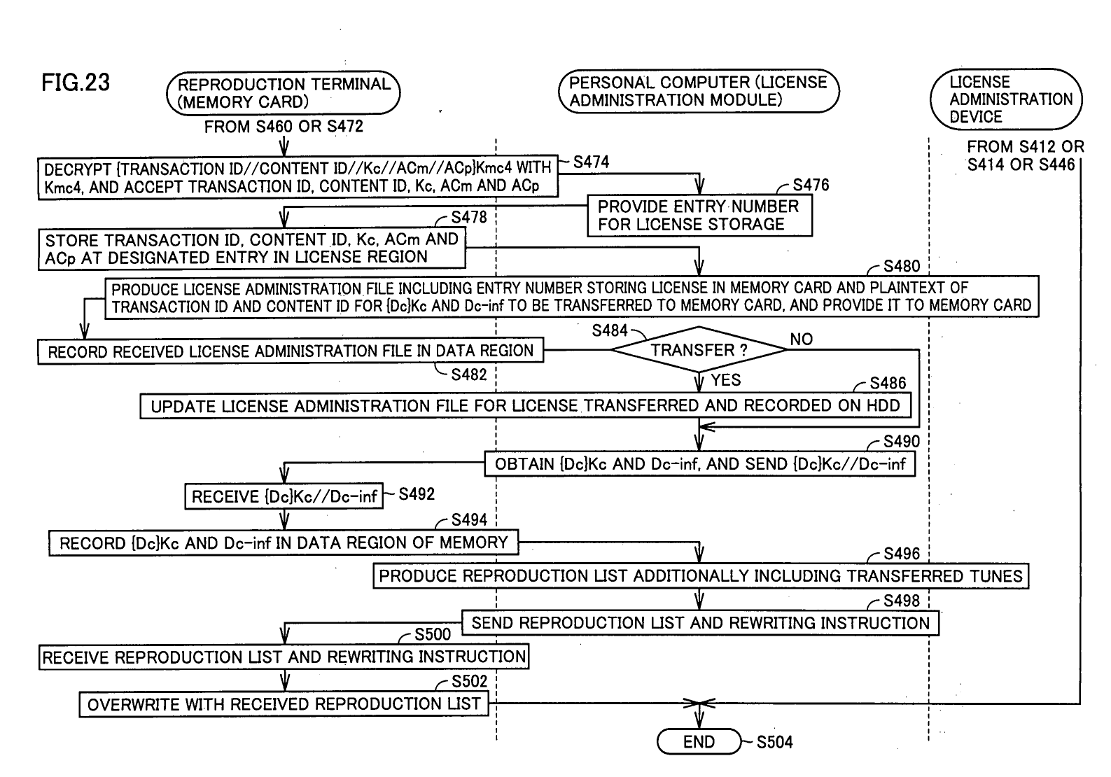

Decryption processing unit 1412 of memory card 110 receives encrypted data {{transaction ID//content ID//Kc//ACm//ACp}Kmc4}Ks2 via bus BS4, decrypts it with session key Ks2 generated by session key generating unit 1418, and accepts encrypted data {transaction ID//content ID//Kc//ACm//ACp}Kmc4 (step S460). Thereafter, the operation moves to a step S474 illustrated in FIG. 23.

When it is determined in step S450 that the certificate revocation list of license administration device 520 is newer than the other, controller 5220 of license administration device 520 obtains data CRL of the latest certificate revocation list from CRL region 5215A of memory 5215 via bus BS5, and produces the differential CRL based on update date/time CRLdate received from memory card 110, i.e., the destination of the license (step S462).

Encryption processing unit 5206 receives the output of encryption processing unit 5217 and the differential CRL via selector switches 5242 and 5246, respectively, and encrypts them with session key Ks2 generated by session key generating unit 5218. Encrypted data {differential CRL//{transaction ID//content ID//Kc//ACm//ACp}Kmc4}Ks2 provided from encryption processing unit 5206 is sent to personal computer 50 via bus BS5, interface 5224 and terminal 5226 (step S464).

Controller 510 of personal computer 50 receives encrypted data {differential CRL//{transaction ID//content ID//Kc//ACm//ACp}Kmc4}Ks2, and sends encrypted data {differential CRL//{transaction ID//content ID//Kc//ACm//ACp}Kmc4}Ks2 to reproduction terminal 102 via USB interface 550, terminal 580 and USB cable 70 (step S466). Controller 1106 of reproduction terminal 102 receives encrypted data {differential CRL//{transaction ID//content ID//Kc//ACm//ACp}Kmc4}Ks2 via terminal 1114, USB interface 1112 and bus BS3, and sends encrypted data {differential CRL//{transaction ID//content ID//Kc//ACm//ACp}Kmc4}Ks2 via bus BS3 and memory card interface 1200 to memory card 110. Controller 1420 of memory card 110 receives encrypted data {differential CRL//{transaction ID//content ID//Kc//ACm//ACp}Kmc4}Ks2 via terminal 1426, interface 1424 and BS4 (step S468).

In memory card 110, decryption processing unit 1412 decrypts the received data on bus BS4 with session key Ks2 provided from session key generating unit 1418, and accepts the differential CRL and encrypted data {transaction ID//content ID//Kc//ACm//ACp}Kmc4 (step S470). Controller 1420 receives differential CRL, which is accepted by decryption processing unit 1412, via bus BS4, and adds the received differential CRL to certificate revocation list CRL held in CRL region 1415A of memory 1415 for updating (step S472).

The operations in steps S454, S456, 458 and S460 are performed to shift or duplicate license key Kc and others to memory card 110 when certificate revocation list CRL of memory card 110 on the receiver side is newer than certificate revocation list CRL of license administration device 520 on the sender side. The operations in steps S462, S464, S466, S468, S470 and S472 are performed to shift or license key Kc and others to memory card 110 when certificate revocation list CRL of license administration device 520 on the sender side is newer than certificate revocation list CRL of memory card 110 on the receiver side. As described above, determination is performed every time update date/time CRLdate is sent from memory card 110, and latest certificate revocation list CRL is stored as certificate revocation list CRL of memory card 110 in CRL region 1514A. Thereby, such a situation can be prevented that memory card 110 provides a license to a content reproducing circuit or another license administration device, of which security is broken, e.g., due to leakage of a private key.

Referring to FIG. 23, after steps S460 or S472, controller 1420 instructs decryption processing unit 1404 to decrypt encrypted license {transaction ID//content ID//Kc//ACm//ACp}Kmc4 with individual private decryption key Kmc4, and license (license key Kc, transaction ID, content ID, access control information ACm and reproduction control information ACp) is accepted (step S474).

Controller 510 of personal computer 50 sends the entry number for storing the license, which is moved to memory card 110, to reproduction terminal 102 via USB interface 550, terminal 580 and USB cable 70. Thereby, controller 1106 of reproduction terminal 102 receives the entry number via terminal 1114, USB interface 1112 and bus BS3, and sends the received entry number to memory card 110 via bus BS3 and memory card interface 1200. Controller 1420 of memory card 110 receives the entry number via terminal 1426 and interface 1424, and stores the license (license key Kc, transaction ID, content ID, access control information ACm and reproduction control information ACp), which is obtained in step S374, in license region 1415B of memory 1415 designated by the received entry number (step S478).

Controller 510 of personal computer 50 produces the license administration file, which includes the entry number of license stored in memory 1415 of memory card 110 as well as the plaintext of the transaction ID and the content ID, and corresponds to encrypted content data {Dc}Kc to be moved to memory card 110 and additional information Dc-inf, and sends it to memory card 110 (step S480).

Controller 1420 of memory card 110 receives license administration file via reproduction terminal 102, and records the received license administration file in data region 1415C of memory 1415 (step S482).

If the shift is performed according to the determination in step S446, controller 510 of personal computer 50 deletes the entry number of the license administration file corresponding to the license shifted to memory card 110 (step S448), and thereby updates the file to indicate “no license” (step S486). Thereafter, controller 510 obtains encrypted content data {Dc}Kc and additional information Dc-inf, which are to be shifted to memory card 110, from the content file recorded on hard disk 530, and sends data {Dc}Kc//Dc-inf to memory card 110 (step S490). Controller 1420 of memory card 110 receives data {Dc}Kc//Dc-inf via reproduction terminal 102 (step S492), and records received data {Dc}Kc//Dc-inf as the content file in data region 1415C of memory 1415 via bus BS4 (step S494).

Thereby, controller 510 of personal computer 50 prepares the reproduction list additionally including the tunes, which are shifted to memory card 110, in a step S496 and sends the reproduction list and the instruction of rewriting the reproduction list to memory card 110 (step S498). Controller 1420 of memory card 110 receives the reproduction list file and the rewriting instruction via reproduction terminal 102 (step S500), and performs the rewriting to replace the reproduction list file, which is recorded in data region 1415C of memory 1415, with the received reproduction list file via bus BS4 (step S502). Thereby, the shift operation ends (step S504).

As described above, it is determined that memory card 110 attached to reproduction terminal 102 is the regular or valid device, and at the same time, it is determined that class public encryption key KPm3, which is encrypted and sent together with class certificate Cm3, is valid. After determining these facts, the content data can be shifted only in response to the shift request to the memory card having class certificate Cm3 not listed in the certificate revocation list, i.e., in the list of the class certificates having the broken class public encryption key KPm3. Therefore, it is possible to inhibit the shift to unauthorized memory card as well as the shift using the descrambled or broken class key.

The encryption keys produced in the license administration module and the memory card are transmitted between them. Each of the license administration module and the memory card executes the encryption with the received encryption key, and sends the encrypted data to the other so that the mutual authentication can be practically performed even when sending and receiving the encrypted data, and it is possible to improve the security in the operation of shifting the encrypted content data and the license.

The above description has been given on the shift processing. In the case where the content supplier allows copy of the license, the above operation is performed as the copy operation, and the license is held in license administration device 520 on the sender side as it is. This copy is an act, which is allowed when the content supplier, i.e., copyright holder allowed the copy at the time of distribution, and the shift/copy flag in access control information ACm was set to allow the shift/copy. Thus, this act does not infringe the right of the copyright holder. The access control information is a part of the license, and the security thereof is ensured so that the copyright is secured.

By using the shift operation described above, even the user of reproduction terminal 102 not having a function of communicating with distribution server 10 can receive the encrypted content data and the license on the memory card via personal computer 50. This improves the user convenience.

The description has been given on the shift of license from license administration device 520 of personal computer 50 to memory card 110. The shift of license from memory card 110 to license administration device 520 is likewise performed in accordance with flow charts of FIGS. 20-23. Thus, cellular phone 100 shown in FIG. 1 receives the distribution, and the encrypted content data and the license stored in memory card 110 can be saved in personal computer 50.

Among the licenses received by personal computer 50 from distribution server 10, only the license received by hardware of license administration device 520 from distribution server 10 can be shifted to memory card 110. The encrypted content data and the license, which are received by software of license administration module 511 from distribution server 10 cannot be sent to the memory card by the “shift”. If the system were configured to allow free shift of them to memory card 110, this would raise the possibility that the license can be duplicated by shifting the license, in view of the fact that hard disk 530 bearing the level-1 extended license encrypted by personal computer 50 is the recording device allowing free backup. For preventing such copy, it is prevented to send the license received by license administration module 511 to memory card 110.

However, if the system were configured to inhibit any shift of the license, which is received by license administration module 511 and is administered by the license administration module having a low security level, to memory card 110, this would run counter to the major purpose of the data distribution system, which is to allow free transmission of the content data while securing the copyright. Accordingly, concepts of check-in and check-out, which will be described below, are employed to allow sending of the content data and the license received by license administration module 511 to memory card 110.

[Check-Out]

In the data distribution systems shown in FIGS. 1 and 2, the encrypted content data and the license, which are distributed from distribution server 10 to license administration module 511 of personal computer 50, are sent to memory card 110 attached to reproduction terminal 102. Description will now be given on this operation, which will be referred to as “check-out”.

In the data distribution systems shown in FIGS. 1 and 2, the license administered by license administration module 511 and the encrypted content data corresponding to the license are sent to memory card 110 attached to cellular phone 100 or reproduction terminal 102 on the precondition that the license is to be returned. Therefore, the license administration module 511 holds public authentication key KPa2 at level 2. In the check-out operation, it is determined whether the check-out of the license can be performed or not, and this determination is performed according to the allowed check-out times in the check-out information held as the encrypted level-1 extended license together with the license. When the allowed check-out times are zero or more, the check-out can be performed. According to the check-out, the license is sent only from level 1 to level 2.

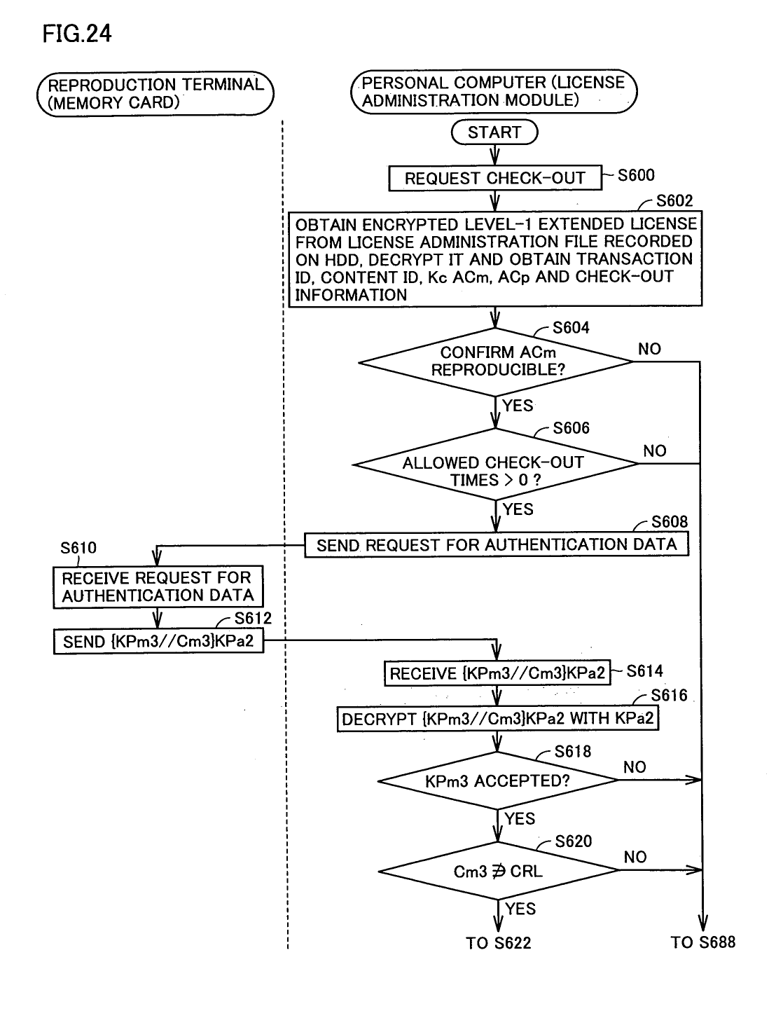

FIGS. 24-27 are first to fourth flow charts illustrating the check-out operation, respectively. Since cellular phone 100 or reproduction terminal 102 operates merely to relay the data even in the check-out, these are not shown in the flow charts. The following description is given on the case of shift to memory card 110 attached to reproduction terminal 102 shown in FIG. 2. However, shift to memory card 110 attached to cellular phone 100 shown in FIG. 1 is performed in a similar manner except for that reproduction terminal 102 is replaced with cellular phone 100.

Before the processing illustrated in FIG. 24, the user of personal computer 50 determines the content to be checked out in accordance with the content list file, and specifies the content file and the license administration file. The following description is based on the premise that the above operation is already performed.

Referring to FIG. 24, when the user enters the check-out request via keyboard 560 of personal computer 50 (step S600), controller 510 obtains the encrypted license data from the license administration file recorded on hard disk 530. In this case, the license administration file is prepared by license administration module 511, and more specifically by receiving the encrypted content data and the license, uniquely encrypting them and storing the encrypted level-1 extended license (see step S266 in FIG. 17). License administration module 511 obtains the encrypted level-1 extended license of the encrypted content data to be checked out from the license administration file, and decrypts it to obtain license (transaction ID, content ID, license key Kc, access control information ACm and reproduction control information ACp) and check-out information (step S602).

License administration module 511 determines access control information ACm (step S604). More specifically, based on the obtained access control information ACm, license administration module 511 determines whether the license to be checked out to memory card 110 attached to reproduction terminal 102 restricts the reproduction or not, and more specifically, determines whether access control information ACm designates the reproduction times of the encrypted content data or not, and whether the reproduction is already inhibited or not. In the case where the reproduction times are restricted, if the license were checked out, it would be impossible to suppress accurately the reproduction in accordance with the allowed reproduction times.

If the reproduction is restricted in a step S604, the operation moves to a step S688, and the check-out operation ends. In step S604, if there is no restriction on the reproduction, the operation moves to a step S606. License administration module 511 determines whether the allowed check-out times included in the obtained check-out information are larger than zero or not (step S606). When the allowed check-out times are 0 or lower in step S606, there is no license for check-out so that the operation moves to step S688, and the check-out operation ends. When the allowed check-out times are larger than zero in step S606, license administration module 511 sends a request for sending of the authentication data via USB interface 550, terminal 580 and USB cable 70 (step S608). Controller 1106 of reproduction terminal 102 receives the request for the authentication data via terminal 1114, USB interface 1112 and bus BS3, and sends the received request for the authentication data to memory card 110 via bus BS3 and memory card interface 1200. Controller 1420 of memory card 110 receives the request for authentication data via terminal 1426, interface 1424 and bus BS4 (step S610).

When controller 1420 receives the request for authentication data, it reads out authentication data {KPm3//Cm3}KPa2 from authentication data holding unit 1400 via bus BS4, and provides authentication data {KPm3//Cm3}KPa2 thus read to reproduction terminal 102 via bus BS4, interface 1424 and terminal 1426. Controller 1106 of reproduction terminal 102 receives authentication data {KPm3//Cm3}KPa2 via memory card interface 1200 and bus BS3, and sends authentication data {KPm3//Cm3}KPa2 to personal computer 50 via bus BS3, USB interface 1112, terminal 1114 and USB cable 70 (step S612).

Thereby, license administration module 511 of personal computer 50 receives authentication data {KPm3//Cm3}KPa2 via terminal 580 and USB interface 550 (step S614), and decrypts received authentication data {KPm3//Cm3}KPa2 with authentication key KPa2 (step S616). License administration module 511 performs the authentication processing based on the result of decryption for determining whether the processing is performed correctly or not, and thus whether it receives or not the authentication data, which is encrypted for certifying its validity by a regular system, for authenticating the fact that memory card 110 holds class public encryption key KPm3 and class certificate Cm3 provided from the regular memory card (step S618). When it is determined that the authentication data is valid, license administration module 511 approves and accepts class public encryption key KPm3 and class certificate Cm3. Then, the operation moves to a next step S620. When the authentication data is not valid, license administration module 511 does not approve class public encryption key KPm3 and class certificate Cm3, and the processing ends without accepting these keys (S688).

When it is determined by the authentication processing that the memory card is a regular card, license administration module 511 then refers to hard disk 530 to determine whether class certificate Cm3 of memory card 110 is listed in certificate revocation list CRL or not. When class certificate Cm3 is listed in certificate revocation list CRL, the check-out operation ends (step S688). When class certificate Cm3 is not listed in certificate revocation list CRL, next processing is performed (step S620).

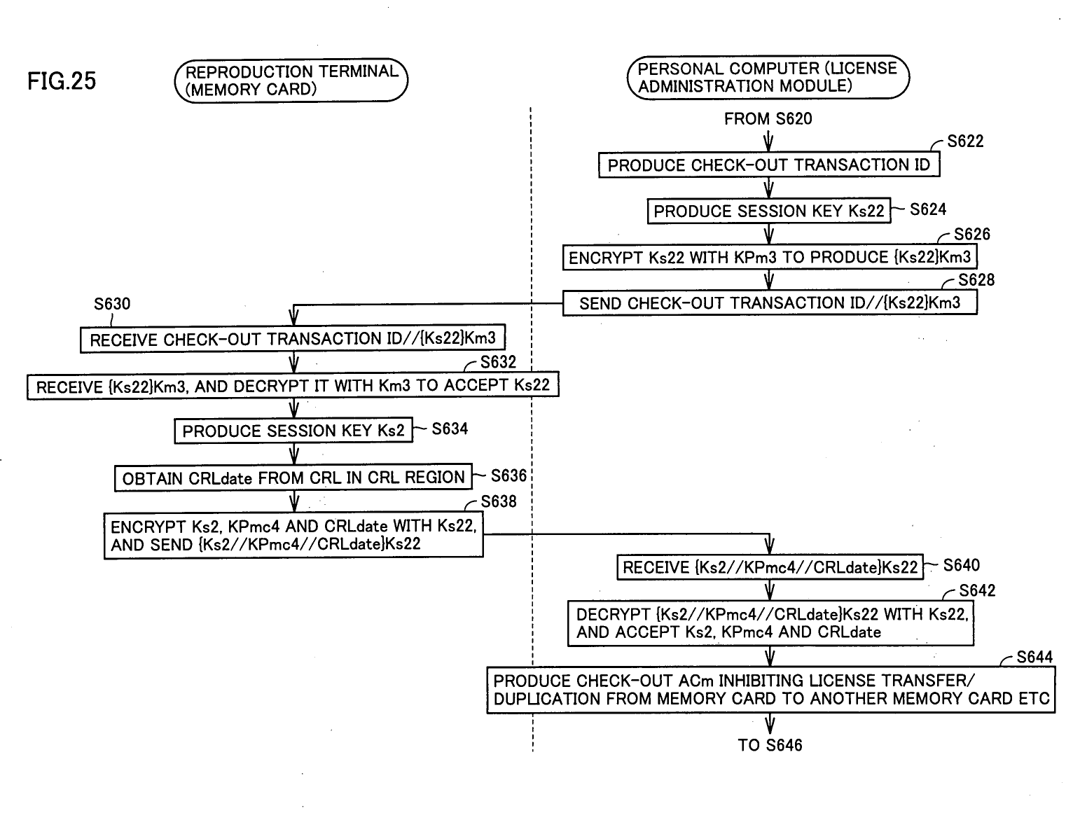

Referring to FIG. 25, when it is determined from a result of the authentication processing that the access is made from the reproduction terminal provided with the memory card having valid authentication data at level 2, and the class is not listed in the certificate revocation list, license administration module 511 generates check-out transaction ID (i.e., transaction ID for check-out), which is the administration code for specifying the check-out (step S622). The check-out transaction ID necessarily takes a value different from all the transaction IDs stored in memory card 110, and is produced as a transaction ID for local use. License administration module 511 produces session key Ks22 for check-out (step S624), and encrypts session key Ks22 thus produced with class public encryption key KPm3 sent from memory card 110 (step S626). License administration module 511 sends check-out transaction ID//{Ks22}Km3, which is prepared by adding check-out transaction ID to encrypted data {Ks22}Km3, to reproduction terminal 102 via USB interface 550, terminal 580 and USB cable 70 (step S628). Thereby, controller 1106 of reproduction terminal 102 receives check-out transaction IDI/{Ks22}Km3 via terminal 1114, USB interface 1112 and bus BS3, and sends check-out transaction ID//{Ks22}Km3 thus received to memory card 110 via memory card interface 1200. Controller 1420 of memory card 110 receives check-out transaction ID//{Ks22}Km3 via terminal 1426, interface 1424 and bus BS4 (step S630). Decryption processing unit 1422 receives encrypted data {Ks22}Km3 from controller 1420 via bus BS4, and decrypts encrypted data {Ks22}Km3 with class private decryption key Km3 sent from Km holding unit 1421. Thereby, decryption processing unit 1422 accepts session key Ks22 (step S632). Session key generating unit 1418 generates session key Ks2 (step S634). Controller 1420 obtains update date/time CRLdate of the certificate revocation list from CRL region 1415A of memory 1415 via bus BS4, and provides the update date/time CRLdate thus obtained to selector switch 1446 (step S636).

Thereby, encryption processing unit 1406 encrypts session key Ks2, individual public encryption key KPmc4 and update date/time CRLdate, which are obtained by successively selecting the contacts of selector switch 1446, with session key Ks22 decrypted by decryption processing unit 1404 to produce encrypted data {Ks2//KPmc4//CRLdate}Ks22. Controller 1420 outputs encrypted data {Ks2//KPmc4//CRLdate}Ks22 to reproduction terminal 102 via bus BS4, interface 1424 and terminal 1426. Controller 1106 of reproduction terminal 102 receives encrypted data {Ks2//KPmc4//CRLdate}Ks22 via memory card interface 1200. Controller 1106 sends it to personal computer 50 via USB interface 1112, terminal 1114 and USB cable 70 (step S638).

License administration module 511 of personal computer 50 receives encrypted data {Ks2//KPmc4//CRLdate}Ks22 via terminal 580 and USB interface 550 (step S640), decrypts encrypted data {Ks2//KPmc4//CRLdate}Ks22 thus received with session key Ks22, and accepts session key Ks2, individual public encryption key KPmc4 and update date/time CRLdate (step S642). License administration module 511 produces access control information ACm for check-out, which inhibits shift and copy of the license from the memory card attached to reproduction terminal 102 to another memory card or the like. More specifically, it produces access control information ACm, in which the reproduction times are not restricted (=255), and the shift/copy flag is set to “0” inhibiting the shift and copy (step S644).

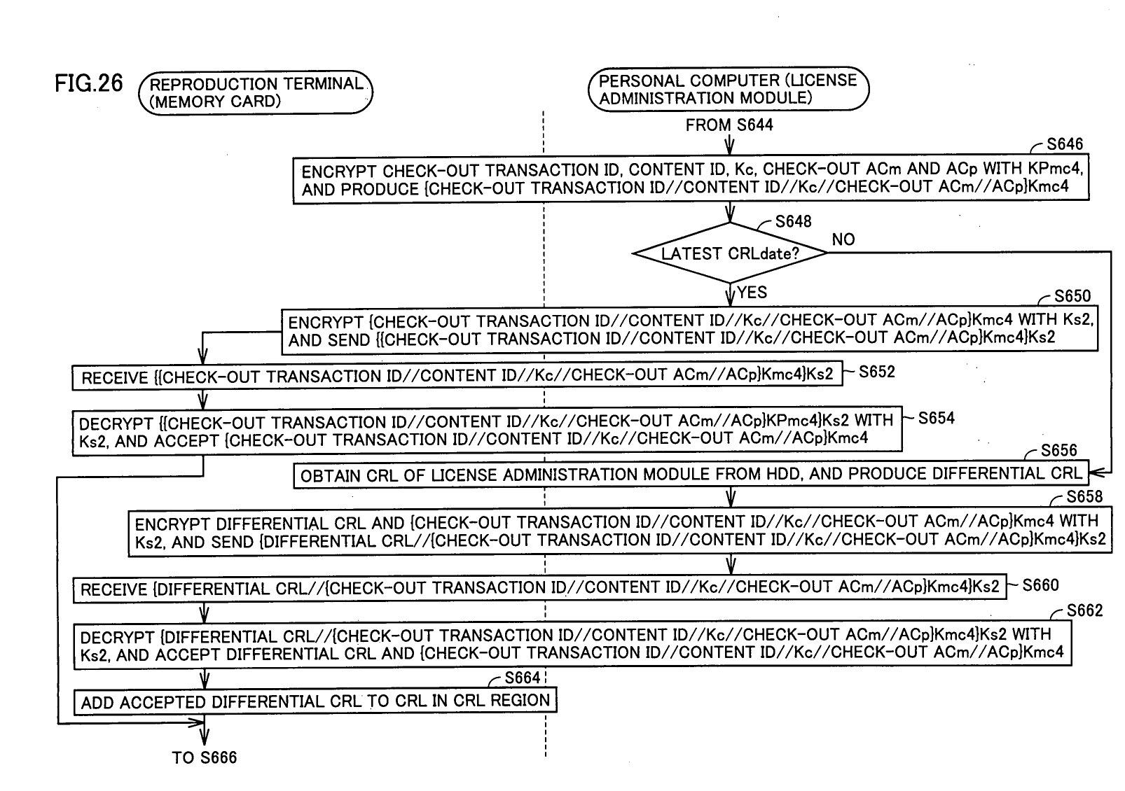

Referring to FIG. 26, license administration module 511 encrypts the license with individual public encryption key KPmc4, which is peculiar to memory card 110 and is received in step S642, to produce encrypted data {check-out transaction ID//content ID//Kc//check-out ACm//ACp}Kmc4 (step S646). A comparison is made between update date/time CRLdate of the certificate revocation list sent from memory card 110 and the update date/time of the certificate revocation list, which is held on hard disk 530 and is administered by license administration module, for determining the newer certificate revocation list. When the list sent from memory card 110 is newer than the other, the operation moves to a step S650. When the list of license administration module 511 is newer than the other, the operation moves to a step S656 (step S648).

When it is determined that the list of memory card 110 is newer than the other, license administration module 511 encrypts encrypted data {check-out transaction ID//content ID//Kc//check-out ACm//ACp}Kmc4 with session key Ks2, and sends encrypted data {{check-out transaction ID//content ID//Kc//check-out ACm//ACp}Kmc4}Ks2 to reproduction terminal 102 via USB interface 550, terminal 580 and USB cable 70 (step S650).

Controller 1106 of reproduction terminal 102 receives encrypted data {{check-out transaction ID//content ID//Kc//check-out ACm//ACp}Kmc4}Ks2 via terminal 1114, USB interface 1112 and bus BS3, and sends encrypted data {{check-out transaction ID//content ID//Kc//check-out ACm//ACp}Kmc4}Ks2 thus received to memory card 110 via bus BS3 and memory card interface 1200. Controller 1420 of memory card 110 receives encrypted data {{check-out transaction ID//content ID//Kc//check-out ACm//ACp}Kmc4}Ks2 via terminal 1426, interface 1424 and bus BS4 (step S652).

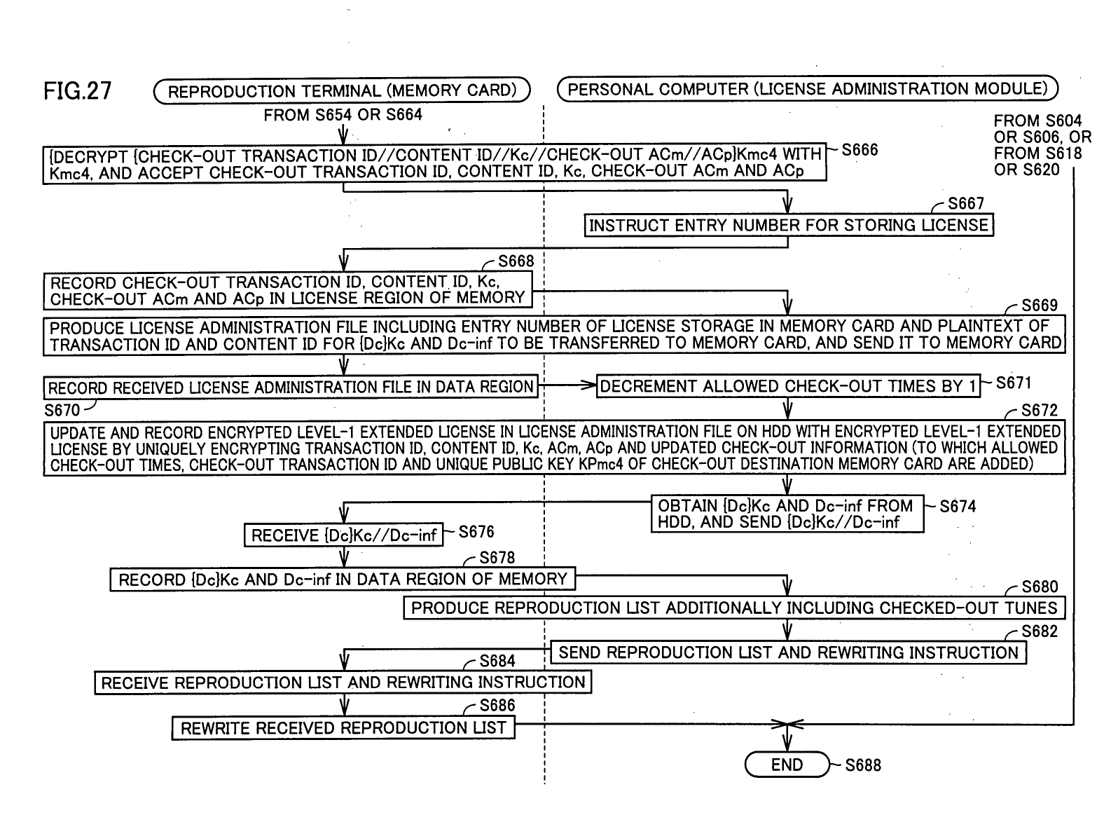

Decryption processing unit 1412 of memory card 110 receives encrypted data {{check-out transaction ID//content ID//Kc//check-out ACm//ACp}Kmc4}Ks2 via bus BS4, and decrypts it with session key Ks2 generated by session key generating unit 1418 to accept encrypted data {check-out transaction ID//content ID//Kc//check-out ACm//ACp}Kmc4 (step S654). Thereafter, the operation moves to a step S666 shown in FIG. 27.

When it is determined in step S648 that the certificate revocation list of license administration module 511 is newer than the other, license administration module 511 obtains certificate revocation list CRL administered by the license administration module from hard disk 530, and produces differential CRL based on update dates and times CRLdate received from memory card 110, i.e., the destination of the license (step S656).

License administration module 511 encrypts encrypted data {check-out transaction ID//content ID//Kc//check-out ACm//ACp}Kmc4 and differential CRL with session key Ks2, and sends encrypted data {differential CRL//{check-out transaction ID//content ID//Kc//check-out ACm//ACp}Kmc4}Ks2 to reproduction terminal 102 via USB interface 550, terminal 580 and USB cable 70 (step S658). Controller 1106 of reproduction terminal 102 receives encrypted data {differential CRL//{check-out transaction ID//content ID//Kc//check-out ACm//ACp}Kmc4}Ks2 via terminal 1114, USB interface 1112 and bus BS3, and outputs encrypted data {differential CRL//{check-out transaction ID//content ID//Kc//check-out ACm//ACp}Kmc4}Ks2 thus received to memory card 110 via bus BS3 and memory card interface 1200. Thereby, controller 1420 of memory card 110 receives encrypted data {differential CRL//{check-out transaction ID//content ID//Kc//check-out ACm//ACp}Kmc4}Ks2 via terminal 1426, interface 1424 and bus BS4 (step S660).

In memory card 110, decryption processing unit 1412 decrypts the received data on bus BS4 with session key Ks2 provided from session key generating unit 1418, and accepts differential CRL and encrypted data {check-out transaction ID//content ID//Kc//check-out ACm//ACp}Kmc4 (step S660). Controller 1420 receives differential CRL, which is accepted by decryption processing unit 1412, via bus BS4, and updates certificate revocation list CRL held in CRL region 1415A of memory 1415 by adding received differential CRL thereto (step S664).

In steps S650, S652 and S654, the operations are performed to check out license key Kc and others to memory card 110, and the operations in these steps are performed in the case where certificate revocation list CRL of memory card 110 on the receiver side is newer than certificate revocation list CRL of license administration module 511 on the sender side. The operations in steps S656, S658, S660, S662 and S664 are performed for checking out license key Kc and others to memory card 110 in the case where certificate revocation list CRL of license administration module 511 on the sender side is newer than certificate revocation list CRL of memory card 110 on the receiver side. As described above, determination is performed every time update date/time CRLdate of the certificate revocation list is sent from memory card 110, and latest certificate revocation list CRL is obtained from hard disk 530, and is stored in CRL region 1514A as certificate revocation list CRL of memory card 110. Thereby, such a situation can be prevented that memory card 110 provides a license to a content reproducing circuit or another license administration device, of which security is broken, e.g., due to leakage of a private key.

Referring to FIG. 27, after step S654 or S664, controller 1420 instructs decryption processing unit 1404 to decrypt encrypted license {check-out transaction ID//content ID//Kc//check-out ACm//ACp}Kmc4 with individual private decryption key Kmc4, and license (license key Kc, check-out transaction ID, content ID, check-out ACm and reproduction control information ACp) is accepted (step S666).

Controller 510 of personal computer 50 sends the entry number for storing the license, which is moved to memory card 110, to reproduction terminal 102 via USB interface 550, terminal 580 and USB cable 70 (step S667). Thereby, controller 1106 of reproduction terminal 102 receives the entry number via terminal 1114, USB interface 1112 and bus BS3, and stores license (license key Kc, check-out transaction ID, content ID, check-out ACm and reproduction control information ACp), which is obtained in step S666, in license region 1415B of memory 1415 designated by the received entry number (step S668).

Controller 510 of personal computer 50 generates the license administration file, which includes the entry number of license stored in memory 1415 of memory card 110 as well as the plaintext of check-out transaction ID and the content ID, and corresponds to encrypted content data {Dc}Kc to be moved to memory card 110 and additional information Dc-inf, and sends the license administration file to memory card 110 (step S669).

Controller 1420 of memory card 110 receives the license administration file via reproduction terminal 102, and records the received license administration file in data region 1415C of memory 1415 (step S670).

License administration module 511 of personal computer 50 decrements the allowed check-out times by one (step S671), and produces new encrypted level-1 extended license by effecting unique encryption on the transaction ID, content ID, license key Kc, access control information ACm, reproduction control information ACp and the updated check-out information (to which allowed check-out times, check-out transaction ID and individual public encryption key KPmc4 of memory card 110 of the check-out destination are added). The encrypted license data thus produced is written into hard disk 530 for updating the level-1 extended license of the license administration file recorded on hard disk 530 (step S672). Individual public encryption key KPmc4 of the check-out destination is stored in a tamper resistant module of the memory card, has a value peculiar to the memory card, and is obtained via a communication system having a high security level ensured by authentication and encryption. Therefore, individual public encryption key KPmc4 can be suitably used as identification information for specifying or identifying the memory card.

License administration module 511 obtains encrypted content data {Dc}Kc and additional information Dc-inf, which are to be checked out to memory card 110, from hard disk 530, and sends data {Dc}Kc//Dc-inf to memory card 110 (step S674). Controller 1420 of memory card 110 receives data {Dc}Kc//Dc-inf via reproduction terminal 102 (step S676), and records data {Dc}Kc//Dc-inf, which is received via bus BS4, as the content file in data region 1415C of memory 1415 (step S678).

Thereby, license administration module 511 of personal computer 50 prepares the reproduction list additionally including the tunes (step S680), which are checked out to memory card 110, and sends the reproduction list and the instruction of rewriting the reproduction list to memory card 110 (step S682). Controller 1420 of memory card 110 receives the reproduction list and the rewriting instruction via reproduction terminal 102 (step S684), and writes the received reproduction list file via bus BS4 into data region 1415C of memory 1415 to renew the reproduction list file recorded therein (step S686). Thereby, the check-out operation ends (step S688).

As described above, it is determined that memory card 110 attached to reproduction terminal 102 is the regular device, and at the same time, it is determined that class public encryption key KPm3, which is encrypted and sent together with class certificate Cm3, is valid. After determining these facts, the content data can be checked out only in response to the request for check-out to the memory card having class certificate Cm3 not listed in the certificate revocation list, i.e., in the list of the class certificates having the broken class public encryption key KPm3. Therefore, it is possible to inhibit the check-out to an unauthorized memory card as well as the check-out using the descrambled or broken class key.

The encryption keys produced in the license administration module and the memory card are transmitted between them. Each of the license administration module and the memory card executes the encryption with the received encryption key, and sends the encrypted data to the other so that the mutual authentication can be practically performed even when sending and receiving the encrypted data, and it is possible to improve the security in the operation of checking out the encrypted content data and the license.

By using the check-out operation described above, even the user of reproduction terminal 102 not having a function of communicating with distribution server 10 can receive the encrypted content data and the license, which are received by software of personal computer 50, on the memory card. This improves the user's convenience.

[Check-In]

In the data distribution systems shown in FIGS. 1 and 2, the encrypted content data and the license, which are checked out to memory card 110 from license administration module 511 of personal computer 50, are returned to license administration module 511. Description will now be given on this returning operation, which is referred to as “check-in”.

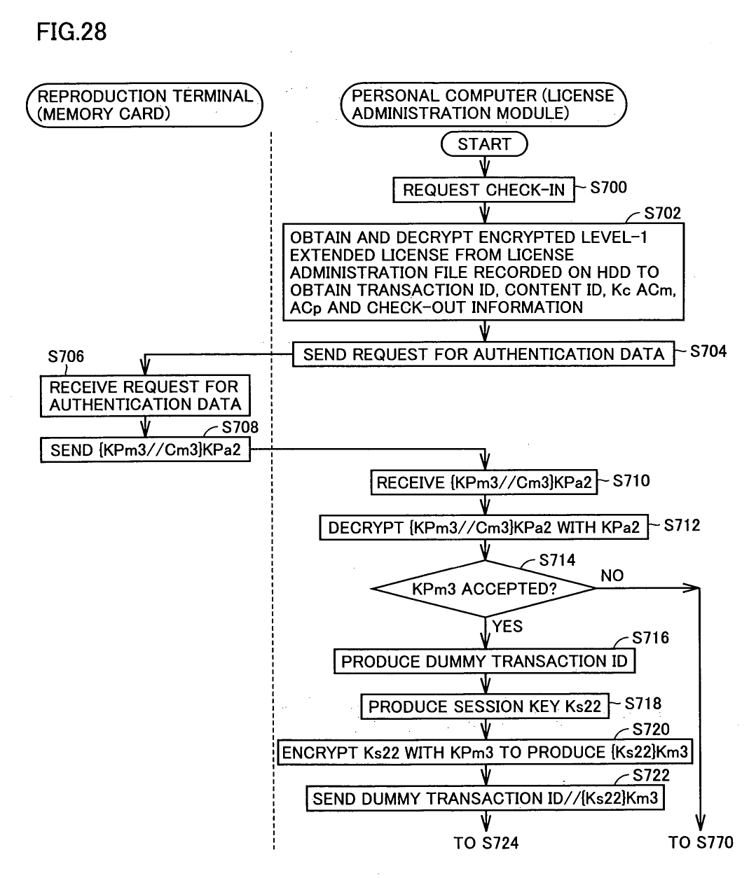

FIGS. 28-30 are first to third flow charts illustrating the check-in operation for returning the encrypted content data and the license, which were checked out to memory card 110 in the check-out operation already described with reference to FIGS. 24-27. Cellular phone 100 and reproduction terminal 102 likewise operate merely to relay data even in the check-in, and therefore are not illustrated in the flow charts. The following description is given on the case where shift is performed from memory card 110 attached to reproduction terminal 102 shown in FIG. 2. However, shift from memory card 110 attached to cellular phone 100 shown in FIG. 1 can be performed in a similar manner except for that reproduction terminal 102 is replaced with cellular phone 100.

Before the processing illustrated in FIG. 28, the user of personal computer 50 determines the content, which is to be checked in, in accordance with the content list file, and the license administration file, which is recorded on hard disk 530 and corresponds to the content thus determined, as well as the content file and the license administration file recorded in memory card 110 are specified. The following description is based on the premise that the above operation is already performed.

Referring to FIG. 28, when the user enters a check-in request via keyboard 560 of personal computer 50 (step S700), license administration module 511 obtains the encrypted level-1 extended license data from the license administration file recorded on hard disk 530, and decrypts it to obtain license (transaction ID, content ID, license key Kc, access control information ACm and reproduction control information ACp) and check-out information (allowed check-out times, check-out transaction ID and individual public encryption key KPmcx of the memory card of the check-out destination) (step S702). License administration module 511 sends a request for sending of the authentication data to reproduction terminal 102 via USB interface 550, terminal 580 and USB cable 70 (step S704). Thereby, controller 1106 of reproduction terminal 102 receives the request for the authentication data via terminal 1114, USB interface 1112 and bus BS3, and sends the request for the authentication data to memory card 110 via bus BS3 and memory card interface 1200. Controller 1420 of memory card 110 receives the request for the authentication data via terminal 1426, interface 1424 and bus BS4 (step S706).

When controller 1420 receives the request for the authentication data, it reads out authentication data {KPm3//Cm3}KPa2 from authentication data holding unit 1400 via bus BS4, and outputs authentication data {KPm3//Cm3}KPa2 thus read to reproduction terminal 102 via bus BS4, interface 1424 and terminal 1426. Controller 1106 of reproduction terminal 102 receives authentication data {KPm3//Cm3}KPa2 via memory card interface 1200 and bus BS3, and sends authentication data {KPm3//Cm3}KPa2 to personal computer 50 via bus BS3, USB interface 1112, terminal 1114 and USB cable 70 (step S708).

Thereby, license administration module 511 of personal computer 50 receives authentication data {KPm3//Cm3}KPa2 via terminal 580 and USB interface 550 (step S710), and decrypts received authentication data {KPm3//Cm3}KPa2 with public authentication key KPa2 at level 2 (step S712). License administration module 511 performs the authentication processing based on the result of decryption for determining whether the processing is performed correctly or not, and thus whether it receives or not the authentication data, which is encrypted for certifying its validity by a regular system, for authenticating the fact that memory card 110 holds class public encryption key KPm3 and class certificate Cm3 provided from the regular memory card (step S714). When it is determined that the authentication data is valid, license administration module 511 approves and accepts class public encryption key KPm3 and class certificate Cm3. Then, processing is performed in a step S716. When the authentication data is not valid, license administration module 511 does not approve class public encryption key KPm3 and class certificate Cm3, and the processing ends without accepting these keys (S770).

When it is determined by the authentication processing that the memory card is a regular card, license administration module 511 produces a dummy transaction ID (step S716). The dummy transaction ID necessarily takes a value different from all the transaction IDs stored in memory card 110, and is produced as a transaction ID for local use. License administration module 511 produces session key Ks22 for check-in (step S718), and encrypts session key Ks22 thus produced with class public encryption key KPm3 sent from memory card 110 to produce encrypted data {Ks22}Km3 (step S720). License administration module 511 sends dummy transaction ID//{Ks22}Km3, which is prepared by adding dummy transaction ID to encrypted data {Ks22}Km3, to reproduction terminal 102 via USB interface 550, terminal 580 and USB cable 70 (step S722).

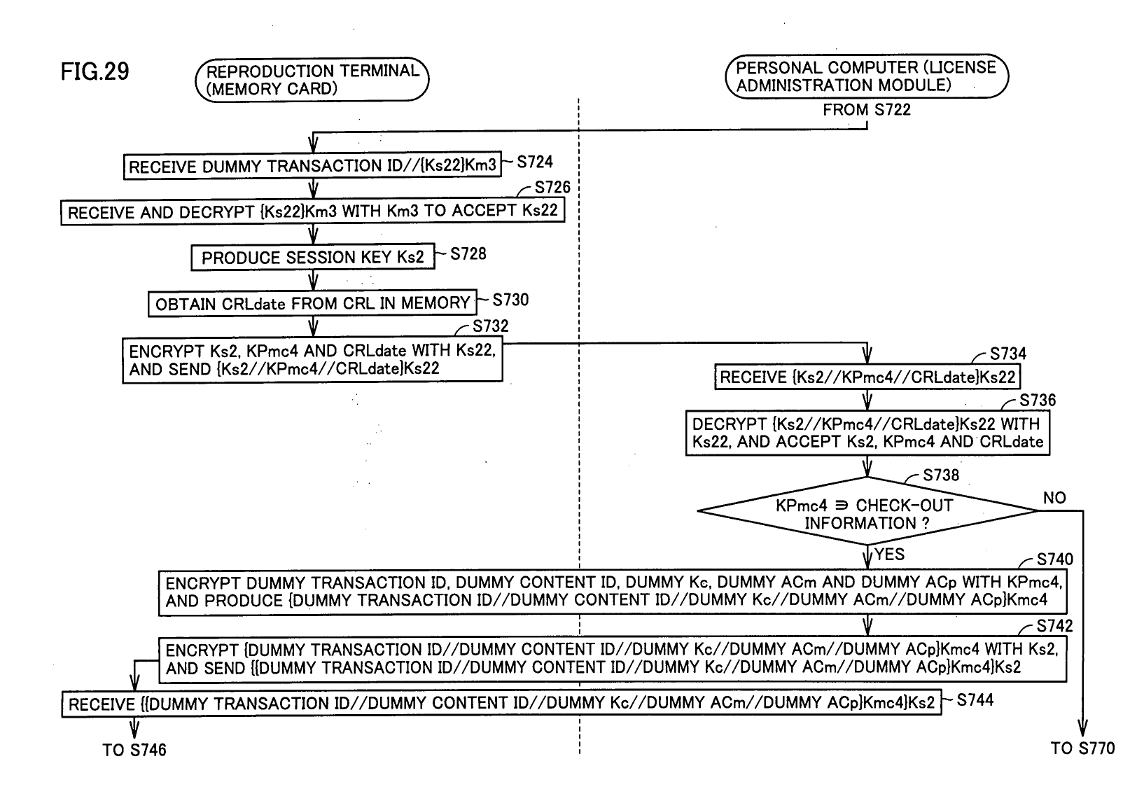

Referring to FIG. 29, controller 1106 of reproduction terminal 102 receives dummy transaction ID//{Ks22}Km3 via terminal 1114, USB interface 1112 and bus BS3, and sends dummy transaction ID//{Ks22}Km3 thus received to memory card 110 via memory card interface 1200. Controller 1420 of memory card 110 receives dummy transaction ID//{Ks22}Km3 via terminal 1426, interface 1424 and bus BS4 (step S724). Decryption processing unit 1422 receives encrypted data {Ks22}Km3 from controller 1420 via bus BS4, and decrypts encrypted data {Ks22}Km3 with class private decryption key Km3 sent from Km holding unit 1421. Thereby, decryption processing unit 1422 accepts session key Ks22 (step S726). Session key generating unit 1418 generates session key Ks2 (step S728). Controller 1420 obtains update date/time CRLdate of certificate revocation list CRL from CRL region 1415A of memory 1415 via bus BS4, and provides the update date/time CRLdate thus obtained to selector switch 1446 (step S730).

Thereby, encryption processing unit 1406 encrypts session key Ks2, individual public encryption key KPmc4 and update date/time CRLdate, which are obtained by successively selecting the terminals of selector switch 1446, with session key Ks22, which is decrypted by decryption processing unit 1404 and is obtained via terminal Pa of selector switch 1442, to produce encrypted data {Ks2//KPmc4//CRLdate}Ks22. Controller 1420 outputs encrypted data {Ks2//KPmc4//CRLdate}Ks22 to reproduction terminal 102 via bus BS4, interface 1424 and terminal 1426. Controller 1106 of reproduction terminal 102 receives encrypted data {Ks2//KPmc4//CRLdate}Ks22 via memory card interface 1200. Controller 1106 sends encrypted data {Ks2//KPmc4//CRLdate}Ks22 to personal computer 50 via USB interface 1112, terminal 1114 and USB cable 70 (step S732).

License administration module 511 of personal computer 50 receives encrypted data {Ks2//KPmc4//CRLdate}Ks22 via terminal 580 and USB interface 550 (step S734), decrypts encrypted data {Ks2//KPmc4//CRLdate}Ks22 thus received with session key Ks22, and accepts session key Ks2, individual public encryption key KPmc4 and update date/time CRLdate (step S736).

Then, license administration module 511 determines whether accepted individual public encryption key KPmc4 is included in the check-out information obtained from the license administration file recorded on hard disk 530, and thus whether it matches with individual public encryption key KPmcx stored corresponding to check-out transaction ID of the license to be checked out (step S738). Individual public encryption key KPmc4 is included in the check-out information, which is updated at the time of check-out of the encrypted content data and the license (see step S672 in FIG. 27). Therefore, by preparing the check-out information, which includes individual public encryption key KPmc4 corresponding to the destination of check-out of the encrypted content data and others, the check-out destination can be easily specified at the time of check-in.

In step S738, if individual public encryption key KPmc4 is not included in the check-out information, the check-in operation ends (step S770). In step S738, if individual public encryption key KPmc4 is included in the check-out information, license administration module 511 encrypts dummy license including the dummy transaction ID, i.e., dummy license (dummy transaction ID, dummy content ID, dummy Kc, dummy ACm and dummy ACp) with individual public encryption key KPmc4 to produce encrypted data {dummy transaction ID//dummy content ID//dummy Kc//dummy ACm//dummy ACp}Kmc4 (step S740).

License administration module 511 encrypts encrypted data {dummy transaction ID//dummy content ID//dummy Kc//dummy ACm//dummy ACp}Kmc4 with session key Ks2 to produce encrypted data {{dummy transaction ID//dummy content ID//dummy Kc//dummy ACm//dummy ACp}Kmc4}Ks2, and sends encrypted data {{dummy transaction ID//dummy content ID//dummy Kc//dummy ACm//dummy ACp}Kmc4}Ks2 to reproduction terminal 102 via USB interface 550, terminal 580 and USB cable 70 (step S742).

Controller 1106 of reproduction terminal 102 receives encrypted data {{dummy transaction ID//dummy content ID//dummy Kc//dummy ACm//dummy ACp}Kmc4}Ks2 via terminal 1114, USB interface 1112 and bus BS3. Controller 1106 sends encrypted data {{dummy transaction ID//dummy content ID//dummy Kc//dummy ACm//dummy ACp}Kmc4}Ks2 thus received to memory card 110 via bus BS3 and memory card interface 1200. Controller 1420 of memory card 110 receives encrypted data {{dummy transaction ID//dummy content ID//dummy Kc//dummy ACm//dummy ACp}Kmc4}Ks2 via terminal 1426, interface 1424 and bus BS4 (step S744).

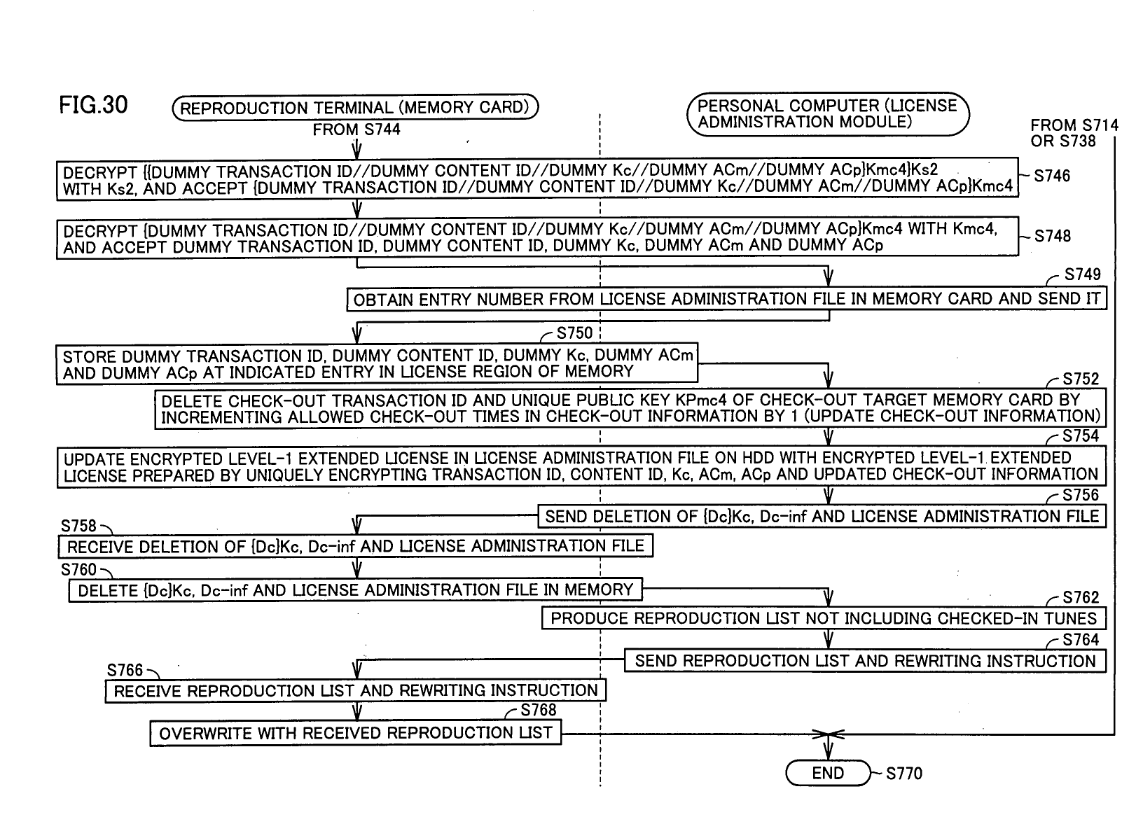

Referring to FIG. 30, decryption processing unit 1412 of memory card 110 receives encrypted data {{dummy transaction ID//dummy content ID//dummy Kc//dummy ACm//dummy ACp}Kmc4}Ks2 via bus BS4, decrypts it with session key Ks2 generated by session key generating unit 1418, and accepts encrypted data {dummy transaction ID//dummy content ID//dummy Kc//dummy ACm//dummy ACp}Kmc4 (step S746). Decryption processing unit 1404 receives encrypted data {dummy transaction ID//dummy content ID//dummy Kc//dummy ACm//dummy ACp}Kmc4 from decryption processing unit 1412, and decrypts encrypted data {dummy transaction ID//dummy content ID//dummy Kc//dummy ACm//dummy ACp}Kmc4 thus received with individual private decryption key Kmc4 obtained from Kmc holding unit 1402 to accept dummy license (dummy transaction ID, dummy content ID, dummy Kc, dummy ACm and dummy ACp) (step S748).

Controller 510 of personal computer 50 obtains an entry number from the license administration file, which is recorded in data region 1415C of memory card 110 and corresponds to the checked-in license, and sends it as the entry number for storing the dummy license to reproduction terminal 102 via USB interface 550, terminal 580 and USB cable 70 (step S749). Thereby, controller 1106 of reproduction terminal 102 receives the entry number via terminal 1114, USB interface 1112 and bus BS3, and sends the received entry number to memory card 110 via bus BS3 and memory card interface 1200. Controller 1420 of memory card 110 receives the entry number via interface 1424 and bus BS4, and stores dummy license (dummy transaction ID, dummy content ID, dummy Kc, dummy ACm and dummy ACp), which is obtained in step S748, in license region 1415B of memory 1415 designated by the entry number thus received (step S750). By writing the dummy license over the license to be checked in, the license checked out to memory card 110 can be erased.

Thereafter, license administration module 511 of personal computer 50 increments the allowed check-out times in the check-out information by one, and updates the check-out information by deleting the check-out transaction ID and the individual public encryption key KPmc4 of the memory card of the check-out destination (step S752). License administration module 511 produces the encrypted extended license data by effecting unique encryption on the transaction ID, content ID, license key Kc, access control information ACm, reproduction control information ACp and the updated check-out information, and updates the new level-1 encrypted extended license in the license administration file recorded on hard disk 530 (step S754).

Then, license administration module 511 sends a deletion instruction for deleting the content file (encrypted content data {Dc}Kc and additional information Dc-inf) and the license administration file for the license, which is checked out and is recorded at data region 1415C in memory 1415 of memory card 100, to reproduction terminal 102 via USB interface 550, terminal 580 and USB cable 70 (step S756). Controller 1106 of reproduction terminal 102 receives the deletion instruction for the content file (encrypted content data {Dc}Kc and additional information Dc-inf) and the license administration file via terminal 1114, USB interface 1112 and bus BS3, and outputs the deletion instruction for the content file (encrypted content data {Dc}Kc and additional information Dc-inf) and the license administration file, which is received via bus BS3 and memory card interface 1200, to memory card 110. Thereby, controller 1420 of memory card 110 receives the deletion instruction for the content file (encrypted content data {Dc}Kc and additional information Dc-inf) and the license administration file via terminal 1426, interface 1424 and bus BS4 (step S758). Controller 1420 deletes the content file (encrypted content data {Dc}Kc and additional information Dc-inf) and the license administration file, which are recorded at data region 1415C in memory 1415, via bus BS4 (step S760).

License administration module 511 of personal computer 50 prepares the reproduction list, from which the checked-in tunes are deleted (step S762), and sends the reproduction list and the instruction for rewriting the reproduction list to memory card 110 (step S764). Controller 1420 of memory card 110 receives the reproduction list file and the rewriting instruction via reproduction terminal 102 (step S766), and writes the received reproduction list file into data region 1415C of memory 1415 via bus BS4 to renew the reproduction list file written therein (step S768). Thereby, the check-in operation ends (step S770).

As described above, the encrypted content data and the license are returned from the opposite side, to which the encrypted content data and the license are checked out. The license is checked out from the license administration module of a low security level inhibiting the shift to the memory card of a high security level, and the memory card can receive the license obtained by the license administration module of the low security level. Therefore, the encrypted content data can be reproduced for enjoyment by the reproduction terminal with the license obtained by the license administration module of the low security level.

The license checked out to the memory card cannot be output from the memory card to another recording device (memory card, license administration device or license administration module) according to specifications in access control information ACm. Therefore, the license, which was checked out, does not leak. By returning or checking in the license, which was checked out, to the original license administration module, the right of the license, which was checked out, returns to the original license administration module. In practice, this is achieved by the erasing the license and the encrypted content data in memory card 110 in accordance with the instruction from the license administration module. Accordingly, the system described above allows neither the unauthorized copy nor the lowering of the security level, and can secure the copyright.

[Reproduction]

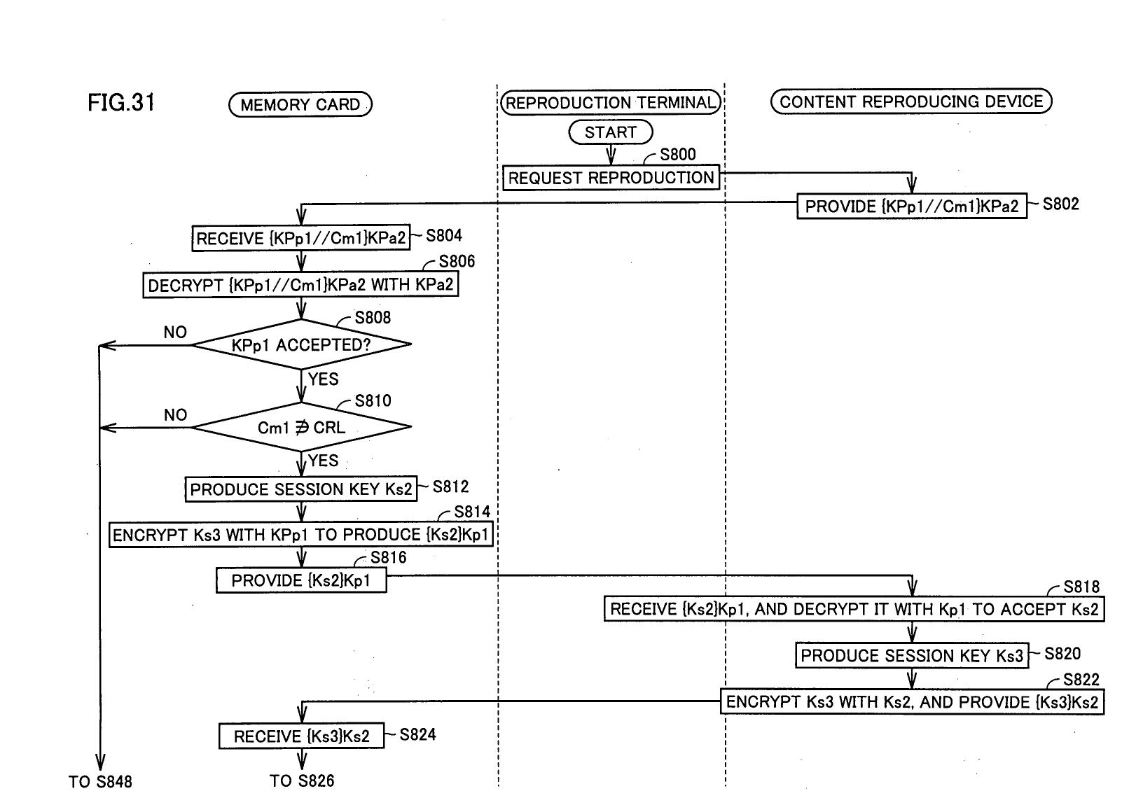

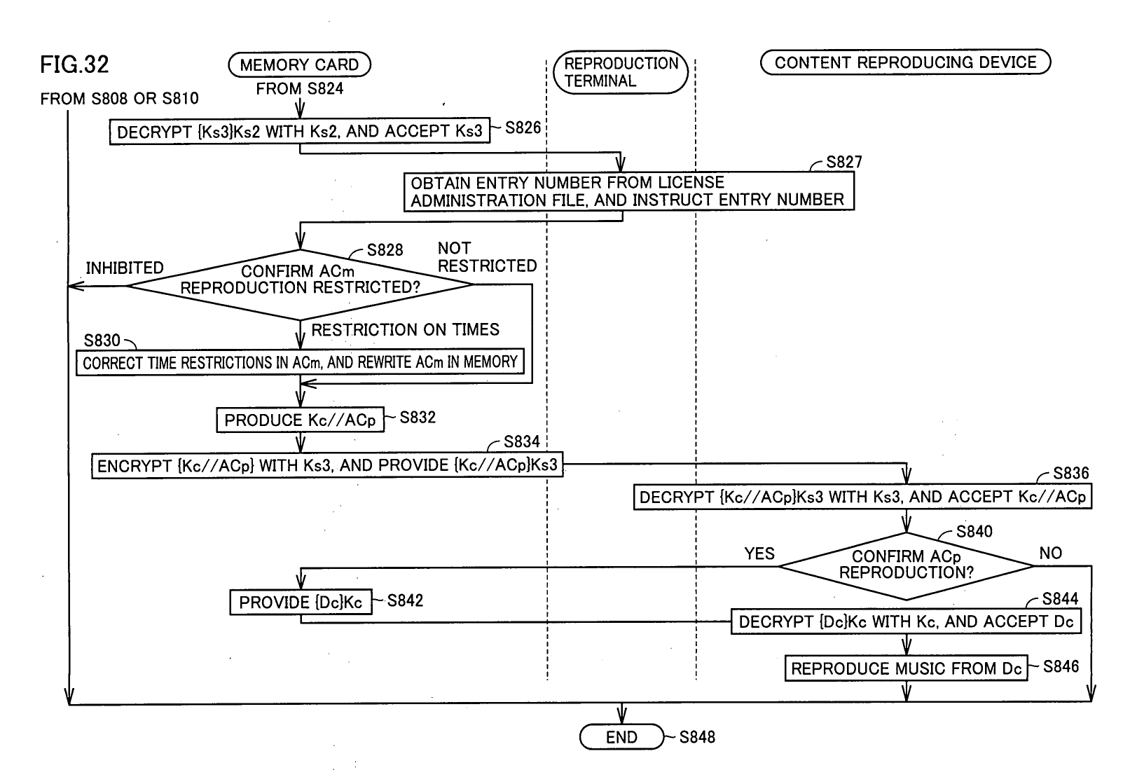

Referring to FIGS. 31 and 32, description will now be given on a reproducing operation of reproduction terminal 102 (which will also be referred to as the “content reproducing device” hereinafter) for reproducing the contents (encrypted content data and license), which are recorded in memory card 110 by distribution, shift, copy or check-out. Before the processing illustrated in FIG. 31, the user of reproduction terminal 102 determines the contents (song or tune) to be reproduced in accordance with the reproduction list, which is recorded at data region 1415C in memory card 110, specifies the content file and obtains the license administration file. The following description is based on the premise that the above operation is already performed.

Referring to FIG. 31, upon start of the reproduction, the user of reproduction terminal 102 provides the reproduction instruction through console panel 1108 to reproduction terminal 102 (step S800). Thereby, controller 1106 reads out authentication data {KPp1//Cp1}KPa2 from authentication data holding unit 1500 via bus BS3, and outputs authentication data {KPp1//Cp1}KPa2 to memory card 110 via memory card interface 1200 (step S802).

Thereby, memory card 110 accepts authentication data {KPp1/Cp1}KPa2 (step S804). Decryption processing unit 1408 of memory card 110 decrypts accepted authentication data {KPp1//Cp1}KPa2 with public authentication key KPa2 held in-KPa holding unit 1414 (step S806), and controller 1420 performs the authentication processing based on the result of decryption in decryption processing unit 1408. This authentication processing is performed for determining whether authentication data {KPp1//Cp1}KPa2 is the regular authentication data or not (step S808). If it cannot be decrypted, the operation moves to a step S848, and the reproduction operation ends. When the authentication data can be decrypted, controller 1420 determines whether class certificate Cp1 obtained thereby is included in certificate revocation list CRL read from CRL region 1415A in memory 1415 or not (step S810). In this case, an identification code is assigned to class certificate Cp1, and controller 1420 determines whether the identification code of accepted class certificate Cp1 is listed in certificate revocation list CRL or not. When it is determined that class certificate Cp1 is listed in certificate revocation list CRL, the operation moves to a step S848, and the reproduction operation ends.

Further, KPa holding unit 1414 of memory card 110 holds only the public authentication key at level 2 so that the reproduction in response to the access from a unit at a low security level of level 1 is stopped in step S808.

When it is determined in step S810 that class certificate Cp1 is not included in certificate revocation list CRL, session key generating unit 1418 of memory card 110 generates session key Ks2 for reproduction session (step S812). Encryption processing unit 1410 encrypts session key Ks2 provided by session key generating unit 1418 with class public encryption key KPp1, which is decrypted by decryption processing unit 1408, and outputs encrypted data {Ks2}Kp1 onto bus BS3 (step S814). Thereby, controller 1420 outputs encrypted data {Ks2}Kp1 to memory card interface 1200 via interface 1424 and terminal 1426 (step S816). Controller 1106 of reproduction terminal 102 obtains encrypted data {Ks2}Kp1 via memory card interface 1200. Kp1 holding unit 1502 outputs class private decryption key Kp1 to decryption processing unit 1504.

Decryption processing unit 1504 decrypts encrypted data {Ks2}Kp1 with class private decryption key Kp1, which is paired with class public encryption key KPp1, and outputs session key Ks2 to encryption processing unit 1506 (step S818). Thereby, session key generating unit 1508 generates session key Ks3 for reproduction session, and outputs session key Ks3 to encryption processing unit 1506 (step S820). Encryption processing unit 1506 encrypts session key Ks3 provided by session key generating unit 1508 with session key Ks2 sent from decryption processing unit 1504, and thereby provides encrypted data {Ks3}Ks2. Controller 1106 outputs encrypted data {Ks3}Ks2 to memory card 110 via bus BS3 and memory card interface 1200 (step S822).

Thereby, decryption processing unit 1412 of memory card 110 inputs encrypted data {Ks3}Ks2 via terminal 1426, interface 1424 and bus BS4 (step S824).

Referring to FIG. 32, decryption processing unit 1412 decrypts encrypted data {Ks3}Ks2 with session key Ks2 generated by session key generating unit 1418, and accepts session key Ks3 produced in reproduction terminal 102 (step S826).

Controller 1106 of reproduction terminal 102 obtains the entry number, at which the license is stored, from the license administration file of the reproduction request tunes obtained in advance from memory card 110, and outputs the obtained entry number to memory card 110 via memory card interface 1200 (step S827).

In accordance with input of the entry number, controller 1420 determines access control information ACm (step S828).

In step S828, access control information ACm, which is the information relating to the restriction on the access to the memory, is determined. More specifically, the allowed reproduction times are determined. If the reproduction is already impossible, the reproduction operation ends. If the allowed reproduction times in access control information ACm are restricted, the allowed reproduction times in access control information ACm are updated (decremented by one), and then the operation moves to a next step (step S830). If the reproduction times in access control information ACm do not restrict the reproduction, step S830 is skipped, and the operation moves to a next step (step S832) without updating the allowed reproduction times in access control information ACm.

When it is determined in step S828 that the reproduction can be performed in the current reproduction operation, license key Kc and reproduction control information ACp, which are recorded at license region 1415B in memory 1415, of the requested tune are output onto bus BS4 (step S832).

License key Kc and reproduction control information ACp thus obtained are sent to encryption processing unit 1406 via a contact Pf of selector switch 1446. Encryption processing unit 1406 encrypts license key Kc and reproduction control information ACp received via selector switch 1446 with session key Ks3, which is received from decryption processing unit 1412 via contact Pb of selector switch 1442, and provides encrypted data {Kc//ACp}Ks3 onto bus BS4 (step S834).

Encrypted data {Kc//ACp}Ks3 on bus BS4 is sent to reproduction terminal 102 via interface 1424, terminal 1426 and memory card interface 1200.

In reproduction terminal 102, decryption processing unit 1510 decrypts encrypted data {Kc//ACp}Ks3 transmitted onto bus BS3 via memory card interface 1200, and license key Kc and reproduction control information ACp are accepted (step S836). Decryption processing unit 1510 transmits license key Kc to decryption processing unit 1516, and provides reproduction control information ACp onto bus BS3.

Controller 1106 accepts reproduction control information ACp via bus BS3, and determines whether the reproduction is allowed or not (step S840).

When it is determined in step S840 from reproduction control information ACp that the reproduction is not allowed, the reproduction operation ends.

When it is determined in step S840 that the reproduction is allowed, controller 1106 requests encrypted content data {Dc}Kc to memory card 110 via memory card interface 1200. Thereby, controller 1420 of memory card 110 obtains encrypted content data {Dc}Kc from memory 1415, and outputs it to memory card interface 1200 via bus BS4, interface 1424 and terminal 1426 (step S842).

Controller 1106 of reproduction terminal 102 obtains encrypted content data {Dc}Kc via memory card interface 1200, and provides encrypted content data {Dc}Kc to decryption processing unit 1516 via bus BS3.

Decryption processing unit 1516 decrypts encrypted content data {Dc}Kc with license key Kc sent from decryption processing unit 1510 to obtain content data Dc (step S844).

Content data Dc thus decrypted is output to music reproducing unit 1518. Music reproducing unit 1518 reproduces content data Dc, and D/A converter 1519 converts digital signals into analog signals, and outputs them to terminal 1530. The music data is output from terminal 1530 via the external output device to headphones 130, and is reproduced (step S846). Thereby, the reproduction operation ends.

The description has been given on the case where reproduction terminal 102 reproduces the encrypted content data recorded on memory card 110. However, content reproducing device 1550 shown in FIG. 7 may be incorporated into personal computer 50, whereby it can reproduce the encrypted content data received by the license administration module 511 and license administration device 520.

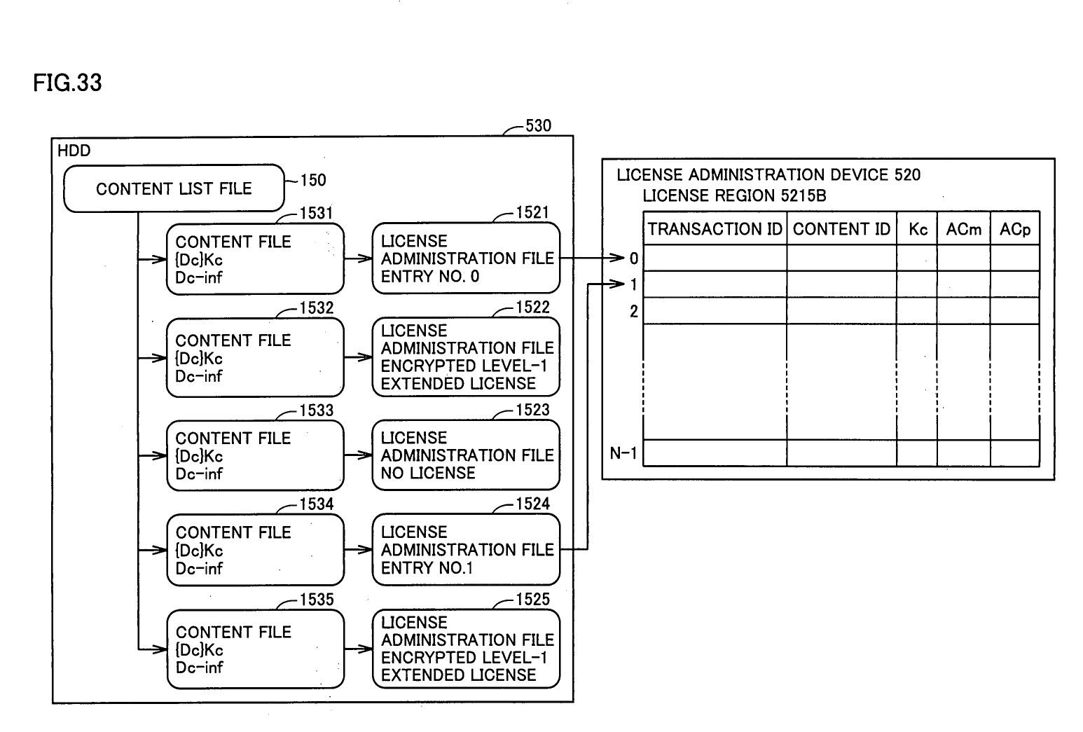

Referring to FIG. 33, description will now be given on the administration of the encrypted content data and the license received by license administration module 511 or license administration device 520 of personal computer 50. Hard disk 530 of personal computer 50 includes a content list file 150, five content files 1531-1535 and five license administration files 1521-1525.

Content list file 150 is a data file describing the owned contents in a list format, and includes information (e.g., title of tune and name of artist) about each content as well as information (file names) representing the content file and license administration file. Information about each content is mentioned automatically or in accordance with the instruction of the user by obtaining necessary information from additional information Dc-inf at the time of reception. The contents, which include only the content file or only the license administration file, and thus cannot be reproduced, can also be administered in the list.

Content files 1531-1535 are files storing encrypted content data {Dc}Kc and additional information Dc-inf, which are received by license administration module 511 or license administration device 520, and these files are provided for each content.

License administration files 1521-1525 are recorded corresponding to content files 1531-1535, respectively, and are employed for administering the license received by license administration module 511 or license administration device 520. As can be seen from the description already made, it is usually impossible to refer to the license, and information other that license key Kc does not cause a problem relating to copyright unless the user can rewrite it. However, it is not preferable to administer license key Kc and the other information separately or independently of each other when operating the system because this may lower the security level. Accordingly, when receiving the distributed license, the transaction ID and content ID, which can be referred to as information of plaintext, as well as copies of matters restricted by access control information ACm and reproduction control information ACp, which can be easily determined from license purchase conditions AC, are recorded in the form of plaintext. When the license is recorded in the license administration device 520, the entry number is recorded, and the encrypted level-1 extended license (license and check-out information) is recorded for the license, which is administered by license administration module 511. The encrypted level-1 extended license is prepared by unique encryption effected by license administration module 511. This unique encryption is linked with information, which can be obtained from personal computer 50 and can specify personal computer 50, such as an individual number of the controller (CPU) of each personal computer 50 and/or a version number of BIOS, which is a startup program of the personal computer. Therefore, the encrypted level-1 extended license thus produced forms the license peculiar to personal computer 50, and copy thereof is meaningless for other devices. License region 5215B in memory 5215 of license administration device 520 is a record region formed of a tamper resistant module, which records the license at a high security level (level 2) ensuring the security by hardware. It includes entries of N in number for recording the license (license key Kc, reproduction control information ACp, access control information ACm and license ID).

The encrypted content data corresponding to the license administered by license administration device 520 is formed of content files 1531 and 1534, which correspond to license administration files 1521 and 1524, respectively.

License administration files 1521 and 1524 include entry numbers 0 and 1, respectively. These indicate the administration regions of the licenses (license ID, license key Kc, access control information ACm and reproduction control information ACp) administered at license region 5215B in memory 5215 of license administration device 520.

When encrypted content data of the file name recorded in content file 1531 is moved to memory card 110 attached to cellular phone 100 or reproduction terminal 102, a search is performed through content file 150 to specify content file and license administration file. By referring to the license administration file, it is possible to determine the place where the license for reproducing the encrypted content data is determined. Since license administration file 1521 corresponding to content file 1531 includes the entry number of “0”, the license for reproducing the encrypted content data of the file name recorded in content file 1531 is recorded at the region, which is designated by the entry number of “0”, in license region 5215B of memory 5215 of license administration device 520. Thereby, the entry number “0” is read from license administration file 1521 recorded on hard disk 530, and is entered into license administration device 520 so that the license can be easily taken and shifted from license region 5215B in memory 5215 to memory card 110. After the license is shifted, the license of the designated entry number is deleted from license region 5215B of memory 5215 (see steps S454 and 466 in FIG. 22) so that “no license” is recorded as is done in license administration file 1523 (see step S486 in FIG. 23).

License administration file 1523 includes “no license”. This results from the shift of the license received by license administration device 520. Corresponding content file 1533 is still kept on hard disk 530. When the license is to be shifted again from memory card 110, or when the license distributed from distribution server 10 is to be received again, it is possible to receive only the distributed license.

The encrypted content data corresponding to the license administered by license administration module 511 is formed of content files 1532 and 1535. The license corresponding to these files are recorded as encrypted level-1 extended licenses in license administration files 1522 and 1525, respectively (see step S278 in FIG. 17). This is because the license administration module 511 receives the encrypted content data and the license by software, and therefore the license is recorded as a file on hard disk 530 instead of writing it in license administration device 520.

For example, when the encrypted content data of the file name recorded on content file 1533 is to be checked out to memory card 110 attached to reproduction terminal 102, a search is performed through content file 150 to specify the license administration files 1521 and 1523 corresponding to content files 1531 and 1533, and thereby the check-out information, license and others can be read from license administration files 1521 and 1523.

According to the invention, the encrypted content data and the license received by license administration module 511 and the encrypted content data and the license received by license administration device 520 are administered in the same format. Thus, the encrypted content data and the license, which are received at different security levels (levels 1 and 2), are administered with the uniform format. Thereby, even when the encrypted content data and the license are received at different security levels, respectively, the encrypted content data can be freely reproduced without lowering the respective security levels while securing the copyright.

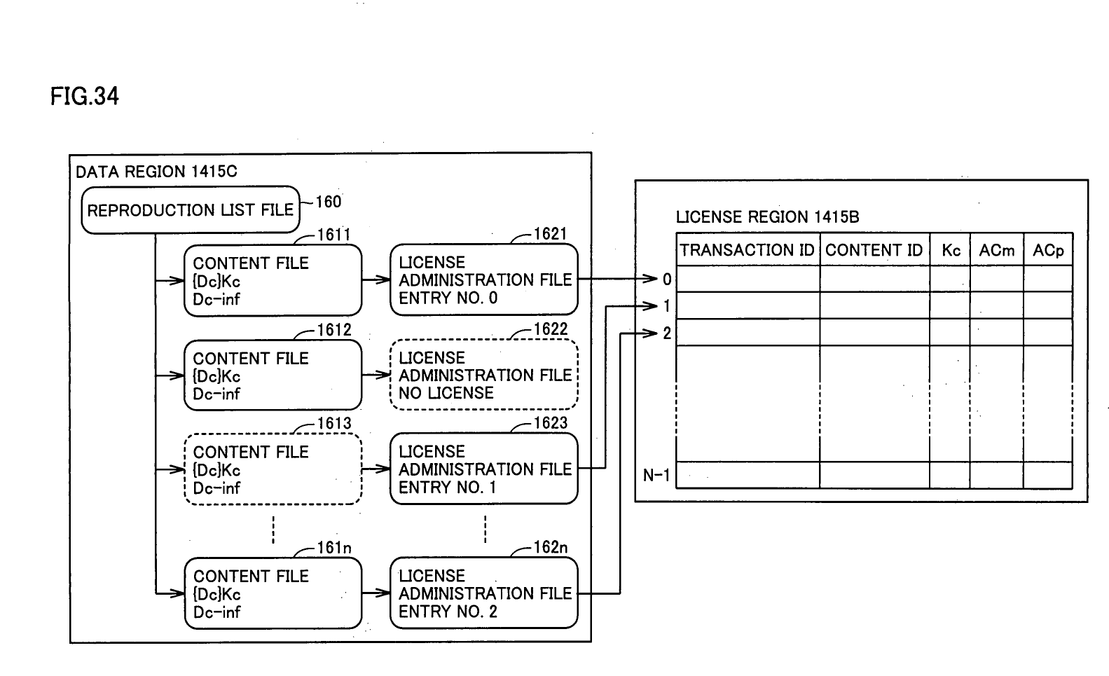

FIG. 34 illustrates license region 1415B and data region 1415C in memory 1415 of memory card 110. In data region 1415C, there are recorded reproduction list file 160, content files 1611-161n and license administration files 1621-162n. The content files of n in number are registered in the reproduction list file. Each of content files 1611-161n includes encrypted content data {Dc}Kc and additional information Dc-inf, which are recorded therein as one file. License administration files 1621-162n are recorded corresponding to content files 1611-16 in, respectively.

From the viewpoint of structure, data region 1415C in memory 1415 of memory card 110 corresponds to hard disk 530 in FIG. 33, and license region 1415B in memory 1415 of memory card 110 corresponds to license region 5215B in memory 5215 of license administration device 520. When viewed as files for storing respective data, reproduction list file 160 corresponds to content file list 150 in FIG. 33. The contents described therein are the same. In cellular phone 100 and reproduction terminal 102 each carrying memory card 110, reproduction list file 160 is referred to, and the reproduction is performed in the order of arrangement of the contents described in reproduction list file 160. The files for such a use is referred to as the reproduction file. Content files 1611-161n are files storing encrypted content data {Dc}Kc and additional information Dc-inf, and the formats thereof are the same as those of content files 1531-1535 in FIG. 33. By the operation of shift/copy or check-out from personal computer 50 to memory card 110, one of content files 1531-1535 stored in hard disk 530 of personal computer 50 is duplicated to data region 1415C in memory 1415 of memory card 110 as it is. License administration files 1621-162n achieve the same functions as license administration files 1521-1525 in FIG. 33, and the formats thereof are the same as those of license administration files 1521 and 1524 corresponding to the license administered by license administration device 520 in FIG. 33.

This is because memory card 110 is configured to administer the license with safety by effectively utilizing its features as the removal device, and therefore is configured to administer the license at the security level ensuring the security by hardware. Therefore, the license sending operation “shift/copy” for sending from level 2 to level 2 and the license sending operation “check-out” for sending from level 1 to level 2 are defined as the operations for sending the license from personal computer 50 to memory card 110.

License administration file 1622 is depicted by dotted line. This represents that license administration file 1622 is not practically recorded. In the illustrated situation, content file 1622 is present, but cannot be reproduced for lack of license. This corresponds to the case where reproduction terminal has received only the encrypted content data from another cellular phone.

Content file 1613 is depicted by dotted line. This represents, for example, such a case that the reproduction terminal receives the encrypted content data and the license from distribution server 10, and sent only the encrypted content data thus received to another cellular phone. This means that the license is present in memory 1415 but the encrypted content data is not present therein.

According to the first embodiment, the content list file recorded on the hard disk of the personal computer administers the license of the encrypted content data, which are obtained at different security levels, while linking the respective licenses with the encrypted content data, respectively. Therefore, the license obtained at different security levels can be administered in the same format.

### SECOND EMBODIMENT

In the first embodiment, which has been described, the encrypted content data and the license obtained from distribution server 10 or music CD 60 by license administration module 511 of personal computer 50 are handled as the encrypted content data and the license with the security level different from that of the encrypted content data and the license obtained from distribution server 10 by license administration device 520.

In a second embodiment, which will now be described, the encrypted content data and the license obtained from distribution server 10 or music CD 60 by license administration module 511 of personal computer 50 are handled with a security level, which is close to a security level of the encrypted content data and the license received from distribution server 10 by license administration device 520.

In the second embodiment, a binding key is employed for handling the encrypted content data and the license, which are obtained from distribution server 10 or music CD 60 by license administration module 511, with a security level close to a security level of the encrypted content data and the license obtained from distribution server 10 by license administration device 520. Thereby, the encrypted content data and the license obtained by the software (license administration module) can be sent to the personal computer provided with the license administration device having the same function according to the concept of “shift”.

For allowing the above, access control information ACm, which is described below, additionally includes a new security level allowing output of a license, and is formed of three items of the allowed reproduction times, the shift/copy flag and the security flag (1: level 1, 2: level 2). The security flag takes the value indicating the minimum level, which is required in the receiver or destination for receiving the license. The security flag at the level 2 (=2) represents that the flag allows the output to the license administration device and the memory card holding the security by the hardware and having the authentication data at level 2. The security flag at the level 1 (=1) represents that the license can be provided to the receiver administering the license at the security level of one or more, and thus to both the destinations at levels 1 and 2.

Further, KPa holding unit 5214 of license administration device 520 holds public authentication keys KPa1 and KPa2 at two levels, and selectively outputs them in accordance with the received authentication data. In the determination from access control information ACp, the determination from the security level is performed based on the security flag in access control information ACm included in the license and the security level of the destination. The security level of the destination is decoded with the provided authentication data of the distribution.

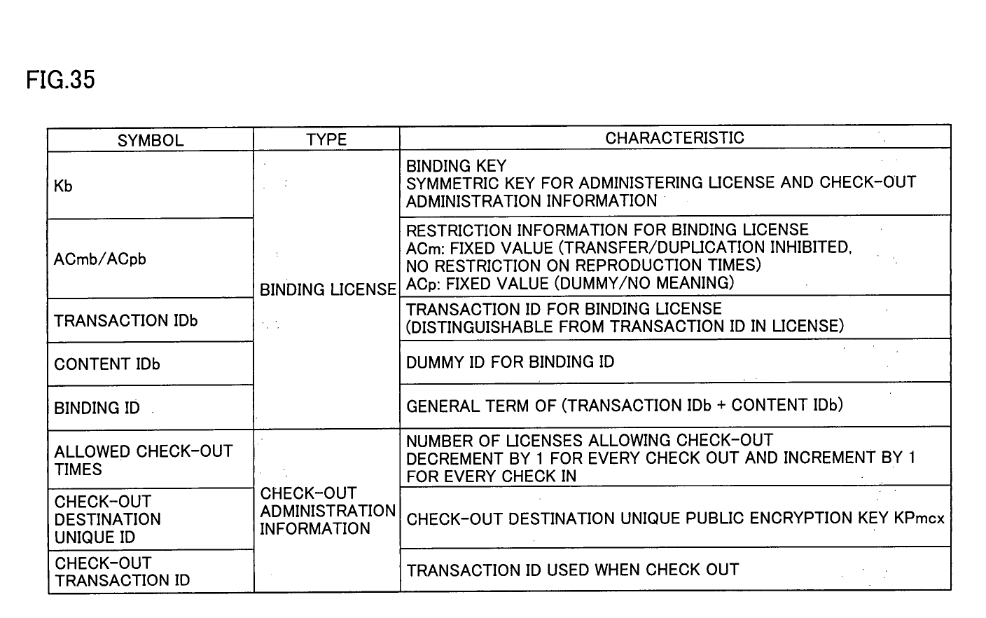

FIG. 35 illustrates a binding license required for encrypting and administering the encrypted content data and the license, which are obtained by the software (license administration module), in a manner linked with the license administration module for allowing shift to another personal computer, and also illustrates check-out administration information in the check-out session for checking out the encrypted content data and the license, which are obtained by the software, to memory card 110.

The binding license is formed of the level-1 license for reproducing the encrypted content data, a binding key, which is a symmetric key for encrypting the information relating to the check-out of the license to achieve the soft tamper resistant module, control information ACmb and ACpb for the binding license, a transaction IDb (i.e., a transaction ID for the binding license), a content IDb (i.e., a dummy for binding ID), and a binding ID generally representing transaction IDb and content IDb. Thus, the binding license is prepared based on the premise that it is recorded as the license in the license administration device, and therefore has the same structure as the license.

Binding key Kb is used for administering the license of the encrypted content data obtained by the software, and is held by hardware. It is impossible to take out the license without using binding key Kb held by the hardware. Control information ACmb and ACpb correspond to information ACm and ACp included in the license for reproducing the encrypted content data, and take the fixed values, respectively. According to information ACmb, the allowed reproduction times are not restricted (=255), the shift/copy flag inhibits the copy (=0), and the security flag indicates level 1 (=1). According to information ACpb, the reproduction period is not restricted.

The check-out administration information is formed of the allowed check-out times, check-out destination unique ID, and a check-out transaction ID (i.e., transaction ID at the time of the check-out). The allowed check-out times represent the allowed times of the check-out of the encrypted content data, and are decremented by one upon every check-out of the encrypted content data. The check-out destination unique ID is identification information for specifying the memory card, to which the encrypted content data is to be checked out, and individual public encryption key KPmcx held by the memory card corresponds to this check-out destination unique ID. The check-out transaction ID is a transaction ID for local use at the time of performing the check-out.

Description will now be given on operations in respective sessions of the data distribution systems shown in FIGS. 1 and 2 according to the second embodiment.

[Initialization]

Initialization is performed as follows before personal computer 50 receives the encrypted content data and the license distributed from distribution server 10.

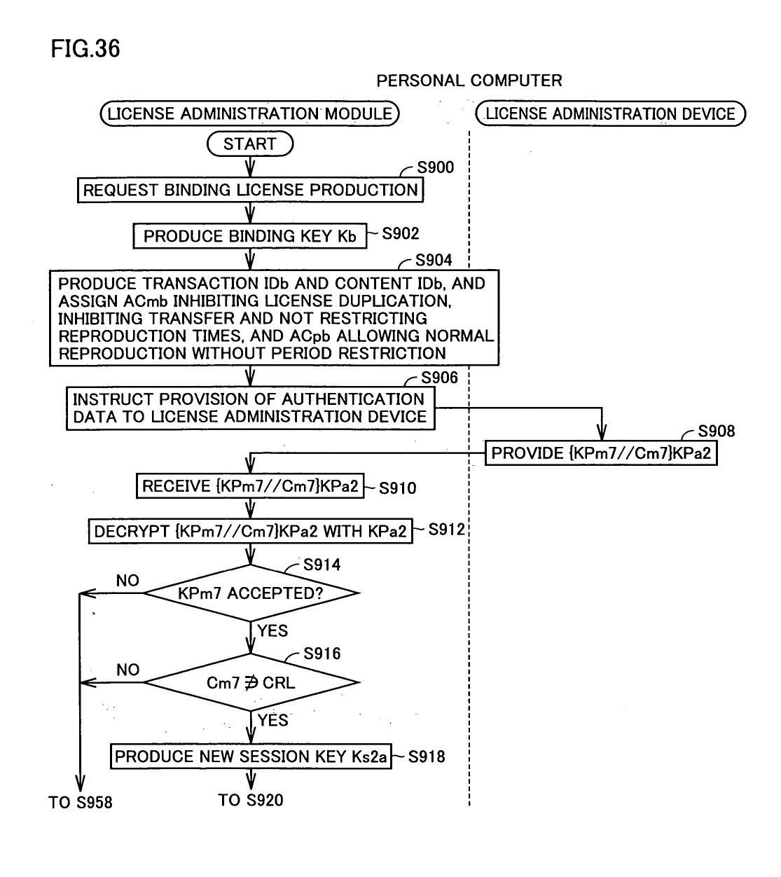

FIGS. 36-38 are first to third flow charts for illustrating the initialization, which is performed before personal computer 50 receives the encrypted content data and the license from distribution server 10, respectively.

Referring to FIG. 36, when a request for production of a binding license is entered via keyboard 560 (step S900), license administration module 511 produces binding key Kb (step S902), and then produces transaction IDb, content IDb and predetermined control information ACmb and ACpb (step S904). Processing in steps S902 and S904 is performed for producing the binding license.

License administration module 511 instructs license administration device 520 to output authentication data via bus BS2 (step S906).

Thereby, controller 5220 of license administration device 520 receives the instruction for output of the authentication data via terminal 5226, interface 5224 and bus BS5, obtains authentication data {KPm7//Cm7}KPa2 from authentication data holding unit 5200 via bus BS5, and outputs authentication data {KPm7//Cm7}KPa2 via bus BS5 interface 5224 and terminal 5226 (step S908). License administration module 511 receives authentication data {KPm7//Cm7}KPa2 via bus BS2 (step S910), and decrypts authentication data {KPm7//Cm7}KPa2 with public authentication key KPa2 at level 2 (step S912).

License administration module 511 performs the authentication processing based on the result of decryption for determining whether the processing is performed correctly or not, and thus whether it receives or not the authentication data, which is encrypted for certifying its validity by a regular system, for authenticating the fact that license administration device 520 holds class public encryption key KPm3 and class certificate Cm3 provided from the regular license administration module (step S914). When it is determined that the regular authentication data is received, license administration module 511 approves and accepts class public encryption key KPm7 and class certificate Cm7. Then, the operation moves to a next step S916. When the authentication data is not valid, license administration module 511 does not approve class public encryption key KPm7 and class certificate Cm7, and the processing ends without accepting these keys (step S958).

When it is determined from the result of the authentication processing that the regular device is used, encrypted CRL recorded on hard disk 530 is read and decrypted for determining whether class certificate Cm7 of license administration device 520 is listed in certificate revocation list CRL administered by the license administration module or not. When class certificate Cm7 is listed in certificate revocation list CRL, the initialization is terminated in this stage (step S958).

When class certificate Cm7 in license administration device 520 is not listed in certificate revocation list CRL, the processing moves to a next step (step S916).

When it is determined from the result of the authentication processing that the access is made from the license administration device having the regular authentication data, and the class certificate is not listed in certificate revocation list CRL, the license administration module 511 produces a session key Ks2a (step S918).

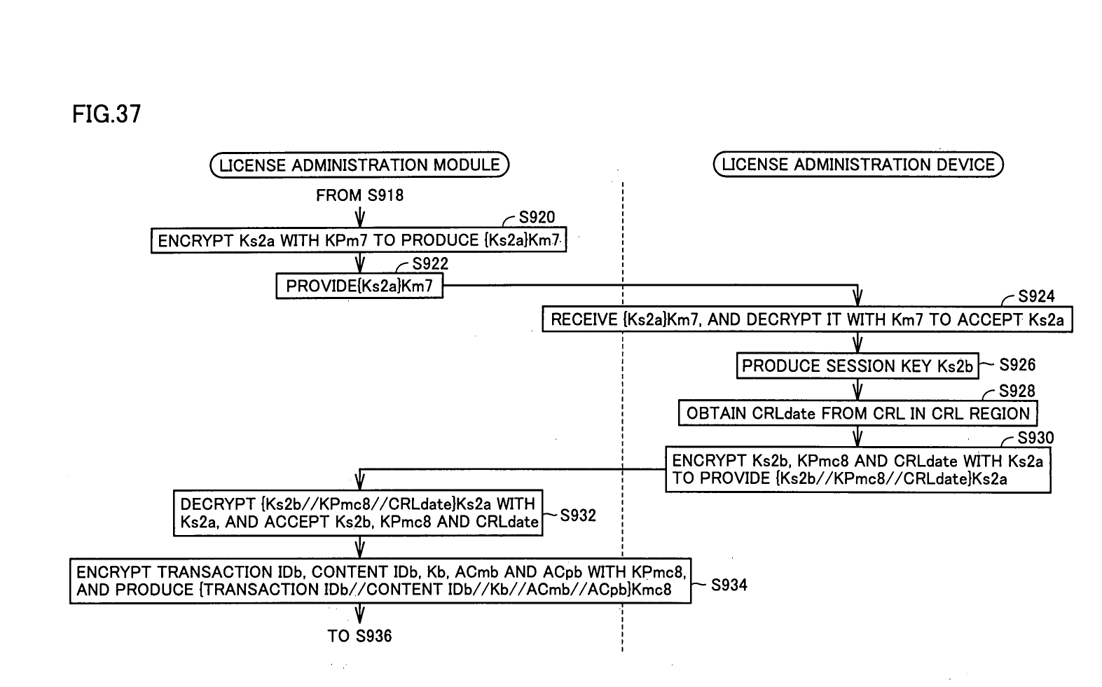

Referring to FIG. 37, license administration module 511 encrypts session key Ks2a with class public encryption key KPm7 to produce encrypted data {Ks2a}Km7 (step S920), and provides encrypted data {Ks2a}Km7 to license administration device 520 via bus BS2 (step S922). Controller 5220 of license administration device 520 receives encrypted data {Ks2a}Km7 via terminal 5226, interface 5224 and bus BS5, and decryption processing unit 5222 decrypts encrypted data {Ks2a}Km7 with class private decryption key Km7 provided from Km holding unit 5221, and accepts session key Ks2a (step S924). In response to acceptance of session key Ks2a, controller 5220 controls session key generating unit 5218 to generate a session key Ks2b. Thereby, session key generating unit 5218 generates session key Ks2b (step S926), and controller 5220 obtains update date/time CRLdate of certificate revocation list CRL from CRL region 5215A in memory 5215 via bus BS5, and provides the update date/time CRLdate thus obtained to selector switch 5246 via bus BS5 (step S928). Thereby, encryption processing unit 5206 encrypts individual public encryption key KPmc8 and update date/time CRLdate with session key Ks2a provided from decryption processing unit 5222. Controller 5220 outputs encrypted data {Ks2b//KPmc8//CRLdate}Ks2a on bus BS5 via interface 5224 and terminal 5226 (step S930).

License administration module 511 receives encrypted data {Ks2b//KPmc8//CRLdate}Ks2a via bus BS2, and decrypts encrypted data {Ks2b//KPmc8//CRLdate}Ks2a with session key Ks2a to accept session key Ks2b, individual public encryption key KPmc8 and update date/time CRLdate (step S932). License administration module 511 encrypts the binding license (transaction IDb, content IDb, binding key Kb and control information ACmb and ACpb) produced in steps S12 and S14 with individual public encryption key KPmc8 to produce encrypted data {transaction IDb//content IDb//Kb//ACmb//ACpb}Kmc8 (step S934).

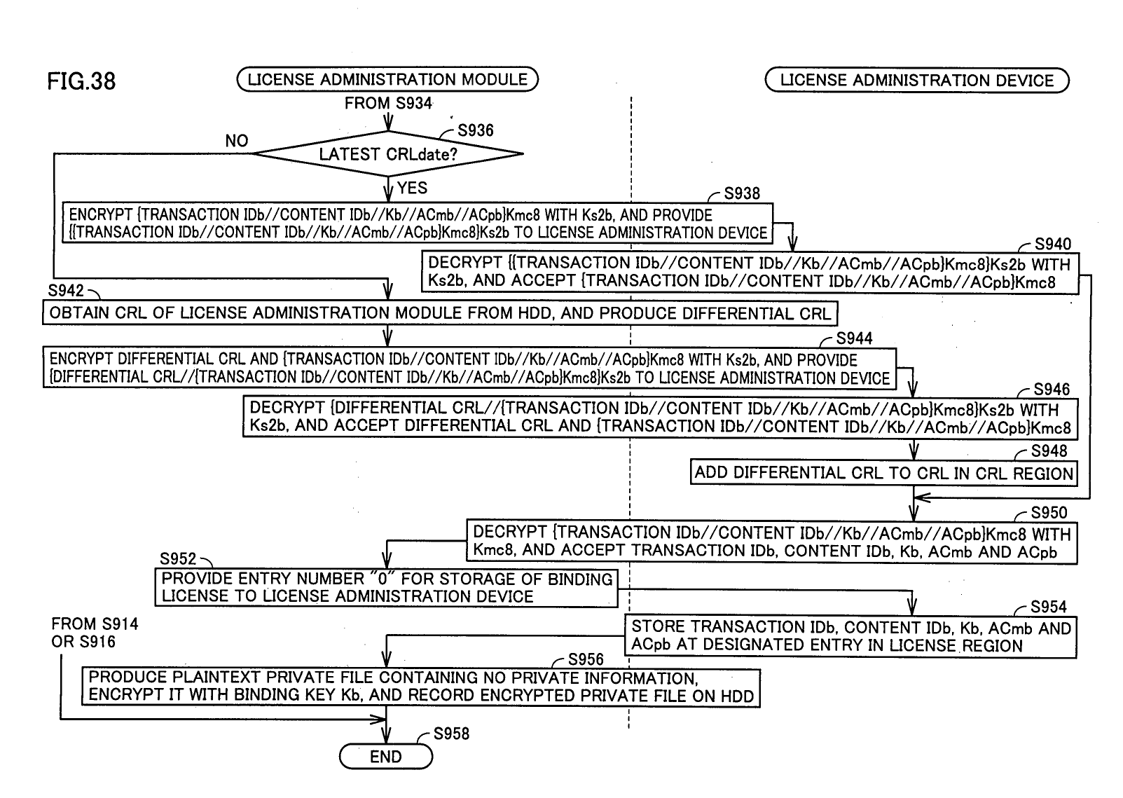

Referring to FIG. 38, license administration module 511 performs a comparison between update date/time CRLdate of the certificate revocation list sent from license administration device 520 and the update date/time of certificate revocation list CRL, which is held on hard disk 530 in the encrypted form and is administered by license administration module 511, for determining the newer certificate revocation list. When certificate revocation list CRL of license administration device 520 is newer than the other, the operation moves to a step S48. When certificate revocation list CRL of license administration module 511 is newer than the other, the operation moves to a step S52 (step S936).

When it is determined that certificate revocation list CRL of license administration device 520 is newer than the other, license administration module 511 encrypts encrypted data {transaction IDb//content IDb//Kb//ACmb//ACpb}Kmc8 with session key Ks2b generated by license administration device 520 to provide encrypted data {{transaction IDb//content IDb//Kb//ACmb//ACpb}Kmc8}Ks2b to license administration device 520 via bus BS2 (step S938).

Controller 5220 of license administration device 520 receives encrypted data {{transaction IDb//content IDb//Kb//ACmb//ACpb}Kmc8}Ks2b via terminal 5226 and interface 5224, and decrypts it with session key Ks2b generated by session key generating unit 5218 to accept encrypted data {transaction IDb//content IDb//Kb//ACmb//ACpb}Kmc8 (step S940). Thereafter, the operation moves to a step S950.

When license administration module 511 determines that certificate revocation list CRL of license administration module 511 is newer than the other, license administration module 511 obtains a unit, which was updated after update date/time CRLdate, of certificate revocation list CRL administered by license administration module 511 for updating certificate revocation list CRL held by license administration device 520 (step S942).

License administration module 511 encrypts differential CRL of the certificate revocation list and encrypted data {transaction IDb//content IDb//Kb//ACmb//ACpb}Kmc8 with session key Ks2b produced by license administration device 520, and provides encrypted data {differential CRL//{transaction IDb//content IDb//Kb//ACmb//ACpb}Kmc8}Ks2b to license administration device 520 via bus BS2 (step S944).

Controller 5220 of license administration device 520 controls decryption processing unit 5212 to decrypt the received data, which is provided onto bus BS5 via terminal 5226 and interface 5224. Decryption processing unit 5212 decrypts the received data on bus BS5 with session key Ks2b provided from session key generating unit 5218, and provides its onto bus BS5 (step S946).

In this stage, bus BS5 is supplied with encrypted data {transaction IDb//content IDb//Kb//ACmb//ACpb}Kmc8, which can be decrypted with individual private decryption key Kmc8 held by Kmc holding unit 5202, and differential CRL (step S946). In accordance with the instruction of controller 5220, differential CRL is added to certificate revocation list CRL held in CRL region 5215A of memory 5125 for updating it (step S948).

The operations in steps S938 and S940 is performed for sending binding key Kb and others to license administration device 520 when certificate revocation list CRL of license administration device 520 on the receiver side is newer than certificate revocation list CRL of license administration module 511 on the sender side. The operations in steps S942, 944, 946 and 948 are performed for sending binding key Kb and others to license administration device 520 when certificate revocation list CRL of license administration module 511 on the sender side is newer than certificate revocation list CRL of license administration device 520 on the receiver side. In this manner, a comparison is made between dates and times CRLdate of the certificate revocation list sent from license administration device 520, and differential CRL, which is the differential data of the certificate revocation list, is obtained from hard disk 530 and is sent to license administration device 520 when certificate revocation list CRL on the receiver side is older than certificate revocation list CRL on the sender side. Thereby, the latest certificate revocation list CRL can always be held.

After step S940 or S948, decryption processing unit 5204 decrypts encrypted data {transaction IDb//content IDb//Kb//ACmb//ACpb}Kmc8 with private decryption key Kmc8 in accordance with the instruction of controller 5220 so that the binding license (binding key Kb, transaction IDb, content IDb, and control information ACm and ACp) is accepted (step S950).

License administration module 511 provides the entry number “0” for storing the binding license to license administration device 520 (step S952), and controller 5220 of license administration device 520 receives entry number “0” via terminal 5226, interface 5224 and bus BS5, and stores the binding license (transaction IDb, content IDb, binding key Kb, and control information ACm and ACp) at a region, which is designated by the received entry number “0”, in license region 5215B of memory 5215 (step S954).

License administration module 511 confirms the region in license administration device 520 for recording binding key Kb, and makes preparations for registration through a series of operations or processing from step S906 in FIG. 36 to step S932 in FIG. 37. This processing is referred to as a “device confirming processing”. A series of operations of processing performed for storing binding key Kb in license region 5215B of license administration device 520 from step S934 in FIG. 37 to step S954 in FIG. 38 is referred to as “binding key registering processing”.

License administration module 511 produces plaintext of a private file including no private information (level-1 license and check-out information), produces an encrypted private file 160 by encrypting the private file with binding key Kb, and records encrypted private file 160 on hard disk 530 (step S956). Thereby, the initializing operation is completed (step S958).

In the initializing operation, as described above, license administration module 511 of personal computer 50 produces the binding license, stores the binding license at a region, which is designated by the entry number “0”, in license region 5215B of memory 5215 of license administration device 520, and produces encrypted private file 160 by encrypting the private file with binding key Kb included in the binding license thus produced. Encrypted private file 160 is used for storing the license received from distribution server 10 by license administration module 511. By encrypting the private file with binding key Kb, it becomes impossible to take out the license from encrypted private file 160 without binding key Kb. Therefore, binding key Kb functions as a symmetric key for administering the license of the encrypted content data. Since binding key Kb is stored in memory 5215 of license administration device 520, binding key Kb can be administered by hardware. This results in that the license of the encrypted content data, which is administered in a software manner by encrypted private file 160 recorded on hard disk 530, is administered by hardware via binding key Kb. As will be described later, therefore, the encrypted content data and the license received by software can be shifted to another personal computer 80.

[Distribution 3]

In the second embodiment, the operation of distributing the encrypted content data and the license requiring the security level of level 2 to license administration device 520 is the same as the operation according to the flow charts of FIGS. 10-13 in the distribution 1 of the first embodiment.

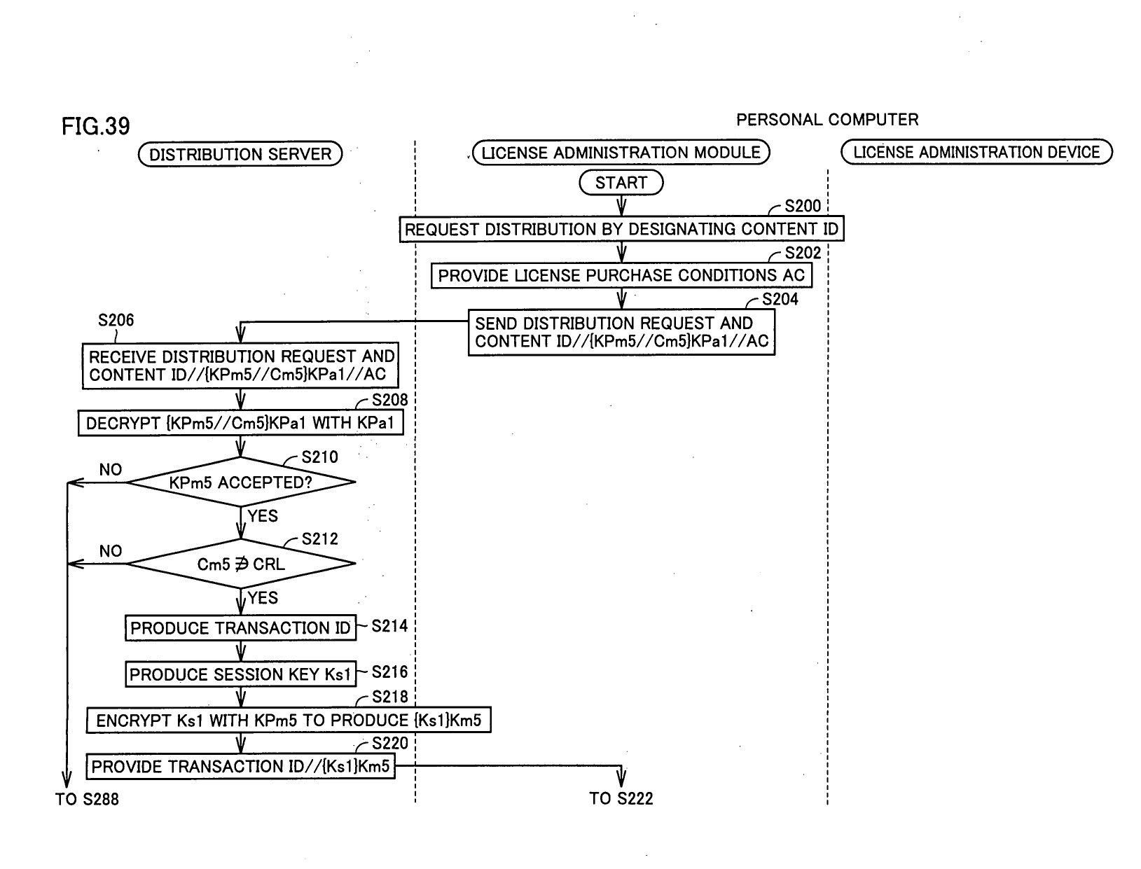

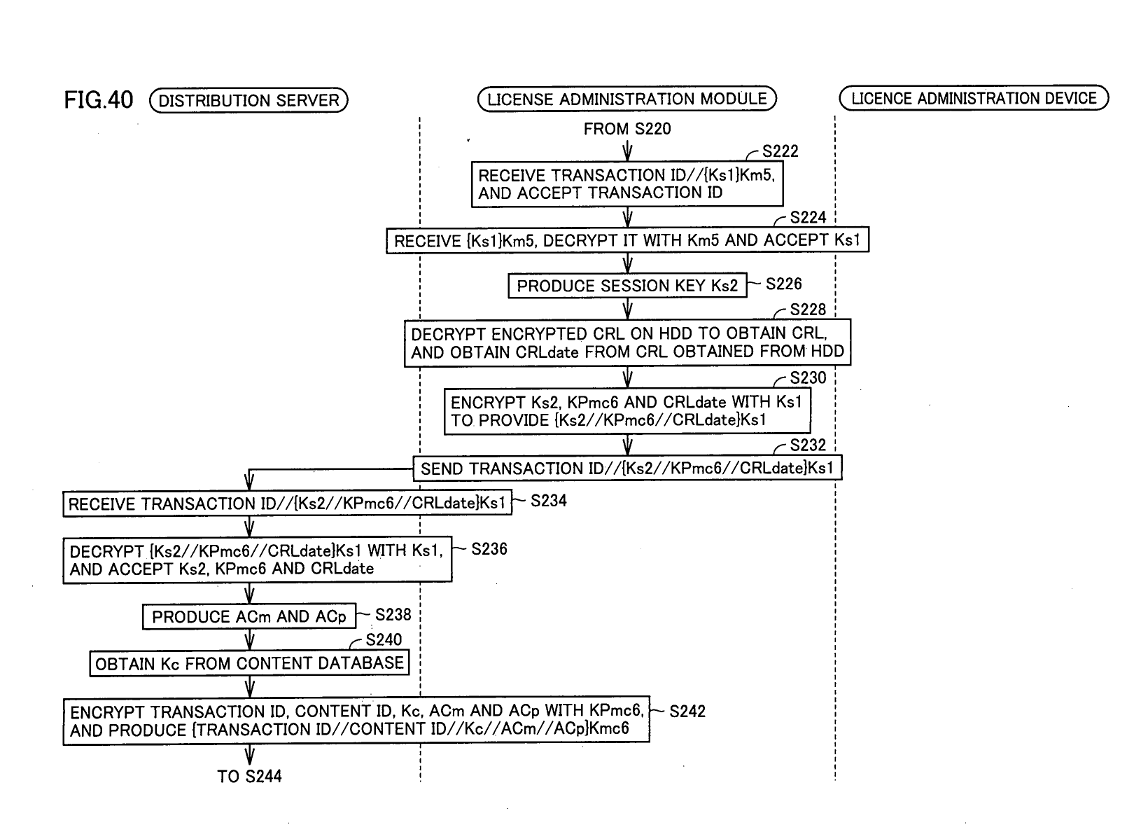

FIGS. 39-43 are first to fifth flow charts illustrating the operation according to the second embodiment, and particularly the operation for distributing the encrypted content data and the license from distribution server 10 to license administration module 511 of personal computer 50 in the data distribution systems shown in FIGS. 1 and 2. This operation is referred to as “distribution 3”.

The flow charts of FIGS. 39-43 are the same as the flow charts of FIGS. 14 to 17 except for that steps S264 and S266 in the flow charts of FIGS. 14-17 are replaced with steps S1000-S1040.

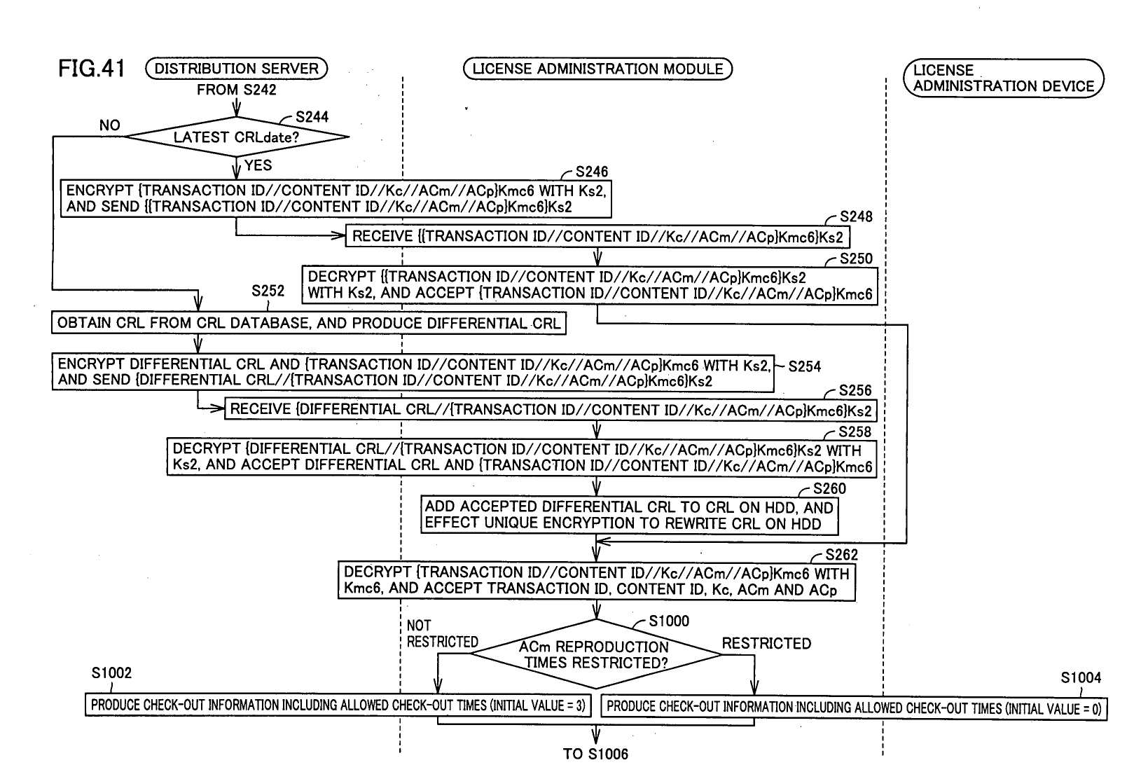

Referring to FIG. 41, after step S262, license administration module 511 determines whether received access control information ACm restricts the allowed reproduction times or not (step S1000). When the allowed reproduction times are not restricted (=255), the operation moves to a step S1002. When the allowed reproduction times are restricted (# 255), the operation moves to a step S1004. When the allowed reproduction times are not restricted, license administration module 511 produces check-out information, which includes allowed check-out times for checking out the encrypted content data and the license received from distribution server 10 to another device (step S1002). In this case, the initial value of the check-out is set to three. When the allowed reproduction times are restricted, license administration module 511 produces check-out information, in which the allowed check-out times for checking out the encrypted content data to another device are set to zero (step S1004). The processing in step S1004 is performed because the allowed reproduction times cannot be administered by the check-out.

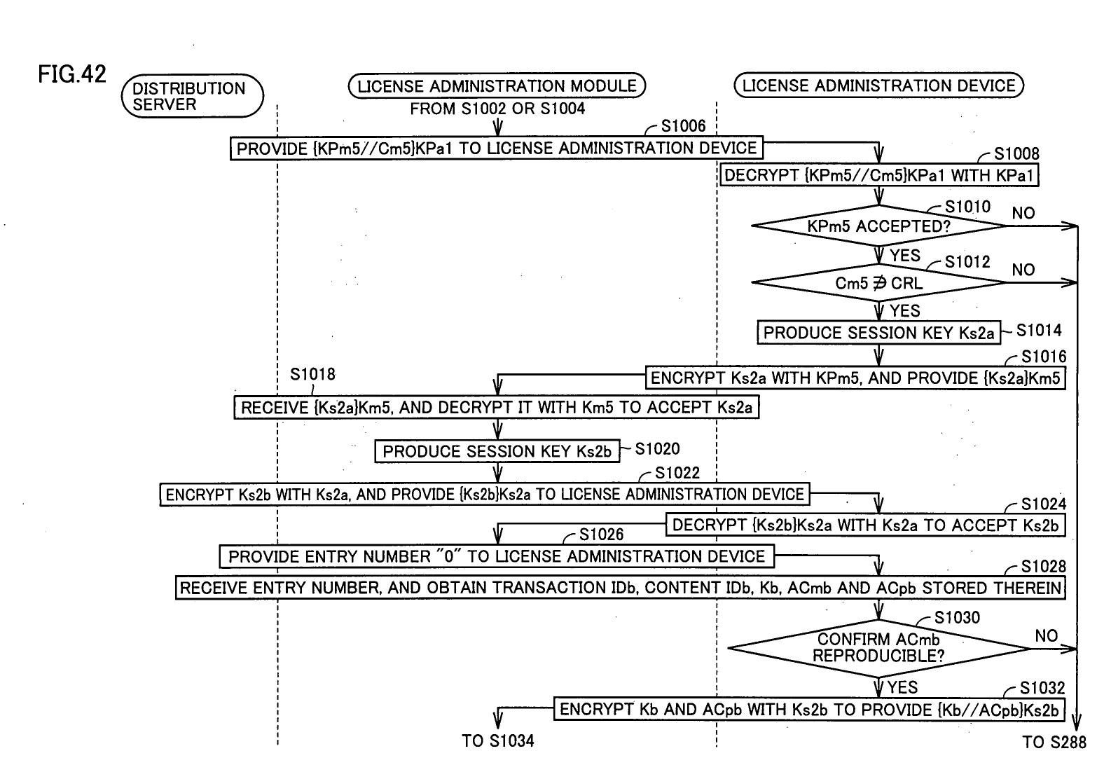

Referring to FIG. 42, after step S1002 or S1004, license administration module 511 provides authentication data {KPm5//Cm5}KPa1 to license administration device 520 via bus BS2 (step S1006). In license administration device 520, which receives authentication data {KPm5//Cm5}KPa1 from license administration module 511, decryption processing unit 5208 receives authentication data {KPm5//Cm5}KPa1, receives public authentication key KPa1 at level 1 from KPa holding unit 5214 based on authentication data {KPm5//Cm5}KPa1, and decrypts authentication data {KPm5//Cm5}KPa1 with received public authentication key KPa1 at level 1 (step S1008).

Controller 5220 performs the authentication processing based on the result of decryption processing in decryption processing unit 5208, and particularly determines whether the processing is performed correctly, and thus whether decryption processing unit 5208 receives or not the authentication data encrypted for certifying the validity of class public encryption key KPm5 and class certificate Cm5 by the regular system (step S1010). When it is determined that the regular authentication data is received, controller 5220 approves and accepts class public encryption key KPm5 and class certificate Cm5. Then, the processing moves to a next step S1012. When the authentication data is not valid, class public encryption key KPm5 and class certificate Cm5 are not approved, and the processing ends without accepting these keys. (step S288).

When it is determined from the authentication processing that the regular authentication data is received, controller 5220 then refers to CRL region 5215A of memory 5215 to determine whether class certificate Cm5 of license administration module 511 is listed in certificate revocation list CRL or not. When this class certificate is listed in the certificate revocation list, the distribution session ends (step S288).

When the class certificate of license administration module 511 is not listed in the certificate revocation list, the operation moves to a next step (step S1012).

When it is determined from the authentication processing that the access is made from license administration module 511 having the valid authentication data, and the class is not listed in the certificate revocation list, session key generating unit 5208 in license administration device 520 produces session key Ks2a (step. S1014), and encryption processing unit 5210 encrypts session key Ks2a with class public encryption key KPm5 to provide encrypted data {Ks2a}Km5 (step S1016).

Controller 5220 provides encrypted data {Ks2a}Km5 via bus BS5, interface 5224 and terminal 5226, and license administration module 511 receives encrypted data {Ks2a}Km5 via bus BS2, and decrypts encrypted data {Ks2a}Km5 with class private decryption key Km5 to accept session key Ks2a (step S1018). License administration module 511 produces session key Ks2b (step S1020), and encrypts session key Ks2b with session key Ks2a to provide encrypted data {Ks2b}ks2a to license administration device 520 via bus BS2 (step S1022).

Controller 5220 of license administration device 520 receives encrypted data {Ks2b}ks2a via terminal 5226, interface 5224 and bus BS5, and decryption processing unit 5212 decrypts encrypted data {Ks2b}ks2a with session key Ks2a generated by session key generating unit 5208 to accept session key Ks2b (step S1024). Thereby, license administration module 511 provides the entry number “0” to license administration device 520 (step S1026), and controller 5220 of license administration device 520 receives the entry number “0” via terminal 5226, interface 5224 and bus BS5. Controller 5220 obtains the binding license (transaction IDb, content IDb, binding key Kb, and control information ACmb and ACpb) stored at a region, designated by the entry number “0”, in license region 5215B of memory 5215 (step S1028). Controller 5220 determines based on control information ACmb whether the binding license is valid or not. When it is valid, the operation moves to step S288, and the distribution session ends. To be “valid” means such a situation that the allowed reproduction times in control information ACmb are not zero, and the processing is authenticated with public authentication key KPa1 at level 1 so that the security level of control information ACmb is level 1.

When the binding license is valid, the operation moves to a step S1032 (step S1030).

In step S1030, when it is determined that the binding license is valid, encryption processing unit 5206 encrypts binding key Kb and control information ACpb obtained via selector switch 5246 with session key Ks2b, which is decrypted by decryption processing unit 5212 and is obtained via switch 5242, and thereby provides encrypted data {Kb//ACpb}Ks2b (step S1032).

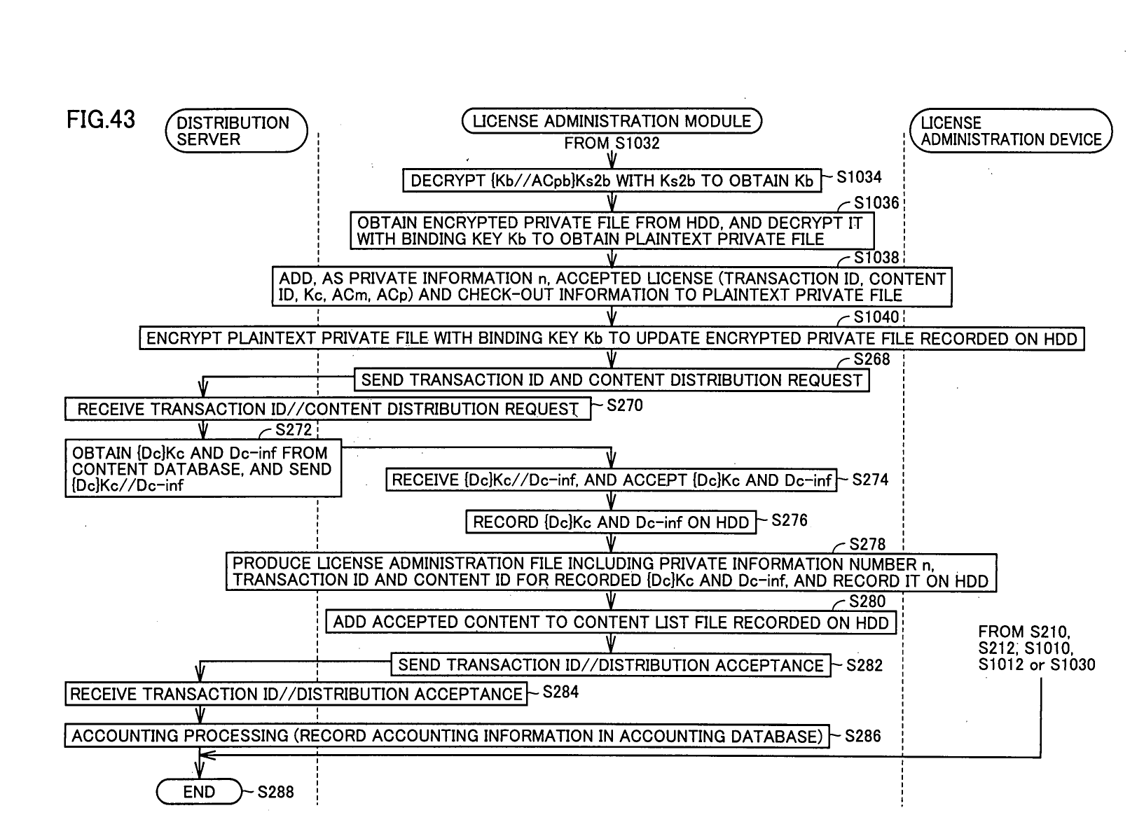

Referring to FIG. 43, controller 5220 provides encrypted data {Kb//ACpb}Ks2b via bus BS5, interface 5224 and terminal 5226, and license administration module 511 receives encrypted data {Kb//ACpb}Ks2b via bus BS2, and decrypts encrypted data {Kb//ACpb}Ks2b with session key Ks2b to obtain binding key Kb and control information ACpb (step S1034).

A series of processing from step S1006 to step S1034 is performed for obtaining binding key Kb from license administration device 520, and is generally referred to as “binding key obtaining processing”.

License administration module 511 obtains encrypted private file 160 from hard disk 530, and decrypts encrypted private file 160 with binding key Kb to obtain plaintext of a private file (step S1036). Thereby, license administration module 511 adds, as private information n, the license (transaction ID, content ID, license key Kc, access control information ACm and reproduction control information ACp) accepted from distribution server 10 and the check-out information produced in step S1002 or S1004 to the plaintext of the private file (step S1038). Thereafter, license administration module 511 encrypts the plaintext of the private file with binding key Kb again, and provides encrypted private file 160 thus prepared to update encrypted private file 160 recorded on hard disk 530 (step S1040). Thereafter, the operation moves to step S268, and steps S268-S288 are executed.

As described above, license administration module 511 transmits the data by software to and from distribution server 10, and receives the encrypted content data and the license by software from distribution server 10. License administration module 511 records the encrypted content data received thereby on hard disk 530, writes the license as private information n into the private file, encrypts the private file with binding key Kb, and stores the license in encrypted private file 160. Binding key Kb for decrypting encrypted private file 160 is held by license administration device 520. The security level of reception of the encrypted content data and the license by license administration module 511 is lower than that of reception of the encrypted content data and the license by license administration device 520, but is close to the latter in view of the fact that the record administration is not linked with personal computer 50.

[Ripping]

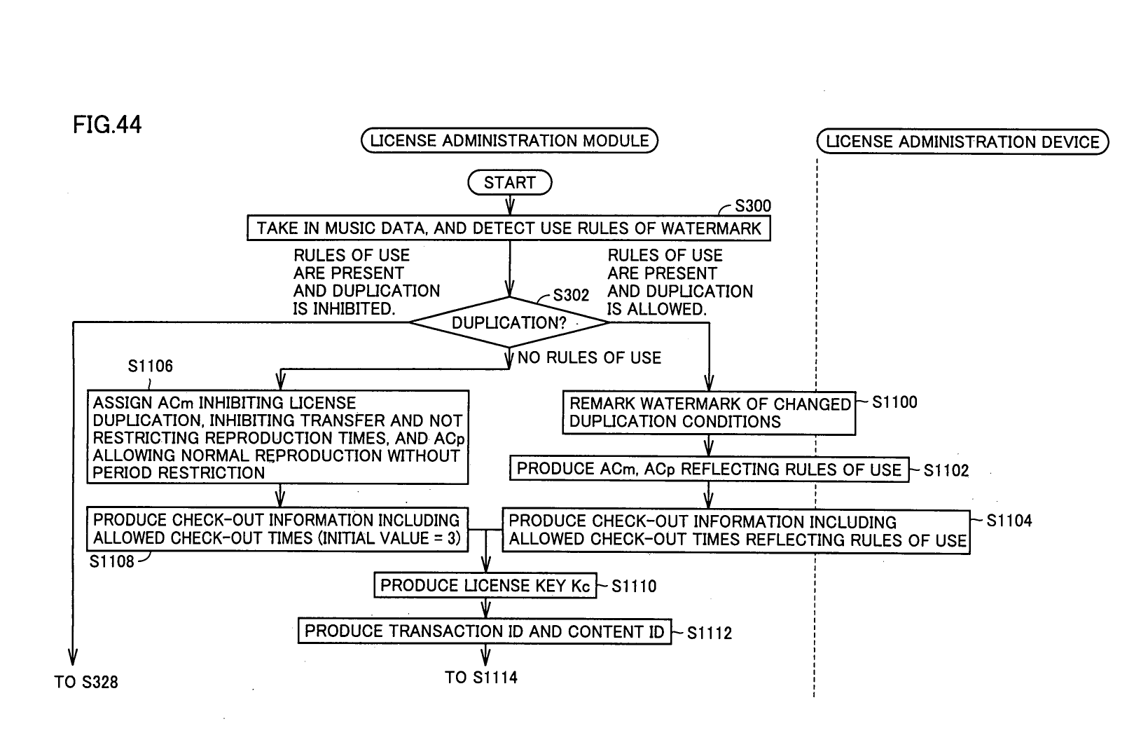

FIGS. 44-46 are first to third flow charts for illustrating a ripping operation according to the second embodiment, respectively. The flow charts of FIGS. 44-46 are the same as the flowchart of FIG. 19 except for that steps S304-S312 in the flowchart of FIG. 19 are replaced with steps S1100-1144, and steps S322 and S324 are replaced with steps S1146-S1150.

Referring to FIG. 44, when it is determined in step S302 that the copy conditions in rules of use do not restrict the copy, processing in step S1102 is performed. When it is determined that the copy conditions allow first-generation copy, processing in step S1100 is performed. When it is determined that the copy conditions do not allow the copy, the copy is inhibited, and the operation moves to step S328 to terminate the ripping operation. When a loaded CD does not contain a watermark and the rules of use are not obtained, the operation moves to a step S1106.

In step S302, when the copy conditions of the rules of use allow the first-generation copy, license administration module 511 replace the watermark, which is contained in the obtained music data, with the watermark, in which the copy conditions in the rules of use are changed to inhibit the copy (step S110). The operation moves to step S102. When the detected rules of use allow the copy, license administration module 511 produces access control information ACm and reproduction control information ACp reflecting the rules of use (step S1102). If the copy is allowed according to the copy conditions, the shift/copy flag of access control information ACm is set to allow the shift/copy (i.e., to 3). If the first-generation is allowed, the shift/copy flag is set to inhibit the shift/copy (i.e., to 0) because the ripping itself is the first-generation operation. Although the corresponding rules of use are not present, the allowed reproduction times are not restricted, and the security level is set to level 1. Thereafter, license administration module 511 sets the allowed check-out times to a value reflecting the maximum check-out times according to the rules of use. When the maximum check-out times are not designated, the allowed check-out times are set to three. The check-out information including the allowed check-out times thus set is produced (step S1104).

When the watermark is not detected in step S302, and therefore it is determined that the rules of use are not present, license administration module 511 sets the shift/copy flag in access control information ACm to inhibit the shift/copy (i.e., to zero), sets the allowed reproduction times to be infinite (=255) and sets the security flag to level 1 (=1). Reproduction control information ACp sets the reproduction infinite (step S1106). Thereafter, license administration module 511 produces the check-out information including the allowed check-out times, of which initial value is equal to three (step S1108).

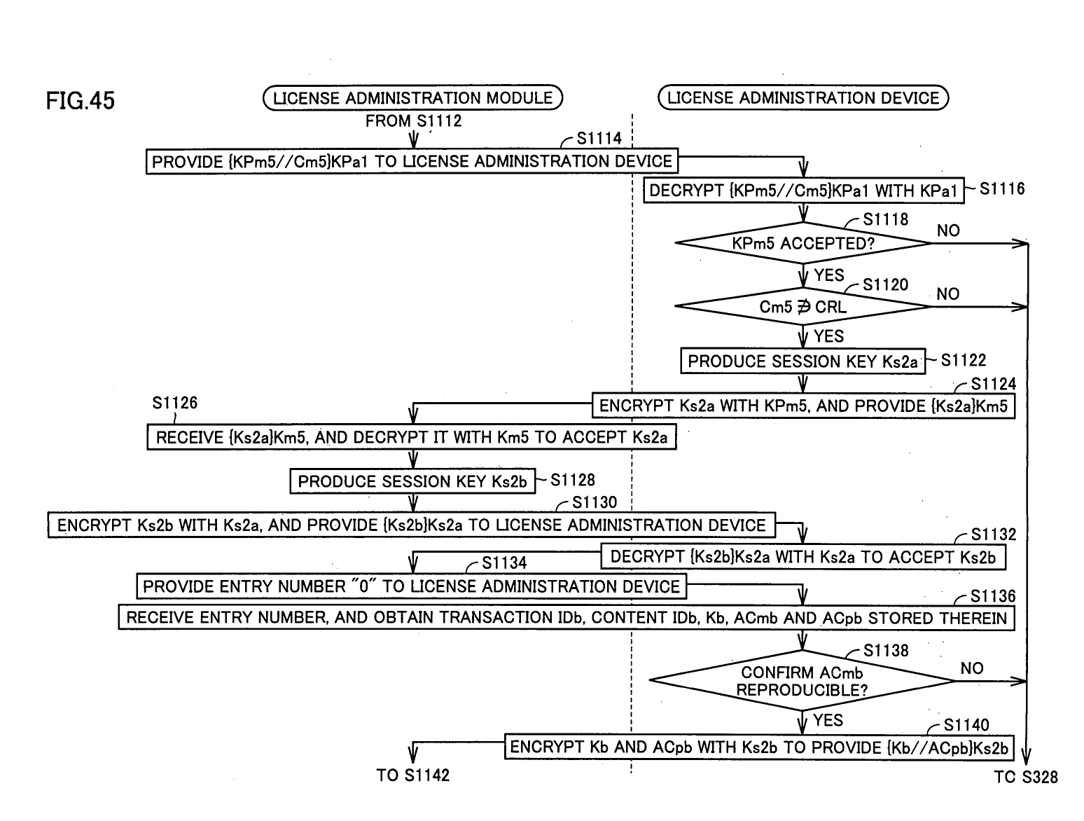

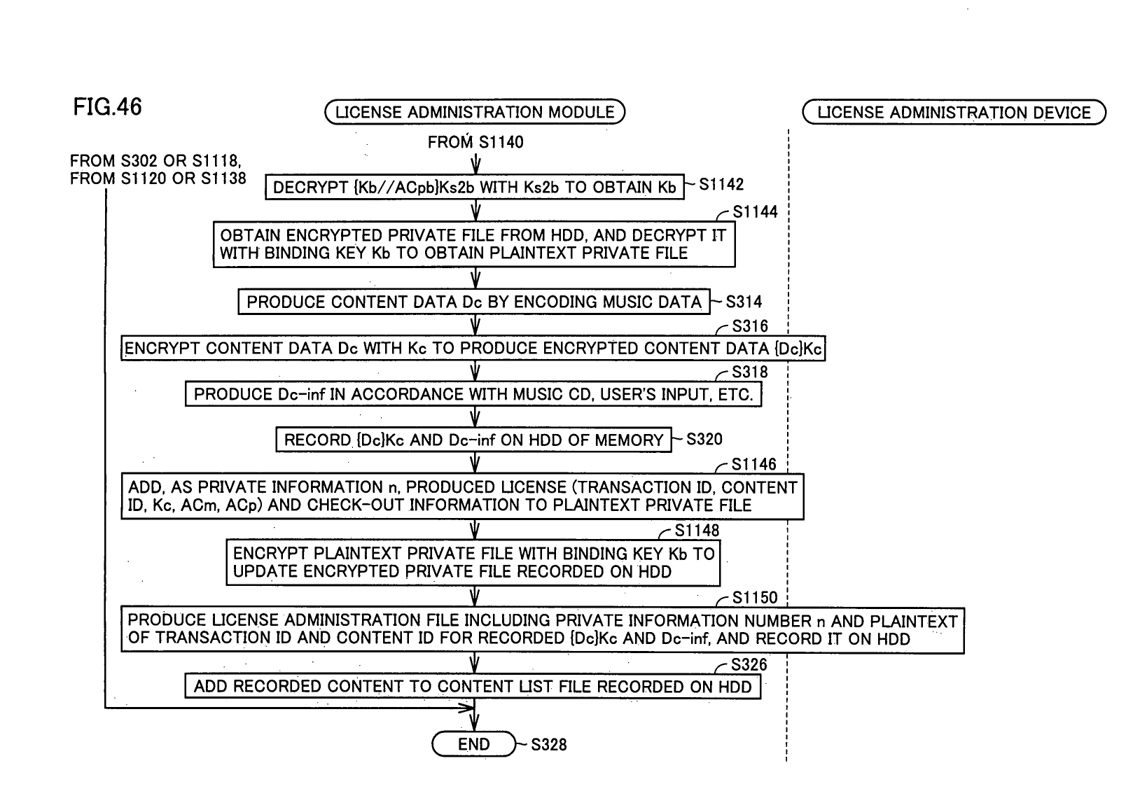

After steps S1104 or S1108, license administration module 511 produces license key Kc based on a random number (step S1110), and produces transaction ID and content ID for a local use (step S1112). Then, license administration module 511 performs processing for obtaining the binding key. A series of processing from a step S1114 in FIG. 45 to a step S1142 in FIG. 46 is the binding key obtaining processing, and is the same as the series of processing from step S1006 in FIG. 42 to step S1034 in FIG. 43 illustrating the distribution processing of the distribution 3. Therefore, description of such processing is not repeated.

Referring to FIG. 46, license administration module 511, which obtained binding key Kb, obtains encrypted private file 160 from hard disk 530 via bus BS2, and decrypts encrypted private file 160 thus obtained with binding key Kb to obtain the plaintext of the private file (step S1144). Thereafter, steps S314, S316, S318 and S320 already described are executed.

After step S320, license administration module 511 adds, as private information n, the produced license (transaction ID, content ID, license key Kc, access control information ACm and reproduction control information ACp) and the check-out information produced in step S1104 or S1108 to the plaintext of the private file (step S1146). Thereafter, license administration module 511 encrypts the plaintext of the private file with binding key Kb, and updates encrypted private file 160 recorded on hard disk 530 by writing encrypted private file 160 thus prepared (step S1148). The license is stored in encrypted private file 160, and then license administration module 511 produces a license administration file for the content file (encrypted content data {Dc}Kc and additional information Dc-inf), which includes a private information number n of private information stored in encrypted private file 160 as well as the plaintext of transaction ID and content ID, and records its on hard disk 530 via bus BS2 (step S1150). Thereafter, foregoing step S326 is executed, and the ripping operation ends (step S328).

As described above, the encrypted content data and the license can likewise be obtained by the ripping from the music CD. The encrypted content data and the license obtained by the ripping from the music CD are administered by license administration module 511 in the same manner as the encrypted content data and the level-1 license provided by distribution.

[Check-Out]

In the data distribution systems shown in FIGS. 1 and 2, the encrypted content data and the license distributed from distribution server 10 to license administration module 511 of personal computer 50 are checked out to memory card 110 attached to reproduction terminal 102 by the following operation according to the second embodiment.

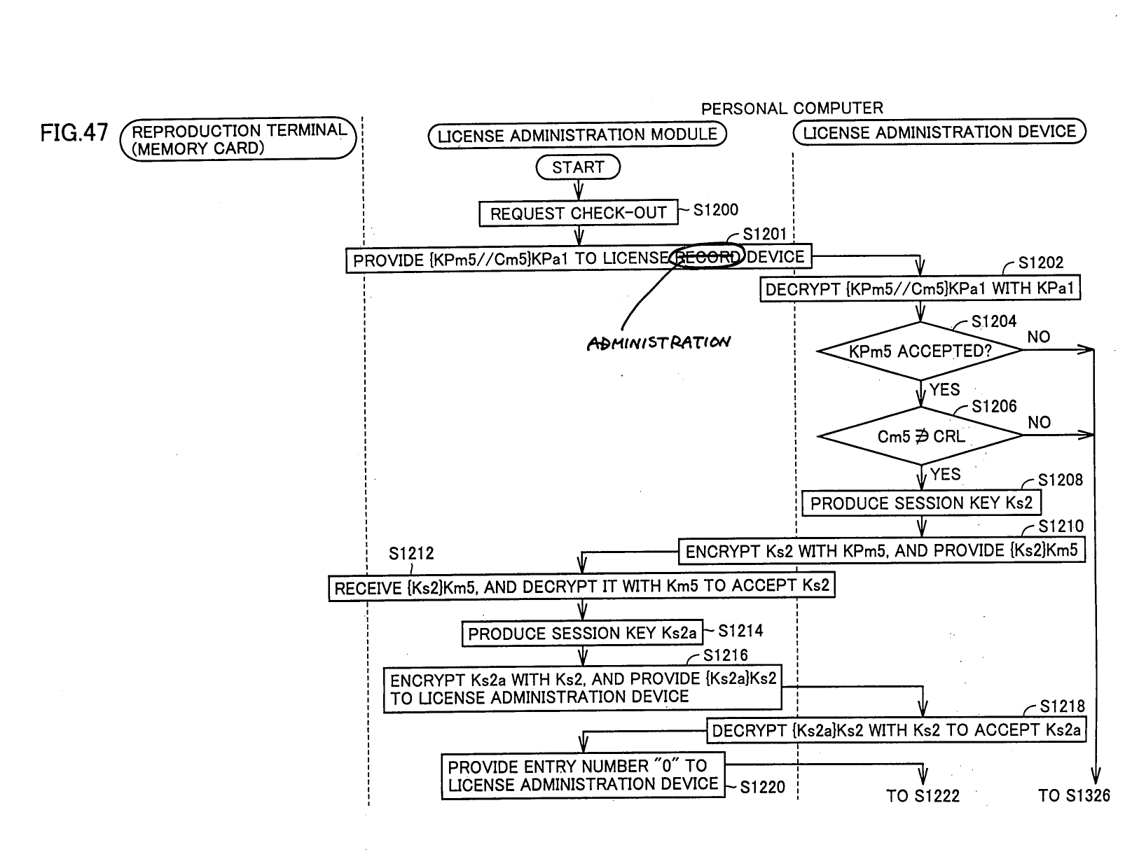

FIGS. 47-51 are first to fifth flow charts of the check-out operation in the data distribution systems shown in FIGS. 1 and 2, respectively, and particularly illustrate the check-out operation, in which license administration module 511 checks out the encrypted content data and the license received from distribution server 10 to memory card 110 attached to reproduction terminal 102 on the conditions that these will be returned. Before the processing in FIG. 47, the user of personal computer 50 determines the content to be checked out in accordance with the content list file, specifies the content file and the license administration file on hard disk 530, and obtains the reproduction list file in memory card 110. The following description is based on the premise that the above operation is already performed.

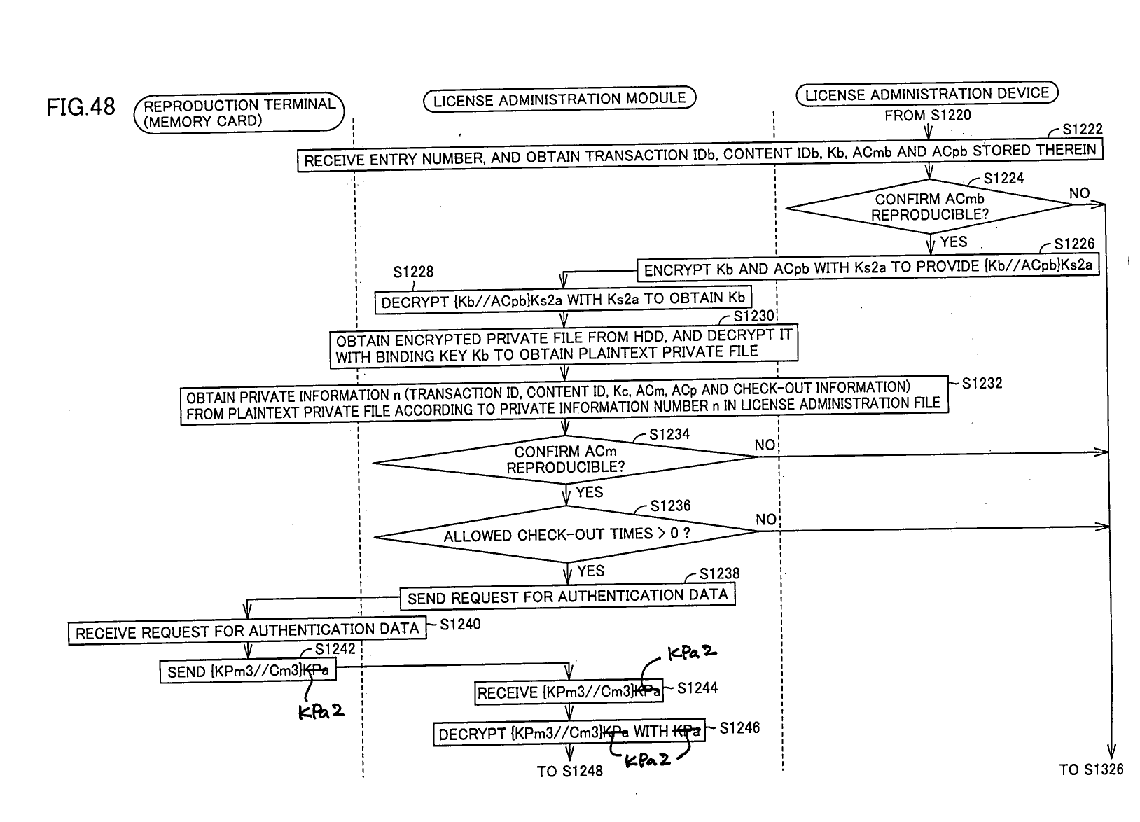

Referring to FIG. 47, when a check-out request is entered via keyboard 560 of personal computer 50 (step S1200), license administration module 511 performs the binding key obtaining processing. A series of processing from step S1201 in FIG. 47 to a step S1228 in FIG. 48 is the binding key obtaining processing, and is the same as the series of processing from step S1006 in FIG. 42 to step S1034 in FIG. 43 illustrating the distribution 3. Therefore, description thereof is not repeated.

Referring to FIG. 48, license administration module 511, which obtained binding key Kb, obtains encrypted private file 160 from hard disk 530 via bus BS2, and decrypts encrypted private file 160 with binding key Kb to obtain the plaintext of the private file (step S1230). Thereafter, license administration module 511 obtains private information n (transaction ID, content ID, license key Kc, access control information ACm and reproduction control information ACp) in the private file corresponding to private information number n recorded in the license administration file (step S1232).

Thereby, license administration module 511 determines based on access control information ACm thus obtained whether the check-out of the license is allowed or not (step S1234). Thus, license administration module 511 determines whether the license to be checked out to memory card 110 attached to reproduction terminal 102 can be reproduced without restrictions on reproduction times by the allowed reproduction times in access control information ACm or not, and also determines whether the reproduction by this license is impossible or not. When the allowed reproduction times are restricted, the encrypted content data and the license are not checked out.

When the reproduction is restricted in step S1234, the operation moves to a step S1326, and the check-out operation ends. When the allowed reproduction times of the encrypted content data are smaller than the restricted times in access control information ACm, the operation moves to a step S1236. License administration module 511 determines whether the allowed check-out times included in the obtained check-out information are larger than zero or not (step S1236). When the allowed check-out times are equal to zero in step S1236, there is no license allowing check-out, so that the operation moves to step S1326, and the check-out operation ends. When the allowed check-out times are larger than zero in step S1236, license administration module 511 sends a request for sending of the authentication data via USB interface 550, terminal 580 and USB cable 70 (step S1238). Controller 1106 of reproduction terminal 102 receives the request for the authentication data via terminal 1114, USB interface 1112 and bus BS3, and sends the received request for the authentication data to memory card 110 via bus BS3 and memory card interface 1200. Controller 1420 of memory card 110 receives the request for the authentication data via terminal 1426, interface 1424 and bus BS4 (step S1240).

When controller 1420 receives the request for the authentication data, it reads out authentication data {KPm3//Cm3}KPa2 from authentication data holding unit 1400 via bus BS4, and provides authentication data {KPm3//Cm3}KPa2 thus read to reproduction terminal 102 via bus BS4, interface 1424 and terminal 1426. Controller 1106 of reproduction terminal 102 receives authentication data {KPm3//Cm3}KPa2 via memory card interface 1200 and bus BS3, and sends authentication data {KPm3//Cm3}KPa2 to personal computer 50 via bus BS3, USB interface 1112, terminal 1114 and USB cable 70 (step S1242).

Thereby, license administration module 511 of personal computer 50 receives authentication data {KPm3//Cm3}KPa2 via terminal 580 and USB interface 550 (step S1244), and decrypts authentication data {KPm3//Cm3}KPa2 thus received with public authentication key KPa2 at level 2 (step S1246).

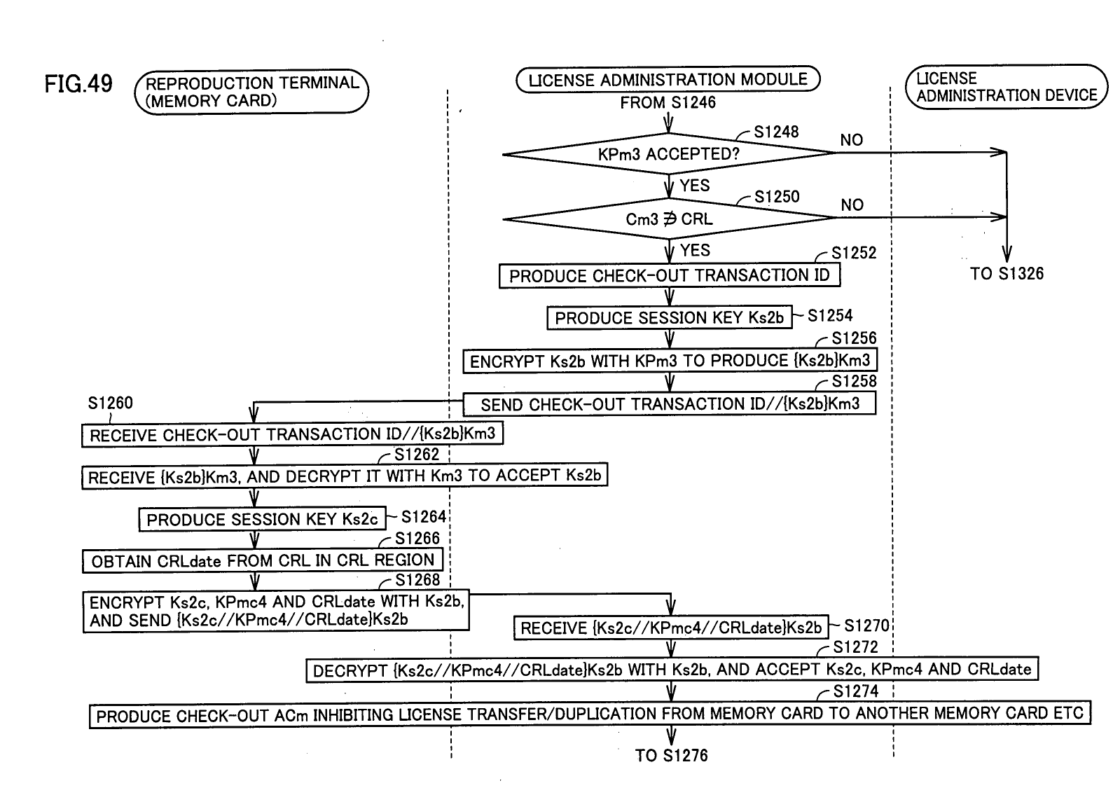

Referring to FIG. 49, license administration module 511 performs the authentication processing based on the result of decryption for determining whether the processing is performed correctly or not, and thus whether it receives or not the authentication data, which is encrypted for certifying its validity by a regular system, for authenticating the fact that memory card 110 holds class public encryption key KPm3 and class certificate Cm3 provided from the regular memory card (step S1248). When it is determined that the authentication data is valid, license administration module 511 approves and accepts class public encryption key KPm3 and class certificate Cm3. Then, processing is performed in a step S1250. When the authentication data is not valid, license administration module 511 does not approve class public encryption key KPm3 and class certificate Cm3, and the processing ends without accepting them (S1326).

When it is determined that it is the regular memory card, license administration module 511 then obtains and decrypts encrypted CRL recorded on hard disk 530 for determining whether class certificate Cm3 of memory card 110 is listed in certificate revocation list CRL or not. When class certificate Cm3 is listed in the certificate revocation list, the check-out operation ends (step S1326). When the class certificate of memory card 110 is not listed in the certificate revocation list, next processing is performed (step S1250).

When it is determined from a result of the authentication processing that the access is made from the reproduction terminal provided with the memory card having valid authentication data, and the class is not listed in the certificate revocation list, license administration module 511 produces check-out transaction ID, which is used for specifying the check-out and takes a value different from those of all the transaction ID stored in memory card 110, as a transaction ID for a local use (step S1252). License administration module 511 produces session key Ks2b for the check-out (step S1254), and encrypts session key Ks2b thus produced with class public encryption key KPm3 sent from memory card 110 (step S1256). License administration module 511 sends check-out transaction ID//{Ks2b}Km3, which is produced by adding check-out transaction ID to encrypted data {Ks2b}Km3, to reproduction terminal 102 via USB interface 550, terminal 580 and USB cable 70 (step S1258). Thereby, controller 1106 of reproduction terminal 102 receives check-out transaction ID//{Ks2b}Km3 via terminal 1114, USB interface 1112 and bus BS3, and sends check-out transaction ID//{Ks2b}Km3 thus received to memory card 110 via memory card interface 1200. Controller 1420 of memory card 110 receives check-out transaction ID//{Ks2b}Km3 via terminal 1426, interface 1424 and bus BS4 (step S1260). Decryption processing unit 1422 receives encrypted data {Ks2b}Km3 via bus BS4 from controller 1420, and decrypts encrypted data {Ks2b}Km3 with class private decryption key Km3 provided from Km holding unit 1421 to accept session key Ks2b (step S1262). Session key generating unit 1418 produces a session key Ks2c (step S1264), and controller 1420 obtains update date/time CRLdate of the certificate revocation list from CRL region 1415A of memory 1415 via bus BS4, and provides update date/time CRLdate thus obtained to selector switch 1446 (step S1266).

Thereby, encryption processing unit 1406 encrypts session key Ks2c, individual public encryption key KPmc4 and update date/time CRLdate, which are obtained by successively selecting the terminals of selector switch 1446, with session key Ks2b decrypted by decryption processing unit 1404 to produce encrypted data {Ks2c//KPmc4//CRLdate}Ks2b. Controller 1420 outputs encrypted data {Ks2c//KPmc4//CRLdate}Ks2b to reproduction terminal 102 via bus BS4, interface 1424 and terminal 1426. Controller 1106 of reproduction terminal 102 receives encrypted data {Ks2c//KPmc4//CRLdate}Ks2b via memory card interface 1200. Controller 1106 sends encrypted data {Ks2c//KPmc4//CRLdate}Ks2b to personal computer 50 via USB interface 1112, terminal 1114 and USB cable 70 (step S1268).

License administration module 511 of personal computer 50 receives encrypted data {Ks2c//KPmc4//CRLdate}Ks2b via terminal 580 and USB interface 550 (step S1270), decrypts encrypted data {Ks2c//KPmc4//CRLdate}Ks2b thus received with session key Ks2b, and accepts session key Ks2c, individual public encryption key KPmc4 and update date/time CRLdate (step S1272). License administration module 511 produces access control information ACm for check-out, which inhibits shift and copy of the license from the memory card attached to reproduction terminal 102 to another memory card or the like. More specifically, it produces access control information ACm, in which the reproduction times are not restricted (=255), the shift/copy flag is set to “0” inhibiting the shift and copy, and the security flag is set to level 1 (=1)(step S1274).

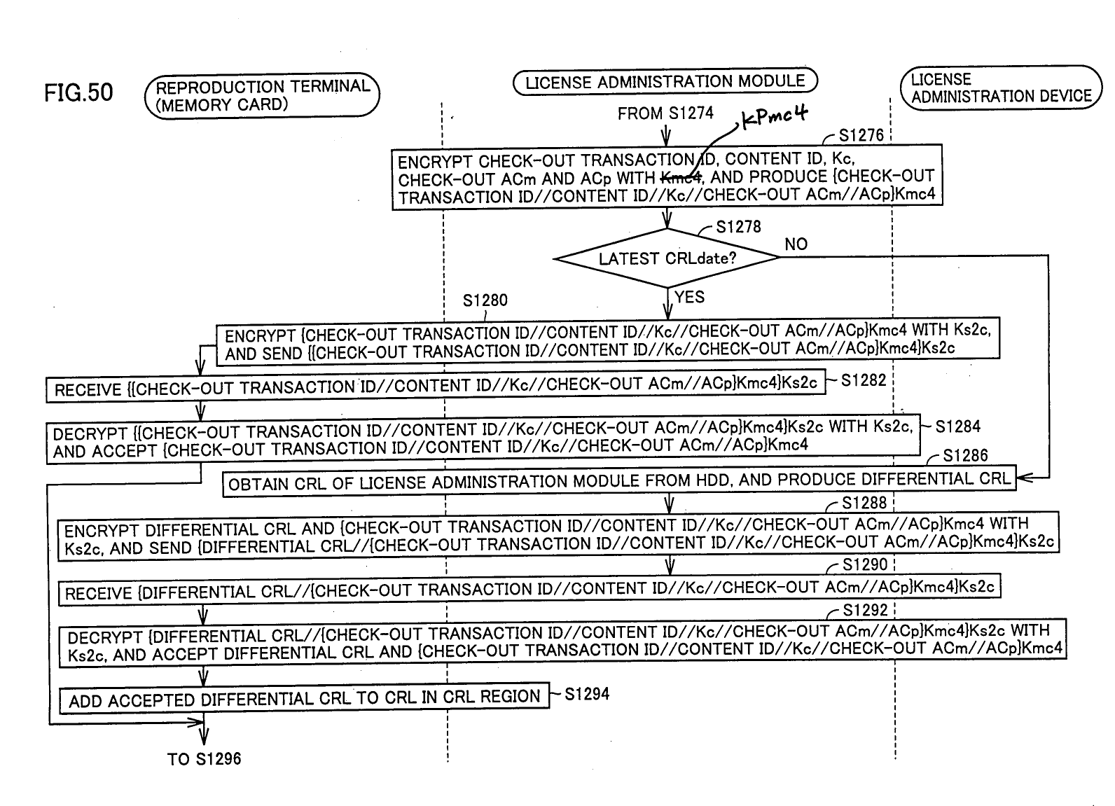

Referring to FIG. 50, license administration module 511 encrypts the license with individual public encryption key KPmc4, which is peculiar to memory card 110 and is received in step S1272, to produce encrypted data {check-out transaction ID//content ID//Kc//check-out ACm//ACp}Kmc4 (step S1276). A comparison is made between update date/time CRLdate sent from memory card 110 and the update date/time of the certificate revocation list, which is held on hard disk 530 and is administered by license administration module 511, for determining the newer certificate revocation list. When the list sent from memory card 110 is newer than the other, the operation moves to a step S1280. When the certificate revocation list of license administration module 511 is newer than the other, the operation moves to a step S544 (step S1278).

When it is determined that the certificate revocation list of memory card 110 is newer than the other, license administration module 511 encrypts encrypted data {check-out transaction ID//content ID//Kc//check-out ACm//ACp}Kmc4 with session key Ks2c, and sends encrypted data {{check-out transaction ID//content ID//Kc//check-out ACm//ACp}Kmc4}Ks2c to reproduction terminal 102 via USB interface 550, terminal 580 and USB cable 70 (step S1280).

Controller 1106 of reproduction terminal 102 receives encrypted data {{check-out transaction ID//content ID//Kc//check-out ACm//ACp}Kmc4}Ks2c via terminal 1114, USB interface 1112 and bus BS3, and sends encrypted data {{check-out transaction ID//content ID//Kc//check-out ACm//ACp}Kmc4}Ks2c thus received to memory card 110 via bus BS3 and memory card interface 1200. Controller 1420 of memory card 110 receives encrypted data {{check-out transaction ID//content ID//Kc//check-out ACm//ACp}Kmc4}Ks2c via terminal 1426, interface 1424 and bus BS4 (step S1282).

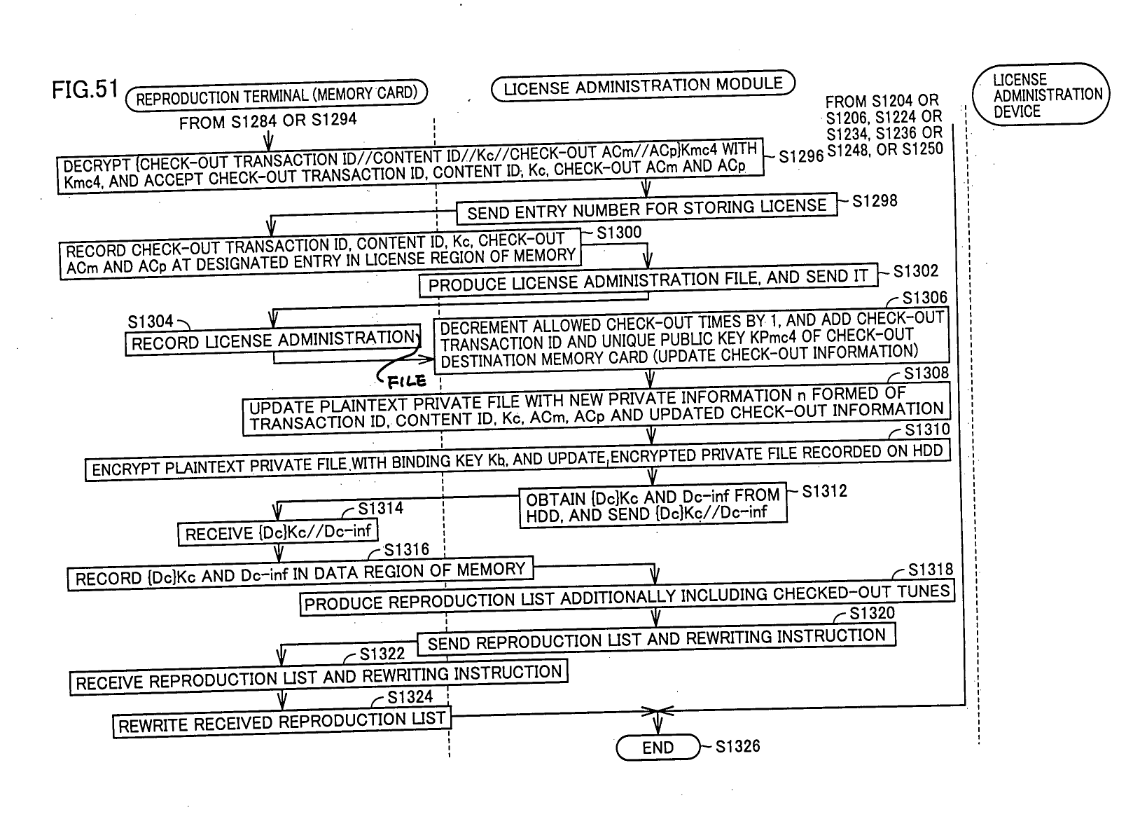

Decryption processing unit 1412 of memory card 110 receives encrypted data {{check-out transaction ID//content ID//Kc//check-out ACm//ACp}Kmc4}Ks2c via bus BS4, and decrypts it with session key Ks2c generated by session key generating unit 1418 to accept encrypted data {check-out transaction ID//content ID//Kc//check-out ACm//ACp}Kmc4 (step S1284). Thereafter, the operation moves to a step S1296 shown in FIG. 51.

When it is determined in step S1278 that the certificate revocation list of license administration module 511 is newer than the other, license administration module 511 obtains certificate revocation list CRL administered by license administration module 511 from hard disk 530. License administration module 511 produces differential CRL based on update date/time CRLdate of certificate revocation list CRL obtained and administered by itself and that of accepted certificate revocation list CRL of memory card 110 (step S1286).

License administration module 511 encrypts encrypted data {check-out transaction ID//content ID//Kc//check-out ACm//ACp}Kmc4 and differential CRL thus produced with session key Ks2c, and sends encrypted data {differential CRL//{check-out transaction ID//content ID//Kc//check-out ACm//ACp}Kmc4}Ks2c to reproduction terminal 102 via USB interface 550, terminal 580 and USB cable 70 (step S1288). Controller 1106 of reproduction terminal 102 receives encrypted data {differential CRL//{check-out transaction ID//content ID//Kc//check-out ACm//ACp}Kmc4}Ks2c via terminal 1114, USB interface 1112 and bus BS3, and outputs encrypted data {differential CRL//{check-out transaction ID//content ID//Kc//check-out ACm//ACp}Kmc4}Ks2c thus received to memory card 110 via bus BS3 and memory card interface 1200. Thereby, controller 1420 of memory card 110 receives encrypted data {differential CRL//{check-out transaction ID//content ID//Kc//check-out ACm//ACp}Kmc4}Ks2c via terminal 1426, interface 1424 and bus BS4 (step S1290).

In memory card 110, decryption processing unit 1412 decrypts the received data on bus BS4 with session key Ks2c provided from session key generating unit 1418, and accepts differential CRL and encrypted data {check-out transaction ID//content ID//Kc//check-out ACm//ACp}Kmc4 (step S1292). Controller 1420 receives differential CRL, which is accepted by decryption processing unit 1412, via bus BS4, and updates certificate revocation list CRL held in CRL region 1415A of memory 1415 by adding received differential CRL thereto (step S1294).

In steps S1280, S1282 and S1284, the operations are performed to check out license key Kc and others to memory card 110, and the operations in these steps are performed in the case where certificate revocation list CRL of memory card 110 on the receiver side is newer than certificate revocation list CRL of license administration module 511 on the sender side. The operations in steps S1286, S1288, S1290, S1292 and S1294 are performed for checking out license key Kc and others to memory card 110 in the case where certificate revocation list CRL of license administration module 511 on the sender side is newer than certificate revocation list CRL of memory card 110 on the receiver side. In the operation of sending the license to memory card 110, as described above, certificate revocation list CRL is obtained from hard disk 530 when certificate revocation list CRL recorded on hard disk 530 is newer than certificate revocation list CRL held in CRL region 1415A of memory card 110, and certificate revocation list CRL thus obtained is set to memory card 110 so that the certificate revocation list CRL held in CRL region 1415A of memory card 110 can be updated.

After step S1284 or S1294, as shown in FIG. 51, controller 1420 instructs decryption processing unit 1404 to decrypt encrypted license {check-out transaction ID//content ID//Kc//check-out ACm//ACp}Kmc4 with individual private decryption key Kmc4, and license (license key Kc, check-out transaction ID, content ID, check-out ACm and reproduction control information ACp) are accepted (step S1296).

License administration module 511 of personal computer 50 sends the entry number for storing the license, which is checked out to memory card 110, to reproduction terminal 102 via USB interface 550, terminal 580 and USB cable 70 (step S1298). Thereby, controller 1106 of reproduction terminal 102 receives the entry number via terminal 1114, USB interface 1112 and bus BS3, and sends the received entry number to memory card 110 via memory card interface 1200. Controller 1420 of memory card 110 receives the entry number via terminal 1426, interface 1424 and bus BS4, and stores license (license key Kc, check-out transaction ID, content ID, check-out ACm and reproduction control information ACp), which is accepted in step S1296, in license region 1415B of memory 1415 designated by the received entry number (step S1300).

License administration module 511 of personal computer 50 generates the license administration file, which includes the entry number of license stored in memory 1415 of memory card 110 as well as the plaintext of check-out transaction ID and the content ID, and corresponds to encrypted content data {Dc}Kc to be moved to memory card 110 and additional information Dc-inf, and sends the license administration file to memory card 110 (step S1302).

Controller 1420 of memory card 110 receives the license administration file via reproduction terminal 102, and records the received license administration file in data region 1415C of memory 1415 (step S1304).

License administration module 511 of personal computer 50 decrements the allowed check-out times by one, and adds the check-out transaction ID and individual public encryption key KPmc4 peculiar to the memory card forming the destination of the check-out to update the check-out information (step S1306). License administration module 511 updates the plaintext of the private file by preparing new private information n, which includes the transaction ID, content ID, license key Kc, access control information ACm, reproduction control information ACp and updated address information (to which allowed check-out times, check-out transaction ID and individual public encryption key KPmc4 peculiar to memory card 110 of the check-out destination are added) (step S1308). Individual public encryption key KPmc4 of the check-out destination is stored in a tamper resistant module of the memory card, and has a peculiar value, which is peculiar to the memory card and is obtained via a communication system having a high security level ensured by authentication and encryption. Therefore, individual public encryption key KPmc4 can be suitably used as identification information for specifying or identifying the memory card.

Thereafter, license administration module 511 encrypts the plaintext of the private file with binding key Kb, and updates encrypted private file 160 recorded on hard disk 530 (step S1310).

License administration module 511 obtains encrypted content data {Dc}Kc and additional information Dc-inf, which are to be checked out to memory card 110, from hard disk 530, and sends data {Dc}Kc//Dc-inf to memory card 110 (step S1312). Controller 1420 of memory card 110 receives data {Dc}Kc//Dc-inf via reproduction terminal 102 (step S1314), and records data {Dc}Kc//Dc-inf received via bus BS4 in data region 1415C of memory 1415 (step S1316).

Thereby, license administration module 511 of personal computer 50 prepares the reproduction list file additionally including the tunes (step S1318), which are checked out to memory card 110, and sends the reproduction list file and the instruction of rewriting the reproduction list file to memory card 110 (step S1320). Controller 1420 of memory card 110 receives the reproduction list file and the rewriting instruction via reproduction terminal 102 (step S1322), and writes the received reproduction list file via bus BS4 into data region 1415C of memory 1415 to renew the reproduction list file recorded therein (step S1324). Thereby, the check-out operation ends (step S1326).

As described above, it is determined that memory card 110 attached to reproduction terminal 102 is the regular device, and at the same time, it is determined that class public encryption key KPm3, which is encrypted and sent together with class certificate Cm3, is valid. After determining these facts, the content data can be checked out only in response to the request for check-out to the memory card having class certificate Cm3 not listed in the certificate revocation list, i.e., in the list of the class certificates having the broken class public encryption key KPm3. Therefore, it is possible to inhibit the check-out to an unauthorized memory card as well as the check-out using the descrambled or broken class key. Further, the encryption keys produced in the license administration module and the memory card are transmitted between them. Each of the license administration module and the memory card executes the encryption with the received encryption key, and sends the encrypted data to the other so that the mutual authentication can be practically performed even when sending and receiving the encrypted data, and it is possible to improve the security in the operation of checking out the encrypted content data and the license. By using the check-out operation described above, even the user of reproduction terminal 102 not having a function of communicating with distribution server 10 can receive the encrypted content data and the license, which are received by software of personal computer 50, on the memory card. This improves the user's convenience.

[Check-In]

In the data distribution systems shown in FIGS. 1 and 2, the encrypted content data and the license, which are checked out to memory card 110 from license administration module 511 of personal computer 50, are checked in and returned to license administration module 511. Description will now be given on this check-in operation.

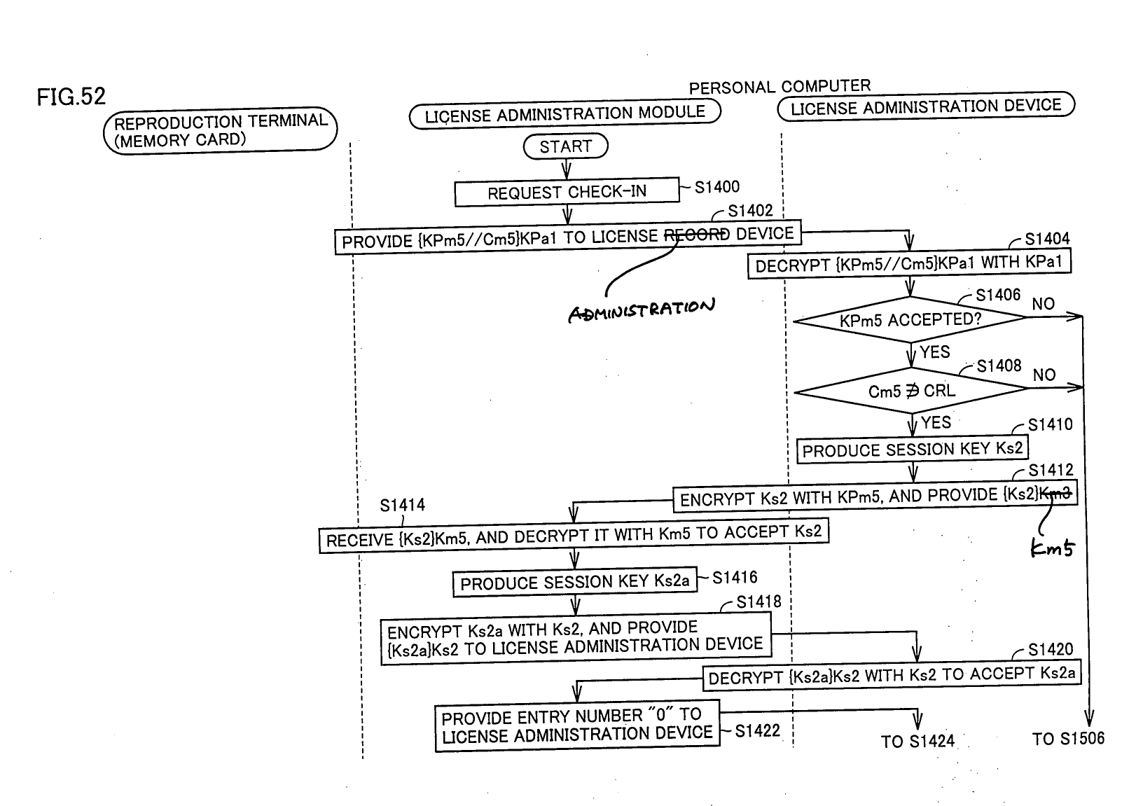

FIGS. 52-55 are first to fourth flow charts illustrating the check-in operation for returning or checking in the encrypted content data and the license, which were checked out to memory card 110 by the check-out operation already described with reference to FIGS. 47-51. Before the processing illustrated in FIG. 52, the user of personal computer 50 obtains the content list file recorded on hard disk 530 and the reproduction list file recorded in data region 1415C of memory card 110. In accordance with these files, the user determines the content to be checked in, specifies the content file and the license administration file of hard disk 530 and memory card 110, and obtains the license administration file of memory card 110. The following description is based on the premise that the above operation is already performed.

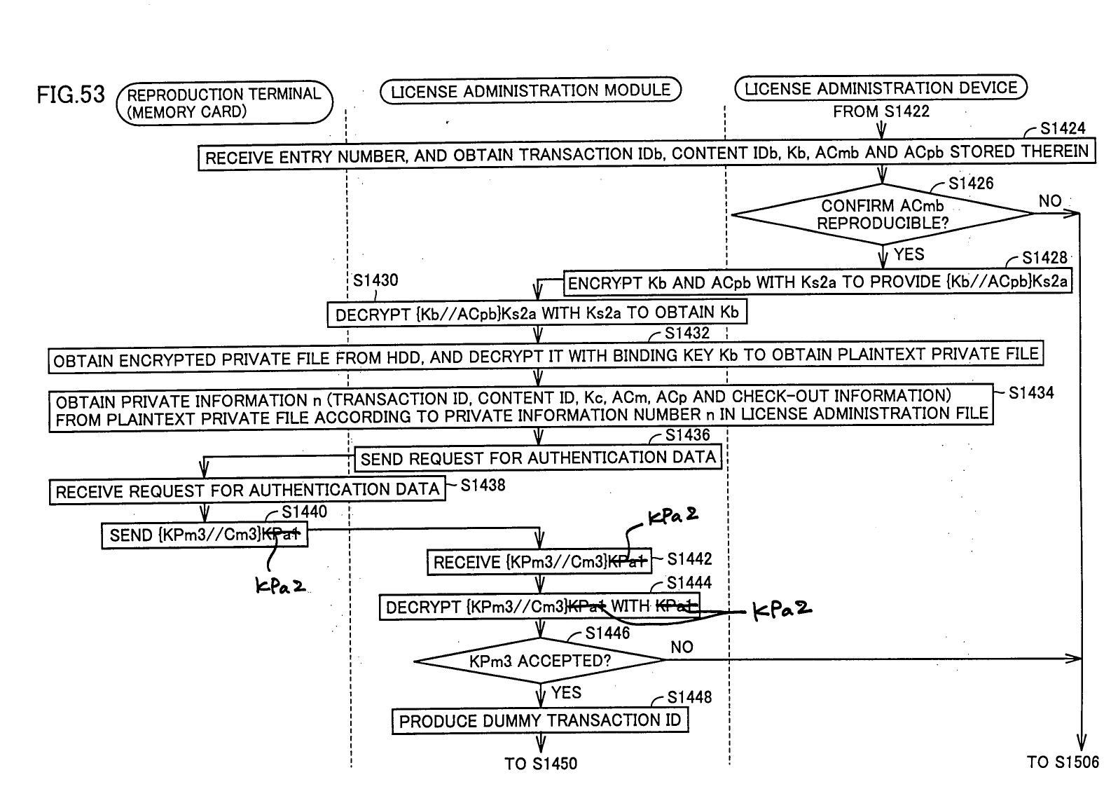

Referring to FIG. 52, when a check-in request is entered via keyboard 560 of personal computer 50 (step S1400), license administration module 511 performs the binding key obtaining processing. A series of processing from step S1402 in FIG. 52 to a step S1430 in FIG. 53 is the binding key obtaining processing, and is the same as the series of processing from step S1006 in FIG. 42 to step S1034 in FIG. 43 illustrating the distribution 3. Therefore, description thereof is not repeated.

Referring to FIG. 53, license administration module 511, which obtained binding key Kb, obtains encrypted private file 160 from hard disk 530 via bus BS2, and decrypts encrypted private file 160 with binding key Kb to obtain the plaintext of the private file (step S1432). Thereafter, license administration module 511 obtains private information n (license (transaction ID, content ID, license key Kc, access control information ACm and reproduction control information ACp) and check-out information (allowed check-out times, check-out transaction ID and individual public encryption key KPmcx of the memory card of the check-out destination)) in the private file corresponding to private information number n recorded in the license administration file as well as (step S1434). License administration module 511 sends a request for sending of the authentication data to reproduction terminal 102 via USB interface 550, terminal 580 and USB cable 70 (step S1436).

Controller 1106 of reproduction terminal 102 receives the request for the authentication data via terminal 1114, USB interface 1112 and bus BS3, and sends the received request for the authentication data to memory card 110 via bus BS3 and memory card interface 1200. Controller 1420 of memory card 110 receives the request for the authentication data via terminal 1426, interface 1424 and bus BS4 (step S1438).

When controller 1420 receives the request for the authentication data, it reads out authentication data {KPm3//Cm3}KPa2 from authentication data holding unit 1400 via bus BS4, and provides authentication data {KPm3//Cm3}KPa2 thus read to reproduction terminal 102 via bus BS4, interface 1424 and terminal 1426. Controller 1106 of reproduction terminal 102 receives authentication data {KPm3//Cm3}KPa2 via memory card interface 1200 and bus BS3, and sends authentication data {KPm3//Cm3}KPa2 to personal computer 50 via bus BS3, USB interface 1112, terminal 1114 and USB cable 70 (step S1440).

License administration module 511 of personal computer 50 receives authentication data {KPm3//Cm3}KPa2 via terminal 580 and USB interface 550 (step S1442), and decrypts authentication data {KPm3//Cm3}KPa2 thus received with public authentication key KPa2 at level 2 (step SS1444). License administration module 511 performs the authentication processing based on the result of decryption for determining whether the processing is performed correctly or not, and thus whether it receives or not the authentication data, which is encrypted for certifying its validity by a regular system, for authenticating the fact that memory card 110 holds class public encryption key KPm3 and class certificate Cm3 provided from the regular memory card (step S1446). When it is determined that the authentication data is valid, license administration module 511 approves and accepts class public encryption key KPm3 and class certificate Cm3. Then, processing is performed in a step S1448. When the authentication data is not valid, license administration module 511 does not approve class public encryption key KPm3 and class certificate Cm3, and the processing ends without accepting them (S1506). When it is determined from the result of the authentication processing that it is the regular memory card, license administration module 511 produces a dummy transaction ID (step S1448). The dummy transaction ID necessarily takes a value different from all the transaction IDs stored in memory card 110, and is produced as a transaction ID for local use.

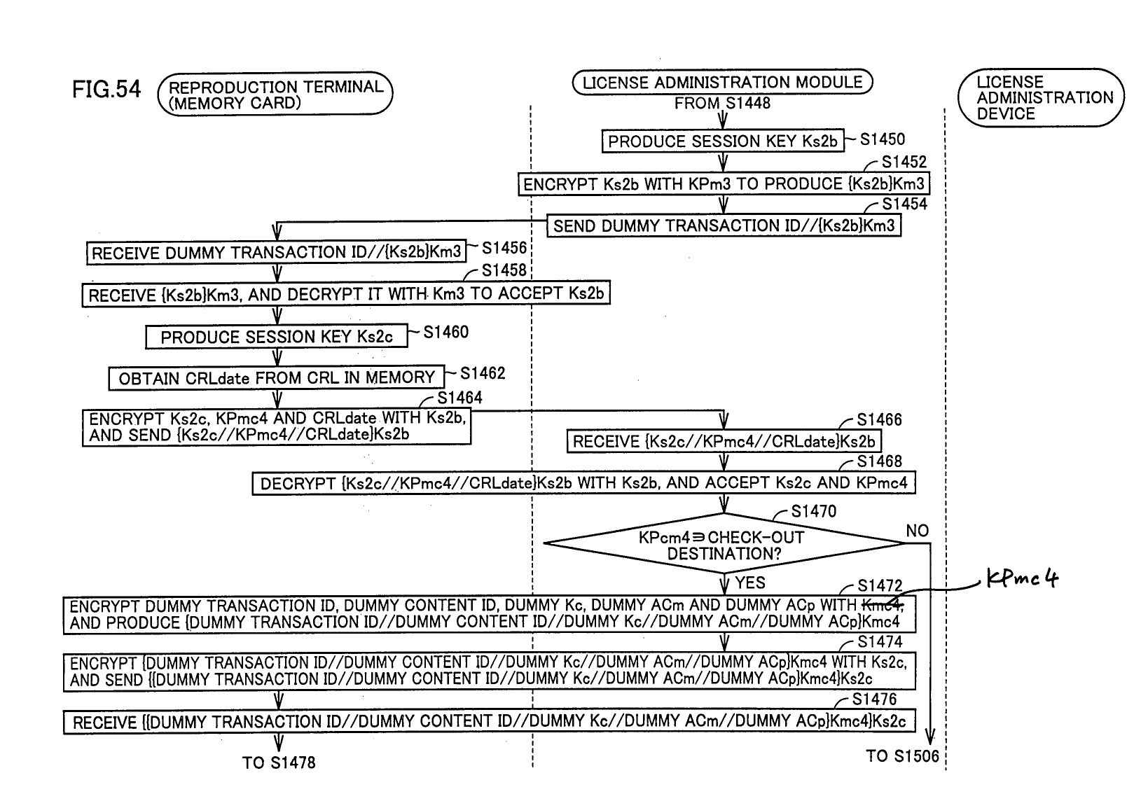

Referring to FIG. 54, license administration module 511 produces session key Ks2b for check-in (step S1450). License administration module 511 encrypts session key Ks2b thus produced with class public encryption key KPm3 sent from memory card 110 to produce encrypted data {Ks2b}Km3 (step S1452), and sends dummy transaction ID//{Ks2b}Km3, which is prepared by adding dummy transaction ID to encrypted data {Ks2b}Km3, to reproduction terminal 102 via USB interface 550, terminal 580 and USB cable 70 (step S1454). Controller 1106 of reproduction terminal 102 receives dummy transaction ID//{Ks2b}Km3 via terminal 1114, USB interface 1112 and bus BS3, and sends dummy transaction ID//{Ks2b}Km3 thus received to memory card 110 via memory card interface 1200. Controller 1420 of memory card 110 receives dummy transaction ID//{Ks2b}Km3 via terminal 1426, interface 1424 and bus BS4 (step S1456). Decryption processing unit 1422 receives encrypted data {Ks2b}Km3 from controller 1420 via bus BS4, and decrypts encrypted data {Ks2b}Km3 with class private decryption key Km3 sent from Km holding unit 1421 to accept session key Ks2b (step S1458). Session key generating unit 1418 generates session key Ks2c (step S1460). Controller 1420 obtains update date/time CRLdate of certificate revocation list CRL from CRL region 1415A of memory 1415 via bus BS4, and provides the update date/time CRLdate thus obtained to selector switch 1446 (step S1462).

Thereby, encryption processing unit 1406 encrypts session key Ks2c, individual public encryption key KPmc4 and update date/time CRLdate, which are obtained by successively selecting the terminals of selector switch 1446, with session key Ks2b, which is decrypted by decryption processing unit 1422 and is obtained via terminal Pa of selector switch 1442, to produce encrypted data {Ks2c//KPmc4//CRLdate}Ks2b. Controller 1420 outputs encrypted data {Ks2c//KPmc4//CRLdate}Ks2b to reproduction terminal 102 via bus BS4, interface 1424 and terminal 1426. Controller 1106 of reproduction terminal 102 receives encrypted data {Ks2c//KPmc4//CRLdate}Ks2b via memory card interface 1200. Controller 1106 sends encrypted data {Ks2c//KPmc4//CRLdate}Ks2b to personal computer 50 via USB interface 1112, terminal 1114 and USB cable 70 (step S1464).

License administration module 511 of personal computer 50 receives encrypted data {Ks2c//KPmc4//CRLdate}Ks2b via terminal 580 and USB interface 550 (step S1466), decrypts encrypted data {Ks2c//KPmc4//CRLdate}Ks2b thus received with session key Ks2b, and accepts session key Ks2c, individual public encryption key KPmc4 and update date/time CRLdate (step S1468).

Then, license administration module 511 determines whether accepted individual public encryption key KPmc4 is included in the check-out information of private information n obtained in step S1434 or not, and thus whether it matches with individual public encryption key KPmcx stored corresponding to check-out transaction ID of the license to be checked out (step S1470).

Individual public encryption key KPmc4 thus accepted is included in the check-out information, which is updated at the time of check-out of the encrypted content data and the license (see step S1300 in FIG. 51). Therefore, by preparing the check-out information, which includes individual public encryption key KPmc4 corresponding to the destination of check-out of the encrypted content data and others, the check-out destination can be easily specified at the time of check-in.

In step S1470, if individual public encryption key KPmc4 is not included in the check-out information, the check-in operation ends (step S1506). In step S635, if individual public encryption key KPmc4 is included in the check-out information, license administration module 511 encrypts dummy license, i.e., dummy transaction ID, dummy content ID corresponding to no content, dummy license key Kc (represented as dummy Kc) not participating in reproduction, dummy access control information ACm (represented as dummy ACm), in which the reproduction times are not restricted (=255), the shift/copy flag is set to “0” inhibiting the shift and copy, and the security flag is set to level 1 (=1), and dummy reproduction control information ACp (represented as dummy ACp) with individual public encryption key KPmc4 to produce encrypted data {dummy transaction ID//dummy content ID//dummy Kc//dummy ACm//dummy ACp}Kmc4 (step S1472).

License administration module 511 encrypts encrypted data {dummy transaction ID//dummy content ID//dummy Kc//dummy ACm//dummy ACp}Kmc4 with session key Ks2c to produce encrypted data {{dummy transaction ID//dummy content ID//dummy Kc//dummy ACm//dummy ACp}Kmc4}Ks2c, and sends encrypted data {{dummy transaction ID//dummy content ID//dummy Kc//dummy ACm//dummy ACp}Kmc4}Ks2c to reproduction terminal 102 via USB interface 550, terminal 580 and USB cable 70 (step S1474).

Controller 1106 of reproduction terminal 102 receives encrypted data {{dummy transaction ID//dummy content ID//dummy Kc//dummy ACm//dummy ACp}Kmc4}Ks2c via terminal 1114, USB interface 1112 and bus BS3. Controller 1106 sends encrypted data {{dummy transaction ID//dummy content ID//dummy Kc//dummy ACm//dummy ACp}Kmc4}Ks2c thus received to memory card 110 via bus BS3 and memory card interface 1200. Controller 1420 of memory card 110 receives encrypted data {{dummy transaction ID//dummy content ID//dummy Kc//dummy ACm//dummy ACp}Kmc4}Ks2c via terminal 1426, interface 1424 and bus BS4 (step S1476).

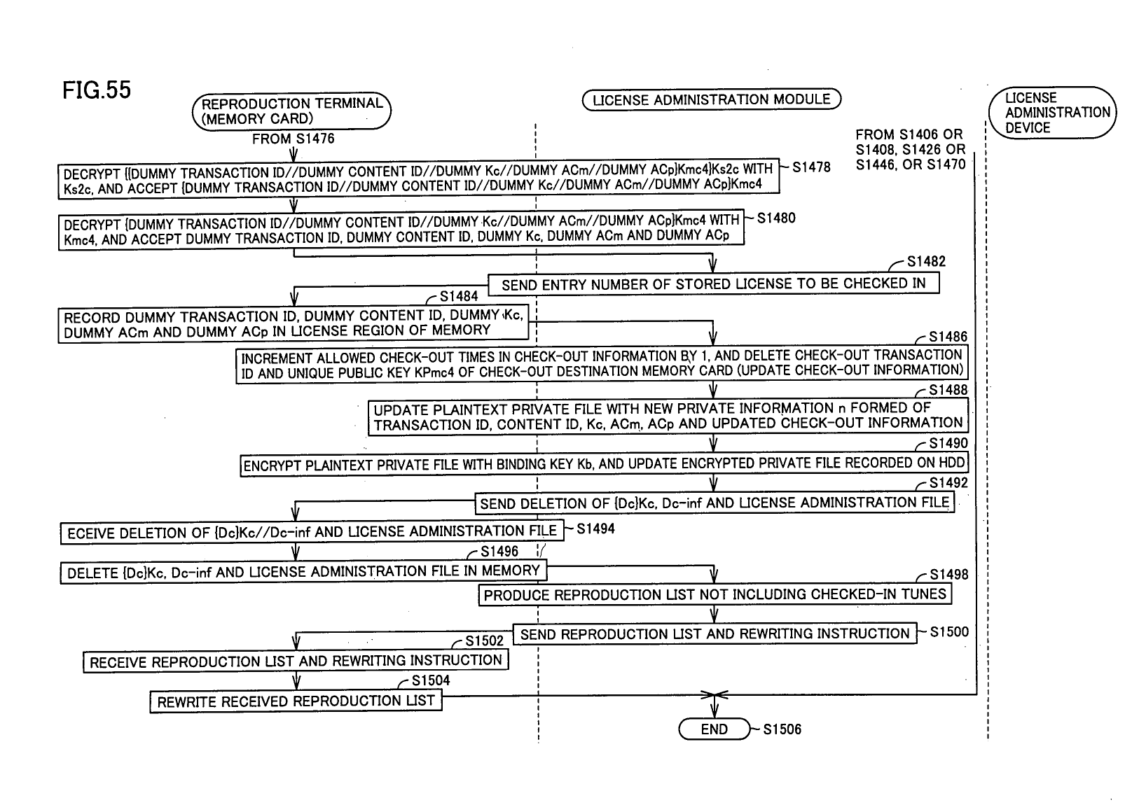

Referring to FIG. 55, decryption processing unit 1412 of memory card 110 receives encrypted data {{dummy transaction ID//dummy content ID//dummy Kc//dummy ACm//dummy ACp}Kmc4}Ks2c via bus BS4, decrypts it with session key Ks2c generated by session key generating unit 1418, and accepts encrypted data {dummy transaction ID//dummy content ID//dummy Kc//dummy ACm//dummy ACp}Kmc4 (step S1478). Decryption processing unit 1404 receives encrypted data {dummy transaction ID//dummy content ID//dummy Kc//dummy ACm//dummy ACp}Kmc4 from decryption processing unit 1412, and decrypts encrypted data {dummy transaction ID//dummy content ID//dummy Kc//dummy ACm//dummy ACp}Kmc4 thus received with individual private decryption key Kmc4 obtained from Kmc holding unit 1402 to accept dummy transaction ID, dummy content ID, dummy Kc, dummy ACm and dummy ACp) (step S1480).

License administration module 511 of personal computer 50 obtains an entry number, where the license for the check-in is stored, from the license administration file of memory card 110, and sends it as the entry number for storing the dummy license to reproduction terminal 102 via USB interface 550, terminal 580 and USB cable 70 (step S1482). Thereby, controller 1106 of reproduction terminal 102 receives the entry number via terminal 1114, USB interface 1112 and bus BS3, and sends the received entry number to memory card 110 via memory card interface 1200. Controller 1420 of memory card 110 receives the entry number via terminal 1426, interface 1424 and bus BS4, and stores dummy license (dummy transaction ID, dummy content ID, dummy Kc, dummy ACm and dummy ACp) in license region 1415B of memory 1415 designated by the entry number thus received (step S1484). By recording dummy transaction ID, dummy content ID, dummy Kc, dummy ACm and dummy ACp in this manner, the license checked out to memory card 110 can be erased.

Thereafter, license administration module 511 of personal computer 50 increments the allowed check-out times in the check-out information by one, and updates the check-out information by deleting the check-out transaction ID and the individual public encryption key KPmc4 of the memory card of the check-out destination (step S1486). License administration module 511 updates the plaintext of the private file by using new private information n, which includes the transaction ID, content ID, license key Kc, access control information ACm, reproduction control information ACp and the updated check-out information (step S1488). Thereafter, license administration module 511 updates the plaintext of the private file with binding key Kb to update encrypted private file 160 recorded on hard disk 530 (step S1490).

Then, license administration module 511 sends a deletion instruction for deleting the content file (encrypted content data {Dc}Kc and additional information Dc-inf) and the license administration file for the license, which is checked out and is recorded at data region 1415C in memory 1415 of memory card 100, to reproduction terminal 102 via USB interface 550, terminal 580 and USB cable 70 (step S1492). Controller 1106 of reproduction terminal 102 receives the deletion instruction for the content file (encrypted content data {Dc}Kc and additional information Dc-inf) and the license administration file via terminal 1114, USB interface 1112 and bus BS3 (step S1494). Thereby, controller 1106 outputs the instruction for deleting the content file (encrypted content data {Dc}Kc and additional information Dc-inf) and the license administration file to memory card 110. Thereby, controller 1420 of memory card 110 receives the deletion instruction for the content file (encrypted content data {Dc}Kc and additional information Dc-inf) and the license administration file via terminal 1426, interface 1424 and bus BS4, and deletes the content file (encrypted content data {Dc}Kc and additional information Dc-inf) and the license administration file via bus BS4 (step S1496).

License administration module 511 of personal computer 50 prepares the reproduction list, from which the checked-in tunes are deleted (step S1498), and sends the reproduction list and the instruction for rewriting the reproduction list to memory card 110 (step S1500). Controller 1420 of memory card 110 receives the reproduction list and the rewriting instruction via reproduction terminal 102 (step S1502), and writes the received reproduction list into memory 1415 via bus BS4 to renew the reproduction list written therein (step S1504). Thereby, the check-in operation ends (step S1506).

As described above, the encrypted content data and the license are returned from the opposite side, to which the encrypted content data and the license are checked out. Thereby, the license is checked out from the license administration module of a low security level inhibiting the shift of the license to the memory card of a high security level, and the memory card can receive the license obtained by the license administration module of the low security level. Therefore, the encrypted content data can be reproduced for enjoyment by the reproduction terminal with the license obtained by the license administration module of a low security level.

The license checked out to the memory card cannot be output from the memory card to another recording device (memory card, license administration device or license administration module) according to specifications in access control information ACm. Therefore, the license, which was checked out, does not leak. By returning or checking in the license, which was checked out, to the original license administration module, the right of the license, which was checked out, returns to the original license administration module. Accordingly, the system allows neither the unauthorized copy nor the lowering of the security level, and can secure the copyright.

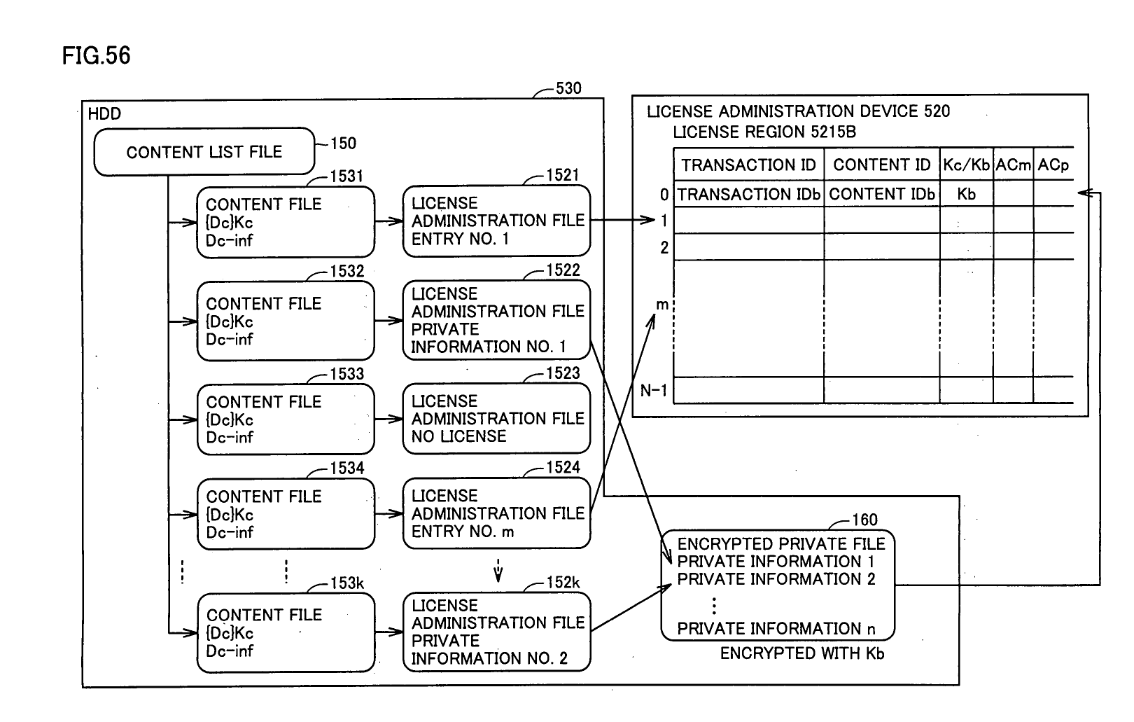

Referring to FIG. 56, description will now be given on the administration of the encrypted content data and the license received by license administration module 511 or license administration device 520 of personal computer 50. Hard disk 530 of personal computer 50 includes content list file 150, content files 1531-153k, license administration files 1521-152k and encrypted private file 160.

Content list file 150 is a data file describing the owned contents in a list format, and includes information (e.g., title of tune and name of artist) about each content as well as information (file names) representing the content file and license administration file. Information about each content is mentioned automatically or in accordance with the instruction of the user by obtaining necessary information from additional information Dc-inf at the time of reception. The contents, which include only the content file or only the license administration file, and thus cannot be reproduced, can also be administered in the list.

Content files 1531-153k of k in number are files storing encrypted content data {Dc}Kc and additional information Dc-inf, which are received by license administration module 511 or license administration device 520, and these files are provided for each content.

License administration files 1521-152k are recorded corresponding to content files 1531-153k, respectively, and are employed for administering the license received by license administration module 511 or license administration device 520. License administration files 1521-152k include information for specifying the storage place of the license and the information relating to the license.

The information for specifying the storage place is the entry number when the license is recorded in license administration device 520, or is the private information number specifying the private information recorded in the encrypted private file.

The information relating to the license is a copy of plaintext of matters, which are restricted in access control information ACm and reproduction control information ACp, and can be easily determined from license purchase conditions AC, as well as transaction ID and content ID, which can be referred to as the plaintext at the time of reception of the license. As is apparent from the description already given, the license is recorded in a manner protected from referring for the purpose of protecting the content. However, no problem occurs from the viewpoint of protection of the content even when the contents of the information other than license key Kc are referred to unless the contents are rewritten. In the application program, each processing starts by referring to the information relating to the license.

The encrypted private information file includes the license and the check-out information administered by license administration module 511. The encrypted private information file takes the form encrypted with binding key Kb.

More specifically, license administration files 1521 and 1524 include entry numbers 0 and 1, respectively. These indicate the administration regions of the licenses (license ID, license key Kc, access control information ACm and reproduction control information ACp) administered at license region 5215B in memory 5215 of license administration device 520.

Accordingly, when the license administered by license administration device 520 as well as the encrypted content data, which is recorded in content file 1531 and can be reproduced with this license, are to be shifted or copied to memory card 110 attached to reproduction terminal 102, a search is performed through content file 150 to specify content file 1531 and license administration file 1521, and the license administration file 1521 is referred to, whereby it is possible to determine the administration place of the license for encrypted content data {Dc}Kc recorded in content file 1531. Since the license administration file 1521 corresponding to content file 1531 includes the entry number of “1”, the license for reproducing the encrypted content data of the file name recorded in content file 1531 is recorded at the region, which is designated by the entry number “1”, in license region 5215B of memory 5215 in license administration device 520. In this case, the entry number “1” is read from license administration module 511 of content list file 150 recorded on hard disk 530, and the entry number “1” thus read is provided to license administration device 520, whereby the license can be easily taken and shifted from license region 5215B of memory 5215 to memory card 110. After the license is shifted, the license at the designated entry number “1” is deleted from license region 5215B of memory 5215 so that “no license” is recorded as is done in license administration file 1523.

License administration module 511 records the license administered by license administration module 511 together with the check-out information as the private information in encrypted private file 160, and administers it with license administration files 1522, 1524, * * * and 152k. License administration files 1522, 1524, * * * and 152k include the private information numbers of the private information formed of the corresponding license in encrypted private file 160 and the check-out information.

For example, when the license administered by license administration module 511 and the encrypted content data, which can be reproduced with this license and is recorded in content file 1534, is to be shifted or copied to personal computer 80, a search is performed through content file 150 to specify content file 1534 and license administration file 1524, and thereby private information number n is obtained from license administration file 1524. Further, binding key Kb is obtained from license administration device 520, and encrypted private file 160 is decrypted with binding key Kb thus obtained to obtain the plaintext of the private file. Thereby, the license and the check-out information can be obtained from the private information in the private file, which corresponds to the private information number n obtained from the license administration file.

According to the first embodiment of the invention, as described above, the license of the encrypted content data received by license administration module 511 is stored as the private information in encrypted private file 160, and encrypted private file 160 can be decrypted only with binding key Kb, which is held by hardware in license administration device 520. Thus, binding key Kb is a symmetric key administering the encrypted content data and the license, and the license cannot be obtained without binding key Kb. Accordingly, the license of the encrypted content data received by license administration module 511 is recorded on hard disk 530 in the form written in encrypted private file 160, and therefore is practically administered by software. However, the license cannot be taken out from encrypted private file 160 without binding key Kb stored in license administration device 520. Therefore, the administration is practically and nearly made by hardware.

However, the license received by license administration device 520 is stored in license region 5215B of memory 5215. Accordingly, the administration level of the license received by license administration module 511 according to the first embodiment of the invention can be close to the administration level of the license received by license administration device 520.

In the above description, it is assumed that the binding license is stored at the entry number “0”.

[Reproduction]

In the second embodiment, the encrypted content data recorded in memory card 110 is reproduced by cellular phone 100 or reproduction terminal 102 in accordance with flow charts of FIGS. 31 and 32.

Personal computers 50 and 80 may be internally provided with content reproducing device 1550 shown in FIG. 7, whereby the encrypted content data received by license administration module 511 or license administration device 520 can be reproduced. For reproducing the encrypted content data, which is obtained by license administration module 511, by content reproducing device 1550, license administration module 511 obtains binding key Kb stored in license administration device 520, decrypts encrypted private file 160 recorded on hard disk 530 with binding key Kb, and reads the license from the plaintext of the private file for providing it to content reproducing device 1550.

Further, personal computers 50 and 80 may be internally provided with reproducing units, which function in accordance with software for reproducing the encrypted content data. Thereby, the encrypted content data obtained by license administration module 511 can be reproduced by software. In this case, license administration module 511 likewise obtains binding key Kb stored in license administration device 520, decrypts encrypted private file 160 recorded on hard disk 530 with binding key Kb, and reads the license of the plaintext of the private file to provide it to content reproducing device 1550. As compared with the reproduction (level 2) ensuring the security by hardware in content reproducing device 1550, the reproduction by software is performed at lower security level (level 1) because the security is ensured by software. Accordingly, the license held by license administration device 520 cannot be used for such reproduction by the software.

[Shift/Copy 2]

In the data distribution systems shown in FIGS. 1 and 2, the encrypted content data and the license obtained by license administration module 511 of personal computer 50 are shifted or copied to personal computer 80. Description will now be given on this operation according to the second embodiment. This operation will be referred to as “shift/copy 2”.

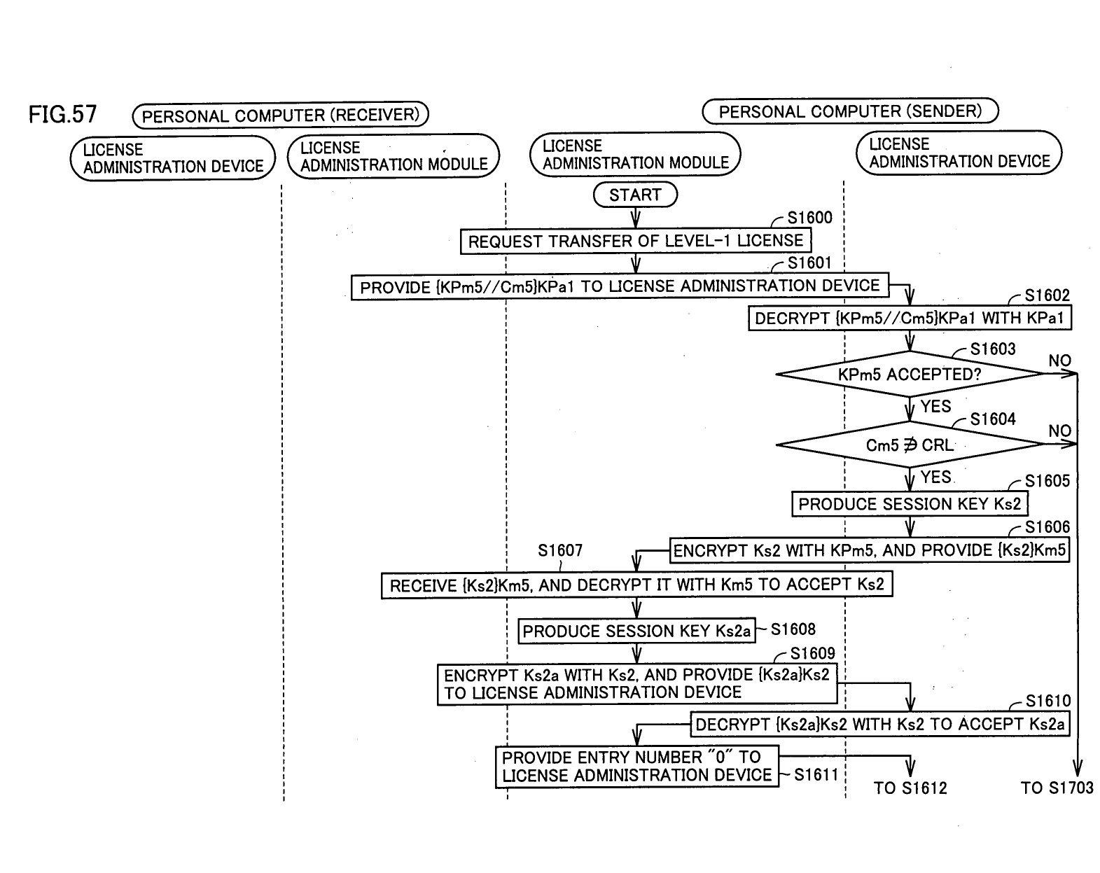

FIGS. 57-64 are first to eighth flow charts illustrating the shift of the encrypted content data and the license obtained by license administration module 511 to personal computer 80. Before the processing illustrated in FIG. 57, the user of personal computer 50 determines the content to be shifted in accordance with the content list file, and the content file and the license administration file in hard disk 530 and memory card 110 are specified. The following description is based on the premise that the above operation is already performed. The natural number w, which identifies the class of the license administration module in personal computer 80 on the receiver side, is equal to five (w=5), and a natural number y for identifying the license administration module is equal to five (y=5).

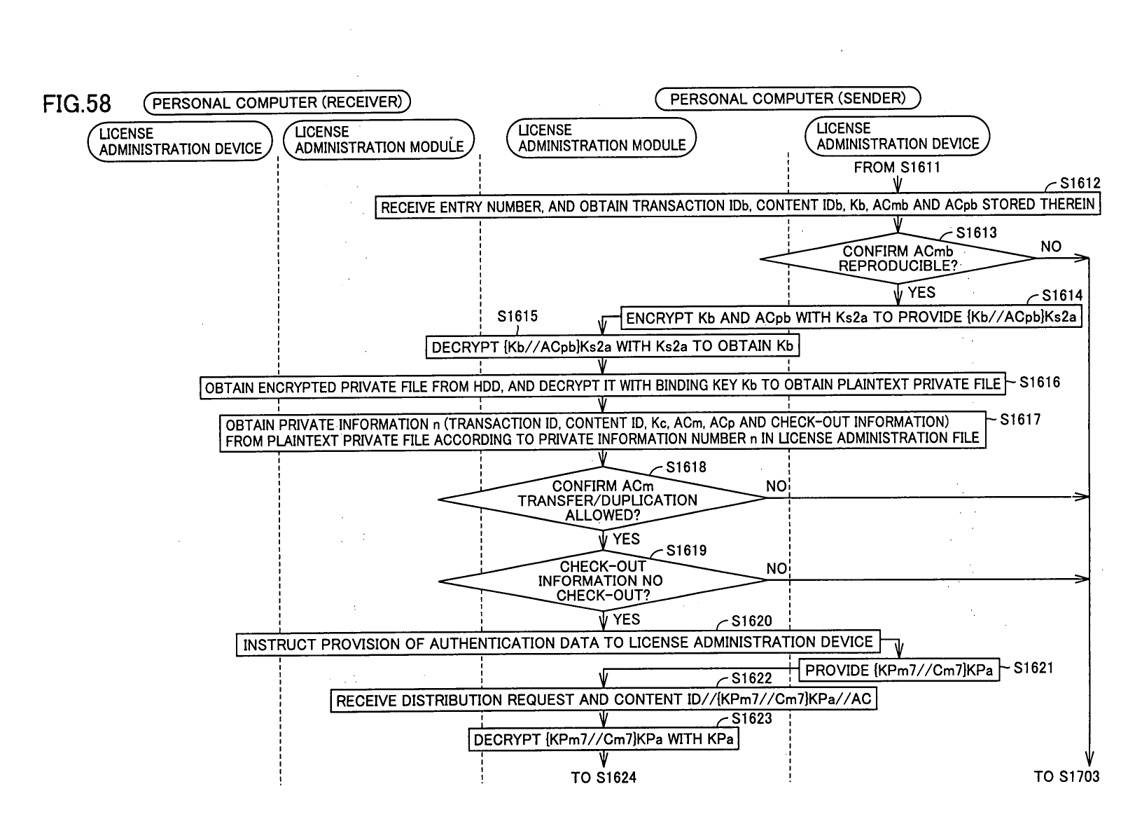

Referring to FIG. 57, when the user enters a shift request for the license, which is obtained by license administration module 511 of personal computer 50, via keyboard 560 of personal computer 50 (step S1600), license administration module 511 of personal computer 50 performs the binding key obtaining processing. A series of processing from a step S1601 in FIG. 57 to a step S1615 in FIG. 58 is the binding key obtaining processing, and is the same as the series of processing from step S1006 in FIG. 42 to step S1034 in FIG. 43. Therefore, description thereof is not repeated.

Referring to FIG. 58, when the binding key is obtained, license administration module 511 of personal computer 50 obtains encrypted private file 160 from hard disk 530 via bus BS2, and decrypts encrypted private file 160 thus obtained with binding key Kb to obtain the plaintext of the private file (step S1616). Thereafter, license administration module 511 of personal computer 50 obtains private information n (transaction ID, content ID, license key Kc, access control information ACm, reproduction control information ACp and check-out information) in the private file corresponding to private information number n recorded in the license administration file (step S1617).

Thereby, license administration module 511 of personal computer 50 determines based on access control information ACm thus obtained whether the shift and copy of the encrypted content data are allowed or not (step S1618). Thus, license administration module 511 determines, based on the allowed reproduction times and shift/copy flag in access control information ACm thus obtained, whether access control information ACm inhibits the shift and copy of the encrypted content data according to the license to be shifted to personal computer 80 or not.

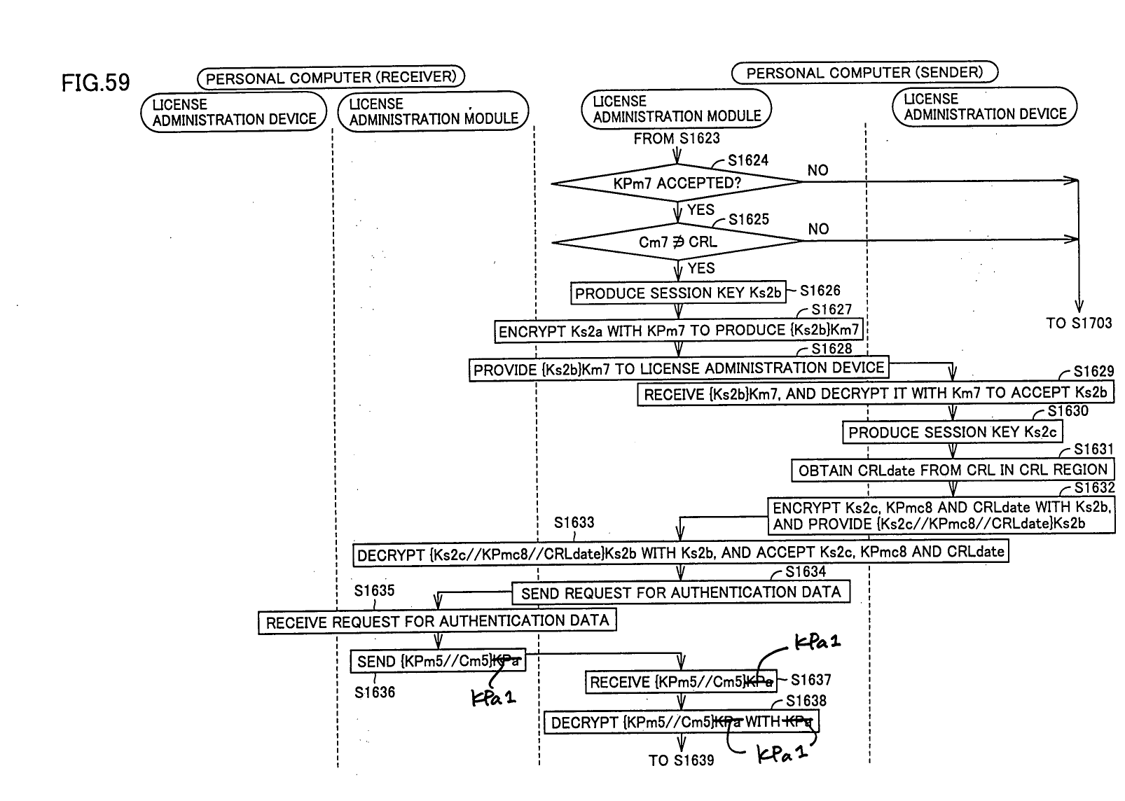

When the shift and copy are restricted in step S1618, the operation moves to a step S1703, and the shift operation ends. When the shift and copy are not inhibited in step S1618, the operation moves to a step S1619. License administration module 511 determines based on the obtained check-out information whether the check-out is allowed or not (step S1619). When the check-out is impossible in step S1619, the check-out is inhibited so that the operation moves to a step S1703, and the check-out operation ends. When the check-out is allowed in step S1619, device determining processing is performed for determining whether license administration device 520 can store a new binding key or not. When license administration device 520 cannot be authenticated according to the device determining processing, or when certificate revocation list CRL prevents the recording of a new binding key, the processing is interrupted for maintaining a current status. A series of processing from a step S1621 in FIG. 58 to a step S1633 in FIG. 59 is the device determining processing, and is the same as the series of processing from step S906 in FIG. 36 to step S932 in FIG. 37 illustrating the initialization in flow charts. Therefore, description thereof is not repeated.

Referring to FIG. 59, when the device determining processing ends, license administration module 511 of personal computer 50 sends a request for sending of the authentication data to personal computer 80 via a communication cable 90 (step S1634). The license administration module of personal computer 80 receives this request for the authentication data (step S1635).

When the license administration module of personal computer 80 receives the request for the authentication data, it sends authentication data {KPm5//Cm5}KPa1 to personal computer 50 (step S1636). License administration module 511 of personal computer 50 receives authentication data {KPm5//Cm5}KPa1 via terminal 580 and US interface 550 (step S1637), and decrypts received authentication data {KPm5//Cm5}KPa1 with level-1 authentication key KPa1 (step S1638).

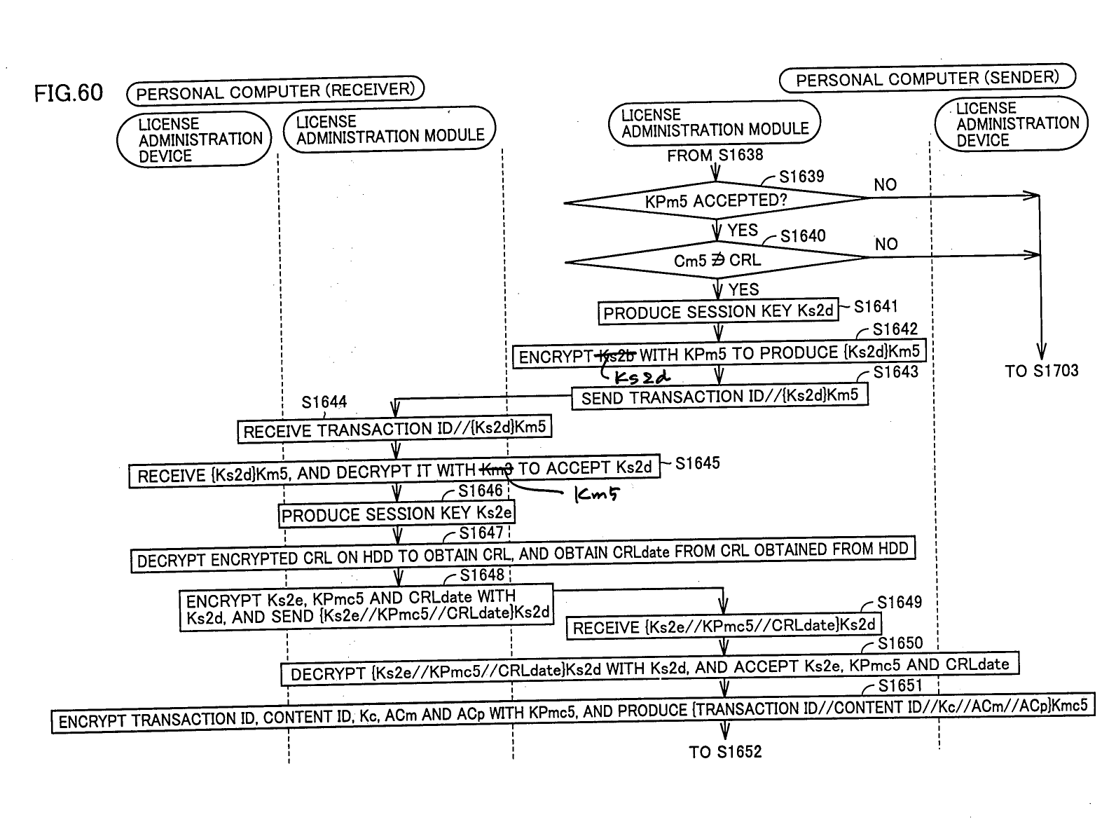

Referring to FIG. 60, license administration module 511 performs the authentication processing based on the result of decryption for determining whether the processing is performed correctly or not, and thus whether it receives or not the authentication data, which is encrypted for certifying its validity by a regular system, for authenticating the fact that the license administration module of personal computer 80 holds class public encryption key KPm5 and class certificate Cm5 provided from the regular license administration module (step S1639). When it is determined that the authentication data is valid, license administration module 511 approves and accepts class public encryption key KPm5 and class certificate Cm5. Then, operation is performed in a step S1640. When the authentication data is not valid, license administration module 511 does not approve class public encryption key KPm5 and class certificate Cm5, and the processing ends without accepting them (S1703). When it is determined that it is the regular license administration module, license administration module 511 then refers to hard disk 530 to determine whether class certificate Cm5 of license administration module is listed in certificate revocation list CRL or not. When class certificate Cm5 is listed in certificate revocation list CRL, the shift operation ends (step S1703). When class certificate Cm5 of the license administration module is not listed in certificate revocation list CRL, next processing is performed (step 1640).

When it is determined from the result of the authentication processing that the access is made from the personal computer with the license administration module having valid authentication data, and the class is not listed in the certificate revocation list, license administration module 511 produces a session key Ks2d for shift (step S1641). License administration module 511 encrypts session key Ks2d thus produced with class public encryption key KPm5 received from personal computer 80 (step S842), and sends transaction ID//{Ks2d}Km5, which is prepared by adding transaction ID to encrypted data {Ks2d}Km5, to personal computer 80 via communication cable 90 (step S1643). The license administration module of personal computer 80 receives transaction ID//{Ks2d}Km5 (step S1644). The license administration module of personal computer 80 decrypts encrypted data {Ks2d}Km5 with class private decryption key Km3, and accepts session key Ks2d (step S1645). The license administration module of personal computer 80 produces a session key Ks2e (step S846), and obtains update date/time CRLdate of the certificate revocation list from the hard disk (step S1647).

The license administration module of personal computer 80 encrypts session key Ks2e, individual public encryption key KPmc5 and update date/time CRLdate with session key Ks2d to produce and send encrypted data {Ks2e//KPmc5//CRLdate}Ks2d to personal computer 50 via communication cable 90 (step S1648).

License administration module 511 of personal computer 50 receives encrypted data {Ks2e//KPmc5//CRLdate}Ks2d via terminal 580 and USB interface 550 (step S849), decrypts encrypted data {Ks2e//KPmc5//CRLdate}Ks2d thus received with session key Ks2d, and accepts session key Ks2e, individual public encryption key KPmc5 and update date/time CRLdate (step S1650). License administration module 511 encrypts transaction ID, content ID, license key Kc, access control information ACm and reproduction control information ACp with individual public encryption key KPmc5 peculiar to personal computer 80 to produce encrypted data {transaction ID//content ID//Kc//ACm//ACp}Kmc5, (step S1651).

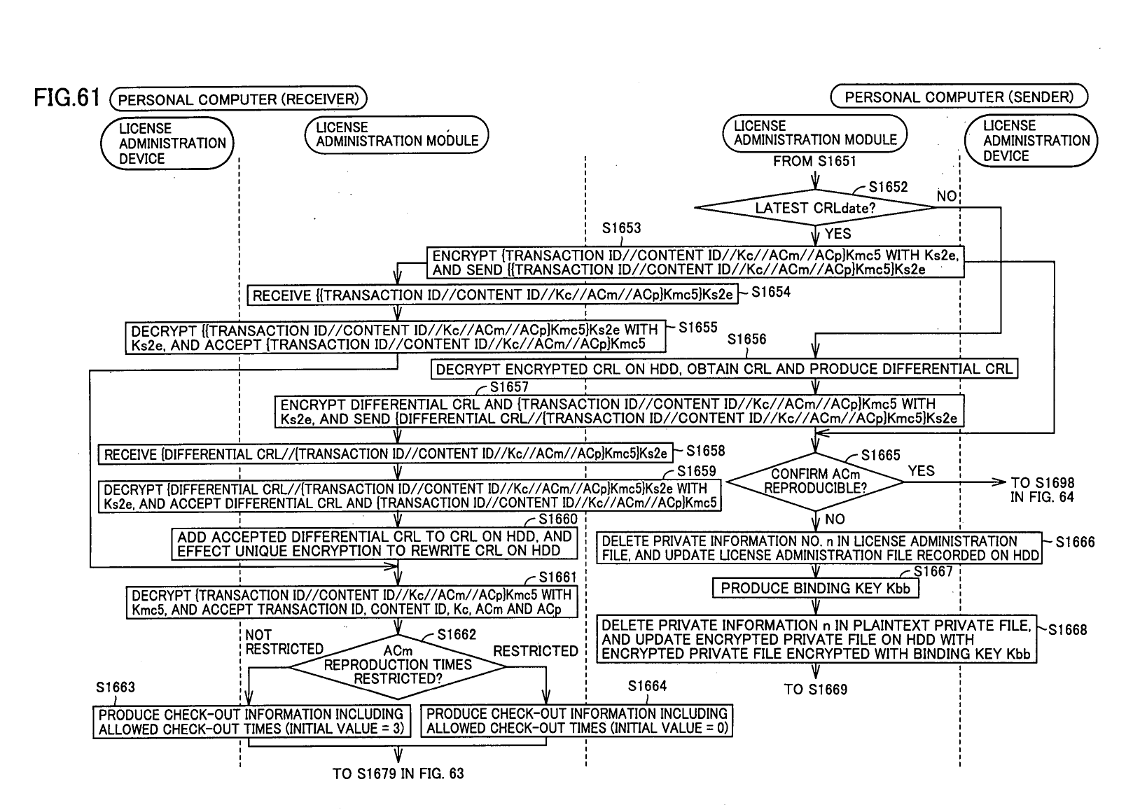

Referring to FIG. 61, license administration module 511 of personal computer 50 determines, based on update date/time CRLdate of the certificate revocation list sent from the license administration module of personal computer 80, the newer certificate revocation list between the certificate revocation list administered by the license administration module of personal computer 80 and the certificate revocation list administered by license administration module 511 itself. When certificate revocation list CRL administered by license administration module 511 itself is older than the other, the operation moves to a step S1653; When certificate revocation list CRL administered by license administration module 511 itself is newer than the other, the operation moves to a step S1656 (step S1652).

When license administration module 511 determines that certificate revocation list CRL administered by itself is older than the other, license administration module 511 encrypts encrypted data {transaction ID//content ID//Kc//ACm//ACp}Kmc5 with session key Ks2e produced by license administration module 511, and provides encrypted data {{transaction ID//content ID//Kc//ACm//ACp}Kmc5}Ks2e to personal computer 80 via communication cable 90 (step S1653).

The license administration module of personal computer 80 receives encrypted data {{transaction ID//content ID//Kc//ACm//ACp}Kmc5}Ks2e (step S854), and decrypts encrypted data {{transaction ID//content ID//Kc//ACm//ACp}Kmc5}Ks2e with session key Ks2e to accept encrypted data {transaction ID//content ID//Kc//ACm//ACp}Kmc5 (step S1655). Thereafter, the operation moves to a step S1661.

When it is determined in step S1652 that certificate revocation list CRL administered by license administration module 511 itself is newer than the other, license administration module 511 of personal computer 50 obtains certificate revocation list CRL from hard disk 530. License administration module 511 produces differential CRL based on update date/time CRLdate of certificate revocation list CRL, which is obtained and administered by itself, and update date/time CRLdate of certificate revocation list CRL administered by the license administration module of personal computer 80 (step S1656). License administration module 511 receives differential CRL and encrypted data {transaction ID//content ID//Kc//ACm//ACp}Kmc5, encrypts them with session key Ks2e to provide encrypted data {differential CRL//{transaction ID//content ID//Kc//ACm//ACp}Kmc5}Ks2e to personal computer 80 via communication cable 90 (step S1657).

Personal computer 80 receives encrypted data {differential CRL//{transaction ID//content ID//Kc//ACm//ACp}Kmc5}Ks2e (step S1658), and the license administration module decrypts it with session key Ks2e to accept the differential CRL and encrypted data {transaction ID//content ID//Kc//ACm//ACp}Kmc5 (step S1659).

The license administration module of personal computer 80 adds the differential CRL thus accepted to certificate revocation list CRL recorded on the hard disk, and thereby updates certificate revocation list CRL (step S1660).

In steps S1653, S1654 and S1655, the operations are performed for shifting license key Kc and others to personal computer 80, and the operations performed in these steps are performed when certificate revocation list CRL held by personal computer 80 on the receiver side is newer than certificate revocation list CRL held by personal computer 50 on the sender side. The operations in steps S1654, S1655, S1656, S1657 and S1660 are performed for shifting license key Kc and others to personal computer 80 in the case where certificate revocation list CRL held by personal computer 80 on the receiver side is older than certificate revocation list CRL held by personal computer 50 on the sender side.

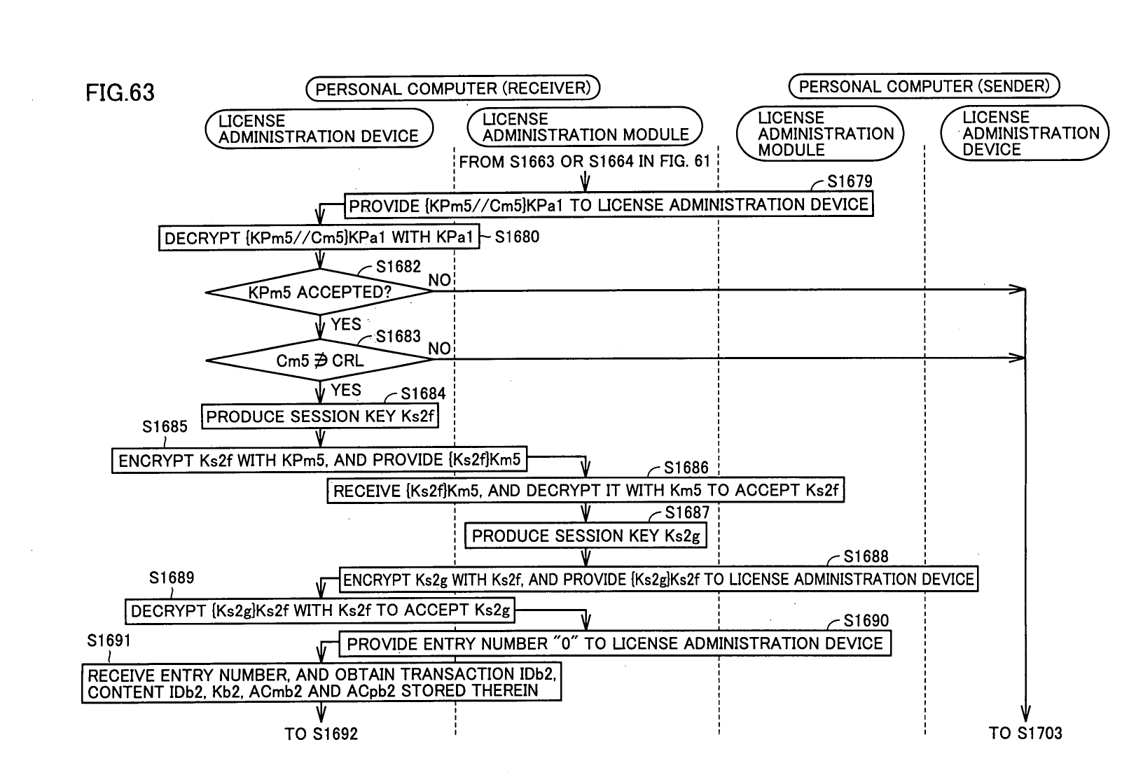

After steps S1655 or S1660, the license administration module of personal computer 80 decrypts encrypted data {transaction ID//content ID//Kc//ACm//ACp}Kmc5 with individual private decryption key Kmc5 to accept the license (license key Kc, transaction ID, content ID, access control information ACm and reproduction control information ACp) (step S1661). The license administration module determines whether access control information ACm thus accepted restricts the reproduction times. When the predetermined times are not restricted, the operation moves to a step S1663. If restricted, the operation moves to a step S1664 (step S1662). When the reproduction times are not restricted, the license administration module produces check-out information, which includes allowed check-out times for checking out the encrypted content data and the license received from personal computer 50 to another device (step S1663). The initial value for the check-out is set to three. When the allowed reproduction times are restricted, the license administration module produces check-out information, in which the allowed check-out times for checking out the encrypted content data to another device are set to zero (step S1664). Thereafter, the operation moves to a step S1679 in FIG. 63.

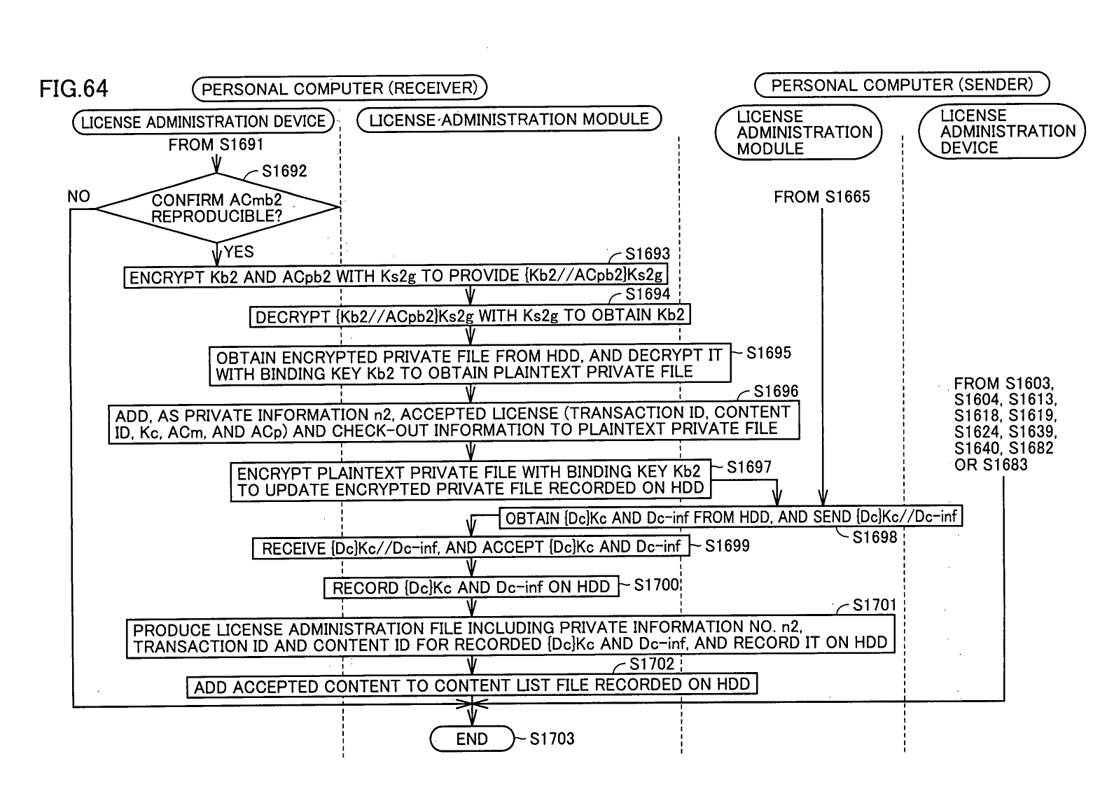

After step S1653 or S1657, an operation of rewriting the binding license held by personal computer 50 is performed in parallel with the shift of the license from personal computer 50 to personal computer 80. After step S1653 or S1657, license administration module 511 of personal computer 50 determines whether the copy of the license is allowed or not (step S1665). When the copy of the license is allowed, the operation moves to a step S1698 in FIG. 64, and encrypted content data {Dc}Kc and additional information Dc-inf are sent to personal computer 80. In step S1665, when shift/copy flag of access control information ACm of the license allows only the shift, license administration module 511 reads out a license administration file 152n of content list file 150 relating to the license, which is recorded on hard disk 530 and is to be shifted, updates license administration file 152n by changing private information number n recorded in the license administration file to “no license” (step S1666), and produces a new binding key Kbb different from initial binding key Kb (step S1667). License administration module 511 deletes private information n, which corresponds to the license to be shifted, in the plaintext of the private file, and encrypts the private file with new binding key Kbb thus produced to update encrypted private file 160 on hard disk 530 (step S1668).

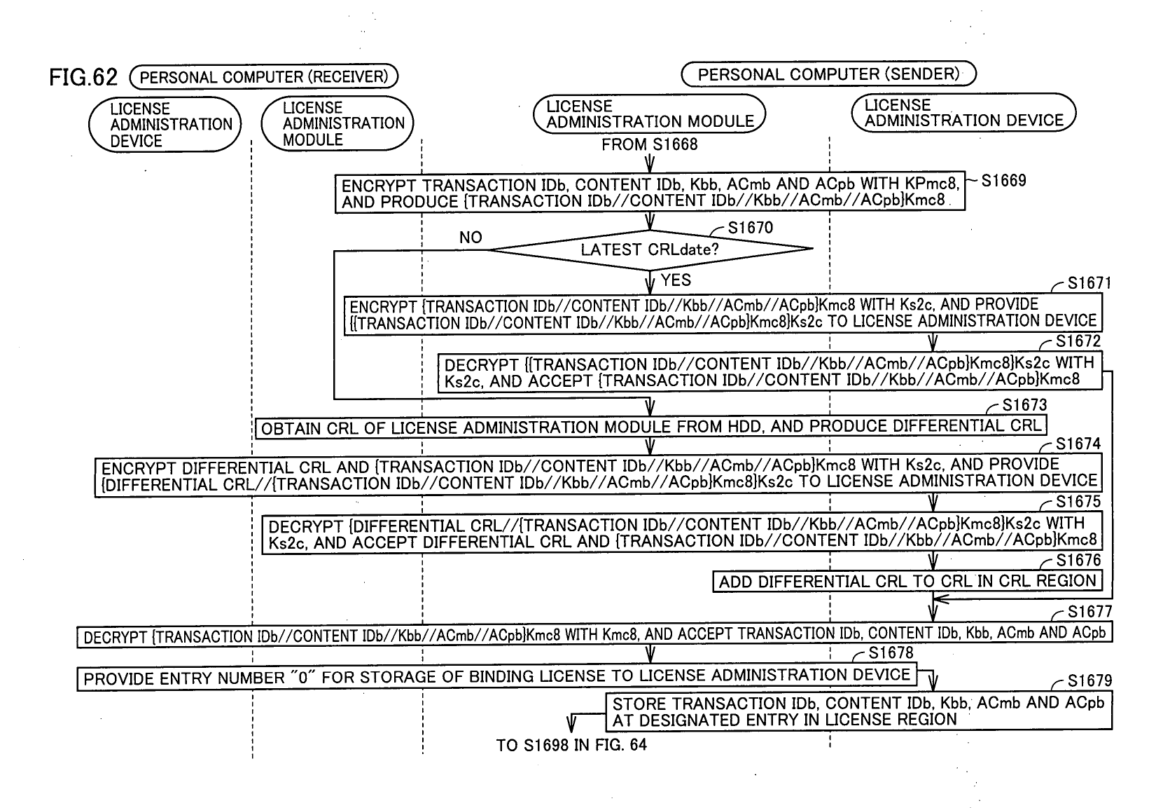

Referring to FIG. 62, license administration module 511 performs the binding key registering processing from a step S1669 to a step S1679 for storing new binding key Kbb thus produced in license administration device 520. This processing is the same as the series of processing from step S934 in FIG. 37 to step S956 in FIG. 38 except for that binding key Kbb and session key Ks2c are used instead of binding key Kb and session key Ks2b, respectively. Accordingly, description of such processing is not repeated.

When registration of new binding key Kbb ends, the operation moves to a step S1698 in FIG. 64.

Referring to FIG. 63, after step S1663 or S1664 in FIG. 61, personal computer 80 operates to obtain binding key Kb2 from the license administration module incorporated therein, and thus performs the binding key obtaining processing. Personal computer performs a series of processing from step S1679 to S1694 in FIG. 64 as the binding key obtaining processing similarly to personal computer 50, and this processing is the same as the series of processing from step S1006 in FIG. 42 to step S1034 in FIG. 43 illustrating the distribution 3 except for that the binding license (transaction IDb2, content IDb2, binding key Kb2, and control information ACmb2 and ACpb2) is obtained, and session keys Ks2g and ks2f are used instead of session keys Ks2a and Ks2b, respectively. Accordingly, description thereof is not repeated.

Referring to FIG. 64, when binding key Kb2 is obtained, the license administration module of personal computer 80 obtains encrypted private file 160 from hard disk 530 via bus BS2, and decrypts encrypted private file 160 thus obtained with binding key Kb2 to obtain the plaintext of the private file (step S1695). Thereafter, the license administration module adds the license (transaction ID, content ID, license key Kc, access control information ACm and reproduction control information ACp) and check-out information, which are received from personal computer 50, as new private information n2 to the plaintext of the private file (step S1696). Then, the license administration module encrypts the plaintext of the private file with binding key Kb2 to update encrypted private file 160 recorded on the hard disk (step S1697).

When both steps S1665 in FIG. 61 and S1697 end, license administration module 511 of personal computer 50 reads the content file (encrypted content data {Dc}Kc and additional information Dc-inf) recorded on hard disk 530, and sends encrypted content data {Dc}Kc and additional information Dc-inf to personal computer 80 via communication cable 90 (step S1698).

The license administration module of personal computer 80 receives encrypted content data {Dc}Kc and additional information Dc-inf, and accepts encrypted content data {Dc}Kc and additional information Dc-inf (step S1699). The license administration module records encrypted content data {Dc}Kc and additional information Dc-inf accepted thereby as the content file on the hard disk via bus BS2 (step S1700). Further, license administration module produces the license administration file, which includes the private information number n2, transaction ID and content ID, for the content file storing encrypted content data {Dc}Kc and additional information Dc-inf, and records it on the hard disk (step S1701). The license administration module adds the name of the accepted content to the content file in the content list file recorded on the hard disk (step S1702), and the shift/copy operation ends (step S1703).

As described above, the license of the encrypted content data obtained by license administration module 511 of personal computer 50 is administered with binding key Kb, whereby the encrypted content data and the license can be shifted or copied from personal computer 50 to personal computer 80.

According to the second embodiment, the license of the encrypted content data, which is obtained by software in the license administration module incorporated in the personal computer, is administered by the binding key administered by hardware in the license administration device. Thereby, the encrypted content data and the license can be sent to another personal computer according to the concept of “shift/copy”, similarly to the license of the encrypted content data obtained by the license administration device.

### THIRD EMBODIMENT

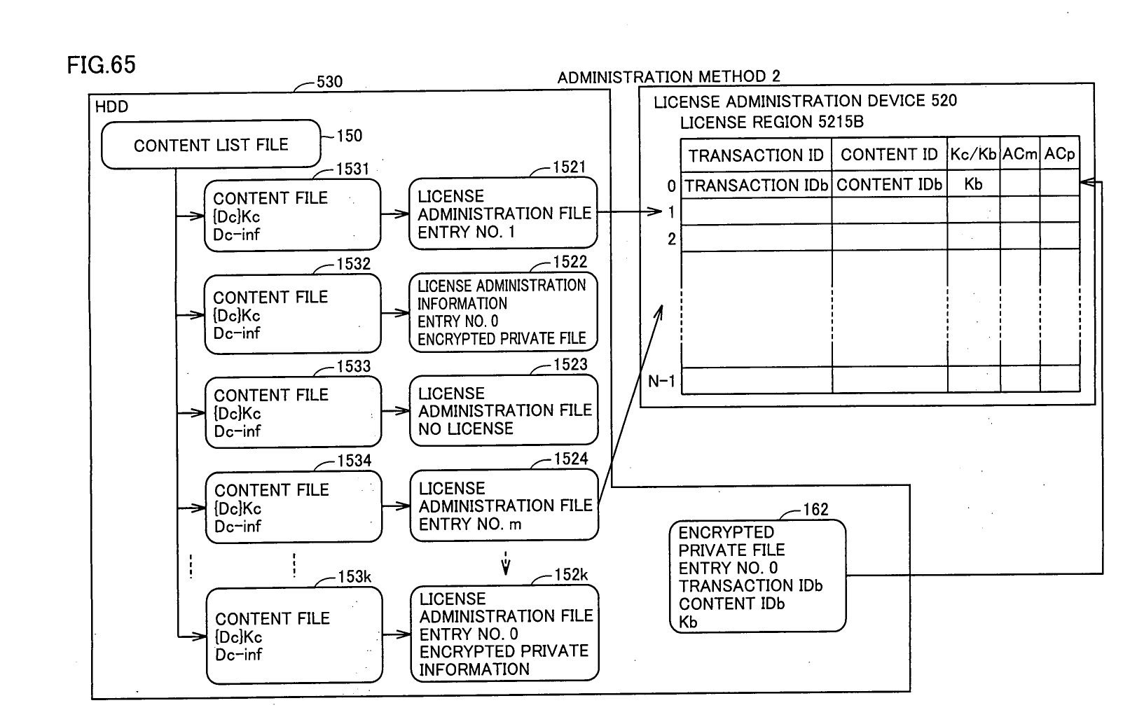

Referring to FIG. 65, description will now be given on the manner of administering the license of the encrypted content data obtained by license administration module 511 according to a third embodiment.

The structure of content list file 150 is the same as that in the second embodiment. Hard disk 530 carries encrypted private file 160, which stores the same transaction IDb, content IDb and binding key Kb as those stored in license administration device 520. An encrypted private file 162 is uniquely encrypted depending on, e.g., the serial number of the CPU of personal computer 50 to inhibit take-out from personal computer 50. Among license administration files 1522, * * * and 152k, license administration files 1522 and 152k correspond to the licenses obtained by license administration module 511. License administration files 1522 and 152k include private information containing the license and check-out information, encrypted private information encrypted similarly to the encrypted private file, and plaintext information relating to the license. The binding license is always stored at the entry number “0” of license administration device 520.

Also, license administration files 1521 and 1524 correspond to the licenses stored in license administration device 520. Instead of the encrypted private file, these files store the entry numbers specifying the entries for the licenses in license region 5215B of license administration device 520. Structures of the other files and license region 5215B are the same as those of the second embodiment in FIG. 56, and therefore, description thereof is not repeated.

When the license is to be taken out from license administration files 1521, * * * or 152k, entry number “0” is sent to license administration device 520 if license administration file 1521, * * * or 152k contain the encrypted private information. Thereby, binding key Kb is obtained from license administration device 520, and it is determined whether binding key Kb thus obtained matches with binding key Kb stored in encrypted private file 162 or not. When matched, the encrypted private information is decrypted to obtain the license and the check-out information. When not matched, obtaining of the license is inhibited so that the processing is stopped. When the entry number is contained, processing is entrusted to license administration device 520. Further, in the case of “no license”, the license does not exist so that the processing is stopped. According to the second embodiment, therefore, all the processing for the license of a low security level (level 1) is performed such that the license of the encrypted content data cannot be taken out from license administration files 1523, * * * and 152k unless binding key Kb stored in license administration device 520 matches with binding key Kb stored in encrypted private file 162.

According to the third embodiment, therefore, the license of the encrypted content data obtained by license administration module 511 can be administered with binding key Kb, and the encrypted content data and the license can be shifted from personal computer 50 to personal computer 80, similarly to the second embodiment already described.

[Initialization]

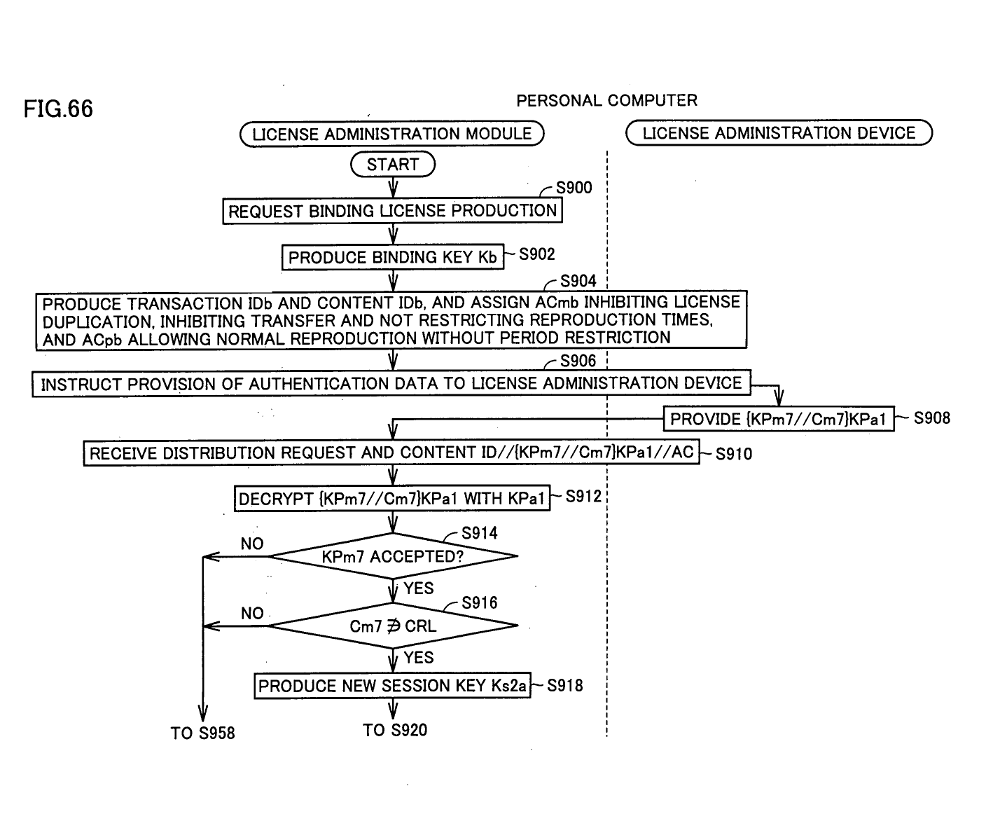

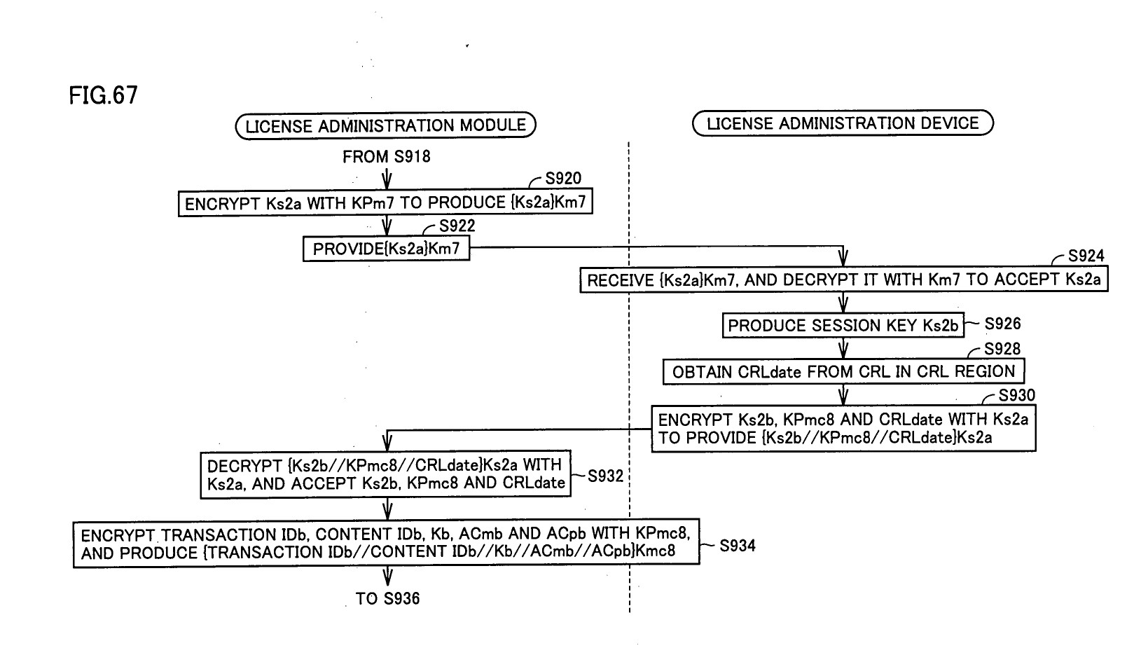

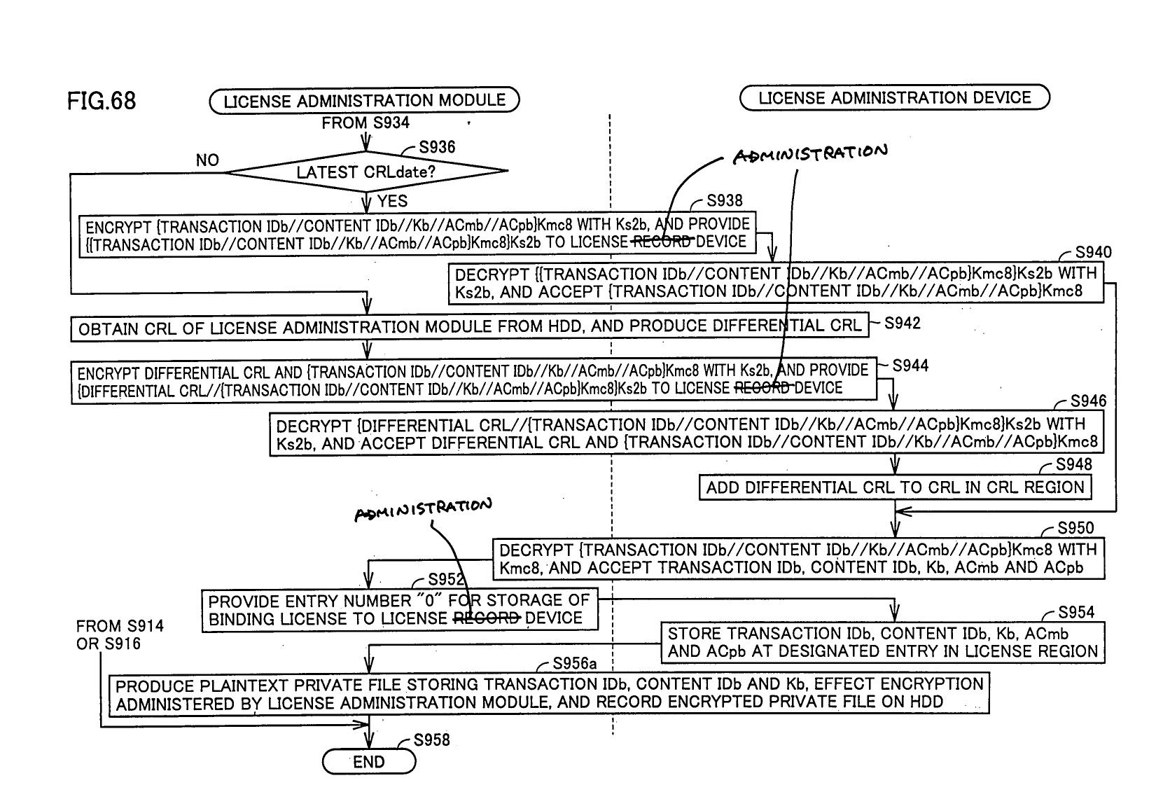

FIGS. 66-68 are first to third flow charts for illustrating the initialization of encrypted private file 160 according to the second embodiment, respectively. The flow charts of FIGS. 66-68 are the same as those of FIGS. 36-38 except for that step S956 in the flow charts of FIGS. 36-38 is replaced with a step S956a. After step S954 in FIG. 68, therefore, license administration module 511 stores transaction IDb, content IDb and binding key Kb in the plaintext of the private file, produces encrypted private file 162 by uniquely encrypting the plaintext of the private file, and records encrypted private file 162 thus produced on hard disk 530 (step S956a). Then, the initializing operation ends (step S958).

[Distribution 4]

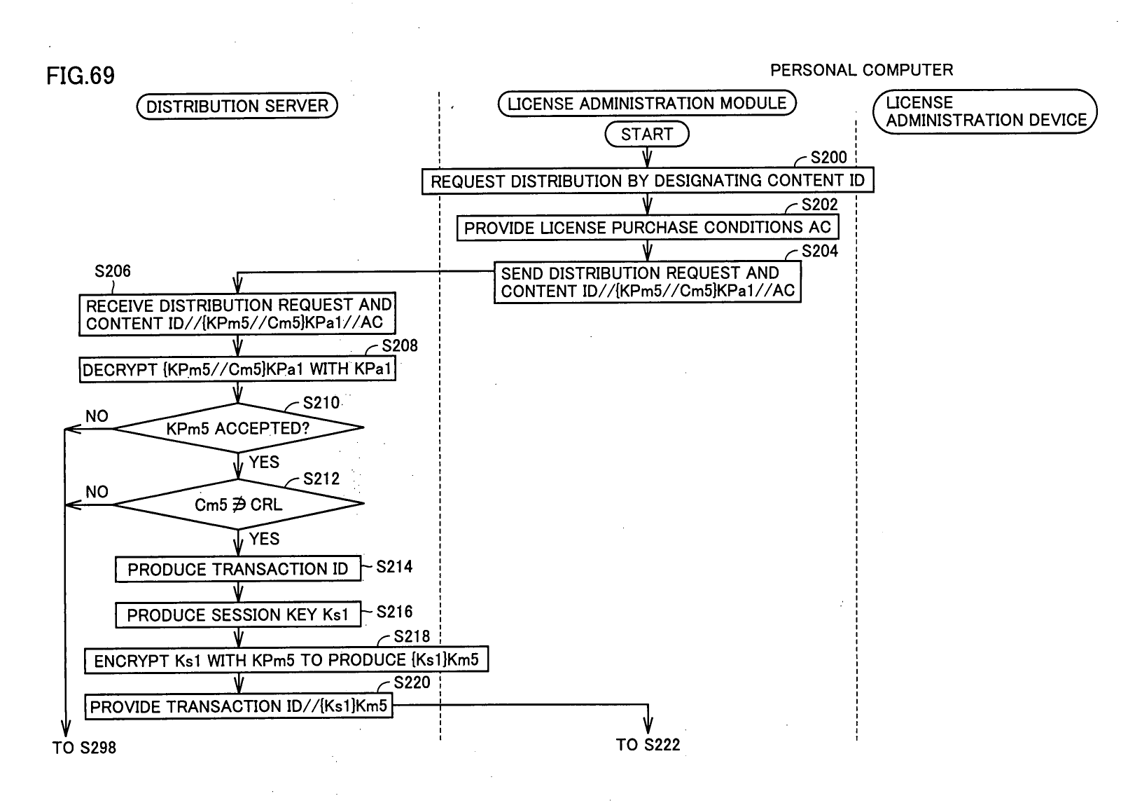

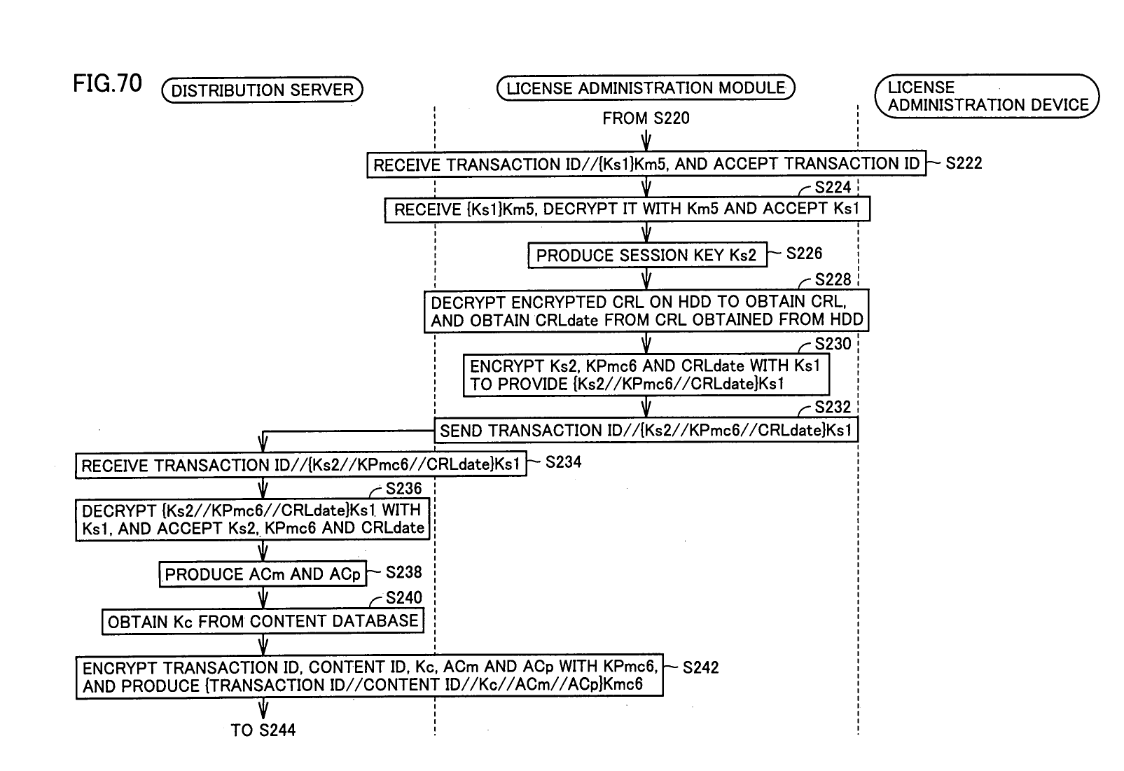

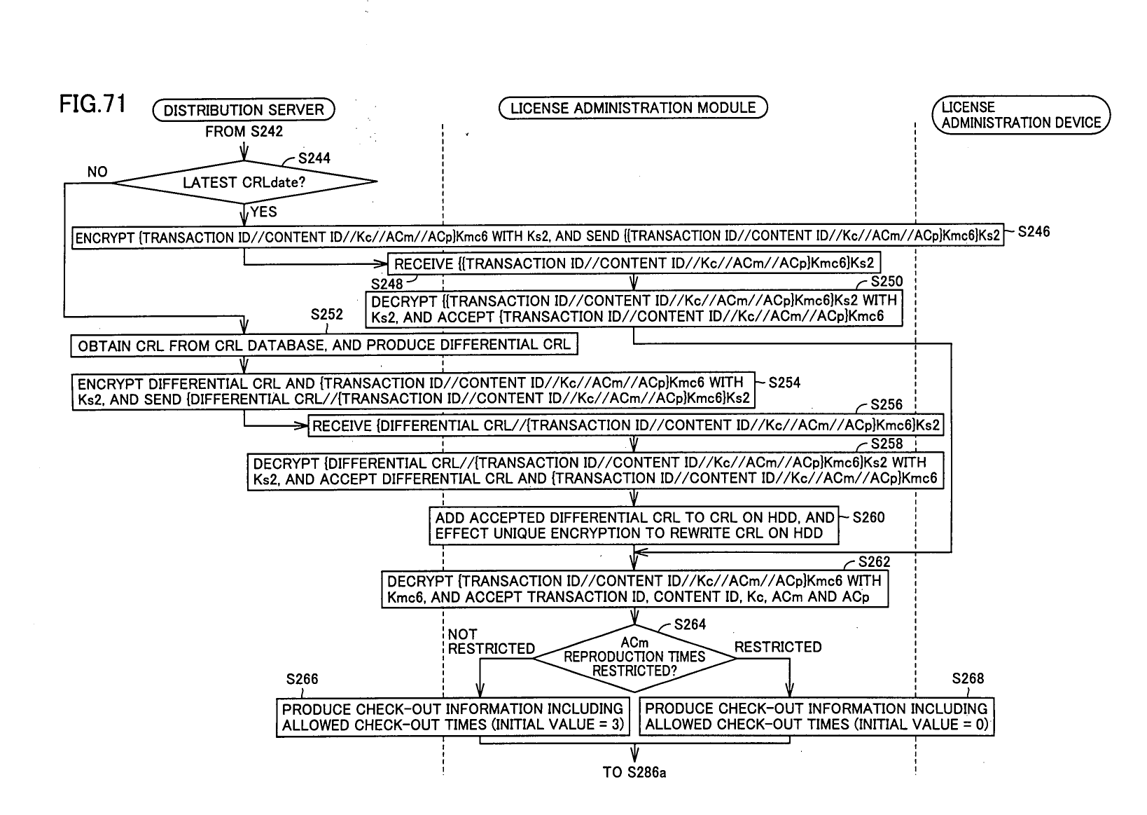

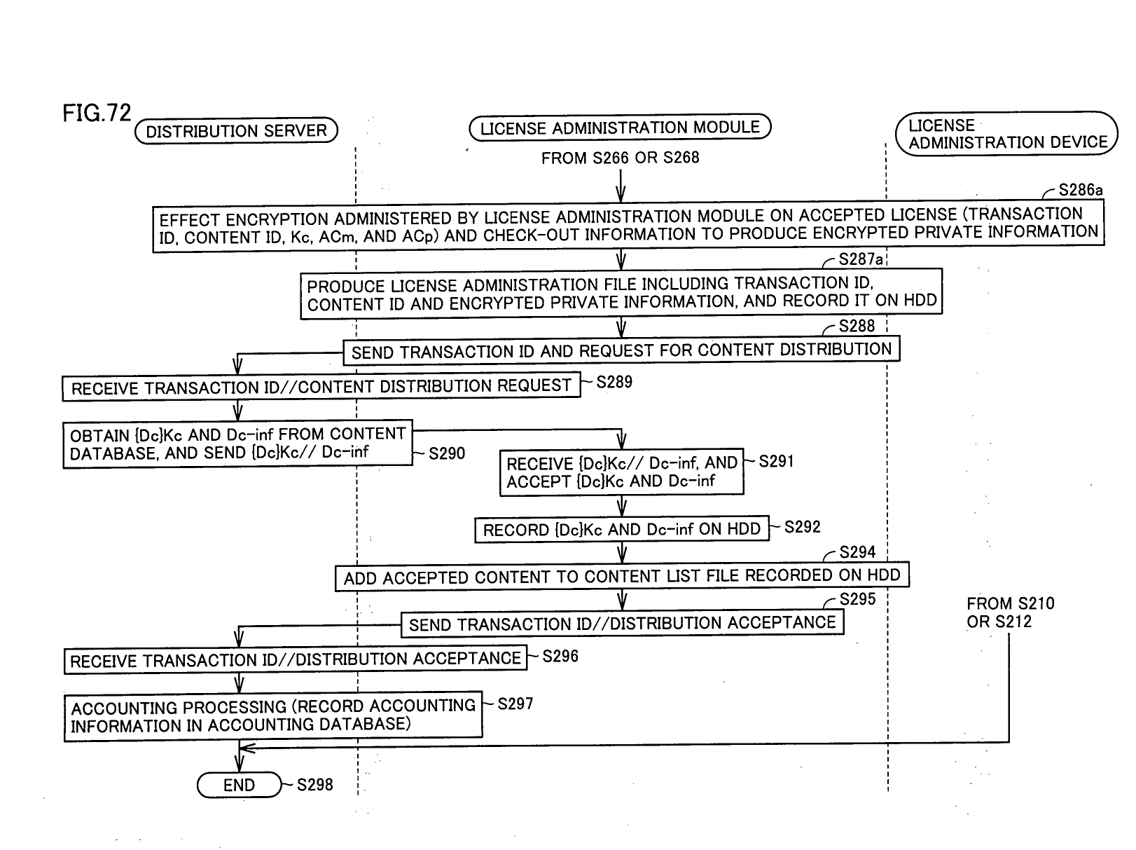

FIGS. 69-72 are first to fourth flow charts for illustrating the operation of receiving the encrypted content data and the license from distribution server 10 by license administration module 511, respectively. The flow charts of FIGS. 69-72 are the same as the flow charts of FIGS. 39-43 except for that the steps between steps S266 and S268 and step S288 are replaced with steps S286a-S287a. Referring to FIG. 72, after production of the check-out information in steps S266 and S268, license administration module 511 uniquely encrypts the accepted license (transaction ID, content ID, license key Kc, access control information ACm and reproduction control information ACp) and the check-out information to produce the encrypted private information (step S286a). License administration module 511 produces the license administration file, which includes the encrypted private information thus produced, transaction ID and content ID, and records it on hard disk 530 (step S287a). Thereafter, the operation moves to step S288, and the respective steps already described are executed so that the operation of distributing encrypted content data and the license ends.

[Ripping]

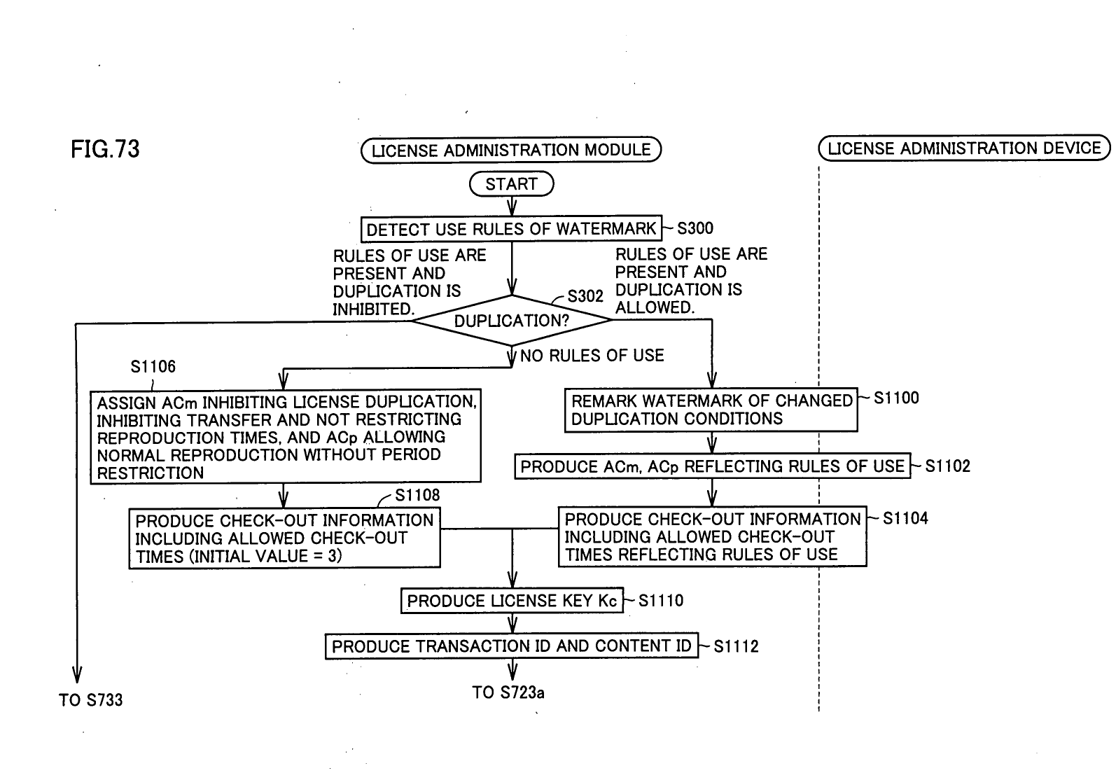

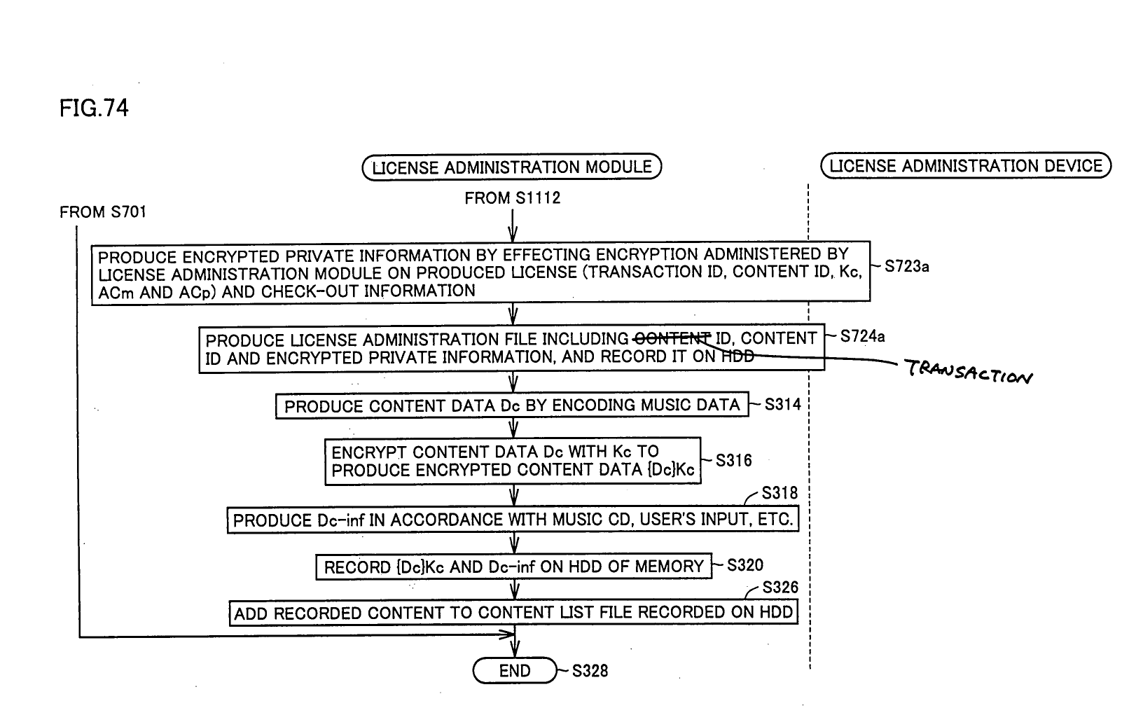

FIGS. 73 and 74 are first and second flow charts for illustrating the ripping operation of obtaining the encrypted content data and the license from music CD by license administration module 511 according to the third embodiment. The flow charts of FIGS. 73 and 74 are the same as the flow charts of FIGS. 44-46 except for that the steps between steps S1112 and S314 in the flow charts of FIGS. 44-46 are replaced with steps S723a-S724a. Referring to FIG. 74, after step S1112, license administration module 511 uniquely encrypts accepted license (transaction ID, content ID, license key Kc, access control information ACm and reproduction control information ACp) and the check-out information to produce the encrypted private file (step S723a). License administration module 511 produces the license administration file including the produced and encrypted private file, the transaction ID and the content ID, and records it on hard disk 530 (step S724a). Thereafter, the operation moves to step S314, and the respective steps already described are executed so that the operation of ripping the encrypted content data and the license ends.

[Check-Out]

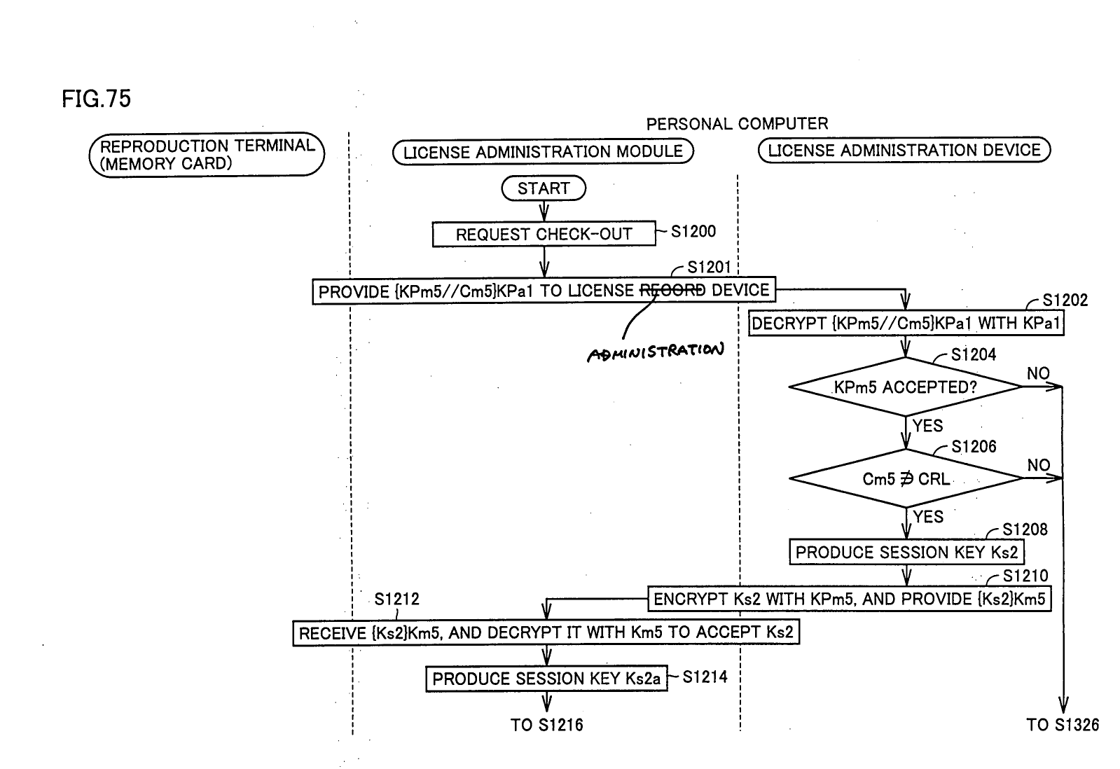

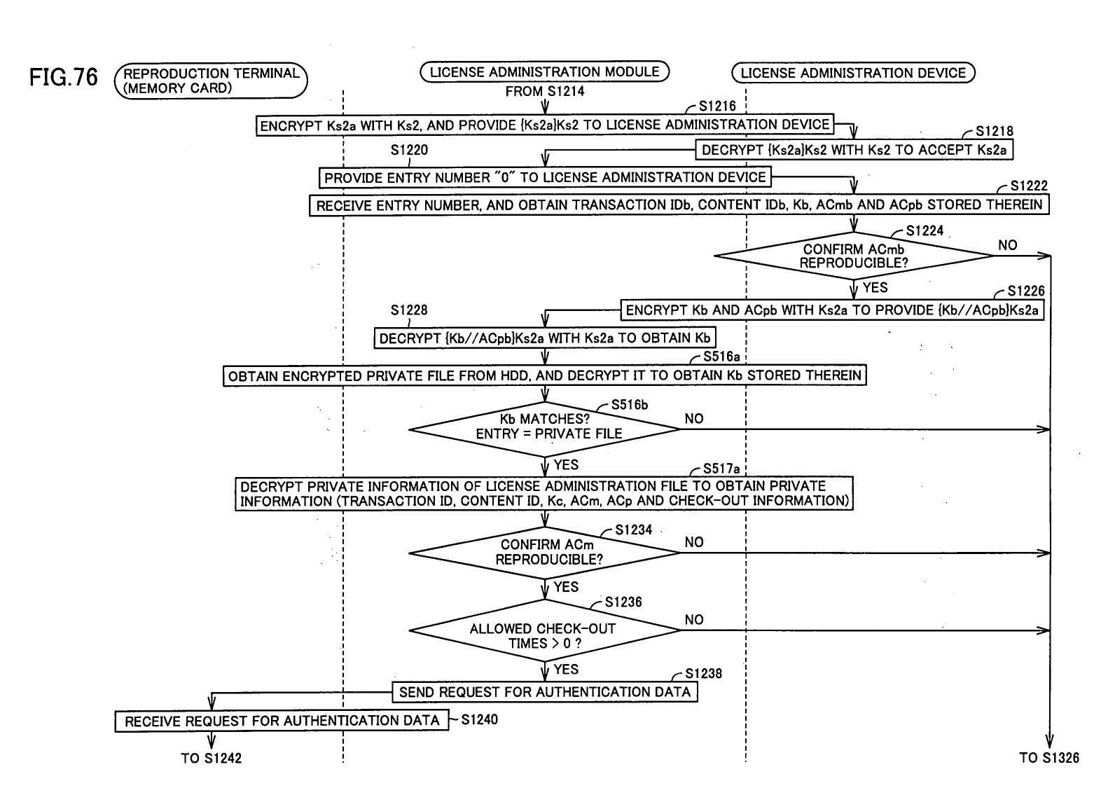

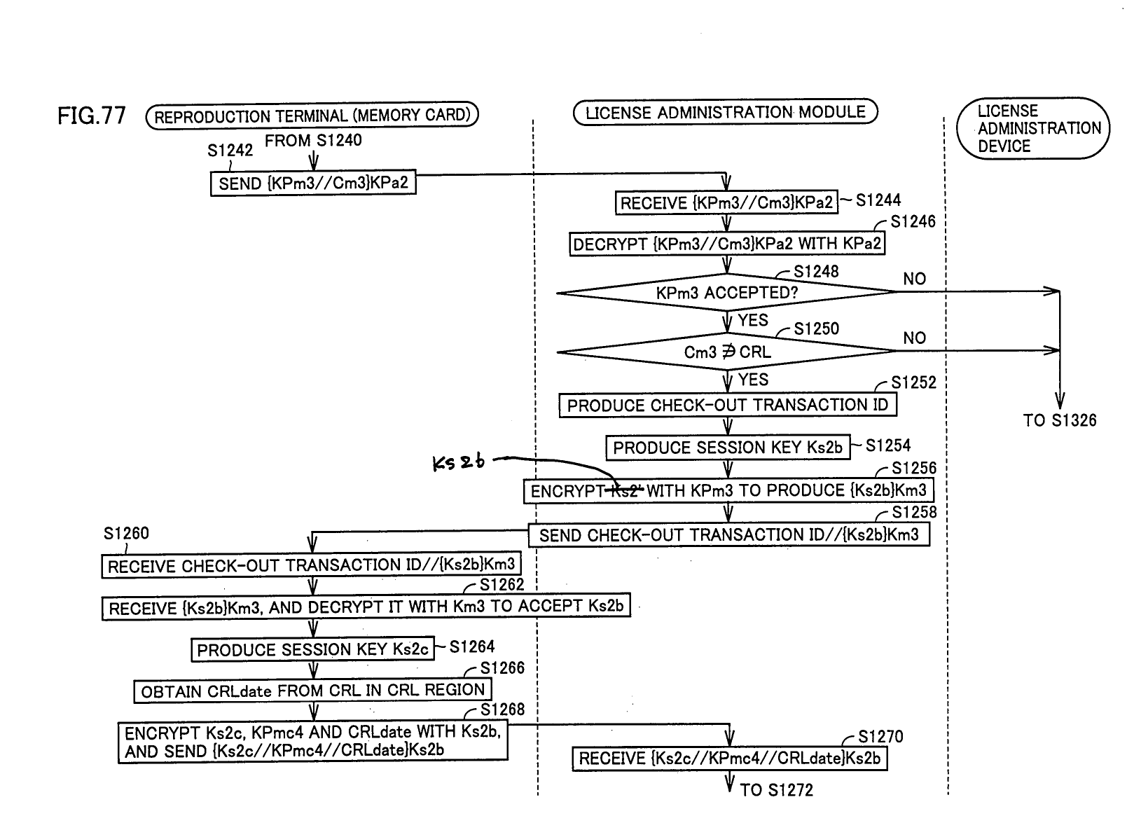

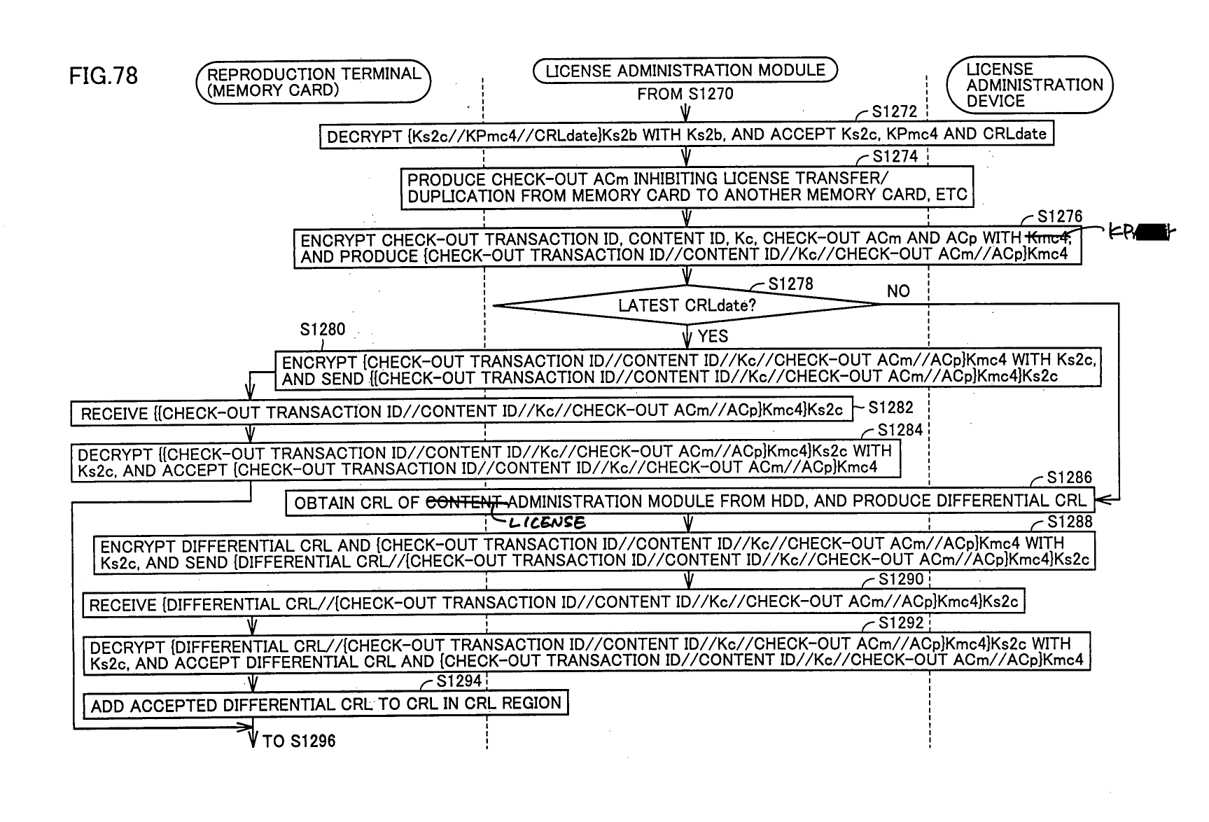

FIGS. 75-79 are first to fifth flow charts for illustrating the operation of checking out the encrypted content data and the license obtained by license administration module 511 to memory card 110 attached to reproduction terminal 102 according to the third embodiment. The flow charts of FIGS. 75-79 are the same as the flow charts of FIGS. 47-51 except for that steps S1230 and S1232 in the flow charts of FIGS. 47-51 are replaced with steps S516a, S516b and S517a, steps S1298, S1302 and S1304 are deleted, and steps S1308 and S1310 are replaced with steps S552a and 553a. After step S1228 in FIG. 76, license administration module 511 takes out encrypted private file 160 recorded on hard disk 530, and decrypts it to obtain binding key Kb stored therein (step S516a). License administration module 511 determines whether binding key Kb obtained from license administration device 520 matches with binding key Kb obtained from encrypted private file 160 or not. When these binding keys Kb do not match with each other, the operation moves to step S561, and the check-out operation ends. When these binding keys Kb match with each other, the operation moves to a next step S517a (step S516b).

When binding key Kb obtained from license administration device 520 matches with binding key Kb obtained from encrypted private file 160, the encrypted private file is obtained from the license administration file, and is decrypted to obtain the license (license key Kc, transaction ID, content ID, access control information ACm and reproduction control information ACp) (step S517a). Then, the operation moves to step S1234.

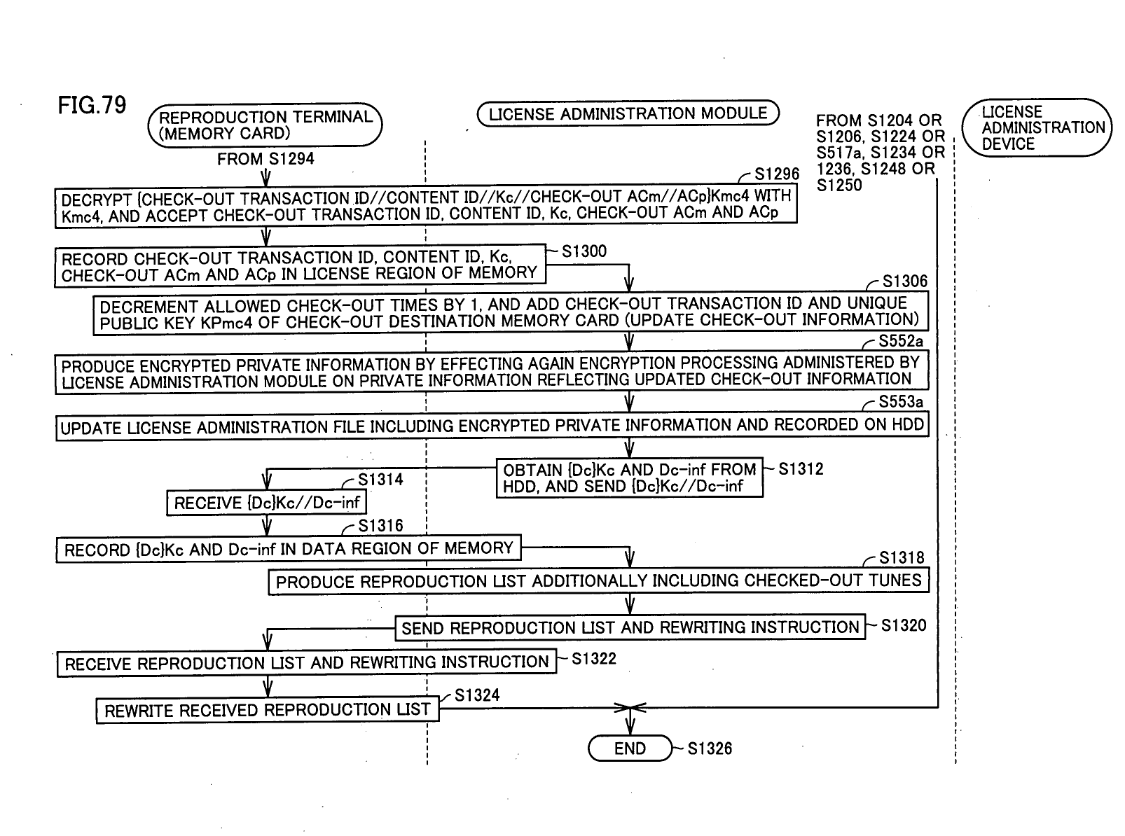

After step S1306 in FIG. 79, license administration module 511 uniquely encrypts the private information reflecting the undated check-out information to produce the encrypted private file (step S552a), and updates the license administration file including the encrypted private information (step S553a). Thereafter, the operation moves to step S554, and the respective steps already described are executed so that the operation of checking out the encrypted content data and the license ends.

As described above, only when the binding key stored in license administration device 520 matches with the binding key stored in encrypted private file 160, the license administration module obtains the encrypted content data and the license from the license administration file. According to the second embodiment, therefore, the binding key is used to administer substantially the license of the encrypted content data.

[Check-In]

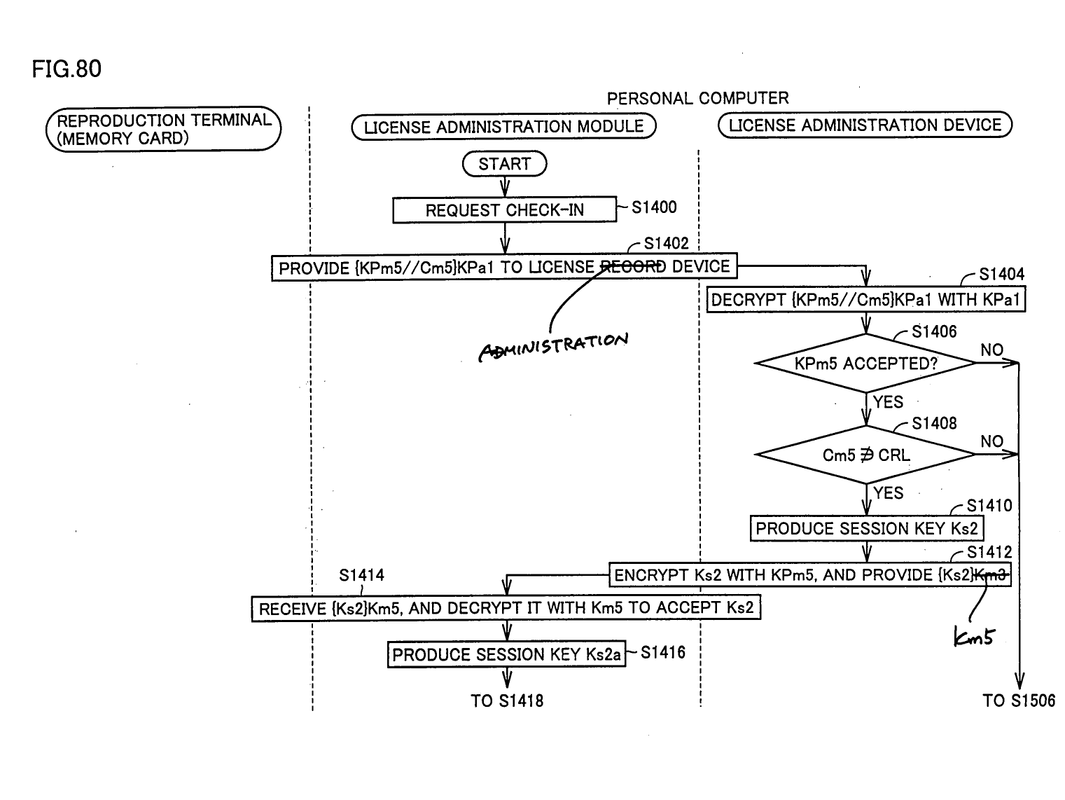

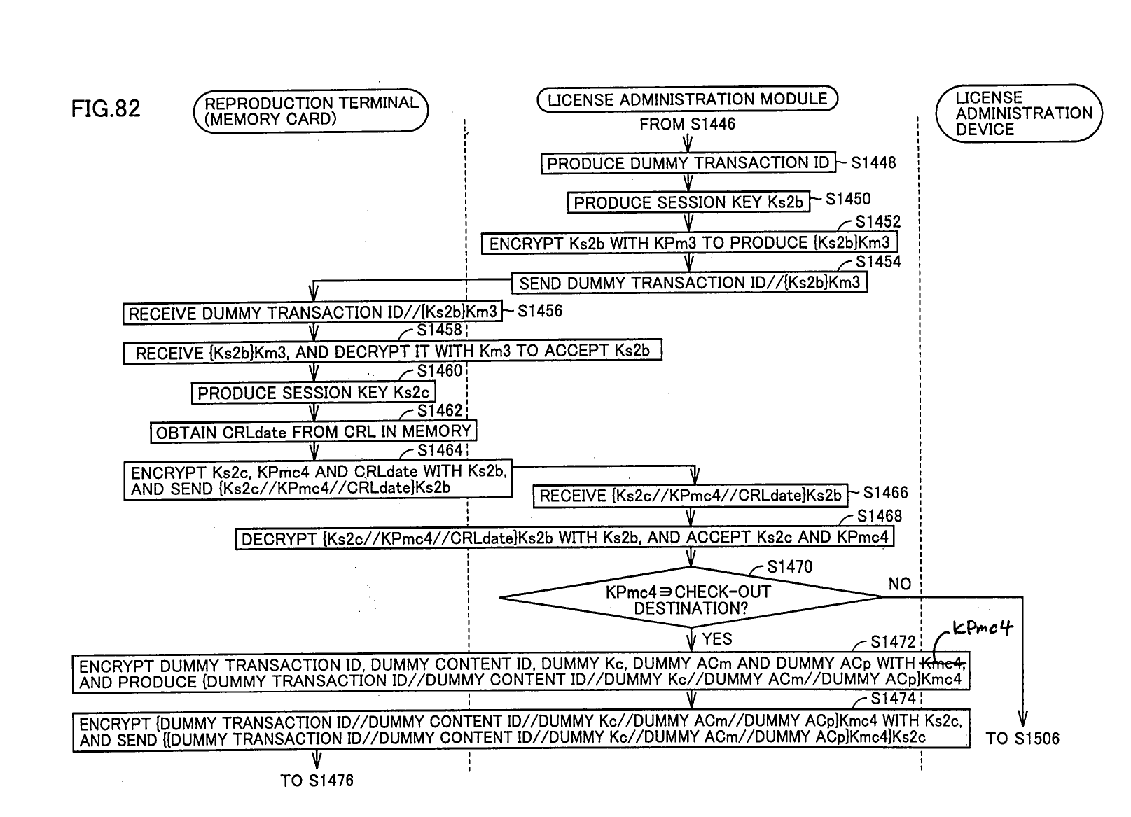

FIGS. 80-83 are first to fourth flow charts for illustrating the operation of check in the encrypted content data and the license, which were checked out to memory card 110 attached to reproduction terminal 102, by license administration module 511, respectively. The flow charts of FIGS. 80-83 are the same as the flow charts of FIGS. 52-55 except for that steps S1432 and S1434 in the flow charts of FIGS. 52-55 are replaced with steps S616a, 616b and 617a, and steps S1488 and S1490 are replaced with steps S644a and S645a.

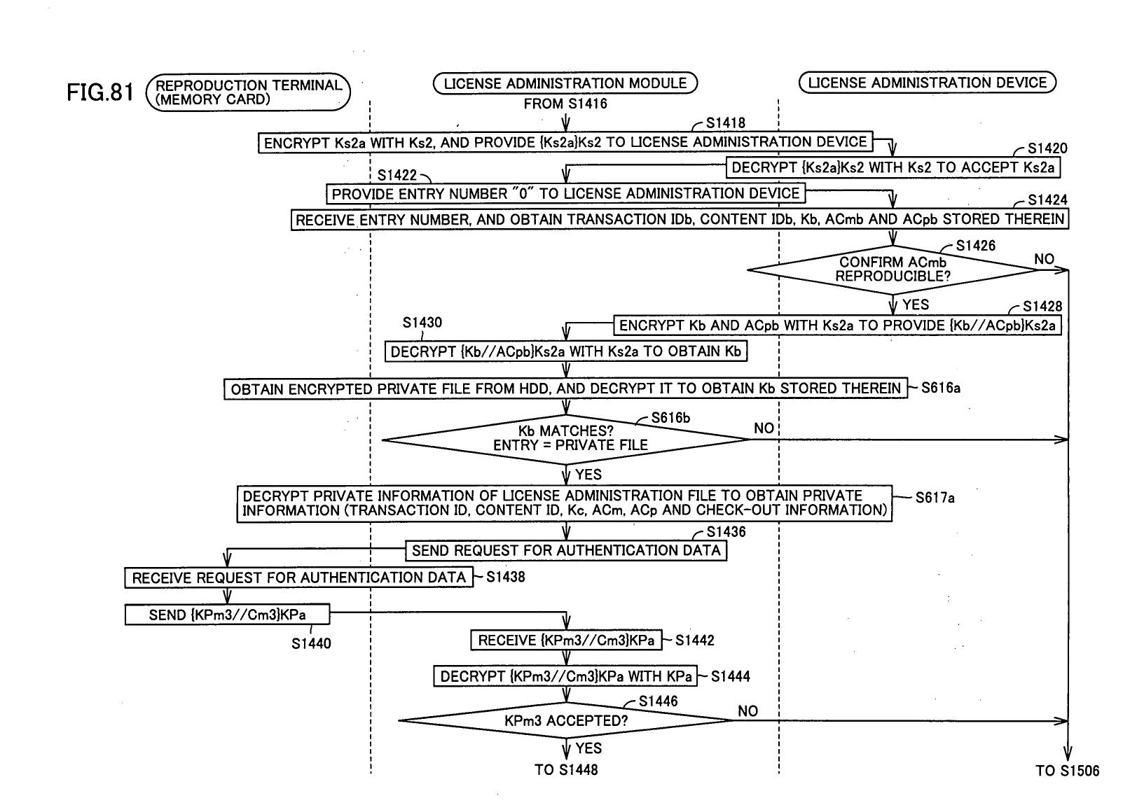

After step 1430 in FIG. 81, license administration module 511 obtains encrypted private file 160 recorded on hard disk 530, and decrypts it to obtain binding key Kb stored therein (step S616a). License administration module 511 determines whether binding key Kb obtained from license administration device 520 matches with binding key Kb obtained from encrypted private file 160 or not. When these binding keys Kb do not match with each other, the operation moves to step S1506, and the check-in operation ends. When these binding keys Kb match with each other, the operation moves to next step S1436 (step S616b).

When binding key Kb obtained from license administration device 520 matches with binding key Kb obtained from encrypted private file 160, the encrypted private file is obtained from the license administration file, and is decrypted to obtain the license (license key Kc, transaction ID, content ID, access control information ACm and reproduction control information ACp) (step S617a). Then, the operation moves to next step S1436.

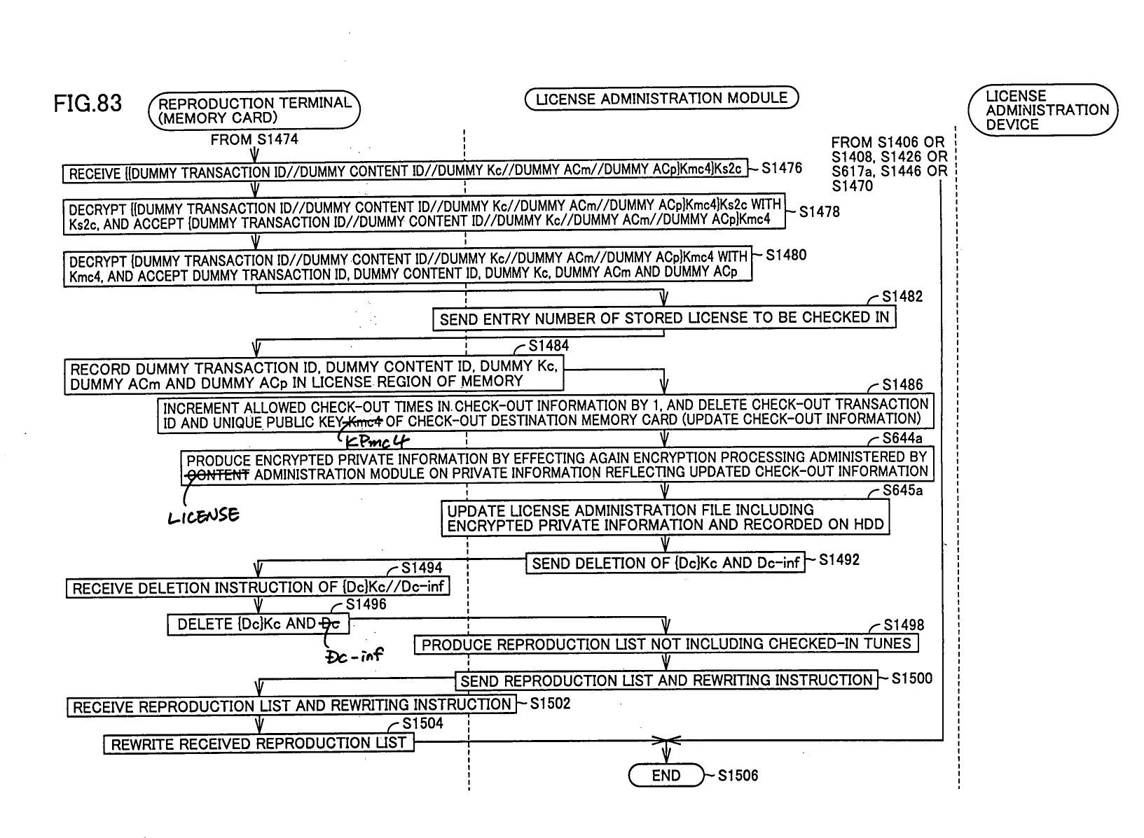

After step S1486 in FIG. 83, license administration module 511 uniquely encrypts the private information reflecting the updated check-out information to produce the encrypted private file (step S644a), and updates the license administration file including the encrypted private file (step S645a). Thereafter, the operation moves to step S1492, and the respective steps already described are executed. Thereby, the operation of checking in the encrypted content data and the license ends.

[Shift/Copy 3]

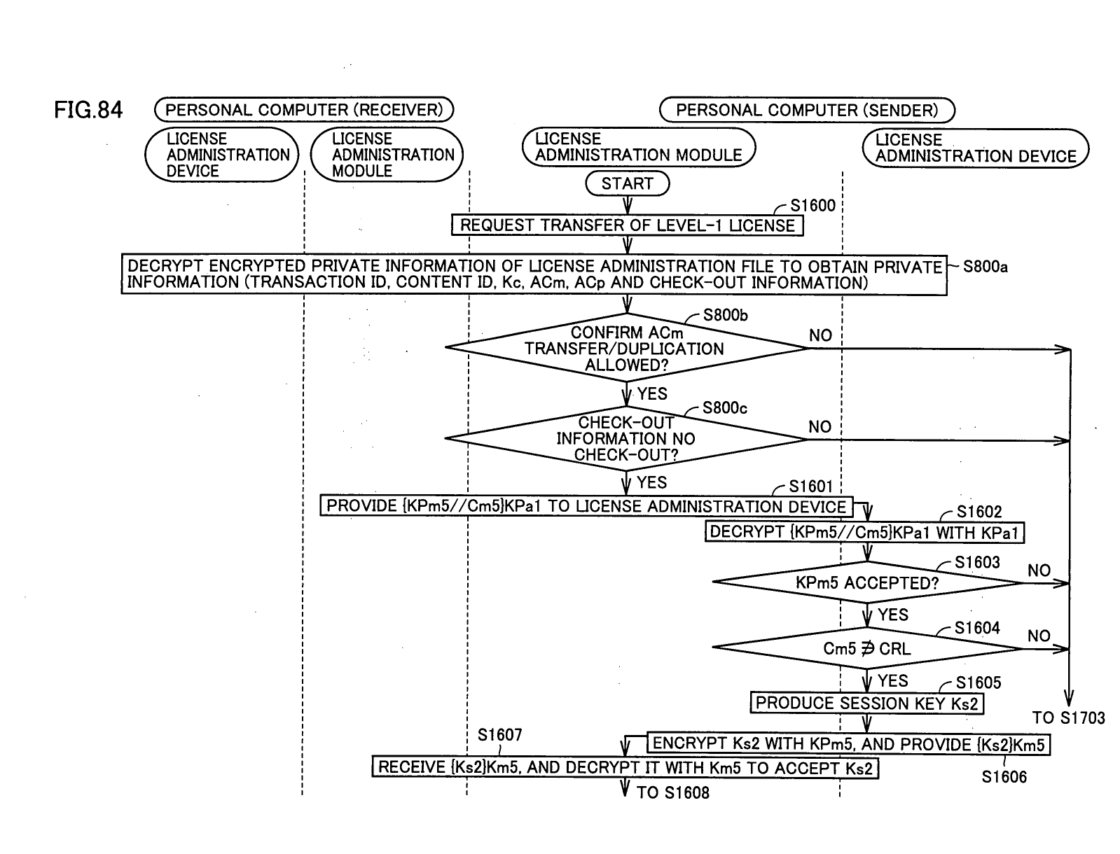

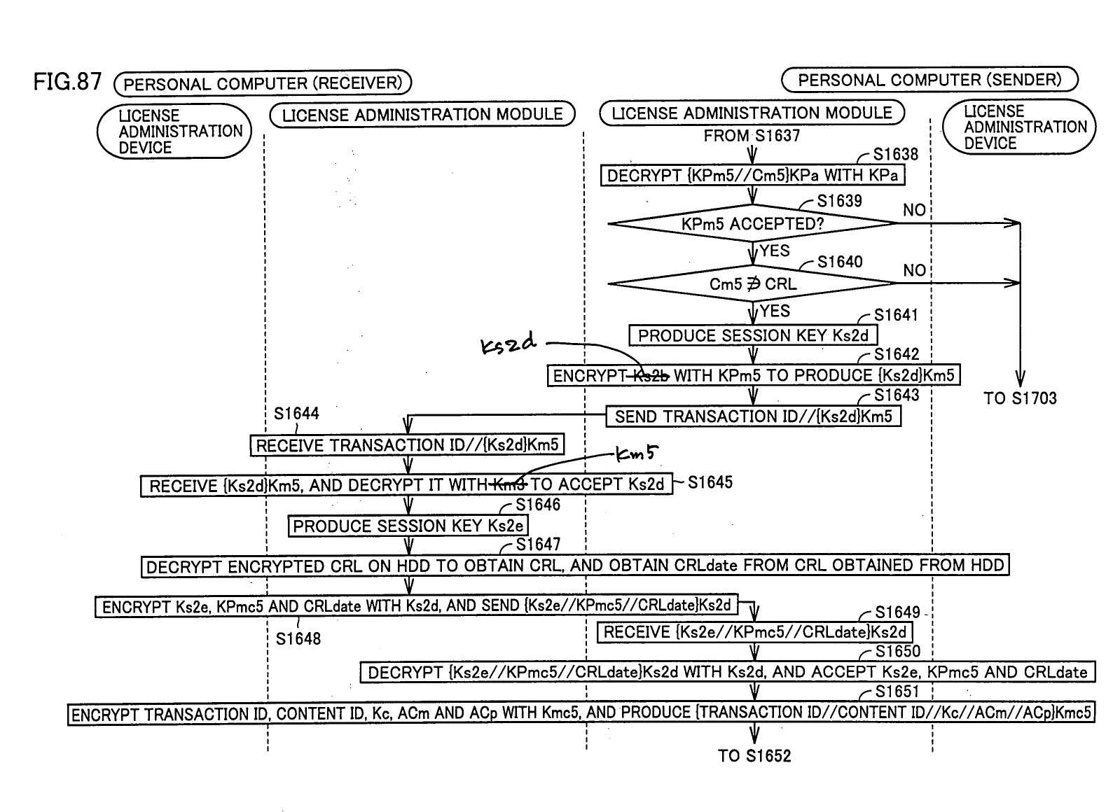

FIGS. 84-90 are first to seventh flow charts for illustrating the operation of shifting the encrypted content data and the license received by license administration module 511 from personal computer 50 to personal computer 80 according to the third embodiment, respectively. The flow charts of FIGS. 84-90 are the same as the flow charts of FIGS. 57-64 except for that steps S800a-S800c are inserted between steps S1600 and S1601 in the flow charts of FIGS. 57-64, the steps between steps S1615 and S1620 are replaced with steps S816a and S817a, step S1667 is replaced with steps S867a and S867b, and the steps between steps S1662 and S1663 and step S1698 are replaced with steps S895a-S896a.

After step S1600 in FIG. 84, license administration module 511 decrypts the encrypted private file of the license administration file to obtain the private information (transaction ID, content ID, license key Kc, access control information ACm, reproduction control information ACp and check-out information) (step S800a); License administration module 511 determines, based on access control information ACm obtained in step S800a, whether the shift and copy of the encrypted content data and the license are allowed or not. When license administration module 511 determines that the shift and copy of the encrypted content data and the license are inhibited, the operation moves to step S1703, and the shift operation ends. When the shift and copy of the encrypted content data and the license are not inhibited, the operation moves to step S800c (step S800b).

When the shift and copy of the encrypted content data and the license are allowed, license administration module 511 determines, based on the check-out information, whether the check-out is allowed or not. When the check-out is not allowed, the operation moves to step S1703, and the shift/copy operation ends. When the check-out is allowed, the operation moves to step S1601.

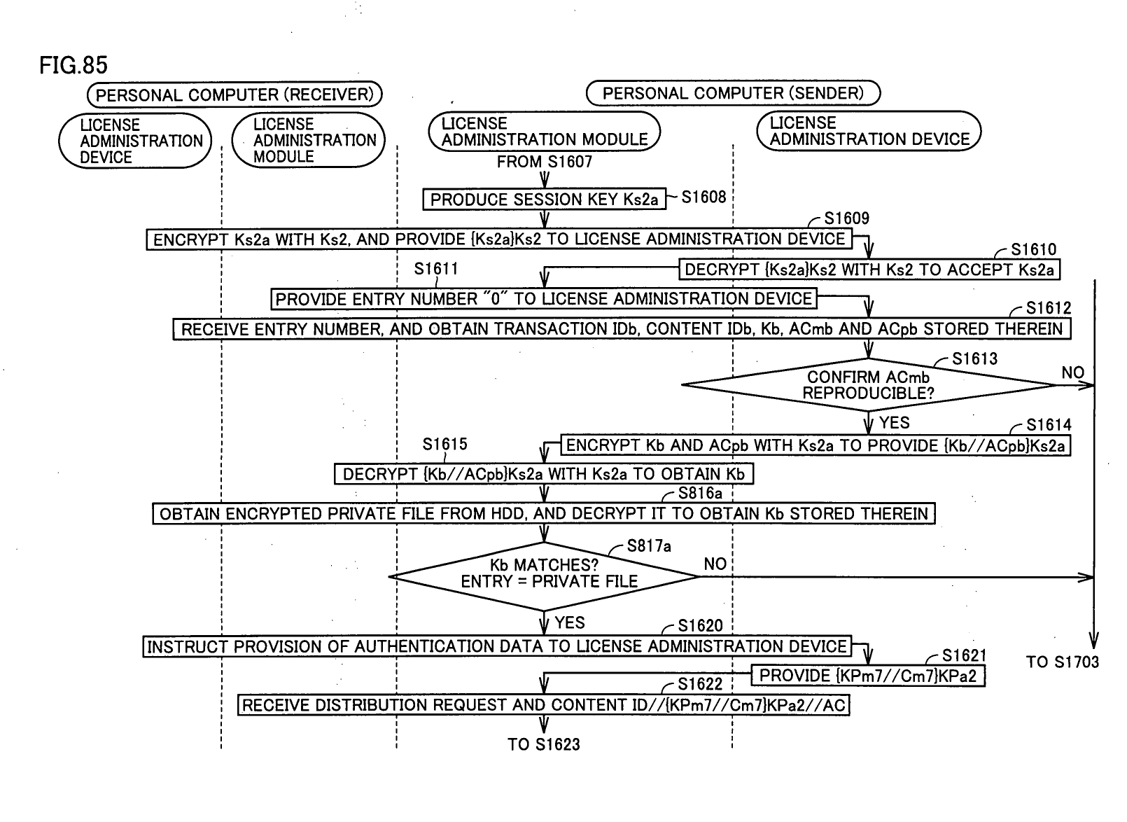

After step S1615 in FIG. 85, license administration module 511 obtains encrypted private file 160 recorded on hard disk 530 to obtain binding key Kb stored therein (step S816a). License administration module 511 determines whether binding key Kb obtained from license administration device 520 matches with binding key Kb obtained from encrypted private file 162 or not. When these binding keys Kb do not match with each other, the operation moves to step S1703, and the shift operation ends. When these binding keys Kb match with each other, the operation moves to step S1620 (step S817a).

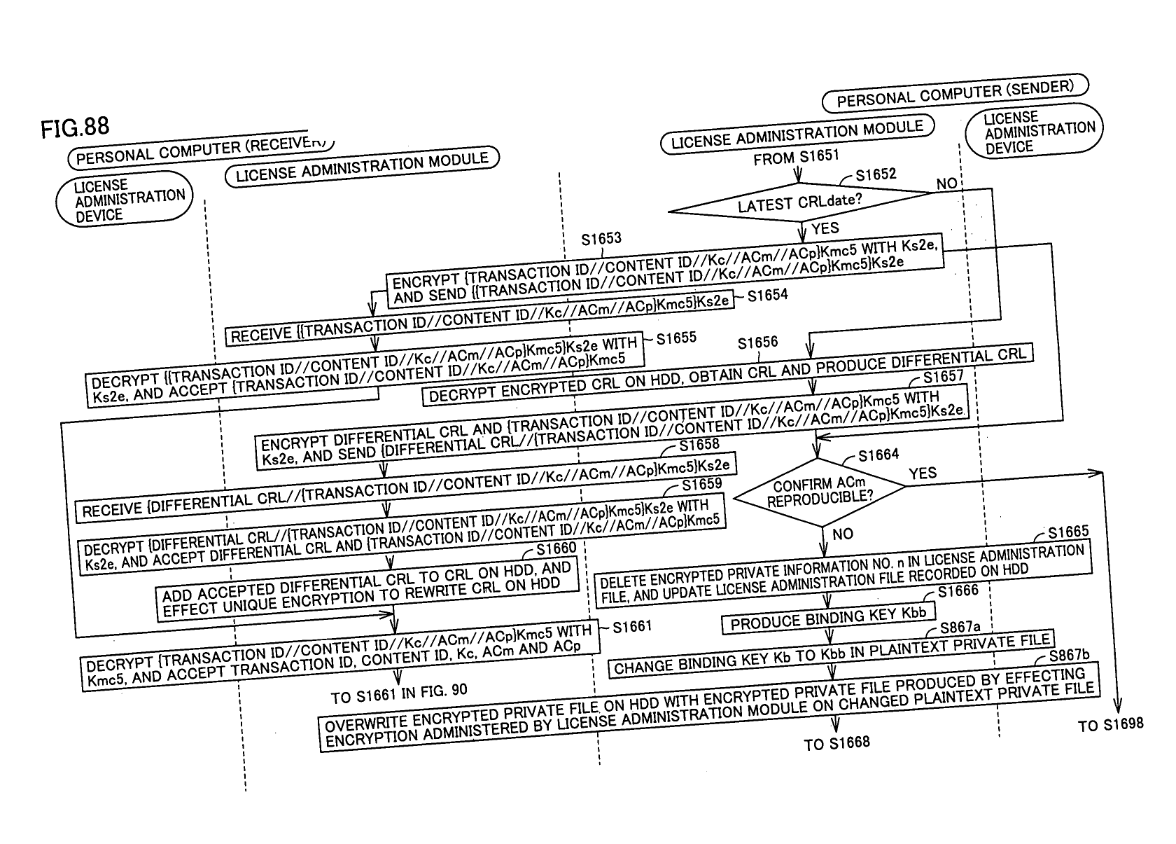

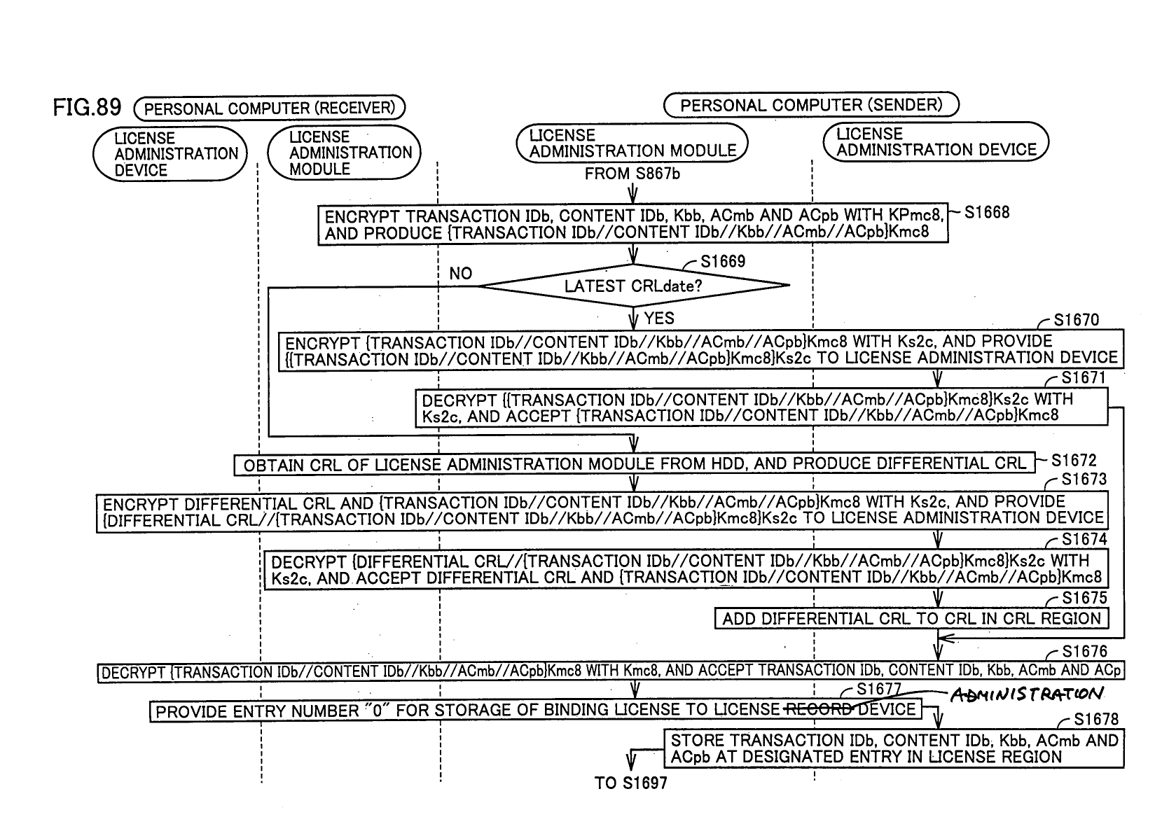

After step S1666 in FIG. 88, license administration module 511 writes binding key Kb over binding key Kbb stored in the plaintext of the private file (step S867a), produces the encrypted private file by unique encryption, and writes the encrypted private file thus produced over encrypted private file 160 on hard disk 530 to provide new encrypted private file 160 (step S867b). Then, the operation moves to step S1668 in FIG. 89.

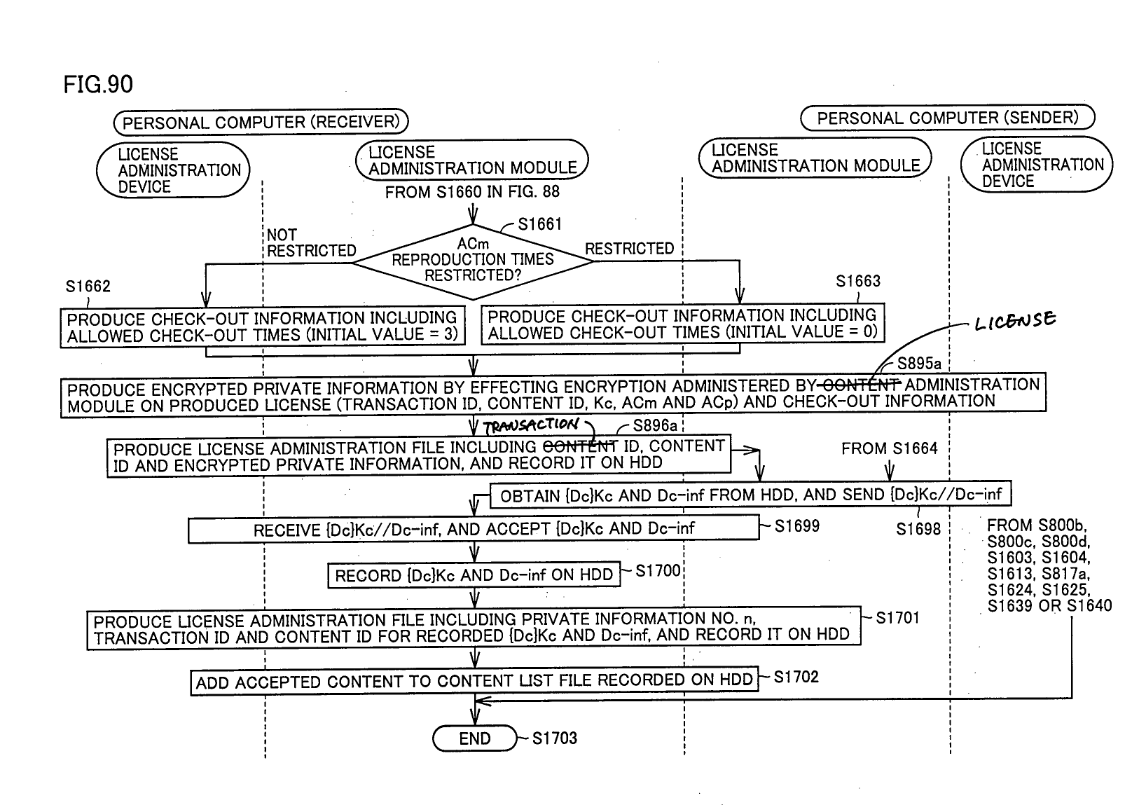

In steps S1662 and S1663 illustrated in FIG. 90, after the check-out information is prepared, license administration module 511 uniquely encrypts the accepted license (transaction ID, content ID, license key Kc, access control information ACm and reproduction control information ACp) and the check-out information to produce the encrypted private file (step S895a). License administration module 511 produces the license administration file including the encrypted private file thus produced, transaction ID and content ID, and records it on hard disk 530 (step S896a). Thereafter, the operation moves to step S1698, and the respective steps already described are executed. Thereby, the operation of distributing the encrypted content data and the license ends.

Processing and operations other than the above are the same as those in the second embodiment.

According to the third embodiment, the license administration module incorporated in the personal computer administers the license of the encrypted content data, which is obtained by software, with the binding key administered by hardware in the license administration device. Therefore, similarly to the license of the encrypted content data obtained by the license administration device, the encrypted content data and the license can be sent to another computer according to the concept of “shift/copy”.

In the second and third embodiments, license administration device 520 can store the binding license and the distributed license. However, it may serve as a administration device dedicated to the binding license.

In the description of the first and second embodiments already given, the binding key is changed only when the license is changed in the shift/copy operation. For safer administration, however, the system may be configured to change the binding key even when the check-out information is changed in the check-out and check-in operations. This can improve the safety in the check-out and check-in operations to attain the same safety level as that in the shift/copy operation.

This can be achieved, for example, in the check-out operation according to the first embodiment by such a manner that the authentication processing of the license administration device from step S1620 in FIG. 58 to step S1633 in FIG. 59 is added between steps S1228 and 1230 in FIG. 48, the binding key production processing in step S1667 is added between steps S1308 and S1310 in FIG. 51, and the binding key registration processing from step S1669 to step S1679 in FIG. 62 is added between steps S1310 and S1312 in FIG. 51. The above can also be achieved in the check-in operation by such a manner that the authentication processing of the license administration device from step S1620 in FIG. 58 to step S1633 in FIG. 59, the binding key production processing in step S1667 in FIG. 61, and the binding key registration processing from step S1669 to step S1679 in FIG. 62 are added between steps S1430 and S1432 in FIG. 53, between steps S1488 and S1490 in FIG. 55 and between steps S1490 and S1492, respectively.

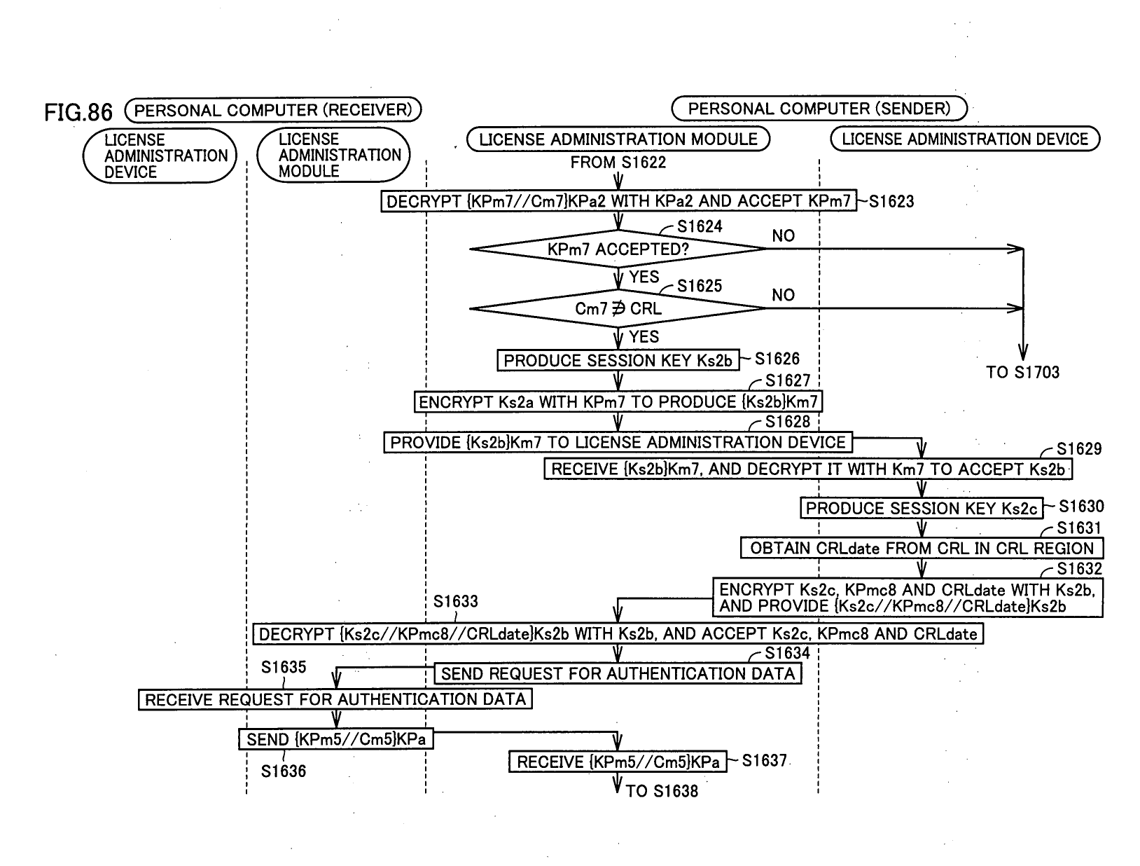

According to the second embodiment, the foregoing safety improvement can be achieved by such a manner that the authentication processing of the license administration device from step S1620 in FIG. 85 to step S1633 in FIG. 86, the binding key production processing in steps. S1666 and S867a in FIG. 88, and the binding key registration processing from step S1668 to step S1678 in FIG. 89 are added, as series of processing, between steps S516b and 517a in FIG. 76 in the case of check-out operation, and between steps S616b and 617a in FIG. 81 in the case of check-in operation, respectively.

Although the entry number of designating the binding license is designated, a dedicated entry may be provided for distinguish it from the license at a high level.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

According to the invention, the data terminal device administers the license of the encrypted content data, which is obtained by software in the incorporated license administration module, with the binding key administered by hardware in the license administration device, and sends the encrypted content data and the license obtained to another personal computer according to the concept of “shift” similarly to the license of the encrypted content data obtained by the license administration device. Therefore, the invention can be applied to the data terminal device, which can shift the license of the encrypted content data obtained by software to another data terminal device.

1. A data terminal device obtaining encrypted content data prepared by encrypting content data and a license for decrypting said encrypted content data to obtain original plaintext, and providing said encrypted content data and said license to another data terminal device, comprising:
a module unit administering the obtaining, storing and providing of said license;
a device unit producing an encrypted private file by encrypting a private file including a plurality of licenses, and storing a binding license including a binding key for decrypting said encrypted private file to extract the private file in a dedicated region;
a storing unit storing data; and
a control unit, wherein
said storing unit stores:
a plurality of encrypted content data, and
an encrypted private file including said plurality of license, and encrypted with said binding key;
in providing said license,
said control unit reads said encrypted private file from said storing unit, and provides said encrypted private file to said module unit;
said module unit obtains the binding license from said device unit, extracts the binding key from the obtained binding license, and provides the license obtained by decrypting said encrypted private file with the extracted binding key.

2. The data terminal device according to claim 1, wherein
in initializing said encrypted private file,
said module unit produces said binding license including said binding key, produces a private file not including said license, encrypts the produced private file with said produced binding key to produce said encrypted private file, and provides said produced binding license to said device unit, and
said control unit stores said encrypted private file produced by said module unit in said storing unit.

3. The data terminal device according to claim 1, wherein
in obtaining said license,
said control unit provides the obtained license to said module unit, reads said encrypted private file stored in said storing unit, and provides the read encrypted private file to said module unit,
said module unit obtains said binding license from said device unit, decrypts said provided and encrypted private file with said binding key included in said binding license obtained from said device unit, adds said provided license to the decrypted private file to update said private file, and encrypts the updated private file with said binding key to produce the updated and encrypted private file, and
said control unit overwrites said encrypted private file stored in said storing unit with said encrypted private file produced and updated by said module unit.

4. The data terminal device according to claim 1, wherein
in providing said license,
said control unit provides said encrypted content data corresponding to said license and stored in said storing unit to a provision destination of said license.

5. The data terminal device according to claim 1, wherein
after providing said license,
said module unit produces one new binding key, produces one new binding license including the produced one new binding key, produces one new encrypted private file by encrypting said private file with said one new binding key, and provides said produced one new binding license to said device unit,
said device unit stores said received one new binding license in said dedicated region by overwriting, and
said control unit overwrites said encrypted private file stored in said storing unit with said one new encrypted private file produced by said module unit.

6. The data terminal device according to claim 1, wherein
in providing said license to said different data terminal device,
said control unit receives authentication data from said different data terminal device, and provides said authentication data to said module unit;
when said module unit authenticates the received authentication data, said module unit constructs an encryption path to said different data terminal device via said control unit, and provides said extracted license to said different data terminal device via said encryption path; and
after providing the license,
said module unit produces one new binding key, produces one new binding license including the produced one new binding key, deletes the sent license from said private file, encrypts the private file previously including said sent and deleted license with said one new binding key to produce one new encrypted private file, and provides said produced one new binding license to said device unit,
said device unit stores said received one new binding license in said dedicated region by overwriting, and
said control unit overwrites said encrypted private file stored in said storing unit with said one new encrypted private file produced by said module unit.

7. The data terminal device according to claim 1, wherein
in obtaining said binding license from said device unit,
said module unit provides authentication data peculiar to said module unit itself to said device unit, constructs an encryption communication path to said device unit in response to authentication of said authentication data by said device unit, and obtains said binding license from said device unit via the constructed encryption communication path.

8. The data terminal device according to claim 1, wherein
in providing said binding license to said device unit,
said module unit receives the authentication data from said device unit, constructs an encryption communication path to said device unit in response to authentication of the received authentication data, and provides said binding license to said device unit via the constructed encryption communication path.

9. The data terminal device according to claim 3, wherein
in obtaining said encrypted content data and said license from said distribution server connected over a data communication network,
said control unit obtains said encrypted content data from said distribution server over said data communication network, and
said module unit provides the authentication data peculiar to said module unit itself via said control unit and over said data communication network, constructs an encryption communication path to said distribution server, and obtains said license from said distribution server via the constructed encryption communication path.

10. The data terminal device according to claim 1, wherein
when the content data is obtained,
said control unit provides the obtained content data to said module unit, reads said encrypted private file stored in said storing unit, and provides the read encrypted private file to said module unit,
said module unit produces a license for said provided content data, produces encrypted content data by encrypting said provided content data with said produced license in a reproducible manner, obtains said binding license from said device unit, decrypts said provided and encrypted private file with the binding key included in said obtained binding license, updates said private file by newly adding said produced license to the decrypted private file, produces the updated and encrypted private file by encrypting the updated private file with said binding key, and
said control unit overwrites said encrypted private file stored in said storing unit with said updated and encrypted private file produced by said module unit, and stores the encrypted content data produced by said module unit in said storing unit.

11. The data terminal device according to claim 1, wherein
said encrypted private file includes, for each license, check-out information for checking out said license to a data recording device,
in providing said license to said data recording device,
said control unit receives authentication data from said data recording device, and provides the received authentication data to said module unit,
when said module unit authenticates the authentication data received from said data recording device, said module unit constructs an encryption path to said data recording device via said control unit, obtains the binding license from said device unit, extracts said license to be provided and said check-out information from the decrypted private file, produces a check-out license to be checked out to said data recording device based on said license to be provided when it is determined from the extracted check-out information that check-out of the license is allowed, constructs an encryption path to said data recording device via said control unit, provides said check-out license to said data recording device via said encryption path, obtains specifying information for specifying said data recording device via said encryption path, produces new check-out information by adding the obtained specifying information to said check-out information, produces one new private file by overwriting said check-out information of said private file with said new check-out information, and produces one new encrypted private file by encryption with said binding key, and
said control unit overwrites the encrypted private file stored in said storing unit with said one new encrypted private file produced by said module unit.

12. The data terminal device according to claim 1, wherein
said encrypted private file includes, for each license, check-out information for checking out said license to a data recording device,
in providing said license to said data recording device,
said control unit receives authentication data from said data recording device, and provides the received authentication data to said module unit,
when said module unit authenticates the authentication data received from said data recording device, said module unit constructs an encryption path to said data recording device via said control unit, extracts said license to be provided and said check-out information from the decrypted private file, produces a check-out license to be checked out to said data recording device based on said license to be sent when it is determined from the extracted check-out information that check-out of the license is allowed, provides said check-out license to said data recording device via said encryption path, and obtains specifying information for specifying said data recording device via said encryption path,
after providing said license,
said module unit produces one new binding key, produces one new binding license including the produced new binding key, produces new check-out information by adding said obtained specifying information to said check-out information, produces one new private file by overwriting said check-out information of said private file with said new check-out information, produces one new encrypted private file by encrypting said produced one new private file with said one new binding key, and provides said produced one new binding license to said device unit,
said device unit stores the received one new binding license in said dedicated region by overwriting, and
said control unit overwrites said encrypted private file stored in said storing unit with said one new encrypted private file produced by said module unit.

13. A data terminal device obtaining encrypted content data prepared by encrypting content data and a license for decrypting said encrypted content data to obtain original plaintext, and providing said encrypted content data and said license to another data terminal device, comprising:
a module unit administering the obtaining, storing and providing of said license, producing a dedicated license including said license and encrypted suitably to the administration, and decrypting said dedicated license;
a device unit storing a binding license including a binding key in a dedicated region;
a storing unit storing data; and
a control unit, wherein
said storing unit stores:
a plurality of encrypted content data,
a plurality of administration files including said dedicated license, and
an encrypted private file encrypted uniquely and including said binding license as a component;
in providing said license,
said control unit reads said encrypted private file and said administration files from said storing unit, and provides said encrypted private file and said administration files to said module unit;
said module unit extracts the binding license by decrypting said encrypted private file, obtains the binding license from said device unit, and provides the license obtained by decrypting the dedicated license included in said administration files when said obtained binding license matches with the binding license extracted from said encrypted private file.

14. The data terminal device according to claim 13, wherein
in initializing said encrypted private file,
said module unit produces said binding license including said binding key, produces a private file storing said produced binding license, uniquely encrypts the produced private file to produce said encrypted private file, and provides said produced binding license to said device unit, and
said control unit stores said encrypted private file produced by said module unit in said storing unit.

15. The data terminal device according to claim 13, wherein
in obtaining said license,
said control unit provides the obtained license to said module unit, produces said dedicated file including the dedicated license produced by said module unit, and stores said dedicated file
in said storing unit, and
said module unit uniquely encrypts said provided license to produce said dedicated license.

16. The data terminal device according to claim 13, wherein
in providing said license,
said control unit sends the encrypted content data corresponding to said license and stored in said storing unit to a destination of said license.

17. The data terminal device according to claim 13, wherein
after providing said license,
said module unit produces one new binding key, produces one new binding license including the produced one new binding key, produces one new private file including said produced one new binding license, produces one new encrypted private file by uniquely encrypting said produced one new private file, and provides said produced one new binding license to said device unit,
said device unit stores said received one new binding license in said dedicated region by overwriting, and
said control unit overwrites said encrypted private file stored in said storing unit with said one new encrypted private file produced by said module unit, and deletes the administration file including said license.

18. The data terminal device according to claim 13, wherein
in providing said license to said different data terminal device,
said control unit receives authentication data from said different data terminal device, and provides said authentication data to said module unit, and
said module unit constructs an encryption path to said different data terminal device via said control unit when the authentication data received from said different data terminal device is authenticated, and provides the license obtainable by decrypting said provided and dedicated license to said different data terminal device via said encryption path;
after providing the license,
said module unit produces one new binding key, produces one new binding license including the produced one new binding key, produces one new private file including the produced one new binding license, produces one new encrypted private file by uniquely encrypting said produced one new private file, and provides said produced one new binding license to said device unit,
said device unit stores said received one new binding license in said dedicated region by overwriting, and
said control unit overwrites said encrypted private file stored in said storing unit with said one new encrypted private file produced by said module unit, and deletes the administration file including said license.

19. The data terminal device according to claim 13, wherein a manner of said uniquely encrypting the file is linked with information peculiar to data terminal device and obtainable from the data terminal device.

20. The data terminal device according to claim 13, wherein
in providing said binding license to said device unit,
said module unit receives authentication data from said device unit, constructs an encryption communication path to said device unit in response to authentication of the received authentication data, and provides said binding license to said device unit via the constructed encryption communication path.

21. The data terminal device according to claim 13, wherein
in obtaining said binding license from said device unit,
said module unit provides authentication data peculiar to said module unit itself to said device unit, constructs an encryption communication path to said device unit in response to authentication of said authentication data by said device unit, and obtains said binding license from said device unit via the constructed encryption communication path.

22. The data terminal device according to claim 15, wherein
in obtaining said encrypted content data and said license from said distribution server connected over a data communication network,
said control unit obtains said encrypted content data from said distribution server over said data communication network, and
said module unit provides the authentication data peculiar to said module unit itself via said control unit and over said data communication network, constructs an encryption communication path to said distribution server, and obtains said license from said distribution server via the constructed encryption communication path.

23. The data terminal device according to claim 13, wherein
when the content data is obtained,
said control unit provides the obtained content data to said module unit, produces said administration file including said dedicated license produced by said module unit, and writes the produced administration file and the encrypted content data produced by said module unit in said storing unit, and
said module unit produces a license for said obtained content data, produces encrypted content data by encrypting said obtained content data with said produced license in a reproducible manner, and produces said dedicated license including said produced license.

24. The data terminal device according to claim 13, wherein
said dedicated license includes check-out information for checking out said license to a data recording device; and
in providing said license to said data recording device,
said control unit receives authentication data from said data recording device, and provides the received authentication data to said module unit,
said module unit produces a check-out license to be checked out to said data recording device based on the extracted license when the authentication data received from said data recording device is authenticated and it is determined according to said check-out information obtainable by decrypting said provided dedicated license that the check-out of the license is allowed; constructs an encryption path to said data recording device via said control unit; provides said check-out license to said data recording device via said encryption path; obtains specifying information specifying said data recording device via said encryption path from said data recording device; produces new check-out information by adding the obtained specifying information to said check-out information; and produces one new dedicated license including said license included in said provided dedicated license and said new check-out information, and
said control unit overwrites the dedicated license in the administration file stored in said storing unit with said one new dedicated license produced by said module unit.

25. The data terminal device according to claim 24, wherein
after providing said check-out license,
said module unit produces one new binding key, produces one new binding license including the produced new binding key, produces one new private file including said produced one new binding license, produces one new encrypted private file by uniquely encrypting the produced one new private file, and provides said produced one new binding license to said device unit,
said device unit stores the received one new binding license in said dedicated region by overwriting, and
said control unit overwrites said encrypted private file stored in said storing unit with said one new encrypted private file produced by said module unit.

26. A data terminal device obtaining encrypted content data prepared by encrypting content data and a license for decrypting said encrypted content data to obtain original plaintext, and administering said encrypted content data and said license, comprising:
a device unit obtaining said license at a first security level, and administering said license at said first security level;
a module unit obtaining said license at a second security level lower than said first security level, producing a dedicated license by effecting encryption suitable to administration at said second security level on said license, and administering said license;
a storing unit storing data; and
a control unit, wherein
said device unit includes a recording unit recording said license while keeping a correspondence to an administration number;
said storing unit stores:
a plurality of first administration files including a plurality of encrypted content data and the administration numbers corresponding to the licenses administered by said device unit,
a plurality of second administration files including said dedicated license, and
a plurality of encrypted content data corresponding to said first administration file or said second administration file; and
when said control unit obtains the license at said first security level, said control unit provides the license obtained at said first security level to said device unit, produces said first administration file, and writes the produced first administration file and the encrypted content data obtained corresponding to the license obtained at said first security level in said storing unit; and, when said control unit obtains the license at said second security level, said control unit provides the license obtained at said second security level to said module unit, obtains said dedicated license including the license obtained at said second security level from said module unit, produces said second administration file, and writes the produced second administration file and the encrypted content data obtained corresponding to the license obtained at said second security level in said storing unit.

27. The data terminal device according to claim 14, wherein
when said control unit obtains the license at said first security level, said control unit provides said administration number to said device unit, and produces said first administration file including the same administration number as said provided administration number, and
said device unit holds said license based on the administration number received from said control unit.

28. The data terminal device according to claim 26, wherein
said module unit produces said dedicated license in an encryption manner determined based on information peculiar to said control unit.

29. The data terminal device according to claim 26, wherein
said dedicated license included in said second administration file includes check-out information for checking out the encrypted content data obtained at said second security level to another device.

30. The data terminal device according to claim 26, wherein
said control unit obtains said encrypted content data and/or said license from a content supply device.

31. The data terminal device according to claim 30, wherein
said device unit further includes an authentication data holding unit for holding the authentication data for said content supply device, and
said control unit provides said authentication data read from said device unit to said content supply device, and receives at least said license based on the authentication of said authentication data by said content supply device.

32. The data terminal device according to claim 30, wherein
said module unit executes reception of said encrypted content data and said license at said second security level by a program.

33. The data terminal device according to claim 26, wherein
when the content data is obtained,
said control unit provides the obtained content data to said module unit,
said module unit produces said license, produces the encrypted content data by encrypting said obtained content data with said produced license in a reproducible manner, and produces said dedicated license including said produced license, and
said control unit obtains said dedicated license including said license produced by said module unit and said produced and encrypted content data from said module unit, produces said second administration file, and writes said produced second administration file and said produced and encrypted content data in said storing unit.

34. The data terminal device according to claim 33, wherein
said module unit obtains rules of use assigned to said content data, and produces said license in accordance with the obtained rules of use.

35. The data terminal device according to claim 29, wherein
when the content data is obtained,
said control unit provides the obtained content data to said module unit,
said module unit produces said license, produces the encrypted content data by encrypting said obtained content data with said produced license in a reproducible manner, produces said dedicated license including said produced license, and produces said dedicated license including check-out information for checking out the encrypted content data obtained at said second security level to another devices,
said control unit obtains said dedicated license including said license produced by said module unit and said produced and encrypted content data from said module unit, produces said second administration file, and writes said produced second administration file and said produced and encrypted content data in said storing unit.

36. The data terminal device according to claim 26, further comprising:
an interface unit transmission to and from a data recording device; and
a key operating unit entering an instruction, wherein
said control unit specifies said first administration file stored in said storing unit and said encrypted content data in accordance with a shift instruction applied via said key operating unit, reads said administration number from the specified first administration file, provides the read administration number to said device unit, obtains said specified and encrypted content data from said storing unit, and provides the obtained and encrypted content data to said data recording device via said interface unit, and
said device unit constructs an encryption path to said data recording device via said control unit and said interface unit, and provides the license corresponding to said applied administration number to said data recording device via said encryption path.

37. The data terminal device according to claim 36, wherein
said device unit erases the license when said device unit provides said license to said data recording device via said encryption path.

38. The data terminal device according to claim 29, further comprising:
an interface unit transmission to and from a data recording device; and
a key operating unit entering an instruction, wherein
said control unit specifies said second administration file stored in said storing unit and said encrypted content data in accordance with a shift instruction applied via said key operating unit, reads said dedicated license from the specified second administration file, provides the read dedicated license to said module unit, obtains said specified and encrypted content data from said storing unit, and provides the obtained and encrypted content data to said data recording device via said interface unit,
said module unit decrypts said applied dedicated license, constructs an encryption path to said data recording device via said control unit and said interface unit based on said check-out information included in said dedicated license, produces the check-out license based on said license included in said provided dedicated license, provides the produced check-out license to said data recording device via said encryption path, obtains specifying information specifying said data recording device via said encryption path from said data recording device, produces new check-out information by adding the obtained specifying information to said check-out information, and produces one new dedicated license including said license included in said provided dedicated license and said new check-out information, and
said control unit overwrites the dedicated license in said second administration file stored in said storing unit with said one new dedicated license produced by said module unit.

39. The data terminal device according to claim 36, wherein
said control unit provides encrypted content data and said license to said data recording device based on the authentication of the authentication data obtained from said data recording device via said interface unit.

40. A program to be executed by a computer to obtain and administer a license used for decrypting encrypted content data to obtain original plaintext, wherein the computer executes:
a first step of obtaining said license;
a second step of decrypting an encrypted private file to obtain a binding license including a binding key for encrypting the encrypted private file;
a third step of obtaining said encrypted private file, and decrypting said obtained and encrypted private file with the binding key included in said binding license to obtain a private file;
a fourth step of writing said obtained license into said private file, encrypting again the private file including said written license with said binding key to produce one new encrypted private file, and overwriting said encrypted private file with the produced one new encrypted private file.

41. The program to be executed by the computer according to claim 40, wherein the computer further executes:
a fifth step of obtaining said encrypted private file and said binding license, extracting the binding key included in the obtained binding license, and decrypting said obtained and encrypted private file with the extracted binding key to obtain the license; and
a sixth step of providing a part or all of said extracted license.

42. The program to be executed by the computer according to claim 41, wherein
the computer further executes a seventh step of updating said encrypted private file when said sixth step is executed; and
said seventh step includes the steps of:
deleting the provided license, producing one new binding key, and producing one new binding license including the produced one new binding key,
encrypting said encrypted private file with said produced one new binding key to produce one new encrypted private file,
storing said produced one new binding license, and
overwriting the encrypted private file already stored with said produced one new encrypted private file.

43. The program to be executed by the computer according to claim 41, wherein when providing said license to a different data terminal device,
said sixth step includes the steps of:
receiving authentication data from said different data terminal device, and authenticating said different data terminal,
constructing an encryption communication path to said different data terminal device, and
sending the license extracted in said fifth step to said different data terminal device via said encryption path.

44. The program to be executed by the computer according to claim 43, wherein
the computer further executes a seventh step of updating said encrypted private file when said sixth step is executed; and
said seventh step includes the steps of:
producing one new binding key, and producing one new binding license including the
produced one new binding key,
deleting the license sent from said private file, encrypting the private file previously including said sent license with said one new binding key to produce one new encrypted private file, and
overwriting said encrypted private file with said produced one new encrypted private file.

45. The program to be executed by the computer according to claim 40, wherein
said encrypted private file includes, for each license, check-out information for checking out said license to a check-out destination; and
said computer further executes:
a fifth step of authenticating authentication data received from said check-out destination,
a sixth step of constructing an encryption path to said check-out destination,
a seventh step of obtaining said binding license, decrypting said encrypted private file with the binding key included in said obtained binding license, and extracting said license to be sent and said check-out information from the decrypted private file,
an eighth step of determining from said extracted check-out information whether the checkout of the license is allowed or not,
a ninth step of producing the check-out license to be checked out to said check-out destination based on the license to be sent when it is determined that the check-out of said license is allowed,
a tenth step of sending said produced check-out license to said check-out destination via said encryption path, and obtaining specifying information for specifying said check-out destination via said encryption path from said check-out destination,
an eleventh step of producing new check-out information by adding said obtained specifying information to said check-out information, and producing one new private file by overwriting the check-out information in said private file with said new check-out information,
a twelfth step of producing one new encrypted private file by encrypting said one new private file with said binding key, and
a thirteenth step of overwriting said encrypted private file with said produced one new encrypted private file.

46. The program to be executed by the computer according to claim 40, wherein
said encrypted private file includes, for each license, check-out information for checking out said license to a check-out destination; and
said computer further executes:
a fifth step of authenticating authentication data received from said check-out destination,
a sixth step of constructing an encryption path to said check-out destination,
a seventh step of obtaining said binding license, decrypting said encrypted private file with the binding key included in said obtained binding license, and extracting said license to be sent and said check-out information from the decrypted private file,
an eighth step of determining from said extracted check-out information whether the checkout of the license is allowed or not,
a ninth step of producing the check-out license to be checked out to said check-out destination based on the license to be sent when it is determined that the check-out of said license is allowed,
a tenth step of sending said check-out license to said check-out destination via said encryption path, and obtaining specifying information for specifying said check-out destination via said encryption path from said check-out destination,
an eleventh step of producing one new binding key, and producing one new binding license including the produced one new binding key,
a twelfth step of producing new check-out information by adding said obtained specifying information to said check-out information, and producing one new private file by overwriting the check-out information in said private file with said new check-out information,
a thirteen step of producing one new encrypted private file by encrypting said produced one new private file with said one new binding key, and
a thirteenth step of overwriting said encrypted private file with said one new encrypted private file.

47. A program to be executed by a computer to obtain and administer a license used for decrypting encrypted content data to obtain original plaintext, wherein the computer executes:
a first step of obtaining said license by software;
a second step of uniquely encrypting said obtained license to produce a dedicated license;
a third step of determining whether a first binding license administered by software matches with a second binding license administered by hardware or not;
a fourth step of obtaining said dedicated license administered by software and decrypting the provided dedicated license when said first binding license matches with said second binding license; and
a fifth step of providing said decrypted license.

48. The program to be executed by the computer according to claim 47, wherein
for initializing an encrypted private file produced by encrypting a private file storing said first binding license,
the computer further executes:
a sixth step of producing said first binding license including a binding key,
a seventh step of producing the private file storing said produced first binding license,
an eighth step of uniquely encrypting said produced private file to produce said encrypted private file, and
a ninth step of providing said produced first binding license as said second binding license to a device unit.

49. The program to be executed by the computer according to claim 47, wherein
after providing said license,
the computer further executes:
a sixth step of producing one new binding key, and producing one new first binding license including the produced one new binding key,
a seventh step of producing one new private file including said produced first binding license,
an eighth step of uniquely encrypting said produced one new private file to produce one new encrypted private file,
a ninth step of providing said produced one new first binding license to a device unit, and
a tenth step of overwriting said encrypted private file already stored with said produced one new encrypted private file.

50. The program to be executed by the computer according to claim 47, wherein
for sending said license to a different terminal device,
the computer further executes:
a sixth step of receiving authentication data from said different terminal device,
a seventh step of extracting said first binding license by decrypting said encrypted private file,
an eighth step of obtaining said second binding license from said device unit,
a ninth step of constructing an encryption communication path to said different terminal device when said obtained second binding license matches with the first binding license extracted from said encrypted private file, and said received authentication data is authenticated, and
a tenth step of sending a license obtained by decrypting said provided dedicated license to said different terminal device via said encryption path; and
after sending said license,
the computer further executes:
an eleventh step of producing one new binding key, and producing one new first binding license including the produced one new binding key,
a twelfth step of producing one new private file including said produced first binding license,
thirteenth step of uniquely encrypting said produced one new private file to produce one new encrypted private file,
a fourteenth step of providing said produced one new first binding license to said device unit, and
a fifteenth step of overwriting said encrypted private file already stored with said produced one new encrypted private file.

51. The program to be executed by the computer according to claim 47, wherein
a manner of said uniquely encrypting the file is linked with information unique to data terminal device and obtainable from the data terminal device.

52. The program to be executed by the computer according to claim 47, wherein
for providing said first binding license to said device unit,
the computer further executes:
a sixth step of receiving authentication data from said device unit,
a seventh step of constructing an encryption communication path to said device unit when said received authentication data is authenticated, and
an eighth step of providing said first binding license to said device unit via said constructed encryption communication path.

53. The program to be executed by the computer according to claim 47, wherein
for obtaining said second binding license from said device unit,
the computer further executes:
a sixth step of providing authentication data to said device unit,
a seventh step of constructing an encryption communication path to said device unit when said device unit authenticates said authentication data, and
an eighth step of obtaining said second binding license from said device unit via said constructed encryption communication path.

54. The program to be executed by the computer according to claim 47, wherein
said dedicated license includes check-out information for checking out said license; and
for output performed for the check-out, the computer further executes:
a sixth step of receiving authentication data from said check-out destination,
a seventh step of reading said encrypted private file and a dedicated license,
an eighth step of decrypting said encrypted private file to extract a first binding license, and obtaining a second binding license from said device unit,
a ninth step of decrypting said read dedicated license to extract the license and the check-out information, and produces a check-out license to be checked out to said check-out destination based on said extracted license when said obtained second binding license matches with said extracted first binding license, the authentication data received from said check-out destination is authenticated and it is determined from said extracted check-out information that check-out of the license is allowed,
a tenth step of constructing an encryption communication path to said check-out destination,
an eleventh step of sending said check-out license to said check-out destination via said encryption path,
a twelfth step of obtaining specifying information for specifying said check-out destination via said encryption path from said check-out destination,
an thirteenth step of producing new check-out information by adding said obtained specif3iing information to said check-out information,
a fourteenth step of producing one new dedicated license including said extracted license and said new check-out information, and
a fifteenth step of overwriting said read dedicated license with said new one dedicated license.

55. The program to be executed by the computer according to claim 54, wherein
after sending said check-out license,
the computer further executes:
sixteenth step of producing one new binding key, and producing one new first binding key including the produced binding key,
a seventeenth step of producing one new private file including said produced one new first binding license, and producing one new encrypted private file by uniquely encrypting the produced one new private file,
an eighteenth step of providing said produced one new first binding license to said device unit, and
a nineteenth step of overwriting the encrypted private file already stored with said produced one new encrypted private file.

56. A program to be executed by a computer to obtain and administer a license used for decrypting encrypted content data to obtain original plaintext, wherein the computer executes:
a first step of obtaining said license at a first security level;
a second step of obtaining said license at a second security level lower than said first security level;
a third step of producing a dedicated license by effecting encryption suitable to administration at said second security level on said license;
a fourth step of operating, when the license is obtained at said first security level, to provide the license obtained at said first security level to said device unit, produce a first administration file, and write the produced first administration file and the encrypted content data obtained corresponding to the license obtained at said first security level in a storing unit; and a fifth step of operating, when the license is obtained at said second security level, to provide the license obtained at said second security level to said module unit, obtain the dedicated license including the license obtained at said second security level from said module unit, produce a second administration file, and write the produced second administration file and the encrypted content data obtained corresponding to the license obtained at said second security level in said storing unit.
